(19) United States
(12) Patent Application Publication
(10) Pub. No.: US 2023/0015092 A1
(43) Pub. Date: Jan. 19, 2023

(54) COMPOSITION COMPRISING STEVIA GLYCOSIDES, METHOD OF MAKING AND USE THEREOF

(71) Applicant: EPC NATURAL PRODUCTS CO., LTD., Beijing (CN)

(72) Inventors: Jingang SHI, Beijing (CN); Hanshang Wang, Beijing (CN); Thomas Eidenberger, Wels (AT); Xiaorui Zhang, Beijing (CN); Weiyao Shi, New York, NY (US)

(21) Appl. No.: 17/806,851

(22) Filed: Jun. 14, 2022

Related U.S. Application Data
(60) Provisional application No. 63/202,553, filed on Jun. 16, 2021.

(51) Int. Cl. A23L 27/30; A23L 27/21; A23L 2/60; A23C 9/156

(52) U.S. Cl. CPC A23L 27/36; A23L 27/215; A23L 2/60; A23C 9/156; A23V 2002/00

(57) ABSTRACT

Compositions comprising glycosylated small molecule weight steviol glycosides (G-SMW-SGs) and glycosylated small molecule weight steviol glycoside Maillard reaction products (G-SMW-SG-MRPs) are described. These compositions provide improved taste profiles and can be used as sweeteners or a flavorants in consumable products, including foods and beverages.

### RELATED APPLICATIONS

This application claims priority of U.S. Provisional Patent Application No. 63/202,553, filed on Jun. 16, 2021, which is incorporated by reference in its entirety.

### FIELD

The present disclosure relates generally to compositions containing one or more glycosylated small molecule weight steviol glycosides (G-SMW-SGs) and/or the Maillard reaction products thereof, and the use of such compositions in food and beverage products.

### BACKGROUND

Dietary sugar has become a much debated health issue, since high consumption of sugars is associated with common “acquired civilization diseases,” including obesity, diabetes, and cardiovascular disease. In recent decades, health policies in the industrialized world have aimed to put forward measures to reduce sugar consumption. Sugar reduction has become a major challenge for food and especially beverage producers. Sugar reduction strategies to e.g., offer less sweet foods and drinks are part of a long term process as they involve consumer education to change consumption patterns for sugar intake and changes in consumer's flavor preferences. In addition, these strategies face challenges and risks associated losses in value and demand of conventional branded products.

The replacement of sugars with high intensity sweeteners (HIS) has a long history. The first commercial applications lead back to the first World War. Saccharin was introduced in Great Britain due to shortages in sugar imports overseas. Saccharin was then primarily used from the 1960's and onward as a sugar replacement for diabetics and in the newly evolving niche of the first small groups of dieters preferring the zero-calorie properties of saccharin. With the broader use of saccharin, prices of saccharin dropped rapidly. Consequently, replacement of sugars with saccharin provided cost reductions to manufacturers. These developments have influenced general attitudes about HIS use up to the present day. However, despite the cost reductions associated with replacement of sugars in favor of HIS, such replacements have not sufficiently considered the sensory attributes of HIS in these replacements.

From a historical perspective, the history of “artificial sweeteners” is not based on sugar reduction, but on sugar replacement due to disease or shortages of sugar. This may explain why the properties of HIS have until now focused on sugar replacement, rather than sugar reduction. Sugar-free foods and beverages do not compete with the sugar alternatives, but themselves. While products containing aspartame and Ace-K may taste better than saccharin, sucralose might be the best solution for sugar-free products. However, all of these “solutions” fail in any comparison to sugar.

Presently, sugar reduction or replacement strategies with HIS need a realignment for the targets. The sensory benchmarks associated with products containing HIS, including the so-called natural HIS sweeteners (e.g., stevia glycosides, thaumatin, mogrosides etc.), are predicated on the perception of sugar sweetness, rather than the sensation of sugar sweetness and the overall teast profile, such as sweetness onset, sweet lingering, mouth feel and aftertaste. To successfully accomplish the foregoing challenges, there is need for developing solutions that mimic sensory properties of sugar sweetness perception.

### SUMMARY

The present application relates to compositions containing one or more glycosylated small molecule weight steviol glycoside Maillard reaction products (G-SMW-SG-MRPs) and their use in consumable products.

One aspect of the present application relates to a composition, comprising: (1) a Maillard reaction product (MRP) formed from a reaction mixture comprising (a) a glycosylated small molecule weight steviol glycoside (G-SMW-SG); and (b) an amine donor, wherein (a) and (b) undergo Maillard reaction; and wherein the sweetening or flavor composition optionally may further comprise (2) a sweetener.

Another aspect of the present application relates to a composition, comprising: (1) a conventiona Maillard reaction product (MRP) formed from a reaction mixture comprising (a) a reducing sugar; and (b) an amine donor, wherein (a) and (b) undergo Maillard reaction; and (2) a G-SMW-SG.

Another aspect of the present application relates to a method to improve the taste profile of a consumable product. The method comprises the step of adding an effective amount of a composition of the present application to the consumable product, wherein the addition of the composition of the present application results in an improved taste profile in the consumable product.

### BRIEF DESCRIPTION OF THE DRAWINGS

FIG. 1 shows a schematic diagram of an exemplary time-intensity curve for illustrative purposes, as described in Ex 1.

FIG. 2A shows sugar equivalence of RU30.

FIG. 2B shows sugar equivalence of GRU30.

FIG. 2C shows the overall likability evaluation of different concentrations of RU30 and GRU30.

FIG. 3 shows sensory evaluation results of RU90 in quinine sulfate dihydrate.

### DETAILED DESCRIPTIONS

### I. Definitions

Unless defined otherwise, all technical and scientific terms used herein have the same meanings as commonly understood by one of ordinary skill in the art to which this application belongs. All publications and patents specifically mentioned herein are incorporated by reference in their entirety for all purposes including describing and disclosing the chemicals, instruments, statistical analyses and methodologies which are reported in the publications which might be used in connection with the application. All references cited in this specification are to be taken as indicative of the level of skill in the art. Nothing herein is to be construed as an admission that the application is not entitled to antedate such disclosure by virtue of prior invention.

In the specification and in the claims, the terms “including” and “comprising” are open-ended terms and should be interpreted to mean “including, but not limited to . . . .” These terms encompass the more restrictive terms “consisting essentially of” and “consisting of”

It must be noted that as used herein and in the appended claims, the singular forms “a,” “an,” and “the” include plural reference unless the context clearly dictates otherwise. Further, the terms “a” (or “an”), “one or more” and “at least one” can be used interchangeably herein. It is also to be noted that the terms “comprising,” “including,” “characterized by” and “having” can be used interchangeably. Further, any reactant concentrations described herein should be considered as being described on a weight to weight (w/w) basis, unless otherwise specified to the contrary (e.g., mole to mole, weight to volume (w/v), etc.).

As used herein, the term “glycoside” refers to a molecule in which a sugar (the “glycone” part or “glycone component” of the glycoside) is bonded to a non-sugar (the “aglycone” part or “aglycone component”) via a glycosidic bond.

The terms “steviol glycoside” and “SG” are used interchangeably with reference to a glycoside of steviol, a diterpene compound shown in Formula I, wherein one or more sugar residues are attached to the steviol compound of Formula I.

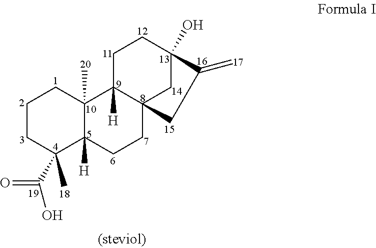

Steviol glycosides also include glycosides of isomers of steviol (isosteviol) as depicted in Formula II below, and derivatives of steviol, such as 12α-hydroxy-steviol and 15α-hydroxy-steviol.

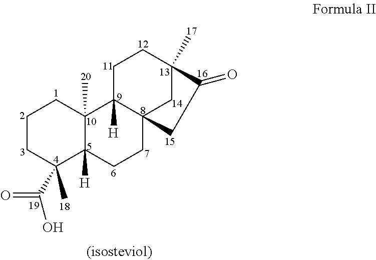

The terms “glycosidic bond” and “glycosidic linkage” refer to a type of chemical bond or linkage formed between the anomeric hydroxyl group of a saccharide or saccharide derivative (glycone) and the hydroxyl group of another saccharide or a non-saccharide organic compound (aglycone) such as an alcohol. The reducing end of the di- or polysaccharide lies towards the last anomeric carbon of the structure, whereas the terminal end lies in the opposite direction.

By way of example, a glycosidic bond in steviol and isosteviol involves the hydroxyl-group at the sugar carbon atom numbered 1 (so-called anomeric carbon atom) and a hydroxyl-group in the C19 carbonyl group of the steviol or isosteviol molecule building up a so-called O-glycoside or glycosidic ester. Additional glycosidic ester linkages can be formed at the hydroxyl group at C13 of steviol and at the carbonyl oxygen at C16 of isosteviol. Linkages at carbon atoms in the C1, C2, C3, C6, C7, C11, C12 and C15 positions of both steviol and isosteviol yield C-glycosides. In addition, C-glycosides can also be formed at the 2 methyl groups at C18 and C20 in both steviol and isosteviol.

The sugar part can be selected from any sugar with 3-7 carbon atoms, derived from either a dihydroxy-acetone (ketose) or a glycerin-aldehyde (aldose). The sugars can occur in open chain or in cyclic form, as D- or L-enantiomers and in α- or β-conformation.

Representative structures of possible sugar (Sug) conformations exemplified by glucose include D-glucopyranose and L-glucopyranose in which the position 1 is determinative of the α- or β-conformation:

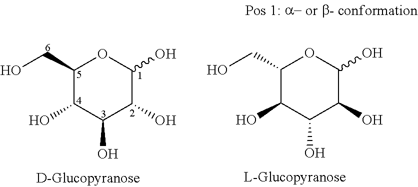 [SMILES: OC[C@H]1OC(O)[C@H](O)[C@@H](O)[C@@H]1O ; OC[C@@H]1OC(O)[C@@H](O)[C@H](O)[C@H]1O]

The steviol glycosides for use in the sweetener or flavor composition of the present application include one or more glycosylated small molecule weight steviol glycoside (G-SMW-SG) compounds with structures depicted in Table A.

TABLE A
Possible positions of sugar (Sug)
molecules linked to steviol/isosteviol.

| | | Sugar | | |
|---|---|---|---|---|
| Aglycone | Position | (Sug) | Conjugation | Category |
| Steviol | 13 | D-α | D-Sug α (1-13) | O-glucoside |
| | | D-β | D-Sug β (1-13) | |
| | | L-α | L-Sug α (1-13) | |
| | | L-β | L-Sug β (1-13) | |
| Isosteviol | 16 | D-α/β | D-Sug α/β (1-16) | O-glucoside |
| | | L-α/β | L-Sug α/β (1-16) | (after reduction |
| | | | | of keto-group) |
| Steviol | 19 | D/L-α/β | D/L-Sug α/β (1-19) | Glucose-ester |
| Isosteviol | | | | |
| Steviol | 1 | D/L-α/β | D/L-Sug α/β (1-1) | C-glucoside |
| | 2 | | D/L-Sug α/β (1-2) | |
| | 3 | | D/L-Sug α/β (1-3) | |
| | (5) | | D/L-Sug α/β (1-5) | |
| | 6 | | D/L-Sug α/β (1-6) | |
| | 7 | | D/L-Sug α/β (1-7) | |
| | (9) | | D/L-Sug α/β (1-9) | |
| | 11 | | D/L-Sug α/β (1-11) | |
| | 12 | | D/L-Sug α/β (1-12) | |
| | 14 | | D/L-Sug α/β (1-14) | |
| | 15 | | D/L-Sug α/β (1-15) | |
| Steviol | (18) | D/L-α/β | D/L-Sug α/β (1-18) | Methylen- |
| | | | | glucoside |
| | (20) | | D/L-Sug α/β (1-20) | |
| Isosteviol | 1 | D/L-α/β | D/L-Sug α/β (1-1) | C-glucoside |
| | 2 | | D/L-Sug α/β (1-2) | |
| | 3 | | D/L-Sug α/β (1-3) | |
| | (5) | | D/L-Sug α/β (1-5) | |
| | 6 | | D/L-Sug α/β (1-6) | |
| | 7 | | D/L-Sug α/β (1-7) | |
| | (9) | | D/L-Sug α/β (1-9) | |
| | 11 | | D/L-Sug α/β (1-11) | |
| | 12 | | D/L-Sug α/β (1-12) | |
| | (13) | | D/L-Sug α/β (1-12) | |
| | 14 | | D/L-Sug α/β (1-14) | |
| | 15 | | D/L-Sug α/β (1-15) | |
| Isosteviol | (18) | D/L-α/β | D/L-Sug α/β (1-18) | Methylen- |
| | | | | glucoside |
| | (20) | | D/L-Sug α/β (1-20) | |

Stevia plants contain a variety of different SGs in varying percentages. The phrase “steviol glycoside” is recognized in the art and is intended to include the major and minor constituents of Stevia. These “SGs” include, for example, stevioside, steviolbioside, rebaudioside A (RA), rebaudioside B (RB), rebaudioside C (RC), rebaudioside D (RD), rebaudioside E (RE), rebaudioside F (RF), rebaudioside M (RM), rebaudioside O (RO), rebaudioside H (RH), rebaudioside I (RI), rebaudioside L (RL), rebaudioside N (RN), rebaudioside K (RK), rebaudioside J (RJ), rebaudioside U, rubusoside (RU), dulcoside A (DA) as well as those listed in Tables A and B or mixtures thereof.

As used herein, the terms “rebaudioside A,” “Reb A,” “Reb-A” and “RA” are equivalent terms referring to the same molecule. The same condition applies to all lettered rebaudiosides with the exception of rebaudioside U, which may be referred to as Reb-U or Reb U, but not RU, so as to not be confused with rubusoside which is also referred to as RU.

Based on the type of sugar (i.e. glucose, rhamnose/deoxyhexose, xylose/arabinose) SGs can be grouped into three families (1) SGs with glucose; (2) SG with glucose and one rhamnose or deoxyhexose moiety; and (3) SGs with glucose and one xylose or arabinose moiety. The steviol glycosides for use in the present application are not limited by source or origin. Steviol glycosides may be extracted from Stevia leaves, synthesized by enzymatic processes, synthesized by chemical syntheses, or produced by fermentation.

Specific examples of steviol glycosides include, but are not limited to, the compounds listed in Table B and isomers thereof. The steviol glycosides for use in the present application are not limited by source or origin. Steviol glycosides may be extracted from Stevia plants, Sweet tea leaves, synthesized by enzymatic processes or chemical syntheses, or produced by fermentation.

The terms “glycosylated steviol glycoside” and “GSG” refer to a molecule that (1) contains a SG backbone and one or more additional sugar residues, and (2) is artificially produced by enzymatic conversion, fermentation or chemical synthesis.

The terms “non-Stevia glycoside”, “non-SG”, including glycosylated forms thereof, are used with reference to glycosides that are not present in Stevia plants or Stevia extracts. Exemplary non-Stevia glycosides or glycosylated forms thereof include, but are not limited to sweet tea extracts, swingle extracts, glycosylated sweet tea extracts, glycosylated swingle extracts, glycosylated sweet tea glycosides, glycosylated mogrosides, glycyrrhizin, glycosylated glycyrrhizin, rubusoside, glycosylated rubusoside, suaviosides, glycosylated suaviosides, mogrosides, glycosylated mogrosides and sucralose. The phrases “natural non-Stevia glycoside sweetener”, “natural non-SG sweetener”, including glycosylated forms thereof, are more broadly used with reference to non-Stevia glycosides, as well as other natural sweeteners that are not derived from Stevia plants or extracts, including but not limited to thaumatin, xylitol, monellin, brazzein, miraculin, curculin, pentadin, and mabinlin, and combination thereof. The phrase “non-Stevia sweetener” is more broadly used with reference to both natural non-SG sweeteners, as well as synthetic and semi-synthetic sweeteners as further described herein.

The terms “sweet tea extract” and “STE” refer to an extract prepared from the sweet tea (ST) plant. It should also be understood that an STE can be purified and/or separated into one or more sweet tea components (STCs).

The terms “sweet tea component” and “STC” refer to a component of an STE.

The terms “sweet tea glycoside” and “STG” refer to a glycoside derived from sweet tea plants or known to be present in sweet tea plants. Examples of STGs include, but are not limited to, rubusoside, suaviosides such as SU-A, SU-B, SU-C1, SU-D1, SU-D2, SU-E, SU-F, SU-G, SU-H, SU-I, and SU-J, steviolmonoside, rebaudioside A, 13-O-β-D-glucosyl-steviol, isomers of rebaudioside B, isomers of stevioside, panicloside IV and sugeroside. Some STGs, such as rubusoside, are also present in Stevia plants and are steviol glycosides (SGs).

The term “glycosylated sweet tea component (GSTC)” refers to a STC that has been subjected to an exogenously preformed glycosylation process. A GSTC may be artificially produced by enzymatic conversion, fermentation or chemical synthesis.

The term “glycosylated sweet tea glycoside (GSTG)” refers to a molecule that (1) contains a STG backbone and one or more additional sugar residues, and (2) is artificially produced by enzymatic conversion, fermentation or chemical synthesis.

The terms “glycosylated rubusoside” “glycosylated RU” and “GRU” are used interchangeably with reference molecules having a RU backbone with additional sugar units added in a glycosylation reaction under man-made conditions. GRUs include, but are not limited to, molecules having a RU backbone and 1-50 additional sugar units. As used herein, the term “sugar unit” refers to a monosaccharide unit.

As used herein, the term “enzymatically catalyzed method” refers to a method that is performed under the catalytic action of an enzyme, in particular of a glycosidase or a glycosyltransferase. The method can be performed in the presence of said glycosidase or glycosyltransferase in isolated (purified, enriched) or crude form.

The term “glycosyltransferase” (GT) refers to an enzyme that catalyzes the formation of a glycosidic linkage to form a glycoside. As used herein, the term “glycosyltransferase” also includes variants, mutants and enzymatically active portions of glycosyltransferases. Likewise, the term “glycosidase” also includes variants, mutants and enzymatically active portions of glycosidases.

The term “monosaccharide” as used herein refers to a single unit of a polyhydroxyaldehyde forming an intramolecular hemiacetal the structure of which including a six-membered ring of five carbon atoms and one oxygen atom. Monosaccharides may be present in different diasteromeric forms, such as a or f3 anomers, and D or L isomers. An “oligosaccharide” consists of short chains of covalently linked monosaccharide units. Oligosaccharides comprise disaccharides which include two monosaccharide units, as well as trisaccharides which include three monosaccharide units. A “polysaccharide” consists of long chains of covalently linked monosaccharide units.

The acronym “G-X” or “GX” refers to the glycosylation products of a composition “X”, i.e., product prepared from an enzymatically catalyzed glycosylation process with X and one or more sugar donors as the starting materials. For example, G-SMW-SG refers to the glycosylation product of a small molecule weight stevia glycoside (SMW-SG).

As used herein, the term “Maillard reaction” refers to a non-enzymatic reaction of (1) one or more reducing and/or non-reducing sugars, and (2) one or more amine donors in the presence of heat, wherein the non-enzymatic reaction produces a Maillard reaction product and/or a flavor. Thus, this term is used unconventionally, since it accommodates the use of non-reducing sweetening agents as substrates, which were not heretofore thought to serve as substrates for the Maillard reaction.

The term “reaction mixture” refers to a composition comprising at least one amine donor and one sugar donor, wherein the reaction mixture is to be subjected to a Maillard reaction; a “reaction mixture” is not to be construed as the reaction contents after a Maillard reaction has been conducted, unless otherwise noted.

The term “sugar,” as used herein, refers to a sweet-tasting, soluble carbohydrate, typically used in consumer food and beverage products.

The term “sugar donor,” as used herein, refers to a sweet-tasting compound or substance from natural or synthetic sources, which can participate as a substrate in a Maillard reaction with an amine group-containing donor molecule.

The term “amine donor,” as used herein, refers to a compound or substance containing a free amino group, which can participate in a Maillard reaction.

The term “Maillard reaction product” or “MRP” refers to any compound produced by a Maillard reaction between an amine donor and a sugar donor in the form of a reducing sugar, non-reducing sugar, or both. Preferably, the sugar donor includes at least one carbonyl group. In certain embodiments, the MRP comprises a compound that provides a flavor (“Maillard flavor”), a color (“Maillard color”), or both.

As used hereinafter, the term “standard MRP” or “conventional MRP (C-MRP)” refers to an MRP formed from a reaction mixture that contains (1) at least one reducing sugar as sugar donor and (2) one or more free amino acids as amine donor, wherein the at least one reducing sugar do not include any high intensity sweetener such as stevia extracts, sweet tea extracts or monk fruit extracts.

The terms “Stevia-MRP” refers to the product of a Maillard reaction, wherein the starting material of the Maillard reaction comprises a Stevia extract (SE), a steviol glycoside (SG), a glycosylated Stevia extract (GSE), a glycosylated steviol glycoside (GSG) or combinations thereof. Accordingly, Stevia-MRPs include, but are not limited to, SE-MRPs, SG-MRPs, GSE-MRPs and GSG-MRPs.

The terms “MRP composition,” “Maillard product composition” and “Maillard flavor composition” are used interchangeably and refer to a composition comprising one or more MRPs, including G-SMW-SG-MRPs, C-MRPs, SG-MRPs, etc.

The term “thaumatin”, as used herein, is used generically with reference to thaumatin I, II, III, a, b, c, etc. and/or combinations thereof.

The term “non-volatile”, as used herein, refers to a compound having a negligible vapor pressure at room temperature, and/or exhibits a vapor pressure of less than about 2 mm of mercury at 20° C.

The term “volatile”, as used herein, refers to a compound having a measurable vapor pressure at room temperature, and/or exhibits a vapor pressure of, or greater than, about 2 mm of mercury at 20° C.

As used herein, the term “sweetener” generally refers to a consumable product, which produces a sweet taste when consumed alone. Examples of sweeteners include, but are not limited to, high-intensity sweeteners, bulk sweeteners, sweetening agents, and low sweetness products produced by synthesis, fermentation or enzymatic conversion methods.

As used herein the term “high-intensity sweetener,” refers to any synthetic or semi-synthetic sweetener or sweetener found in nature. High-intensity sweeteners are compounds or mixtures of compounds which are sweeter than sucrose. High-intensity sweeteners are typically many times (e.g., 20 times and more, 30 times and more, 50 times and more or 100 times sweeter than sucrose). For example, sucralose is about 600 times sweeter than sucrose, sodium cyclamate is about 30 times sweeter, Aspartame is about 160-200 times sweeter, and thaumatin is about 2000 times sweeter then sucrose (the sweetness depends on the tested concentration compared with sucrose).

High-intensity sweeteners are commonly used as sugar substitutes or sugar alternatives because they are many times sweeter than sugar but contribute only a few to no calories when added to foods. High-intensity sweeteners may also be used to enhance the flavor of foods. High-intensity sweeteners generally will not raise blood sugar levels.

As used herein, the term “high intensity natural sweetener,” refers to sweeteners found in nature, typically in plants, which may be in raw, extracted, purified, refined, or any other form, singularly or in combination thereof. High intensity natural sweeteners characteristically have higher sweetness potency, but fewer calories than sucrose, fructose, or glucose. Examples of high intensity natural sweetener include, but are not limited to, sweet tea extracts, stevia extracts, swingle extracts, steviol glycosides, suaviosides, mogrosides, mixtures, salts and derivatives thereof.

As used herein, the term “high intensity synthetic sweetener” or “high intensity artificial sweetener” refers to high intensity sweeteners that are not found in nature. High intensity synthetic sweeteners include “high intensity semi-synthetic sweeteners” or “high intensity semi-artificial sweeteners”, which are synthesized from, artificially modified from, or derived from natural products. Examples of high intensity synthetic sweeteners include, but are not limited to, sucralose, aspartame, acesulfame-K, neotame, saccharin and aspartame, glycyrrhizic acid ammonium salt, sodium cyclamate, saccharin, advantame, neohesperidin dihydrochalcone (NHDC) and mixtures, salts and derivatives thereof.

As used herein, the term “sweetening agent” refers to a high intensity sweetener.

As used herein, the term “bulk sweetener” refers to a sweetener, which typically adds both bulk and sweetness to a confectionery composition and includes, but is not limited to, sugars, sugar alcohols, sucrose, commonly referred to as “table sugar,” fructose, commonly referred to as “fruit sugar,” honey, unrefined sweeteners, syrups, such as agave syrup or agave nectar, maple syrup, corn syrup and high fructose corn syrup (or HFCS).

As used herein, the term “sweetener enhancer” refers to a compound (or composition) capable of enhancing or intensifying sensitivity of the sweet taste. The term “sweetener enhancer” is synonymous with a “sweetness enhancer,” “sweet taste potentiator,” “sweetness potentiator,” and/or “sweetness intensifier.” A sweetener enhancer enhances the sweet taste, flavor, mouth feel and/or the taste profile of a sweetener without giving a detectable sweet taste by the sweetener enhancer itself at an acceptable use concentration. In some embodiments, the sweetener enhancer provided herein may provide a sweet taste at a higher concentration by itself. Certain sweetener enhancers provided herein may also be used as sweetening agents.

Sweetener enhancers can be used as food additives or flavors to reduce the amounts of sweeteners in foods while maintaining the same level of sweetness. Sweetener enhancers work by interacting with sweet receptors on the tongue, helping the receptor to stay switched “on” once activated by the sweetener, so that the receptors respond to a lower concentration of sweetener. These ingredients could be used to reduce the calorie content of foods and beverages, as well as save money by using less sugar and/or less other sweeteners. Examples of sweetener enhancers include, but are not limited to, brazzein, miraculin, curculin, pentadin, mabinlin, thaumatin, and mixtures thereof.

In some cases, sweetening agents or sweeteners can be used as sweetener enhancers or flavors when their dosages in food and beverage are low. In some cases, sweetener enhancers can be utilized as sweeteners where their dosages in foods and beverages are higher than dosages regulated by FEMA, EFSA or other related authorities.

As used herein, the phrase “low sweetness products produced by synthesis, fermentation or enzymatic conversion” refers to products that have less sweetness or similar sweetness than sucrose. Examples of low sweetness products produced by extraction, synthesis, fermentation or enzymatic conversion method include, but are not limited to, sorbitol, xylitol, mannitol, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-phenylalanine 1-methyl ester, glycyrrhizin, and mixtures thereof.

For example, “sugar alcohols” or “polyols” are sweetening and bulking ingredients used in manufacturing of foods and beverages. As sugar substitutes, they supply fewer calories (about a half to one-third fewer calories) than sugar, are converted to glucose slowly, and are not characterized as causing spiked increases in blood glucose levels.

Sorbitol, xylitol, and lactitol are exemplary sugar alcohols (or polyols). These are generally less sweet than sucrose, but have similar bulk properties and can be used in a wide range of food and beverage products. In some case, their sweetness profile can be fine-tuned by being mixed together with high-intensity sweeteners.

The terms “flavor” and “flavor characteristic” are used interchangeably with reference to the combined sensory perception of one or more components of taste, aroma, and/or texture.

The terms “flavoring agent”, “flavoring” and “flavorant” are used interchangeably with reference to a product added to food or beverage products to impart, modify, or enhance the flavor of food. As used herein, these terms do not include substances having an exclusively sweet, sour, or salty taste (e.g., sugar, vinegar, and table salt).

The term “natural flavoring substance” refers to a flavoring substance obtained by physical processes that may result in unavoidable but unintentional changes in the chemical structure of the components of the flavoring (e.g., distillation and solvent extraction), or by enzymatic or microbiological processes, from material of plant or animal origin.

The term “synthetic flavoring substance” refers to a flavoring substance formed by chemical synthesis.

The term “enhance,” as used herein, includes augmenting, intensifying, accentuating, magnifying, and potentiating the sensory perception of a flavor characteristic without changing the nature or quality thereof.

Unless otherwise specified, the terms “modify” or “modified” as used herein, includes altering, varying, suppressing, depressing, fortifying and supplementing the sensory perception of a flavor characteristic where the quality or duration of such characteristic was deficient.

The phrase “sensory profile” or “taste profile” is defined as the temporal profile of all basic tastes of a sweetener. The onset and decay of sweetness when a sweetener is consumed, as perceived by trained human tasters and measured in seconds from first contact with a taster's tongue (“onset”) to a cutoff point (typically 180 seconds after onset), is called the “temporal profile of sweetness.” A plurality of such human tasters is called a “sensory panel”. In addition to sweetness, sensory panels can also judge the temporal profile of the other “basic tastes”: bitterness, saltiness, sourness, piquance (aka spiciness), and umami (aka savoriness or meatiness). The onset and decay of bitterness when a sweetener is consumed, as perceived by trained human tasters and measured in seconds from first perceived taste to the last perceived aftertaste at the cutoff point, is called the “temporal profile of bitterness”.

The phrase “sucrose equivalence” or “SugarE” is the amount of non-sucrose sweetener required to provide the sweetness of a given percentage of sucrose in the same food, beverage, or solution. For instance, a non-diet soft drink typically contains 12 grams of sucrose per 100 ml of water, i.e., 12% sucrose. This means that to be commercially accepted, diet soft drinks must generally have the same sweetness as a 12% sucrose soft drink, i.e., a diet soft drink must have a 12% SugarE. Soft drink dispensing equipment assume an SugarE of 12%, since such equipment is set up for use with sucrose-based syrups.

As used herein, the term “off-taste” refers to an amount or degree of taste that is not characteristically or usually found in a beverage product or a consumable product of the present disclosure. For example, an off-taste is an undesirable taste of a sweetened consumable to consumers, such as, a bitter taste, a licorice-like taste, a metallic taste, an aversive taste, an astringent taste, a delayed sweetness onset, a lingering sweet aftertaste, and the like, etc.

The term “orally consumable product” refers to a composition that can be drunk, eaten, swallowed, inhaled, ingested or otherwise in contact with the mouth or nose of man or animal, including compositions which are taken into and subsequently ejected from the mouth or nose. Orally consumable products are safe for human or animal consumption when used in a generally acceptable range.

As used herein, the term “fruit” refers to firm fruits, soft fruits, sliced pieces with skin remaining, and/or dried/scarified/pricked/scraped fruit, which are well-known in the art, and described herein. Examples of fruit include, but are not limited to, apple, pear, orange, tangerine, lemon, lime, apricot, plum, prune, kiwi, guava, pineapple, coconut, papaya, mango, grape, cherry, pomegranate, grape fruit passion fruit, dragon fruit, melons and berries. Example of berries include, but are not limited to, cranberry, blueberry, boysenberry, elderberry, chokeberry, lingonberry, raspberry, mulberry, gooseberry, huckleberry, strawberry, blackberry, cloudberry, blackcurrant, redcurrant and white currant. Exemplary melons include, but are not limited to, watermelon, cantolope, Muskmelon, honeydew melon, canary melon, casaba melon, chareatais melon, crenshaw melon, galia melon, golden Langkawi melon, hami melon, honey globe melon, horned melon, jadedew melon, kantola melon and Korean melon.

The term “fruit juice” refers to a juice derived from one or more fruits. Fruit juices include freshly prepare fruit juices, concentrated fruit juices, and juices reconstituted from concentrated fruit juices.

The term “vegetables” refers to fresh vegetables, preserved vegetables, dried vegetables, vegetable juice and vegetable extracts. Examples of vegetables include, but are not limited to, broccoli, cauliflower, artichokes, capers, cabbage, turnip, radish, carrot, celery, parsnip, beetroot, lettuce, beans, peas, potato, eggplant, tomato, sweet corn, cucumber, squash, zucchinis, pumpkins, onion, garlic, leek, pepper, spinach, yam, sweet potato, taro, and yams and cassava.

The term “vegetable juice” refers to a juice derived from one or more vegetables. Vegetables juices include freshly prepare vegetables juices, concentrated vegetables juices, and juices reconstituted from concentrated vegetables juices.

Unless otherwise noted, the term “ppm” (parts per million) means parts per million on a w/w or wt/wt basis.

### II. Compositions and Methods of the Present Application

In one aspect, the present application relates to compositions that comprises (1) a Maillard reaction product (MRP) formed from a reaction mixture comprising: (a) a sugar donor glycosylated small molecule weight steviol glycoside (G-SMW-SG); and (b) an amine donor, wherein (a) and (b) undergo the Maillard reaction; and (2) a sweetener or favorant.

In some embodiments, the MRP is formed from a reaction mixture that comprises one or more G-SMW-SGs (G-SMW-SG-MRP). In some embodiments, the one or more G-SMW-SGs are selected from the group consisting of glycosylated rebaudioside B (GRB), glycosylated steviolbioside (GSTB), glycosylated steviol monoside (GSTM) and glycosylated rubusoside (GRU). In some embodiments, the MRP is formed from a reaction mixture that comprises one or more SMW-SGs (SMW-SG-MRP). In some embodiments, the one or more SMW-SGs are selected from the group consisting of rebaudioside B (RB), steviolbioside (STB), steviol monoside (STM) and rubusoside (RU). In some embodiments, the MRP is a conventional MRP. In some embodiments, the MRP is formed from a reducing sugar and an amine donor in the absence of a high intensity sweetener.

In some embodiments, the sweetener or favorant comprises a high intensity sweetener, such as a stevia extract, steviol glycoside, monk fruit extract, mogroside, sweet tea extract, rubusoside, suavioside, sucralose, acesulfame K, saccharine, aspartame, licorice extract or a combination thereof. In some embodiments, the the sweetener or favorant comprises one or more SMW-SGs and/or G-SMW-SGs.

In some embodiments, the composition of the present application comprises a G-SMW-SG-MRP, a SMW-SG-MRP and/or a C-MRP in an amount of 000.1-99.9 wt % of the composition. In some embodiments, the G-SMW-SG-MRP is an MRP derived from GRB (GRB-MRP). In some embodiments, the G-SMW-SG-MRP is an MRP derived from GSTB (GSTB-MRP). In some embodiments, the G-SMW-SG-MRP is an MRP derived from GSTM (GSTM-MRP). In some embodiments, the G-SMW-SG-MRP is an MRP derived from GRU (GRU-MRP). In some embodiments, the G-SMW-SG-MRP is an MRP derived from a Maillar reaction mixture that contains a G-SMW-SG product derived from a stevia extract enriched for SMW-SGs, such as RB30, or a sweet tea extracts enriched for SMW-SGs, such as RU30 and RU40.

In some embodiments, C-MRP, G-SMW-SG-MRP, such as GRB-MRP, GSTB-MRP, GSTM-MRP and GRU-MRP, and/or SMW-SG-MRP, such as RB-MRP, STB-MRP, STM-MRP and RU-MRP, is present in the composition of the present application in the amount of 0.001-99 wt %, 0.001-75 wt %, 0.001-50 wt %, 0.001-25 wt %, 0.001-10 wt %, 0.001-5 wt %, 0.001-2 wt %, 0.001-1 wt %, 0.001-0.1 wt %, 0.001-0.01 wt %, 0.01-99 wt %, 0.01-75 wt %, 0.01-50 wt %, 0.01-25 wt %., 0.01-10 wt %, 0.01-5 wt %, 0.01-2 wt %, 0.01-1 wt %, 0.1-99 wt %, 0.1-75 wt %, 0.1 wt-50 wt %, 0.1-25 wt %, 0.1-10 wt %, 0.1-5 wt %, 0.1-2 wt %, 0.1-1 wt %, 0.1-0.5 wt %, 1-99 wt %, 1-75 wt %, 1-50 wt %, 1-25 wt %, 1-10 wt %, 1-5 wt %, 5-99 wt %, 5-75 wt %, 5-50 wt %, 5-25 wt %, 5-10 wt %, 10-99 wt %, 10-75 wt %, 10-50 wt %, 10-25 wt %, 10-15 wt %, 20-99 wt %, 20-75 wt %, 20-50 wt %, 30-99 wt %, 30-75 wt %, 30-50 wt %, 40-99 wt %, 40-75 wt %, 40-50 wt %, 50-99 wt %, 50-75 wt %, 60-99 wt %, 60-75 wt %, 70-99 wt %, 70-75 wt %, 80-99 wt %, 80-90 wt %, 90-99 wt %, or any range defined by any pair of these integers.

In some embodiments, the sweetener or favorant comprises one or more SMW-SGs and/or one or more G-SMW-SGs. In some embodiments, the one or more SMW-SGs comprise RB, STB, STM and/or RU, and the one or more G-SMW-SGs comprise GRB, GSTB, GSTM and/or GRU. In some embodiments, the one or more SMW-SGs are selected from the stevia extracts enriched for SMW-SGs, such as RA30, and sweet tea extracts enriched for SMW-SGs, such as RU30 and RU40.

In some embodiments, the composition further comprises a Stevia extract (SE) and/or steviol glycoside (SG).

In some embodiments, the composition further comprises a glycosylated Stevia extract (GSE) and/or a glycosylated steviol glycoside (GSG).

In some embodiments, the composition further comprises an SE-MRP, GSE-MRP, SG-MRP, GSG-MRP, or combination thereof.

In some embodiments, the composition further comprises an SE, STE, GSE or GSTE that contains an enriched SG or GSG.

In some embodiments, the composition further comprises an SE that contains an enriched diterpene glycoside or glycosylated diterpene glycoside.

In some embodiments, the composition of the present application further comprises one or more components selected from the group consisting of conventional MRPs (C-MRPs), glycosylated C-MRPs (G-C-MRPs), sweet tea extracts (STEs), glycosylated STEs (GSTEs), GSTE-MRPs, sweet tea components (STCs), glycosylated STCs (GSTCs), sweet tea glycosides (STGs), glycosylated STGs (GSTGs), GSTG-MRPs, or a combination thereof.

In some embodiments, the composition of the present application further comprises one or more non-stevia glycoside components selected from the group consisting of sweet tea extracts, swingle extracts, glycosylated sweet tea extracts, glycosylated swingle extracts, glycosylated sweet tea glycosides, glycosylated mogrosides, glycyrrhizin, glycosylated glycyrrhizin, rubusoside, glycosylated rubusoside, suaviosides, glycosylated suaviosides, mogrosides, glycosylated mogrosides and sucralose.

In some embodiments, the composition of the present application further comprises one or more non-stevia sweeteners selected from the group consisting of cyclamates and salts thereof, aspartame, saccharin and salts thereof, xylitol, acesulfame-K, neotame, N—[N-[3-(3-hydroxy-4-methoxyphenyl) propyl]-alpha-aspartyl]-phenylalanine 1-methyl ester (ANS9801), monellin, brazzein, miraculin, curculin, pentadin, and mabinlin.

In some embodiments, the composition of the present application further comprises thaumatin.

In some embodiments, the composition of the present application comprises an SE, SG, GSE, GSG, SE-MRP, SG-MRP, GSE-MRP, GSG-MRP, C-MRP, G-C-MRP, STE, STC, STG, GSTE, GSTC, GSTG, STE-MRP, GSTE-MRP, or combination thereof, individually or collectively, in an amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, 95-99 wt %, or any range defined by any pair of these integers.

In some embodiments, the composition of the present application comprises a Stevia extract (SE) and/or a glycosylated SE (GSE) having an enriched content of one or more SMW-SGs or G-SMW-SGs in an amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the composition of the present application comprises a Stevia extract (SE) enriched for SMW-SGs, wherein the amount of SMW-SG in the SE is at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or is in any range defined by any pair of these integers. In some embodiments, the composition of the present application comprises a Stevia extract (SE) enriched for SMW-SGs, wherein HMW-SGs are present in the in the SE in an amount that equals to, or is less than, 1 wt %, 2 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, or 90 wt %, or is is any range defined by any pair of these integers. In some embodiments, the composition of the present application comprises a G-SMW-SG derived from the a Stevia extract (SE) enriched for SMW-SGs, as described above. In some embodiments, the composition of the present application comprises a G-SMW-SG-MRP derived from the a G-SMW-SG described above.

In some embodiments, the composition of the present application further comprises one or more flavonoid glycosides, isoflavone glycosides, saponin glycosides, phenol glycosides, cynophore glycosides, anthraquinone glycosides, cardiac glycosides, bitter glycosides, coumarin glycosides, or sulfur glycosides.

Exemplary flavonoids include, but are not limited to, anthocyanidins; anthoxanthins, including flavones, such as luteolin, apigenin, tangeritin; and flavonols, such as quercetin, kaempferol, myricetin, fisetin, galangin, isorhamnetin, pachypodol, rhamnazin, pyranoflavonols, furanoflavonols; flavanones, such as hesperetin, naringenin, eriodictyol, and homoeriodictyol; flavanonols, such as taxifolin (or dihydroquercetin) and dihydrokaempferol; and flavans, including flavanols, such as catechin, gallocatechin, catechin 3-gallate, gallocatechin 3-gallate, epicatechin, epigallocatechin (EGC), epicatechin 3-gallate, epigallocatechin 3-gallate, theaflavin, theaflavin-3′-gallate, theaflavin-3,3′-digallate, thearubigin, and proanthocyanidins, which are dimers, trimers, oligomers, or polymers of the flavanols, and glycosides thereof.

Exemplary isoflavonoids include isoflavones, such as genistein, daidzein, glycitein; isoflavanes, isoflavandiols, isoflavenes, coumestans, pterocarpans, and glycosides thereof.

In some embodiments, the composition of the present application further comprises one or more polyphenols. Exemplary polyphenols include gallic acid, ellagic acid, quercetin, isoquercitrin, rutin, citrus flavonoids, catechins, proanthocyanidins, procyanidins, anthocyanins, reservatrol, isoflavones, curcumin, hesperidin, naringin, and chlorogenic acid, and glycosides thereof.

In some embodiments, the composition of the present application further comprises one or more tannins. Exemplary tannins include gallic acid esters, ellagic acid esters, ellagitannins, including rubusuaviins A, B, C, D, -E, and -F; punicalagins, such as pedunculagin and 1(β)-O-galloyl pedunculagin; strictinin, sanguiin H-5, sanguiin H-6, 1-desgalloyl sanguiin H-6. lambertianin A, castalagins, vescalagins, castalins, casuarictins, grandimins, punicalins, roburin A, tellimagrandin II, terflavin B; gallotannins, including digalloyl glucose and 1,3,6-trigalloyl glucose; flavan-3-ols, oligostilbenoids, proanthocyanidins, polyflavonoid tannins, catechol-type tannins, pyrocatecollic type tannins, flavolans, and glycosides thereof.

In some embodiments, the composition of the present application further comprises one or more carotenoids. Exemplary carotenoids include carotenes, including α-, β-, γ-, δ-, and ε-carotenes, lycopene, neurosporene, phytofluene, phytoene; and xanthophylls, including canthaxanthin, cryptoxanthin, zeaxanthin, astaxanthin, lutein, rubixanthin, and glycosides thereof.

In some embodiments, the composition of the present application further comprises one or more diterpenes, diterpenoids, triterpenes and/or triterpenoids. Exemplary diterpenes and diterpenoids include steviol, ent-16α,17-dihydroxy-kaurane-19-oic acid, ent-13-hydroxy-kaurane-16-en-19-oic acid, ent-16β,17-dihydroxy-kaurane-3-one, ent-16α,17-dihydroxy-kaurane-19-oic acid, ent-16α,17-dihydroxy-kaurane-3-one, ent-kaurane-3α,16β,17-3-triol, ent-13,17-dihydroxy-kaurane-15-en-19-oic acid, and glycosides thereof. Exemplary triterpenes and triterpenoids, include oleanolic acid, ursolic acid, saponin, and glycoside thereof.

In some embodiments, the composition of the present application is a sweetening or flavor composition. In some embodiments, the composition is a consumable product. In some embodiment, the consumable product is a food product, a bakery product, a diary product or a beverage.

Another aspect of the present application relates to a composition that that comprises (1) one or more G-SMW-SGs; and (2) one or more HMW-SGs, wherein the addition of the one or more G-SMW-SGs improves the taste profile of the one or more HMW-SGs.

Another aspect of the present application relates to a composition that that comprises (1) one or more G-SMW-SGs; and (2) one or more SMW-SGs, wherein the addition of the one or more G-SMW-SGs improves the taste profile of the one or more SMW-SGs.

### A. Glycosylated Small Molecule Weight Steviol Glycosides (G-SMW-SGs)

Compared with G-HMV-SGs, the inventor surprisingly found that G-SMW-SGs provide a more sugar-like sweet taste profile with quick onset and higher sweetness level. The sweetness level of G-SMW-SGs in solution, in relation to its concentration, is more linear. Thus, this discovery provides an opportunity to use stevia derivatives as sugar-mimic sweeteners with SE higher than 6SE, 8SE, and LOSE. An exemplary embodiment of a sweetener composition comprises G-SMW-SGs, which can reach a higher sweetness level without significant bitterness. In certain embodiments, a sweetener composition combines G-SMW-SGs with C-MRPs.

(1) Small Molecule Weight Steviol Glycosides (SMW-SGs)

As used herein, a “small molecule weight steviol glycoside” or “SMW-SG” refers to a steviol glycoside having a molecular weight less than 965 daltons. An exemplary listing of SMW-SGs for use in the present application is steviolbioside (STB) or steviol monoside (STM).

TABLE B
Exemplary small molecule weight steviol glycosides (SMW-SGs)

| | | | # Added | | | | |
|---|---|---|---|---|---|---|---|
| | | | Rhamnose/ | # Added | | | |
| | | # Added | Deoxy- | Xylose/ | | | |
| | | Glucose | hexose | Arabinose | | | |
| | | moieties | moieties | moieties | | | |
| SG Name | MW | mw = 180 | mw = 164 | mw = 150 | R1 (C-19) | R2 (C-13) | Backbone |
| Related | 457 | — | | | | | |
| SvGn#l | | | | | | | |
| Steviol- | 479 | 1 | | | H- | Glcβ1- | Steviol |
| monoside | | | | | | | |
| Steviol- | 479 | 1 | 1 | | Glcβ1- | H- | |
| monoside | | | | | | | |
| A | | | | | | | |
| SG-4 | 611 | 1 | | 1 | H- | Xylβ(1- | Steviol |
| | | | | | | 2)Glcβ1- | |
| Dulcoside | 625 | 1 | 1 | | H- | Rhaα(1- | Steviol |
| A1 | | | | | | 2)Glcβ1- | |
| Iso- | 641 | 2 | | | H- | Glcβ(1- | Isosteviol |
| steviol- | | | | | | 2)Glcβ1- | |
| bioside | | | | | | | |
| Reb-G1 | 641 | 2 | | | H- | Glcβ(1- | Steviol |
| | | | | | | 3)Glcβ1- | |
| Rubusoside | 641 | 2 | | | Glcβ1- | Glcβ1- | Steviol |
| Steviolbioside | 641 | 2 | | | H- | Glcβ(1- | Steviol |
| | | | | | | 2)Glcβ1- | |
| Related | 675 | — | | | | | |
| SvGn#3 | | | | | | | |
| Reb-F1 | 773 | 2 | | 1 | H- | Xylβ(1- | Steviol |
| | | | | | | 2)[Glc(1- | |
| | | | | | | 3)]Glcp1- | |
| Reb-R1 | 773 | 2 | | 1 | H- | Glβ(1- | Steviol |
| | | | | | | 2)[Glβ(1- | |
| | | | | | | 3)]Xy1β1- | |
| Stevioside | 773 | 2 | | 1 | Glcβ1- | Xylβ(1- | Steviol |
| F (SG-1) | | | | | | 2)Glcβ1- | |
| SG-Unkl | 773 | 2 | | 1 | — | — | Steviol |
| Dulcoside | 787 | 2 | 1 | | Glcβ1- | Rhaα(l- | Steviol |
| A | | | | | | 2)Glcβ1- | |
| Dulcoside | 787 | 2 | 1 | | H- | Rhaα(1- | Steviol |
| B (JECFA | | | | | | 2)[Glcβ(1- | |
| C) | | | | | | 3)]Glcβ1- | |
| SG-3 | 787 | 2 | 1 | | H- | 6- | Steviol |
| | | | | | | deoxyGlcβ | |
| | | | | | | (1- | |
| | | | | | | 2)[Glcβ(1- | |
| | | | | | | 3)]Glcβ1- | |
| Stevioside | 787 | 2 | 1 | | Glcβ1- | Glcβ(1- | |
| D | | | | | | 2)6- | |
| | | | | | | deoxyGlcβ | |
| | | | | | | l- | |
| Iso-Reb B | 803 | 3 | | | H- | Glcβ(1- | Isosteviol |
| | | | | | | 2)[Glcβ(1- | |
| | | | | | | 3)]Glcβ1- | |
| Iso- | 803 | 3 | | | Glcβ1- | Glcβ(1- | Isosteviol |
| Stevioside | | | | | | 2)Glcβ1- | |
| Reb B | 803 | 3 | | | H- | Glcβ(1- | Steviol |
| | | | | | | 2)[Glcβ(1- | |
| | | | | | | 3)]Glcβ1- | |
| Reb G | 803 | 3 | | | Glcβ1- | Glcβ(1- | Steviol |
| | | | | | | 3)Glcβ1- | |
| Reb-KA | 803 | 3 | | | Glcβ(1- | Glcβ1- | Steviol |
| | | | | | 2)Glcβ1- | | |
| SG-13 | 803 | 3 | | | Glcβ1- | Glcβ(1- | Isomeric |
| | | | | | | 2)Glcβ1- | steviol |
| | | | | | | | (12a- |
| | | | | | | | hydroxy) |
| Stevioside | 803 | 3 | | | Glcβ1- | Glcβ(1- | Steviol |
| | | | | | | 2)Glcβ1- | |
| Stevioside | 803 | 3 | | | Glcβ(1- | Glcβ1- | Steviol |
| B (SG-15) | | | | | 3)Glcβ1- | | |
| Reb F | 935 | 3 | | 1 | Glcβ1- | Xylβ- | Steviol |
| | | | | | | 2)[Glcβ(1- | |
| | | | | | | 3)]Glcβ1- | |
| Reb R | 935 | 3 | | 1 | Glcβ1- | Glcβ(1- | Steviol |
| | | | | | | 2)[Glcβ(1- | |
| | | | | | | 3)]Xylβ1- | |
| SG-Unk2 | 935 | 3 | | 1 | — | — | Steviol |
| SG-Unk3 | 935 | 3 | | 1 | — | — | Steviol |
| Reb F3 | 935 | 3 | | 1 | Xy1β(l- | Glcβ(1- | Steviol |
| (SG-11) | | | | | 6)Glcβ1- | 2)Glcβ1- | |
| Reb F2 | 935 | 3 | | 1 | Glcβ1- | Glcβ(1- | Steviol |
| (SG-14) | | | | | | 2)[Xylβ(1- | |
| | | | | | | 3)]Glcβ1- | |
| RebC | 949 | 3 | 1 | | Glcβ1- | Rhaα(1- | Steviol |
| | | | | | | 2)[Glcβ(1- | |
| | | | | | | 3)]Glcβ1- | |
| Reb | 949 | 3 | 1 | | Rhaα(1- | Glcp(l- | Steviol |
| C2/Reb S | | | | | 2)Glcβ1- | 2)Glcβ1- | |
| Stevioside | 949 | 3 | 1 | | Glcβ1- | 6- | Steviol |
| E (SG-9) | | | | | | DeoxyGlcβ | |
| | | | | | | (1- | |
| | | | | | | 2)[Glcβ(1- | |
| | | | | | | 3)]Glcβ1- | |
| Stevioside | 949 | 3 | 1 | | 6- | Glcβ(1- | |
| E2 | | | | | DeoxyGlcβ | 2)[Glcβ(1- | |
| | | | | | 1- | 3)]Glcβ1- | |
| SG-10 | 949 | 3 | 1 | | Glcβ1- | Glcβ(1- | Steviol |
| | | | | | | 3)Glcβ(1- | |
| | | | | | | 2)[Glcβ(1- | |
| | | | | | | 3])Glcβ1- | |
| Reb Li | 949 | 3 | 1 | | H- | Glcβ(l- | Steviol |
| | | | | | | 3)Rhaα(1- | |
| | | | | | | 2)[Glcβ(1- | |
| | | | | | | 3)]Glcβ1- | |
| SG-2 | 949 | 3 | 1 | | Glcβ1- | 6- | Steviol |
| | | | | | | deoxyGlcβ | |
| | | | | | | (1- | |
| | | | | | | 2)[Glcβ(1- | |
| | | | | | | 3)]Glcβ1- | |

Note:
The phrase “# Added sugar moieties” means sugar moieties added to the steviol or isosteviol backbone. The “added sugar moieties” are native to the respective steviol glycoside and are NOT sugar groups added in an exogenous glycosylation reaction.
Legend:
SG-1 to 16: SGs without a specific name; SG-Unk1-6: SGs without detailed structural proof; Glc: Glucose; Rha: Rhamnose; Xyl: Xylose; Ara: Arabinose.

The term “SMW-SG” as used herein, refers to isolated small molecule weight steviol glycoside, purified steviol glycoside and enriched steviol glycoside. SMW-SGs may be produced from Stevia extracts, sweet tea extracts or other plants that contain steviol glycosides (e.g., SMW-SG RU30 is a sweet tea extracts enriched for RU and contains 30-40 wt % RU). SMW-SGs may also be produced by bio-conversion, fermentation, chemical syntheses or other methods.

(2) Glycosylation Reaction

The G-SMW-SGs of the present application are glycosylated forms of small molecule weight steviol glycosides (SMW-SGs). Generally, the SMW-SGs used to prepare a G-SMW-SG composition according to the present application is prepared as follows: (i) dissolving a sugar-donor material in water to form a liquefied sugar-donor material; (ii) adding a starting SMW-SG composition to liquefied sugar-donor material to obtain a mixture; and (iii) adding an effective amount of an enzyme to the mixture to form a reaction mixture, wherein the enzyme catalyzes the transfer of sugar moieties from the sugar-donor material to the SMW-SG in the starting SMW-SG composition; and (iv) incubating the reaction mixture at a desired temperature for a desired length of reaction time to glycosylate the SMW-SG with sugar moieties present in the sugar-donor molecule.

After achieving a desired ratio of G-SMW-SGs and residual SMW-SG contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the sugar is glucose and the sugar donor is a glucose donor. In some embodiments, the glucose donor is starch. In some embodiments the resulting solution comprising G-SMW-SGs, residual SMW-SGs and dextrin is decolorized.

In some embodiments the resulting solution of G-SMW-SGs, including residual SMW-SGs and dextrin is dried. In some embodiments, the drying is by spray drying. In some embodiments, step (i) comprises the substeps of (a) mixing a glucose-donor material with a desired amount of water to form a suspension, (b) adding a desired amount of enzyme to the suspension and (c) incubate the suspension at a desired temperature for a desired time to form liquefied glucose-donor material. Starch can be a suitable substitute for dextrin(s) and/or dextrin(s) can be obtained by the hydrolysis of starch. The unreacted stevia glycosides, with or without dextrins, can be separated from glycosylated stevia glycosides if necessary.

In some embodiments, one or more G-SMW-SGs, such as GRB, GSTB, GSTM and GRU are present in the composition of the present application in an amount of 0.001-99 wt %, 0.001-75 wt %, 0.001-50 wt %, 0.001-25 wt %, 0.001-10 wt %, 0.001-5 wt %, 0.001-2 wt %, 0.001-1 wt %, 0.001-0.1 wt %, 0.001-0.01 wt %, 0.01-99 wt %, 0.01-75 wt %, 0.01-50 wt %, 0.01-25 wt %., 0.01-10 wt %, 0.01-5 wt %, 0.01-2 wt %, 0.01-1 wt %, 0.1-99 wt %, 0.1-75 wt %, 0.1 wt-50 wt %, 0.1-25 wt %, 0.1-10 wt %, 0.1-5 wt %, 0.1-2 wt %, 0.1-1 wt %, 0.1-0.5 wt %, 1-99 wt %, 1-75 wt %, 1-50 wt %, 1-25 wt %, 1-10 wt %, 1-5 wt %, 5-99 wt %, 5-75 wt %, 5-50 wt %, 5-25 wt %, 5-10 wt %, 10-99 wt %, 10-75 wt %, 10-50 wt %, 10-25 wt %, 10-15 wt %, 20-99 wt %, 20-75 wt %, 20-50 wt %, 30-99 wt %, 30-75 wt %, 30-50 wt %, 40-99 wt %, 40-75 wt %, 40-50 wt %, 50-99 wt %, 50-75 wt %, 60-99 wt %, 60-75 wt %, 70-99 wt %, 70-75 wt %, 80-99 wt %, 80-90 wt % or 90-99 wt %.

In some embodiments, the G-SMW-SG is a glycosylated steviol glycoside selected from the group consisting of steviol monoside A, dulcoside A, dulcoside A1, dulcoside B, stevioside, stevioside B, stevioside D, stevioside E, stevioside E2, stevioside F, rubusoside, rebaudioside C, rebaudioside C2, rebaudioside G, rebaudioside G1, rebaudioside F, rebaudioside F1, rebaudioside F2, rebaudioside F3, rebaudioside KA, rebaudioside Ll, rebaudioside R, rebaudioside R1, and isomers thereof.

In some embodiments, the G-SMW-SG is a mono-glycosylated, di-glycosylated, tri-glycosylated, tetra-glycosylated, or penta-glycosylated glycosylation product of an SMW-SG. In certain embodiments, the G-SMW-SG is a glycosylated RB, glycosylated steviolbioside, glycosylated steviol monoside or glycosylated rubusoside.

In some embodiments, the G-SMW-SG composition is prepared from an SE that contains an enriched SMW-SG. In some embodiments, the G-SMW-SG composition is prepared from RB30, RU30 or RU40.

The liquefied sugar-donor materials are typically liquefied products of starch, such as maltodextrin and β-cyclodextin.

Glycosyltransferases, Glycosyl Hydrolases and Transglycosidases

The G-SMW-SG products described in the present application are formed by an exogenous glycosylation reaction in the present of a glycosyltransferase.

As used herein, a “glycosyltransferase” refers to an enzyme that catalyzes the formation of a glycosidic linkage to form a glycoside. A glycoside is any molecule in which a sugar group is bonded through its anomeric carbon to another group via a glycosidic bond. Glycosides can be linked by an O- (an O-glycoside), N- (a glycosylamine), S- (a thioglycoside), or C- (a C-glycoside) glycosidic bond. The sugar group is known as the glycone and the non-sugar group is known as the aglycone. The glycone can be part of a single sugar group (monosaccharide) or several sugar groups (oligosaccharide). A glycosyltransferase according to the present application further embraces “glycosyltransferase variants” engineered for enhanced activities.

Glycosyltransferases utilize “activated” sugar phosphates as glycosyl donors, and catalyze glycosyl group transfer to an acceptor molecule comprising a nucleophilic group, usually an alcohol. A retaining glycosyltransferases is one which transfers a sugar residue with the retention of anomeric configuration. Retaining glycosyltransferase enzymes retain the stereochemistry of the donor glycosidic linkage after transfer to an acceptor molecule. An inverting glycosyltransferase, on the other hand, is one which transfers a sugar residue with the inversion of anomeric configuration. Glycosyltransferases are classified based on amino acid sequence similarities. Glycosyltransferases are classified by the Nomenclature Committee of the International Union of Biochemistry and Molecular Biology (NC-IUBMB) in the enzyme class of EC 2.4.1 on the basis of the reaction catalyzed and the specificity.

Glycosyltransferases can utilize a range of donor substrates. Based on the type of donor sugar transferred, these enzymes are grouped into families based on sequence similarities. Exemplary glycosyltransferases include glucanotransferases, N-acetylglucosaminyltransferases, N-acetylgalactosaminyltransferases, fucosyltransferases, mannosyltransferases, galactosyltransferases, sialyltransferases, galactosyltransferases, fucosyltransferase, Leloir glycosyltransferases, non-Leloir glycosyltransferases, and other glycosyltransferases in the enzyme class of EC 2.4.1. The Carbohydrate-Active Enzymes database (CAZy) provides a continuously updated list of the glycosyltransferase families.

In some embodiments, the G-SMW-SGs are formed from a reaction mixture comprising an exogenous glycosyltransferase classified as an EC 2.4.1 enzyme, including but not limited to members selected from the group consisting of cyclomaltodextrin glucanotransferase (CGTase; EC 2.4.1.19), amylosucrase (EC 2.4.1.4), dextransucrase (EC 2.4.1.5), amylomaltase, sucrose: sucrose fructosyltransferase (EC 2.4.1.99), 4-α-glucanotransferase (EC 2.4.1.25), lactose synthase (EC 2.4.1.22), sucrose-1,6-α-glucan 3(6)-α-glucosyltransferase, maltose synthase (EC 2.4.1.139), alternasucrase (EC 2.4.1.140), including variants thereof.

Cyclomaltodextrin glucanotransferase, also known as CGTase, is an enzyme assigned with enzyme classification number EC 2.4.1.19, which is capable of catalyzing the hydrolysis and formation of (1→4)-α-D-glucosidic bonds, and in particular the formation of cyclic maltodextrins from polysaccharides as well as the disproportionation of linear oligosaccharides.

Dextransucrase is an enzyme assigned with enzyme classification number EC 2.4.1.5, and is also known as sucrose 6-glucosyltransferase, SGE, CEP, sucrose-1,6-α-glucan glucosyltransferase or sucrose: 1,6-α-D-glucan 6-α-D-glucosyltransferase. Dextransucrases are capable of catalyzing the reaction: sucrose+[(1→6)-α-D-glucosyl]n=D-fructose+[(1→6)-α-D-glucosyl]n+1. In addition, a glucosyltransferase (DsrE) from Leuconostoc mesenteroides, NRRL B-1299 has a second catalytic domain (“CDT”) capable of adding alpha-1,2 branching to dextrans (U.S. Pat. Nos. 7,439,049 and 5,141,858; U.S. Patent Appl. Publ. No. 2009-0123448; Bozonnet et al., J. Bacteria 184:5753-5761, 2002).

Glycosyltransferases and other glycosylating enzymes for use in the present application may be derived from any source and may be used in a purified form, in an enriched concentrate or as a crude enzyme preparation.

In some embodiments, the glycosylation reaction is carried out by glycosylating an aglycone or glycoside substrate using e.g., a nucleotide sugar donor (e.g., sugar mono- or diphosphonucleotide) or “Leloir donor” in conjunction with a “Leloir glycosyltransferase” (after Nobel prize winner, Luis Leloir) that catalyzes the transfer of a monosaccharide unit from the nucleotide-sugar (“glycosyl donor’) to a “glycosyl acceptor”, typically a hydroxyl group in an aglycone or glycoside substrate.

Accordingly, in some embodiments the G-SMW-SGs of the present application is formed from a reaction mixture comprising a nucleotide sugar.

In certain embodiments, the glycosylation reactions may involve the use of a specific Leloir glycosyltransferase in conjunction with a wide range of sugar nucleotides donors, including e.g., UDP-glucose, GDP-glucose, ADP-glucose, CDP-glucose, TDP-glucose or IDT-glucose in combination with a glucose-dependent glycosyltransferase (GDP-glycosyltransferases; GGTs), ADP-glucose-dependent glycosyltransferase (ADP-glycosyltransferases; AGTs), CDP-glucose-dependent glycosyltransferase (CDP-glycosyltransferases; CGTs), TDP-glucose-dependent glycosyltransferase (TDP-glycosyltransferases; TGTs) or IDP-glucose-dependent glycosyltransferase (IDP-glycosyltransferases; IGTs), respectively.

In particular embodiments, the exogenous glycosylation reaction is carried out using an exogenous Leloir-type UDP-glycosyltransferase enzyme of the classification EC 2.4.1.17, which catalyzes the transfer of glucose from UDP-α-D-glucuronate (also known as UDP-glucose) to an acceptor, releasing UDP and forming acceptor β-D-glucuronoside. In some embodiments, the glycosyltransferases include, but are not limited to, enzymes classified in the GT1 family. In certain preferred embodiment, the glycosylation reaction is catalyzed by an exogenous UDP-glucose-dependent glycosyltransferase. In some embodiments, the glycosylation reaction is catalyzed by a glycosyltransferase capable of transferring a non-glucose monosaccharide, such as fructose, galactose, ribose, arabinose, xylose, mannose, psicose, fucose and rhamnose, and derivative thereof, to the recipient.

U.S. Pat. No. 9,567,619 describes several UDP-dependent glycosyltransferases that can be used to transfer monosaccharides to rubusoside, including UGT76G1 UDP glycosyltransferase, HV1 UDP-glycosyltransferase, and EUGT11, a UDP glycosyltransferase-sucrose synthase fusion enzyme. The EUGT11 fusion enzyme contains a uridine diphospho glycosyltransferase domain coupled to a sucrose synthase domain and can exhibit 1,2-β glycosidic linkage and 1,6-β glycosidic linkage enzymatic activities, as well as sucrose synthase activity. Of the foregoing enzymes, UGT76G1 UDP glycosyltransferase contains a 1,3-O-glucose glycosylation activity which can transfer a second glucose moiety to the C-3′ of 13-O-glucose of rubusoside to produce rebaudioside G (“Reb G”); HV1 UDP-glycosyltransferase contains a 1,2-O-glucose glycosylation activity which can transfer a second glucoside moiety to the C-2′ of 19-O-glucose of rubusoside to produce rebaudioside KA (“Reb KA”); and the EUGT11 fusion enzyme contains a 1,2-O-glucose glycosylation activity which transfers a second glucose moiety to the C-2′ of 19-O-glucose of rubusoside to produce rebaudioside KA or transfer a second glucose moiety to the C-2′ of 13-O-glucose of rubusoside to produce stevioside. In addition, HV1 and EUGT11 can transfer a second sugar moiety to the C-2′ of 19-O-glucose of rebaudioside G to produce rebaudioside V (“Reb V”) and can additionally transfer a second glucose moiety to the C-2′ of 13-O-glucose of rebaudioside KA to produce rebaudioside E (“Reb E”). Furthermore, when used singly or in combination, these enzymes can be used to generate a variety of steviol glycosides known to be present in Stevia rebaudiana, including rebaudioside D (“Reb D”) and rebaudioside M (“Reb M”).

Monosaccharides that can be transferred to a saccharide or monosaccharide acceptor include, but are not limited to, glucose, fructose, galactose, ribose, arabinose, xylose, mannose, psicose, fucose and rhamnose, and derivative thereof, as well as acidic sugars, such as sialic acid, glucuronic acid and galacturonic acid. In some embodiments, the sugar donor is the reducing sugar defined in this specification which are also used for Maillard Reaction.

In some embodiments, glycosylation of SMW-SGs is driven by an exogenous glycosyl hydrolase or glycosidase from the enzyme class of EC 3.2.1. GHs normally cleave a glycosidic bond. However, they can be used to form glycosides by selecting conditions that favor synthesis via reverse hydrolysis. Reverse hydrolysis is frequently applied e.g., in the synthesis of aliphatic alkylmonoglucosides.

Glycosyl hydrolases have a wide range of donor substrates employing usually monosaccharides, oligosaccharides or/and engineered substrates (i.e., substrates carrying various functional groups). They often display activity towards a large variety of carbohydrate and non-carbohydrate acceptors. Glycosidases usually catalyze the hydrolysis of glycosidic linkages with either retention or inversion of stereochemical configuration in the product.

In some embodiments, the G-SMW-SGs of the present application are formed from a reaction mixture comprising an exogenous glycosyl hydrolase classified as an EC 3.2.1 enzyme, including but not limited to alpha-glucosidase, beta-glucosidase and beta-fructofuranosidase.

Exemplary glycosyl hydrolases for use in the present application include, but are not limited to α-amylases (EC 3.2.1.1), α-glucosidases (EC 3.2.1.20), β-glucosidases (EC 3.2.1.21), α-galactosidases (EC 3.2.1.22), β-galactosidases (EC 3.2.1.23), α-mannosidase (EC 3.2.1.24), β-mannosidase (EC 3.2.1.25), β-fructofuranosidase (EC 3.2.1.26), amylo-1,6-glucosidases (EC 3.2.1.33), β-D-fucosidases (EC 3.2.1.38), α-L-rhamnosidases (EC 3.21.40), glucan 1,6-α-glucosidases (EC 3.2.70), and variants thereof.

In some embodiments, the G-SMW-SGs of the present application are formed using a class of glycoside hydrolases or glycosyltransferases known as “transglycosylases.” As used herein, the term “transglycosylase” and “transglycosidase” (TG) are used interchangeably with reference to a glycoside hydrolase (GH) or glycosyltransferase (GT) enzyme capable of transferring a monosaccharide moiety from one molecule to another. Thus, a GH can catalyze the formation of a new glycosidic bond either by transglycosylation or by reverse hydrolysis (i.e., condensation).

The acceptor for transglycosylase reaction acceptor can be saccharide acceptor or a monosaccharide acceptor. Thus, a transglycosidase can transfer a monosaccharide moiety to a diverse set of aglycones, including e.g., monosaccharide acceptors, such as aromatic and aliphatic alcohols. Transglycosidases can transfer a wide variety of monosaccharides (D- or L-configurations) to saccharide acceptors, including glycosides, as well as monosaccharide acceptors, including a wide variety of flavonoid aglycones, such as naringenin, quercetin, hesperetin.

Monosaccharides that can be transferred to a saccharide or monosaccharide acceptor include, but are not limited to glucose, fructose, galactose, ribose, arabinose, xylose, mannose, psicose, fucose and rhamnose, and derivative thereof, as well as acidic sugars, such as sialic acid, glucuronic acid and galacturonic acid. The term “transglucosidase” is used when the monosaccharide moiety is a glucose moiety.

Transglycosidases include GHs or GTs from the enzyme classes of EC 3.2.1 or 2.4.1, respectively. In spite of the inclusion of certain glycosyltransferases as transglycosidases, TGs are classified into various GH families on the basis of sequence similarity. A large number of retaining glycosidases catalyze both hydrolysis and transglycosylation reactions. In particular, these enzymes catalyze the intra- or intermolecular substitution of the anomeric position of a glycoside. Under kinetically controlled reactions, retaining glycosidases can be used to form glycosidic linkages using a glycosyl donor activated by a good anomeric leaving group (e.g., nitrophenyl glycoside). In contrast, thermodynamically controlled reverse hydrolysis uses high concentrations of free sugars.

Transglycosidases corresponding to any of the GH families with notable transglycosylase activity may be used in the present application, and may include the use of e.g., members of the GH2 family, including LacZ β-galactosidase, which converts lactose to allolactose; GH13 family, which includes cyclodextran glucanotransferases that convert linear amylose to cyclodextrins, glycogen debranching enzyme, which transfers three glucose residues from the four-residue glycogen branch to a nearby branch, and trehalose synthase, which catalyzes the interconversion of maltose and trehalose; GH16 family, including xyloglucan endotransglycosylases, which cuts and rejoins xyloglucan chains in the plant cell wall; GH31, for example α-transglucosidases, which catalyze the transfer of individual glucosyl residues between α-(1→4)-glucans; GH70 family, for example glucansucrases, which catalyze the synthesis of high molecular weight glucans, from sucrose; GH77 family, for examples amylomaltase, which catalyzes the synthesis of maltodextrins from maltose; and the GH23, GH102, GH103, and GH104 families, which include lytic transglycosylases that convert peptidoglycan to 1,6-anhydrosugars.

In one embodiment, the glycosyltransferase is a transglucosylase from the glycoside hydrolase 70 (GH70) family. GH70 enzymes are transglucosylases produced by lactic acid bacteria from, e.g., Streptococcus, Leuconostoc, Weisella or Lactobacillus genera. Together with the families GH13 and GH77 enzymes, they form the clan GH-H. Most of the enzymes classified in this family use sucrose as the D-glucopyranosyl donor to synthesize α-D-glucans of high molecular mass (>106 Da) with the concomitant release of D-fructose. They are also referred to as glucosyltransferases or glucansucrases.

A wide range of α-D-glucans, varying in size, structure, degree of branching and spatial arrangements can thus be produced by GH70 family members. For example, GH70 glucansucrases can transfer D-glucosyl units from sucrose onto hydroxyl acceptor groups. Glucansucrases catalyze the formation of linear as well as branched α-D-glucan chains with various types of glycosidic linkages, namely α-1,2; α-1,3; α-1,4; and/or α-1,6.

In addition, sucrose analogues such as α-D-glucopyranosyl fluoride, p-nitrophenyl α-D-glucopyranoside, α-D-glucopyranosyl α-L-sorofuranoside and lactulosucrose can be utilized as D-glucopyranosyl donors. A large variety of acceptors may be recognized by glucansucrases, including carbohydrates, alcohols, polyols or flavonoids to yield oligosaccharides or gluco-conjugates.

Exemplary glucansucrases for use in the present application include e.g., dextransucrase (sucrose:1,6-α-D-glucosyltransferase; EC 2.4.1.5), alternansucrase (sucrose:1,6(1,3)-α-D-glucan-6(3)-α-D-glucosyltransferase, EC 2.4.1.140), mutansucrase (sucrose:1,3-α-D-glucan-3-α-D-glucosyltransferase; EC 2.4.1.125), and reuteransucrase (sucrose:1,4(6-α-D-glucan-4(6)-α-D-glucosyltransferase; EC 2.4.1.-). The structure of the resultant glucosylated product is dependent upon the enzyme specificity.

In some embodiments, a fructosyltransferase may be used to catalyze the transfer of one or more fructose units, optionally comprising terminal glucose, of the following sequence: (Fru)n-Glc consisting of one or more of: β 2,1, β 2,6, α 1,2 and β-1,2 glycosidic bonds, wherein n typically is 3-10. Variants include Inulin type β-1,2 and Levan type β-2,6 linkages between fructosyl units in the main chain. Exemplary fructosytransferase for use in the present application include e.g., β-fructofuranosidase (EC 3.2.1.26), inulosucrase (EC 2.4.1.9) levansucrase (EC 2.4.1.10), or endoinulinase.

In some embodiments, a galactosyltransferase or β-galactosidase may be used to catalyze the transfer of multiple saccharide units, in which one of the units is a terminal glucose and the remaining units are galactose and disaccharides comprising two units of galactose. In certain embodiments, the resulting structure includes a mixture of galactopyranosyl oligomers (DP=3-8) linked mostly by β-(1,4) or β-(1,6) bonds, although low proportions of β-(1,2) or β-(1,3) linkages may also be present. Terminal glucosyl residues are linked by β-(1,4) bonds to galactosyl units. These structures may be synthesized by the reverse action of β-galactosidases (EC 3.2.1.23) on lactose at relatively high concentrations of lactose.

In some embodiments, the transglycosidase is an enzyme having trans-fucosidase, trans-sialidase, trans-lacto-N-biosidase and/or trans-N-acetyllactosaminidase activity.

In some embodiments, the glycosylation reactions may utilize a combination of any of glycosyltransferases described herein in combination with any one of the glycosyl hydrolases or transglycosidases described herein. In these reactions, the transglycosylase and the glycosyl hydrolase or transglycosidase may be present in a range of ratios (w/w), wherein the transglycosylase/glycosyl hydrolase ratio (w/w) ranges from 100:1, 80:1, 60:1, 40:1, 30:1, 25:1, 20:1, 15:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:15, 1:20, 1:25, 1:30, 1:40, 1:50, 1:60, 1:80, 1:100, or any ratio derived from any two of the aforementioned integers.

Reaction Conditions for glycosylation

The G-SMW-SGs of the present application can be obtained e.g., by synthetic manipulation or by enzymatic processes. The G-SMW-SGs obtained by these methods are therefore non-naturally occurring SMW-SGs. In some embodiments, the G-SMW-SGs obtained by these methods may contain trace amount of natural occurred SMW-SGs.

The glycosylating enzyme may be dissolved in the reaction mixture or immobilized on a solid support which is contacted with the reaction mixture. If the enzyme is immobilized, it may be attached to an inert carrier. Suitable carrier materials are known in the art. Examples for suitable carrier materials are clays, clay minerals such as kaolinite, diatomeceous earth, perlite, silica, alumina, sodium carbonate, calcium carbonate, cellulose powder, anion exchanger materials, synthetic polymers, such as polystyrene, acrylic resins, phenol formaldehyde resins, polyurethanes and polyolefins, such as polyethylene and polypropylene. For preparing carrier-bound enzymes the carrier materials usually are used in the form of fine powders, wherein porous forms are preferred. The particle size of the carrier material usually does not exceed 5 mm, in particular 2 mm. Further, suitable carrier materials are calcium alginate and carrageenan. Enzymes may directly be linked by glutaraldehyde. A wide range of immobilization methods are known in the art. Ratio of reactants can be adjusted based on the desired performance of the final product. The temperature of the glycosylation reaction can be in the range of 1-100° C., preferably 40-80° C., more preferably 50-70° C.

In certain embodiments, the G-SMW-SGs used in the present application are prepared as follows: (i) mixing a starting SMW-SG composition with a sugar-donor material to obtain a mixture; and (ii) adding an effective amount of an enzyme to the mixture to form a reaction mixture, where the enzyme catalyzes the transfer of sugar moieties from the sugar-donor material to the SMW-SGs in the starting SMW-SG composition; and (iii) incubating the reaction mixture at a desired temperature for a desired length of reaction time to glycosylate the SMW-SGs with sugar moieties present in the sugar-donor molecule. In some embodiments, after achieving a desired ratio of G-SMW-SG to residual SMW-SG contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the resulting solution comprising G-SMW-SGs, residual SMW-SGs and residue sugar donor is decolorized. Examples of sugar donors include, but are not limited to, glucose, fructose, galactose, lactose, and mannose.

In some embodiments, the G-SMW-SGs used in the present application are prepared as follows: (i) dissolving a glucose-donor material in water to form a liquefied glucose-donor material; (ii) adding a starting SMW-SG composition to liquefied glucose-donor material to obtain a mixture; and (iii) adding an effective amount of an enzyme to the mixture to form a reaction mixture, wherein the enzyme catalyzes the transfer of glucose moieties from the glucose-donor material to the SMW-SGs in the starting SMW-SG composition; and (iv) incubating the reaction mixture at a desired temperature for a desired length of reaction time to glycosylate the SMW-SGs with glucose moieties present in the glucose-donor molecule. In some embodiments, after achieving a desired ratio of G-SMW-SG and SMW-SG contents, the reaction mixture is heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the resulting solution comprising G-SMW-SGs, residual SMW-SGs and dextrin is decolorized. In certain embodiments the resulting solution of G-SMW-SGs, including residual SMW-SGs and dextrin is dried. In some embodiments, the drying is by spray drying. In some embodiments, step (i) comprises the substeps of (a) mixing a glucose-donor material with a desired amount of water to form a suspension, (b) adding a desired amount of enzyme to the suspension and (c) incubate the suspension at a desired temperature for a desired time to form liquefied glucose-donor material. Starch can be a suitable substitute for dextrin(s) and/or dextrin(s) can be obtained by the hydrolysis of starch.

The enzymatically catalyzed reaction can be carried out batch wise, semi-batch wise or continuously. Reactants can be supplied at the start of reaction or can be supplied subsequently, either semi-continuously or continuously. The catalytic amount of glycosidase or glycosyltransferase required for the method of the invention depends on the reaction conditions, such as temperature, solvents and amount of substrate.

The reaction can be performed in aqueous media such as buffer. A buffer adjusts the pH of the reaction mixture to a value suitable for effective enzymatic catalysis. Typically the pH is in the range of about pH 4 to about pH 9, for example of about pH 5 to about pH 7. Suitable buffers comprise, but are not limited to, sodium acetate, tris(hydroxymethyl) aminomethane (“Tris”) and phosphate buffers.

Optionally, the reaction may take place in the presence of a solvent mixture of water and a water miscible organic solvent at a weight ratio of water to organic solvent of from 0.1:1 to 9:1, for example from 1:1 to 3:1. The organic solvent is not primary or secondary alcohol and, accordingly, is non-reactive towards the polysaccharide. Suitable organic solvents comprise alkanones, alkylnitriles, tertiary alcohols and cyclic ethers, and mixtures thereof, for example acetone, acetonitrile, t-pentanol, t-butanol, 1,4-dioxane and tetrahydrofuran, and mixtures thereof. Generally, the use of organic solvents is not preferred.

Glycosylation Products

The G-SMW-SGs may include both reacted and unreacted components from the starting materials (i.e., the mixture of materials before the initiation of the glycosylation reaction). In some embodiments, the G-SMW-SGs are present in the glycosylation reaction products, individually or collectively, in a range between 0.00001-99.5 wt %, 0.0001-99.5 wt %, 0.001-99.5 wt %, 0.01-99.5 wt %, 0.01-0.02 wt %, 0.01-0.05 wt %, 0.01-0.07 wt %, 0.01-0.1 wt %, 0.01-0.2 wt %, 0.01-0.5 wt %, 0.01-0.7 wt %, 0.01-1 wt %, 0.01-2 wt %, 0.01-5 wt %, 0.01-7 wt %, 0.01-10 wt %, 0.01-20 wt %, 0.01-50 wt %, 0.01-70 wt %, 0.01-99 wt %, 0.02-0.05 wt %, 0.02-0.07 wt %, 0.02-0.1 wt %, 0.02-0.2 wt %, 0.02-0.5 wt %, 0.02-0.7 wt %, 0.02-1 wt %, 0.02-2 wt %, 0.02-5 wt %, 0.02-7 wt %, 0.02-10 wt %, 0.02-20 wt %, 0.02-50 wt %, 0.02-70 wt %, 0.02-99 wt %, 0.05-0.07 wt %, 0.05-0.1 wt %, 0.05-0.2 wt %, 0.05-0.5 wt %, 0.05-0.7 wt %, 0.05-1 wt %, 0.05-2 wt %, 0.05-5 wt %, 0.05-7 wt %, 0.05-10 wt %, 0.05-20 wt %, 0.05-50 wt %, 0.05-70 wt %, 0.05-99 wt %, 0.07-0.1 wt %, 0.07-0.2 wt %, 0.07-0.5 wt %, 0.07-0.7 wt %, 0.07-1 wt %, 0.07-2 wt %, 0.07-5 wt %, 0.07-7 wt %, 0.07-10 wt %, 0.07-20 wt %, 0.07-50 wt %, 0.07-70 wt %, 0.07-99 wt %, 0.1-0.2 wt %, 0.1-0.5 wt %, 0.1-0.7 wt %, 0.1-1 wt %, 0.1-2 wt %, 0.1-5 wt %, 0.1-7 wt %, 0.1-10 wt %, 0.1-20 wt %, 0.1-50 wt %, 0.1-70 wt %, 0.1-99 wt %, 0.2-0.5 wt %, 0.2-0.7 wt %, 0.2-1 wt %, 0.2-2 wt %, 0.2-5 wt %, 0.2-7 wt %, 0.2-10 wt %, 0.2-20 wt %, 0.2-50 wt %, 0.2-70 wt %, 0.2-99 wt %, 0.5-0.7 wt %, 0.5-1 wt %, 0.5-2 wt %, 0.5-5 wt %, 0.5-7 wt %, 0.5-10 wt %, 0.5-20 wt %, 0.5-50 wt %, 0.5-70 wt %, 0.5-99 wt %, 0.7-1 wt %, 0.7-2 wt %, 0.7-5 wt %, 0.7-7 wt %, 0.7-10 wt %, 0.7-20 wt %, 0.7-50 wt %, 0.7-70 wt %, 0.7-99 wt %, 1-2 wt %, 1-5 wt %, 1-7 wt %, 1-10 wt %, 1-20 wt %, 1-50 wt %, 1-70 wt %, 1-99 wt %, 2-5 wt %, 2-7 wt %, 2-10 wt %, 2-20 wt %, 2-50 wt %, 2-70 wt %, 2-99 wt %, 5-7 wt %, 5-10 wt %, 5-20 wt %, 5-50 wt %, 5-70 wt %, 5-99 wt %, 7-10 wt %, 7-20 wt %, 7-50 wt %, 7-70 wt %, 7-99 wt %, 10-20 wt %, 10-50 wt %, 10-70 wt %, 10-99 wt %, 20-50 wt %, 20-70 wt %, 20-99 wt %, 50-70 wt %, 50-99 wt %, or 70-99 wt %.

In some embodiments, the G-SMW-SGs are present, individually or collectively, in the glycosylation product in an amount greater than 0.01 wt %, 0.1 wt %, 1 wt %, 2 wt %, 5 wt %, 10 wt %, 20 wt %, 30 wt %, 40 wt %, 50 wt %, 60 wt %, 70 wt %, 80 wt %, 90 wt %, 95 wt %, or 99 wt %.

In some embodiments, the glycosylation products of SMW-SGs, such as GRB, GSTB, GSTM and GRU, are present, individually or collectively, in an amount ranging 1-5 wt %, 1-10 wt %, 1-15 wt %, 1-20 wt %, 1-30 wt %, 1-40 wt %, 1-50 wt %, 1-60 wt %, 1-70 wt %, 1-80 wt %, 1-90 wt %, 1-95 wt %, 1-99 wt %, 5-10 wt %, 5-15 wt %, 5-20 wt %, 5-30 wt %, 5-40 wt %, 5-50 wt %, 5-60 wt %, 5-70 wt %, 5-80 wt %, 5-90 wt %, 5-95 wt %, 5-99 wt %, 10-15 wt %, 10-20 wt %, 10-30 wt %, 10-40 wt %, 10-50 wt %, 10-60 wt %, 10-70 wt %, 10-80 wt %, 10-90 wt %, 10-95 wt %, 10-99 wt %, 15-20 wt %, 15-30 wt %, 15-40 wt %, 15-50 wt %, 15-60 wt %, 15-70 wt %, 15-80 wt %, 15-90 wt %, 15-95 wt %, 15-99 wt %, 20-30 wt %, 20-40 wt %, 20-50 wt %, 20-60 wt %, 20-70 wt %, 20-80 wt %, 20-90 wt %, 20-95 wt %, 20-99 wt %, 30-40 wt %, 30-50 wt %, 30-60 wt %, 30-70 wt %, 30-80 wt %, 30-90 wt %, 30-95 wt %, 30-99 wt %, 40-50 wt %, 40-60 wt %, 40-70 wt %, 40-80 wt %, 40-90 wt %, 40-95 wt %, 40-99 wt %, 50-60 wt %, 50-70 wt %, 50-80 wt %, 50-90 wt %, 50-95 wt %, 50-99 wt %, 60-70 wt %, 60-80 wt %, 60-90 wt %, 60-95 wt %, 60-99 wt %, 70-80 wt %, 70-90 wt %, 70-95 wt %, 70-99 wt %, 80-90 wt %, 80-95 wt %, 80-99 wt %, 90-95 wt %, 90-99 wt %, or 95-99 wt %.

In some embodiments, where the glycosylation reaction products include G-SMW-SGs and unreacted SMW-SGs, the weight ratio of G-SMW-SGs (individually or collectively) to SMW-SGs (individually or collectively) in the reaction mixture is 99:1 to 1:2, 99:1 to 1:1, 99:1 to 2:1, 99:1 to 5:1, 99:1 to 10:1, 99:1 to 20:1, 99:1 to 40:1, 99:1 to 60:1, 99:1 to 80:1, 80:1 to 1:2, 80:1 to 1:1, 80:1 to 2:1, 80:1 to 5:1, 80:1 to 10:1, 80:1 to 20:1, 80:1 to 40:1, 80:1 to 60:1, 60:1 to 1:2,60:1 to 1:1,60:1 to 2:1, 60:1 to 5:1, 60:1 to 10:1, 60:1 to 20:1, 60:1 to 40:1, 40:1 to 1:2, 40:1 to 1:1, 40:1 to 2:1, 40:1 to 5:1, 40:1 to 10:1, 40:1 to 20:1, 20:1 to 1:2, 20:1 to 1:1, 20:1 to 2:1, 20:1 to 5:1, 20:1 to 10:1, 10:1 to 1:2, 20:1 to 1:1, 20:1 to 2:1, 20:1 to 5:1, 20:1 to 10:1, 10:1 to 1:1, 10:1 to 2:1, 10:1 to 5:1, 5:1 to 1:2, 5:1 to 1:1, 5:1 to 2:1, 2:1 to 1:2, 2:1 to 1:1, or 1:1 to 1:2.

In some embodiments, the G-SMW-SG molecules include glycosylated molecules with different levels of glycosylation as shown in Table A with 1-20 additional monosaccharide units that are added to the steviol or isosteviol backbone during a man-made glycosylation reaction. In some embodiments, the additional monosaccharide units are glucose units. In some embodiments, the additional monosaccharide units are non-glucose units, such as fructose, xylose and galactose units. In some embodiments, the additional monosaccharide units are a mixture of glucose units and non-glucose units.

In some embodiments, the glycosylation products of SMW-SGs, such as GRB, GSTB, GSTM and GRU, are present individually or collectively in an amount of less than 99%, 80%, 75%, 70%, 65%, 60%, 55%, 50%, 45%, 40%, 35%, 30%, 25%, 20%, 15% or 10% by weight of the glycosylation products. In some embodiments, the glycosylation products of SMW-SGs, such as GRB, GSTB, GSTM and GRU, are present individually or collectively in an amount of greater than 5%, 10%, 15%, 20%, 25%, 30%, 35%, 40%, 45%, 50%, 55%, 60%, 65%, 70%, 75%, 80%, 85%, 90% or 95% by weight of the glycosylation products.

In some embodiments, the glycosylation products of SMW-SGs, such as GRB, GSTB, GSTM and GRU, contain less than 99%, 80%, 50%, 10%, 8%, 6%, 4% or 2% of mono-glycosylated RB, mono-glycosylated STB, mono-glycosylated STM, and mono-glycosylated RU, individually or collectively (i.e., in a steviol or isosteviol backbone with one added monosaccharide unit) by weight. In some embodiments, the glycosylation products of SMW-SGs, such as mono-glycosylated RB, mono-glycosylated STB, mono-glycosylated STM, and mono-glycosylated RU, contain greater than 5%, 10%, 15%, 20%, 25%, 30%, 35%, 40%, 45%, 50%, 55%, 60%, 70% or 80% of mono-glycosylated RB, mono-glycosylated STB, mono-glycosylated STM, and mono-glycosylated RU, individually or collectively by weight.

In some embodiments, the glycosylation products contain less than 10%, 8%, 6%, 4% or 2% of di-glycosylated SMW-SGs, such as di-glycosylated RB, di-glycosylated STB, di-glycosylated STM, and di-glycosylated RU, individually or collectively (i.e., in a steviol or isosteviol backbone with two added monosaccharide units) by weight. In some embodiments, the glycosylation products contain greater than 5%, 10%, 15%, 20%, 25%, 30%, 35%, 40%, 45%, 50%, 55% or 60% of di-glycosylated SMW-SGs, such as di-glycosylated RB, di-glycosylated STB, di-glycosylated STM, and di-glycosylated RU, individually or collectively by weight.

In some embodiments, the glycosylation products contain less than 90%, 70%, 50%, 10%, 8%, 6%, 4% or 2% of tri-glycosylated SMW-SGs, such as tri-glycosylated RB, tri-glycosylated STB, tri-glycosylated STM, and tri-glycosylated RU, individually or collectively (i.e., in a steviol or isosteviol backbone with three added monosaccharide units) by weight. In some embodiments, the glycosylation products contain greater than 5%, 10%, 15%, 20%, 25%, 30%, 35%, 40%, 45%, 50%, 55%, 60%, 70% or 80% of tri-glycosylated SMW-SGs, such as tri-glycosylated RB, tri-glycosylated STB, tri-glycosylated STM, and tri-glycosylated RU, individually or collectively by weight.

In some embodiments, the glycosylation products comprise mono-glycosylated, di-glycosylated, and/or tri-glycosylated glycosylation products of SMW-SGs, such as GRB, GSTB, GSTM and GRU, individually or collectively, in a total amount of less than 60%, 50%, 30%, 25%, 20%, 15%, 10%, 5%, 4%, 3%, 2% or 1% by weight of the glycosylation products. In some embodiments, the glycosylation products comprise mono-glycosylated, di-glycosylated, and/or triglycosylated glycosylation products of SMW-SGs, such as GRB, GSTB, GSTM and GRU, individually or collectively, in a total amount of greater than 1%, 2%, 5%, 10%, 15%, 20%, 25%, 30%, 35%, 40%, 45%, 50%, 55%, 60%, 65%, 70%, 75%, 80%, 85% or 90% by weight of the glycosylation products.

In some embodiments, the glycosylation products are produced from one or more stevia extract compositions, each enriched for one or more SMW-SGs, where the weight percentage of the one or more SMW-SGs in each extract is at least 10%, 20%, 50%, 55%, 60%, 65%, 70%, 75%, 80%, 85%, 90% or 95% by weight, wherein the enriched SMW-SGs are produced from isolated stevia leaves. In some embodiments, the stevia extract compositions from which the glycosylation product are produced further include unreacted SGs and/or dextrins.

### B. The Maillard Reaction Products

(1) The Maillard Reaction

The Maillard reaction generally refers to a non-enzymatic browning reaction of a sugar donor with an amine donor in the presence of heat which produces flavor. Common flavors produced as a result of the Maillard reaction include, for example, those associated with red meat, poultry, coffee, vegetables, bread crust etc. subjected to heat. A Maillard reaction relies mainly on sugars and amino acids but it can also contain other ingredients including: autolyzed yeast extracts, hydrolyzed vegetable proteins, gelatin (protein source), vegetable extracts (i.e., onion powder), enzyme treated proteins, meat fats or extracts and acids or bases to adjust the pH of the reaction. The reaction can be in an aqueous environment with an adjusted pH at specific temperatures for a specified amount of time to produce a variety of flavors. Typical flavors include those associated with chicken, pork, beef, caramel, chocolate etc. However, a wide variety of different taste and aroma profiles can be achieved by adjusting the ingredients, the temperature and/or the pH of the reaction. The main advantage of the reaction flavors is that they can produce characteristic meat, burnt, roasted, caramellic, or chocolate profiles desired by the food industry, which are not typically achievable by using compounding of flavor ingredients.

Reducing groups can be found on reducing sugars (sugar donors) and amino groups can be found on amino donors such as free amino acids, peptides, and proteins. Initially, a reactive carbonyl group of a reducing sugar condenses with a free amino group, with a concomitant loss of a water molecule. A reducing sugar substrate for Maillard reaction typically has a reactive carbonyl group in the form of a free aldehyde or a free ketone. The resultant N-substituted glycoaldosylamine is not stable. The aldosylamine compound rearranges, through an Amadori rearrangement, to form a ketosamine. Ketosamines that are so-formed may further react through any of the following three pathways: (a) further dehydration to form reductones and dehydroreductones; (b) hydrolytic fission to form short chain products, such as diacetyl, acetol, pyruvaldehyde, and the like, which can, in turn, undergo Strecker degradation with additional amino groups to form aldehydes, and condensation, to form aldols; and (c) loss of water molecules, followed by reaction with additional amino groups and water, followed by condensation and/or polymerization into melanoids. Factors that affect the rate and/or extent of Maillard reactions include among others the temperature, water activity, and pH. The Maillard reaction is enhanced by high temperature, low moisture levels, and alkaline pH.

In the Maillard reaction, suitable carbonyl containing reactants include those that comprise a reactive aldehyde (—CHO) or keto (—CO—) group, such that the carbonyl free aldehyde or free keto group is available to react with an amino group associated with the reactant. Typically, the reducing reactant is a reducing sugar, e.g., a sugar that can reduce a test reagent, e.g., can reduce Cu2+ to Cu+, or can be oxidized by such reagents.

Monosaccharides, disaccharides, oligosaccharides, polysaccharides (e.g., dextrins, starches, and edible gums) and their hydrolysis products are suitable reducing reactants if they have at least one reducing group that can participate in a Maillard reaction. Reducing sugars include aldoses or ketoses such as glucose, fructose, maltose, lactose, glyceraldehyde, dihydroxyacetone, arabinose, xylose, ribose, mannose, erythrose, threose, and galactose. Other reducing reactants include uronic acids (e.g., glucuronic acid, glucuronolactone, and galacturonic acid, mannuronic acid, iduronic acid) or Maillard reaction intermediates bearing at least one carbonyl group such as aldehydes, ketones, alpha-hydroxycarbonyl or dicarbonyl compounds.

(2) Maillard Reaction Components

The inventors of the present application have found that Maillard reaction product (MRP) compositions can provide improved taste profiles over previously reported high intensity natural sweetener compositions. In addition, the inventors have surprisingly discovered that non-reducing sugars, including steviol glycosides may serve as substrates in the Maillard reaction so as to provide improved taste profiles. Thus, the G-SMW-SG compositions or extracts may also serve as substrates in the Maillard reaction and provide Maillard reaction product (MRP) compositions having improved taste or flavor profiles.

In some embodiments, the present application provides a G-SMW-SG Maillard reaction product (G-SMW-SG-MRP) composition that is formed from heating a reaction mixture comprising (1) one or more exogenously added amine donors, and (2) one or more G-SMW-SGs and/or one or more glycosylated Stevia extracts enriched for one or more SMW-SGs.

In some embodiments, the present application provides a conventional Maillard reaction product that is formed from heating a reaction mixture comprising (1) one or more exogenously added amine donors, and (2) one or more sugar donor. The C-MRP may be added to a composition comprising one or more SMW-SGs, one or more G-SMW-SGs and/or one or more G-SMW-SG-MRPs to enhance the taste or flavor profiles of the composition.

In some embodiments, the present application provides a G-SMW-SG-MRP composition that is formed from heating a reaction mixture comprising (1) one or more exogenously added reducing sugars; and (2) one or more G-SMW-SGs, one or more glycosylated Stevia extracts enriched for one or more SMW-SGs, and/or one or more glycosylated sweet tea extracts enriched for RU.

In some embodiments, the present application provides a G-SMW-SG-MRP composition that is formed by heating a reaction mixture comprising: (1) one or more exogenously added amine donors, (2) one or more exogenously added reducing sugars; and (3) one or more G-SMW-SGs, one or more glycosylated Stevia extracts enriched for one or more SMW-SGs, and/or one or more glycosylated sweet tea extracts enriched for RU.

In some embodiments, the present application provides a G-SMW-SG-MRP composition that is formed from heating a reaction mixture comprising (1) one or more exogenously added amino acids; (2) one or more exogenously added non-reducing sugars; and (3) one or more G-SMW-SGs, one or more glycosylated Stevia extracts enriched for one or more SMW-SGs and/or one or more glycosylated sweet tea extracts enriched for RU.

In some embodiments, the present application provides a G-SMW-SG-MRP composition that is formed from heating a reaction mixture comprising (1) one or more exogenously added amino acids, (2) one or more G-SMW-SGs, one or more glycosylated Stevia extracts enriched for one or more SMW-SGs, and/or one or more glycosylated sweet tea extracts enriched for RU.

In some embodiments, the present application provides a G-SMW-SG-MRP composition that is formed from heating a reaction mixture comprising (1) one or more exogenously added amine donors, (2) one or more exogenously added reducing sugars; (3) one or more exogenously added non-reducing sugars; and (4) one or more G-SMW-SGs, one or more glycosylated Stevia extracts enriched for one or more SMW-SGs and/or one or more glycosylated sweet tea extracts enriched for RU.

In some embodiments, the one or more G-SMW-SGs, the one or more glycosylated Stevia extracts enriched for one or more SMW-SGs, or the one or more glycosylated sweet tea extracts enriched for RU, comprise both G-SMW-SGs and SMW-SGs at a G-SMW-SGs (collectively)-to-SMW-SGs (collectively) weight ratio of 99:1 to 1:2, 99:1 to 1:1, 99:1 to 2:1, 99:1 to 5:1, 99:1 to 10:1, 99:1 to 20:1, 99:1 to 40:1, 99:1 to 60:1, 99:1 to 80:1, 80:1 to 1:2, 80:1 to 1:1, 80:1 to 2:1, 80:1 to 5:1, 80:1 to 10:1, 80:1 to 20:1, 80:1 to 40:1, 80:1 to 60:1, 60:1 to 1:2, 60:1 to 1:1, 60:1 to 2:1, 60:1 to 5:1, 60:1 to 10:1, 60:1 to 20:1, 60:1 to 40:1, 40:1 to 1:2, 40:1 to 1:1, 40:1 to 2:1, 40:1 to 5:1, 40:1 to 10:1, 40:1 to 20:1, 20:1 to 1:2, 20:1 to 1:1, 20:1 to 2:1, 20:1 to 5:1, 20:1 to 10:1, 10:1 to 1:2, 20:1 to 1:1, 20:1 to 2:1, 20:1 to 5:1, 20:1 to 10:1, 10:1 to 1:1, 10:1 to 2:1, 10:1 to 5:1, 5:1 to 1:2, 5:1 to 1:1, 5:1 to 2:1, 2:1 to 1:2, 2:1 to 1:1, or 1:1 to 1:2.

In some embodiments, the present application provides a G-SMW-SG-MRP that is formed by glycosylation of a SMW-SG-MRP. Exemplary conditions of glycosylation are described in Section II(A)(2).

In some embodiments, the present application provides a glycosylated stevia extract-MRP (GSE-MRP), glycosylated sweet tea extract (GSTE-MRP) or a glycosylated steviol glycoside-MRP (G-SG-MRP) that is formed by glycosylation of a SG-MRP or STE-MRP. Exemplary conditions of glycosylation are described in Section II(A)(2).

Amine Donor

The G-SMW-SG-MRP compositions of the present application are formed from a reaction mixture comprising at least one exogenous amine donor comprising a free amino group. As used herein, the term “amine donor” refers to a compound or substance containing a free amino group, which can participate in a Maillard reaction. Amine containing reactants include amino acids, peptides (including dipeptides, tripeptides, and oligopeptides), proteins, proteolytic or nonenzymatic digests thereof, and other compounds that react with reducing sugars and similar compounds in a Maillard reaction, such as phospholipids, chitosan, lipids, etc. In some embodiments, the amine donor also provides one or more sulfur-containing groups. Exemplary amine donors include amino acids, peptides, proteins, protein extracts.

Exemplary amino acids include, for example, nonpolar amino acids, such as alanine, glycine, isoleucine, leucine, methionine, tryptophan, phenylalanine, proline, valine; polar amino acids, such as cysteine, serine, threonine, tyrosine, asparagine, and glutamine; polar basic (positively charged) amino acids, such as histidine and lysine; and polar acidic (negatively charged) amino acids, such as aspartate and glutamate.

Exemplary peptides include, for example, hydrolyzed vegetable proteins (HVPs) and mixtures thereof.

Exemplary proteins include, for example, sweet taste-modifying proteins, soy protein, sodium caseinate, whey protein, wheat gluten or mixtures thereof. Exemplary sweet taste-modifying proteins include, for example, thaumatin, monellin, brazzein, miraculin, curculin, pentadin, mabinlin, and mixtures thereof. In certain embodiments, the sweet-taste modifying proteins may be used interchangeably with the term “sweetener enhancer.”

Exemplary protein extracts include yeast extracts, plant extracts, bacterial extracts and the like.

The nature of the amino donor can play an important role in accounting for the many flavors produced from a Maillard reaction. In some embodiments, the amine donor may account for one or more flavors produced from a Maillard reaction. In some embodiments, a flavor may be produced from a Maillard reaction by using one or more amine donors, or a particular combination of an amine donor and sugar donor.

In certain embodiments, the amine donor is present in the compositions described herein in a range of from about 1 to about 99 weight percent, from about 1 to about 50 weight percent, from about 1 to about 10 weight percent, from about 2 to about 9 weight percent, from about 3 to about 8 weight percent, from about 4 to about 7 weight percent, from about 5 to about 6 weight percent and all values and ranges encompassed over the range of from about 1 to about 50 weight percent. In some embodiments, the amine donor is from a plant source, such as vegetable juice, fruit juice, berry juice, etc.

Sugar Donor

In some embodiments, the sugar donor is a reducing sugar. Reducing sugars for use in the present application include, for example, all monosaccharides and some disaccharides, which can be aldose reducing sugars or ketose reducing sugars. Typically, the reducing sugar may be selected from the group consisting of aldotetrose, aldopentose, aldohexose, ketotetrose, ketopentose, and ketohexose reducing sugars. Suitable examples of aldose reducing sugars include erythrose, threose, ribose, arabinose, xylose, lyxose, allose, altrose, glucose, mannose, gulose, idose, galactose and talose. Suitable examples of ketose reducing sugars include erythrulose, ribulose, xylulose, psicose, fructose, sorbose and tagatose. The aldose or the ketose may also be a deoxy-reducing sugar, for example a 6-deoxy reducing sugar, such as fucose or rhamnose.

Specific monosaccharide aldoses include, for example, reducing agents include, for example, where at least one reducing sugar is a monosaccharide, or the one or more reducing sugars are selected from a group comprising monosaccharide reducing sugars, typically at least one monosaccharide reducing sugar is an aldose or a ketose.

Where the reducing sugar is a monosaccharide, the monosaccharide may be in the D- or L-configuration, or a mixture thereof. Typically, the monosaccharide is present in the configuration in which it most commonly occurs in nature. For example, the one or more reducing sugars may be selected from the group consisting of D-ribose, L-arabinose, D-xylose, D-lyxose, D-glucose, D-mannose, D-galactose, D-psicose, D-fructose, L-fucose and L-rhamnose. In a more particular embodiment, the one or more reducing sugars are selected from the group consisting of D-xylose, D-glucose, D-mannose, D-galactose, L-rhamnose and lactose.

Specific reducing sugars include ribose, glucose, fructose, maltose, lyxose, galactose, mannose, arabinose, xylose, rhamnose, rutinose, lactose, maltose, cellobiose, glucuronolactone, glucuronic acid, D-allose, D-psicose, xylitol, allulose, melezitose, D-tagatose, D-altrose, D-alditol, L-gulose, L-sorbose, D-talitol, inulin, stachyose, including mixtures and derivatives therefrom.

Exemplary disaccharide reducing sugars for use in the present application include maltose, lactose, lactulose, cellubiose, kojibiose, nigerose, sophorose, laminarbiose, gentiobiose, turanose, maltulose, palantinose, gentiobiulose, mannobiose, melibiose, melibiulose, rutinose, rutinulose or xylobiose.

Mannose and glucuronolactone or glucuronic acid can be used as sugar donors under Maillard reaction conditions, although they have seldom been used. Maillard reaction products of mannose, glucuronolactone or glucuronic acid provide yet another unique approach to provide new taste profiles with the sweetening agents described throughout the specification alone or in combination with additional natural sweeteners, synthetic sweeteners, and/or flavoring agents described herein.

In some embodiments, one or more carbohydrate sweeteners may be added to a reaction mixture subjected to the Maillard reaction. In other embodiments, one or more carbohydrate sweeteners may be added to an MRP composition. Non-limiting examples of carbohydrate sweeteners for use in the present application include caloric sweeteners, such as, sucrose, fructose, glucose, D-tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, sugar alcohols, such as erythritol, xylitol, mannitol, sorbitol, maltitol, lactitol, mannitol, and inositol; xylo-oligosaccharides (xylotriose, xylobiose and the like), gentio-oligoscaccharides (gentiobiose, gentiotriose, gentiotetraose and the like), galacto-oligosaccharides, sorbose, nigero-oligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (containing fructose and glucose, e.g., HFCS55, HFCS42, or HFCS90), coupling sugars, soybean oligosaccharides, and glucose syrup. Additionally, the above carbohydrates may be in either the D- or L-configuration.

It should be noted, however, that not all carbohydrate sweeteners are reducing sugars. Sugars having acetal or ketal linkages are not reducing sugars, as they do not have free aldehyde chains. They therefore do not react with reducing-sugar test solutions (e.g., in a Tollens' test or Benedict's test). However, a non-reducing sugar can be hydrolyzed using diluted hydrochloric acid.

In some embodiments, the sugar donor is a non-reducing sugar that does not contain free aldehyde or free keto groups. Exemplary non-reducing sugars include, but are not limited to, sucrose, trehalose, xylitol, and raffinose. In some embodiments, the sugar donor comprises both reducing sugar and non-reducing sugar. In some embodiments, the sugar donor is derived from a food ingredient, such as sugar, flour, starch, vegetable and fruits.

In some embodiments, the sugar donor is derived from a plant source. For example, in some embodiments, the sugar donor comprises a fruit juice, berry juice, vegetable juice, syrup, plant extract, vegetable extract etc. Alternatively, or in addition, the fruit juice, berry juice, vegetable juice, syrup, plant extract or vegetable extract may be used as a component added to the G-SMW-SG-MRP.

In some embodiments, the sugar donor is orange juice, cranberry juice, apple juice, peach juice, watermelon juice, pineapple juice, grape juice and concentrated products thereof.

In some embodiments, the fruit juice, berry juice or vegetable juice serves as both amine donor and sugar donor.

Reducing sugars can be derived from various sources for use as sugar donors in the Maillard reaction or as a component added to a G-SMW-SG-MRP composition. For example, a sugar syrup may be extracted from a natural source, such as Monk fruit, fruit juice or juice concentrate (e.g., grape juice, apple juice, etc.), vegetable juice (e.g., onion etc.), or fruit (e.g., apples, pears, cherries, etc.) for use as a sugar donor.

The syrup may include any type of juice regardless of whether there is any ingredient being isolated from juice, such as purified apple juice with trace amounts of malic acid etc. The juice can be in the form of liquid, paste or solid. Sugar donors may also be extracted from Stevia, sweet tea, luohanguo, etc. after isolation of high intensity sweetening agents described herein (containing non-reducing sugars) from crude extracts and mixtures thereof. Extracts from any part of plant containing reducing sugars can be used as sugar donors in Maillard reactions with or without other additional reducing sugars. In some embodiments, the MRPs are prepared using a plant extract as a sugar donor.

In some embodiments, the sugar donor and amino donor are present in the reaction mixture in a molar ratio of 10:1 to 1:10, 8:1 to 1:8, 6:1 to 1:6, 4:1 to 1:4, 3:1 to 1:3 or 2:1 to 1:2. In some embodiments, the sugar donor and amino donor are present in the reaction mixture in a molar ratio of 10:1, 9:1, 8:1, 7:1, 6:1, 5:1, 4:1, 3:1, 2:1, 1:1, 1:2, 1:3, 1:4, 1:5, 1:6, 1:7, 1:8, 1:9 or 1:10.

In some embodiments, the sugar donor and amino donor are present in the reaction mixture in a sugar donor:amino donor weight ratio of 10:1 to 1:10, 8:1 to 1:8, 6:1 to 1:6, 4:1 to 1:4, 3:1 to 1:3 or 2:1 to 1:2. In some embodiments, the sugar donor and amino donor are present in the reaction mixture in a molar ratio of 10:1, 9:1, 8:1, 7:1, 6:1, 5:1, 4:1, 3:1, 2:1, 1:1, 1:2, 1:3, 1:4, 1:5, 1:6, 1:7, 1:8, 1:9 or 1:10.

(3) Maillard Reaction Conditions

Maillard reaction conditions are affected by temperature, pressure, pH, reaction times, ratio of different reactants, types of solvents, and solvents-to-reactants ratio. Accordingly, in certain embodiments, the reaction mixture may include a pH regulator, which can be an acid or a base. Suitable base regulators include, for example, sodium hydroxide, potassium hydroxide, baking powder, baking soda any useable food grade base salts including alkaline amino acids. Additionally, the Maillard reaction can be conducted in the presence of alkalinic amino acids without the need of an additional base where the alkaline amino acid serves as the base itself. The pH of the reaction mixture can be maintained at any pH suitable for the Maillard reaction. In certain embodiments, the pH is maintained at a pH of from about 2 to about 14, from about 2 to about 7, from about 3 to about 9, from about 4 to about 8, from about 5 to about 7, from about 7 to about 14, from about 8 to about 10, from about 9 to about 11, from about 10 to about 12, or any pH range derived from these integer values.

In some embodiments, the reaction mixture has a pH of 4, 5, 6, 7, 8 or 9 at the initiation of the Maillard reaction.

In any of the embodiments described in the present application, the reaction temperature in any of the MRP reaction mixtures described in the present application may be 0° C., 5° C., 10° C., 20° C., 25° C., 30° C., 35° C., 40° C., 50° C., 55° C., 60° C., 65° C., 70° C., 80° C., 90° C., 100° C., 110° C., 120° C., 125° C., 130° C., 135° C., 140° C., 150° C., 155° C., 160° C., 165° C., 170° C., 180° C., 190° C., 200° C., 210° C., 220° C., 225° C., 230° C., 235° C., 240° C., 250° C., 255° C., 260° C., 265° C., 270° C., 280° C., 290° C., 300° C., 400° C., 500° C., 600° C., 700° C., 800° C., 900° C., 1000° C., or any temperature range defined by any two temperature values in this paragraph.

In more particular embodiments, the reaction temperature in any of the MRP reaction mixtures described in the present application may range from 0° C. to 1000° C., 10° C. to 300° C., from 15° C. to 250° C., from 20° C. to 250° C., from 40° C. to 250° C., from 60° C. to 250° C., from 80° C. to 250° C., from 100° C. to 250° C., from 120° C. to 250° C., from 140° C. to 250° C., from 160° C. to 250° C., from 180° C. to 250° C., from 200° C. to 250° C., from 220° C. to 250° C., from 240° C. to 250° C., from 30° C. to 225° C., from 50° C. to 225° C., from 70° C. to 225° C., from 90° C. to 225° C., from 110° C. to 225° C., from 130° C. to 225° C., from 150° C. to 225° C., from 170° C. to 225° C., from 190° C. to 225° C., from 210° C. to 225° C., from 80° C. to 200° C., from 100° C. to 200° C., from 120° C. to 200° C., from 140° C. to 200° C., from 140° C. to 200° C., from 160° C. to 200° C., from 180° C. to 200° C., from 90° C. to 180° C., from 100° C. to 180° C., from 110° C. to 180° C., from 120° C. to 180° C., from 130° C. to 180° C., from 140° C. to 180° C., from 150° C. to 180° C., from 160° C. to 180° C., from 80° C. to 160° C., from 90° C. to 160° C., from 100° C. to 160° C., from 110° C. to 160° C., from 120° C. to 160° C., from 130° C. to 160° C., from 140° C. to 160° C., from 150° C. to 160° C., from 80° C. to 140° C., from 90° C. to 140° C., from 100° C. to 140° C., from 110° C. to 140° C., from 120° C. to 140° C., from 130° C. to 140° C., from 80° C. to 120° C., from 85° C. to 120° C., from 90° C. to 120° C., from 95° C. to 120° C., from 100° C. to 120° C., from 110° C. to 120° C., from 115° C. to 120° C., from 80° C. to 100° C., from 85° C. to 100° C., from 90° C. to 100° C., from 95° C. to 100° C.; or any aforementioned temperature value in this paragraph, or a temperature range defined by any pair of the aforementioned temperature values in this paragraph.

Maillard reaction(s) can be conducted either under open or sealed conditions. The reaction time is generally from 1 second to 100 hours, more particularly from 1 minute to 24 hours, from 1 minute to 12 hours, from 1 minute to 8 hours, from 1 minute to 4 hours, from 1 minute to 2 hours, from 1 minute to 1 hour, from 1 minute to 40 minutes, from 1 minute to 20 minutes, from 1 minute to 10 minutes, from 10 minutes to 24 hours, from 10 minutes to 12 hours, from 10 minutes to 8 hours, from 10 minutes to 4 hours, from 10 minutes to 2 hours, from 10 minutes to 1 hour, from 10 minutes to 40 minutes, from 10 minutes to 20 minutes, from 20 minutes to 24 hours, from 20 minutes to 12 hours, from 20 minutes to 8 hours, from 20 minutes to 4 hours, from 20 minutes to 2 hours, from 20 minutes to 1 hour, from 20 minutes to 40 minutes, from 40 minutes to 24 hours, from 40 minutes to 12 hours, from 40 minutes to 8 hours, from 40 minutes to 4 hours, from 40 minutes to 2 hours, from 40 minutes to 1 hour, from 1 hour to 24 hours, from 1 hour to 12 hours, from 1 hour to 8 hours, from 1 hour to 4 hours, from 1 hour to 2 hours, from 2 hour to 24 hours, from 2 hour to 12 hours, from 2 hour to 8 hours, from 2 hour to 4 hours, from 4 hour to 24 hours, from 4 hour to 12 hours, from 4 hour to 8 hours, from 8 hour to 24 hours, from 8 hour to 12 hours, or from 12 hour to 24 hours. Depending on the desired taste, the reaction can be terminated at any time. The Maillard reaction mixture can contain unreacted reactants, degraded substances from the reactants, pH regulator(s), and/or salt(s).

The Maillard reactions can be conducted at atmospheric pressure or under pressure. When conducted under pressure, the reaction mixture may be subjected to constant pressure or it may be subjected to varying pressures over time. In certain embodiments, the pressure in the reaction vessel is at least 10 MPa, at least 20 MPa, at least 30 MPa, at least 40 MPa, at least 50 MPa, at least 75 MPa, at least 100 MPa, at least 150 MPa, at least 200 MPa, at least 250 MPa, at least 300 MPa, at least 400 MPa, at least 500 MPa, at least 600 MPa, at least 700 MPa, at least 800 MPa, and any pressure range derived from the aforementioned pressure values.

In some embodiments, it is desirable to suppress the Maillard reaction, in part. This can be achieved by exercising one or more of the following approaches, including the use of raw materials that are not susceptible to browning, adjusting the factors affecting the browning velocity of Maillard reaction, lowering the temperature, lowering pH, adjusting water activity, increasing the level of oxygen, using oxidant, introducing enzymes, etc.

In certain embodiments, the use of low solubility or insoluble amino acids in the Maillard reaction may result in insoluble reactants present in the final MRP composition. In such cases, filtration may be used to remove any insoluble components present in the MRP compositions.

A general method to prepare derived Maillard reaction product(s) is described as follows. Briefly, an SMW-SG or SE enriched for an SMW-SG, such as rebaudioside B, steviolbioside or steviol monoside is dissolved with or without a sugar donor, and together with amino acid donor in water, followed by heating of the solution at an elevated temperature, for example from 30, 40, or 50° C. up to 250° C. The reaction time can be varied from more than one second to a few days, more generally a few hours, until Maillard reaction products (MRPs) are formed or the reaction components have been exhausted or the reaction has been completed, with or without formation of caramelization reaction products (CRPs), which are further described below. When required, a pH adjuster or pH buffer can be added to regulate the pH of the reaction mixture before, during or after reaction as further described herein. The resultant solution is dried by spray dryer or hot air oven to remove the water and to obtain the MRP(s).

When the reaction is completed, the product mixture does not need to be neutralized or it can be neutralized. Water and/or solvent(s) do not necessarily need to be removed but can be removed by distillation, spray drying or other known methods if the product is desired as a powder or liquid, whatever the case may be.

Interestingly, when a reaction mixture is dried to a powder, such as by spray drying, the resultant powders only have a slight smell associated with them. This is in contrast to regular powdered flavoring agents that generally have a strong smell. The dried powdered reaction mixtures of the embodiments, when dissolved in a solvent, such as water or alcohol or mixtures thereof, release the smell. This demonstrates that the volatile substances in the MRPs can be preserved by SGs or SEs present in the reaction products and compositions of the present application. Powders with strong aromas can be obtained too, particularly where the carrier, such as an SE, is much less compared with MRP flavors or strong flavor substances used during Maillard reactions.

In some embodiments, the MRP mixtures may further include one or more carriers (or flavor carriers) acceptable for use with sweetening agents or flavoring agents. In addition, such carriers may be suitable e.g., as solvents for the Maillard reaction.

Exemplary carriers include acetylated distarch adipate, acetylated distarch phosphate, agar, alginic acid, beeswax, beta-cyclodextrine, calcium carbonate, calcium silicate, calcium sulphate, candelilla wax, carboxymethyl cellulose, sodium salt, carnauba wax, carrageenan, microcrystalline cellulose, dextran, dextrin, diammonium phosphate, distarch phosphate, edible fats, elemi resin, ethyl lactate, ethyl cellulose, ethyl hydroxyethyl cellulose, ethyl tartrate, gelatin, gellan gum, ghatti gum, glucose, glyceryl diacetate, glyceryl diesters of aliphatic fatty acids C6-C18, glyceryl monoesters of aliphatic fatty acids C6-C18, gyceryl triacetate (triacetin), glyceryl triesters of aliphatic fatty acids C6-C18, glyceryl tripropanoate, guar gum, gum arabic, hydrolyzed vegetable protein, hydroxyproplymethyl cellulose, hydroxypropyl cellulose, hydroxypropyl distarch phosphate, hydroxypropyl starch, karaya gum, konjac gum, lactic acid, lactose, locust bean gum (carob bean gum), magnesium carbonate, magnesium salts of fatty acids, maltodextrin, methyl cellulose, medium chain triglyceride, modified starches, such as acetylated distarch adipate, acetylated oxidized starch, acid-treated starch, alkaline treated starch, bleached starch, roasted starch dextrins, distarch phosphate, hydroxypropyl distarch phosphate, acetylated distarch phosphate, hydroxypropyl starch, monostarch phosphate, oxidized starch, phosphated distarch phosphate, starch acetate, starch sodium octenyl succinate, and enzyme treated starches; mono-, di- and tri-calcium orthophosphate, Na, K, NH4 and Ca alginate, pectins, processed euchema seaweed, propylene glycol alginate, sodium chloride (salt), silicon dioxide, sodium aluminium diphosphate, sodium aluminium silicate, Sodium, potassium and calcium salts of fatty acids, starch, starch (sodium) octenyl succinate, starch acetate, sucro glycerides, sucrose, sucrose esters of fatty acids, type I and type II sucrose oligoesters, taragum, tragacanth, triethylcitrate, whey powder, xanthan gum, fibers such as non-starch polysaccharides, lignin, cellulose, methylcellulose, the hemicelluloses, β-glucans, mucilage, inulins, oligosaccharides, polydextrose, fructooligosaccharides, cyclodextrins, chitins, and combinations thereof, and thickeners such as carbomers, cellulose base materials, gums, waxes, algin, agar, pectins, carrageenan, gelatin, mineral or modified mineral thickeners, polyethylene glycol and polyalcohols, polyacrylamide and other polymeric thickeners, and combinations thereof.

When utilizing the MRP compositions for use in a sweetening or flavor composition, one or more additional components may be added to the MRP composition after the Maillard reaction has occurred, including the components described above in section IV above. In some embodiments, these additional components include flavoring substances. Moreover, the reaction products after the Maillard reaction has been completed can further include, for example, one or more sweetening agents, reducing sugars (i.e., residue sugar donors), amine donors, sweetener enhancers, and CRPs, as well as one or more degraded sweetening agents, degraded sugar donors, degraded amine donors, and salts.

It should also be understood, for example, that the Maillard reaction can be performed under conditions containing an excess of amine donors in comparison to reducing sugars or much less than the amount of reducing sugars present. In the first instance, the resultant MRPs would include unreacted amine donors, degraded amine donors and/or residues from reacted amine donors. Conversely, when there is an excess of reducing sugars present in the Maillard reaction, the amine donors would be more fully reacted during the course of the reaction and a greater amount of unreacted reducing sugars as well as degraded reducing sugars and/or degrading reducing sugars and residues therefrom. Surprisingly, where the reducing sugar is replaced with a sweetening agent (e.g., a material such as an SMW-SG that does not include a reactive aldehydic or ketone moiety) and reacted with one or more amine donors, the amine donors may be present in the reaction products in reduced amounts reflecting their consumption in the Maillard type reaction or there excess of amine donors, as well as amine donor residues and/or amine degradation products after the Maillard reaction has been completed.

There are many ways to control the resulting MRPs. For instance, adjusting the pH, pressure, reaction time, and ingredient additions to optimize the ratio of raw materials etc. Further, the separation of MRPs products can provide a means for preparing different types of flavors or flavor enhancers. For example, MRPs include both volatile substances and non-volatile substances. Therefore, by evaporating the volatile substances, non-volatile substances can be purified for use. These non-volatile substances (or products) can be used as flavor modifiers or with the top note flavor in final products, such as volatile peach, lemon flavor provided by traditional flavor houses.

Volatile substances can be used as flavor or flavor enhancers as well. Partial separation of MRPs can be carried out to obtain volatile substances, which can be further separated by distillation etc. or obtain non-volatile substances for instance by recrystallization, chromatograph etc. could be done to meet different targets of taste and flavor. Therefore, in this specification, MRPs include a composition including one or more volatile substances, one or more non-volatile substances or mixtures thereof. Non-volatile substances in MRPs or isolated from MRPs can provide a good mouth feel, umami and Kokumi taste.

(4) Use of Raw Materials, Such as Fruit Juices and Plant Extract, in Maillard Reaction

Raw materials in MRP reactions and/or MRP-containing composition

In some embodiments, the reactants for the Maillard reaction include a number of different raw materials for producing the G-SMW-SG-MRP compositions of the present application. The raw materials may be categorized into the following groups comprising the following exemplary materials:

(1) Protein Nitrogen Sources:

Protein nitrogen containing foods (meat, poultry, eggs, dairy products, cereals, vegetable products, fruits, yeasts), extracts thereof and hydrolysis products thereof, autolyzed yeasts, peptides, amino acids and/or their salts.

(2) Carbohydrate Sources:

Foods containing carbohydrates (cereals, vegetable products and fruits) and their extracts; mono-, di- and polysaccharides (sugars, dextrins, starches and edible gums), and hydrolysis products thereof.

(3) Fat or Fatty Acid Sources:

Foods containing fats and oils, edible fats and oil from animal, marine or vegetable origin, hydrogenated, trans-esterified and/or fractionated fats and oils, and hydrolysis products thereof.

4) Miscellaneous List of Additional Ingredients:
Foodstuffs, herbs, spices, their extracts and flavoring agents identified therein
Water
Thiamine and its hydrochloric salt
Ascorbic, Citric, Lactic, Fumaric, Malic, Succinic, Tartaric and the Na, K, Ca, Mg and NH4 salts of these acids
Guanylic acid and inosinic acid and its Na, K and Ca salts
Inositol
Sodium, potassium and ammonium sulphides, hydrosulphides and polysulphides
Lecithin
Acids, bases and salts as pH regulators:
Acetic, hydrochloric, phosphoric and sulphuric acids
Sodium, potassium, calcium and ammonium hydroxide.
Salts of the above acids and bases
Polymethylsiloxane as antifoaming agent.

In another aspect, the present application contemplates the use of any one of a number of raw materials exemplified below to produce NATURAL PRODUCTS:

Sugar Syrups: Xylose syrup, arabinose syrup and rhamnose syrup manufactured from beech wood. Ardilla Technologies supply these along with natural crystalline L-xylose, L-arabinose and L-rhamnose. Xylose syrup may also be obtained from natural sources, such as the xylan-rich portion of hemicellulose, mannose syrup from ivory nut, etc. These and other types of syrup described herein can be used as sugar donors in the compositions described herein.

Hydrolyzed gum arabic: Thickeners, such as gum arabic can be hydrolyzed with an organic acid or by enzyme hydrolysis to produce a mixture containing arabinose. Arabinose could also be obtained from other wood-based or biomass hydrolysate. Cellulose enzymes can also be used.

Meat Extracts: Commercially available from a number of companies, such as Henningsens (Chicken skin and meat), which gives excellent chicken notes.

Jardox: Meat and poultry extracts and stocks.

Kanegrade: Fish powders, anchovy, squid, tuna and others.

Vegetable Powders: onion and garlic powders, celery, tomato and leek powders are effective flavor contributors to reaction flavors.

Egg Yolk: Contains 50% fat and 50% protein. The fat contains phospholipids and lecithin. The proteins are coagulating proteins and their activity must be destroyed by hydrolysis with acid or by the use of proteases prior to use. This will also liberate amino acids and peptides useful in reaction flavors (Allergen activity).

Vegetable oils: Peanut (groundnut) oil—Oleic acid 50%, Linoleic acid 32%—beef and lamb profile. Sunflower—linoleic acid 50-75%, oleic 25%—chicken profile. Canola (rapeseed)—oleic 60%, linoleic 20%, alpha-linoleic 10%, gadoleic 12%.

Sauces: Fish sauce, soy sauce, oyster sauce, miso.

Enzyme Digests: Beef heart digest—rich in phospholipids. Liver digest—at low levels <5% gives a rich meaty character. Meat digests can also add authenticity but they are usually not as powerful as yeast extracts and HVPs.

Enzyme enhanced umami products—shitake or porcini mushrooms, kombu, etc. Enzyme digested fats—beef, lamb, etc.

All of the components of the compositions disclosed herein can be purchased or made by processes known to those of ordinary skill in the art and combined (e.g., precipitation/co-precipitation, mixing, blending, grounding, mortar and pestle, microemulsion, solvothermal, sonochemical, etc.) or treated as defined by the current invention.

The Maillard reaction is conducted with a suitable solvent. Additionally, solvents can be employed along with water. Suitable solvents approved for oral use include, for example, alcohols, such as low molecular weight alcohols, e.g., methanol, ethanol, propanol, butanol, pentanol, hexanol, ethylene glycol, propylene glycol, butyl glycol, etc. The following additional solvents may be used in the Maillard reaction or may act as carriers for Maillard reaction products: acetone, benzyl alcohol, 1,3-butylene glycol, carbon dioxide, castor oil, citric acid esters of mono- and di-glycerides, ethyl acetate, ethyl alcohol, ethyl alcohol denatured with methanol, glycerol (glycerin), glyceryl diacetate, glyceryl triacetate (triacetin), glyceryl tributyrate (tributyrin), hexane, isopropyl alcohol, methyl alcohol, methyl ethyl ketone (2-butanone), methylene chloride, monoglycerides and diglycerides, monoglyceride citrate, 1,2-propylene glycol, propylene glycol mono-esters and diesters, triethyl citrate, and mixtures thereof.

Although recognizing that other suitable solvents may be used for flavoring agents, The International Organization of the Flavor Industry (IOFI) Code of Practice (Version 1.3, dated Feb. 29, 2012) lists the following solvents as being appropriate for use in flavoring agents: acetic acid, benzyl alcohol, edible oils, ethyl alcohol, glycerol, hydrogenated vegetable oils, isopropyl alcohol, mannitol, propylene glycol, sorbitol, sorbitol syrup, water, and xylitol. Accordingly, in certain embodiments, these are preferred solvents.

In some embodiments, the solvent is water. In some embodiments, the solvent is glycerol. In some embodiments, the solvent is a glycerol-water mixture with a glycerol:water ratio (v:v) of 10:1 to 1:10, 9:1 to 1:9, 8:1 to 1:8, 7:1 to 1:7, 6:1 to 1:6, 1:5 to 5:1, 1:4 to 4:1, 1:3 to 3:1, 1:2 to 2:1. In some embodiments, the solvent is a glycerol-water mixture with a glycerol:water ratio (v:v) of 1:9, 1:8, 1:7, 1:6, 1:5, 1:4, 1:3, 1:2, 1:1, 2:1, 3:1, 4:1, 5:1, 6:1, 7:1, 8:1 or 9:1.

In some embodiments, the reaction mixture comprises a solvent in an amount of 10-90 wt %, 10-80 wt %, 10-70 wt %, 10-60 wt %, 10-50 wt %, 10-40 wt %, 10-30 wt %, 10-20 wt %, 20-90 wt %, 20-80 wt %, 20-70 wt %, 20-60 wt %, 20-50 wt %, 20-40 wt %, 20-30 wt %, 30-90 wt %, 30-80 wt %, 30-70 wt %, 30-60 wt %, 30-50 wt %, 30-40 wt %, 40-90 wt %, 40-80 wt %, 40-70 wt %, 40-60 wt %, 40-50 wt %, 50-90 wt %, 50-80 wt %, 50-70 wt %, 50-60 wt %, 60-90 wt %, 60-80 wt %, 60-70 wt %, 70-90 wt %, 70-80 wt %, or 80-90 wt % of the reaction mixture. In some embodiments, the reaction mixture comprises a solvent in an amount of about 10 wt %, about 15 wt %, about 20 wt %, about 25 wt %, about 30 wt %, about 33 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, or about 90 wt % of the reaction mixture.

In some embodiments, the sugar donor may account for one or more flavors produced from a Maillard reaction. More particularly, a flavor may be produced from a Maillard reaction by using one or more sugar donors, wherein at least one sugar donor is selected from a product comprising a glycoside and a free carbonyl group. In some embodiments, glycosidic materials for use in Maillard reactions include natural juice/concentrates/extracts selected from strawberry, blueberry, blackberry, bilberry, raspberry, lingonberry, cranberry, red currants, white currants, blackcurrants, apple, peach, pear, apricot, mango, grape, water melon, cantolope, grapefruit, passion fruit, dragon fruit, carrot, celery, eggplant, tomato, etc.

The natural extracts used in Maillard reactions described herein can include any solvent extract-containing substances, such as polyphenols, free amino acids, flavonoids etc. The extracts can be further purified by methods such as resin-enriched, membrane filtration, crystallization etc., as further described herein.

In one embodiment, a Maillard reaction mixture or an MRP composition produced thereof may include a sweetener, a sweetener enhancer, such as thaumatin, and optionally one or more MRP products, wherein the sweetener is selected from date paste, apple juice concentrate, monk fruit concentrate, sugar beet syrup, pear juice or puree concentrate, apricot juice concentrate. Alternatively, a root or berry juice may be used as sugar donor or sweetener added to an MRP composition.

In some embodiments, particular flavors may be produced from a Maillard reaction through the use of one or more sugar donors, where at least one sugar donor is selected from plant juice/powder, vegetable juice/powder, berries juice/powder, fruit juice/powder. In certain preferred embodiments, a concentrate or extract may be used, such as a bilberry juice concentrate or extract having an abundance of anthocyanins. Optionally, at least one sugar donor and/or one amine donor is selected from animal source based products, such as meat, oil etc. Meat from any part of an animal, or protein(s) from any part of a plant could be used as source of amino donor(s) in this application.

In some embodiments, the Maillard reactants may further include one or more high intensity synthetic sweeteners, natural non-SG sweeteners, and/or the glycosylation products thereof. Alternatively, or in addition, the high intensity synthetic sweeteners may be added to an MRP composition comprising reaction products formed in the Maillard reaction.

High intensity synthetic sweeteners are synthetically produced sugar substitutes or sugar alternatives that are similarly many times sweeter than sugar and contribute few to no calories when added to foods. Moreover, they can be similarly used as Maillard reaction components or as flavor enhancers added to MRP compositions of the present application. High intensity synthetic sweeteners include Advantame, Aspartame, Acesulfame potassium (Ace-K), Neotame, Sucralose, and Saccharin.

The inventor has found that Advantame, a non-caloric high intensity synthetic sweetener and aspartame analog, can boost the flavor and taste profile of the compositions disclosed herein, especially when added after Maillard reaction. Generally, Advantame and other high intensity synthetic sweeteners can be added in the range of 0.01 ppm to 100 ppm.

### C. Embodiments of the Composition of the Present Application

In some embodiments, the composition of the present application includes (1) a G-SMW-SG-MRP composition formed from a reaction mixture containing a G-SMW-SG, an amine donor, and optionally a sugar donor; and (2) a sweetener. The amine donor and/or sugar donor for use in the Maillard reaction may include any of the foregoing amine donors or sugar donors described above.

In some embodiments, the G-SMW-SG-MRP composition is present in the composition of the present application in an amount of 0.001-99 wt %, 0.001-75 wt %, 0.001-50 wt %, 0.001-25 wt %, 0.001-10 wt %, 0.001-5 wt %, 0.001-2 wt %, 0.001-1 wt %, 0.001-0.1 wt %, 0.001-0.01 wt %, 0.01-99 wt %, 0.01-75 wt %, 0.01-50 wt %, 0.01-25 wt %., 0.01-10 wt %, 0.01-5 wt %, 0.01-2 wt %, 0.01-1 wt %, 0.1-99 wt %, 0.1-75 wt %, 0.1 wt-50 wt %, 0.1-25 wt %, 0.1-10 wt %, 0.1-5 wt %, 0.1-2 wt %, 0.1-1 wt %, 0.1-0.5 wt %, 1-99 wt %, 1-75 wt %, 1-50 wt %, 1-25 wt %, 1-10 wt %, 1-5 wt %, 5-99 wt %, 5-75 wt %, 5-50 wt %, 5-25 wt %, 5-10 wt %, 10-99 wt %, 10-75 wt %, 10-50 wt %, 10-25 wt %, 10-15 wt %, 20-99 wt %, 20-75 wt %, 20-50 wt %, 30-99 wt %, 30-75 wt %, 30-50 wt %, 40-99 wt %, 40-75 wt %, 40-50 wt %, 50-99 wt %, 50-75 wt %, 60-99 wt %, 60-75 wt %, 70-99 wt %, 70-75 wt %, 80-99 wt %, 80-90 wt %, or 90-99 wt % of the composition.

In some embodiments, the G-SMW-SG-MRP composition is prepared from a Maillard reaction mixture that includes a G-SMW-SG formed from an SMW-SG. In some embodiments, the G-SMW-SG is formed from one, two, three, four, five or more SMW-SGs selected from the group consisting of steviol monoside A, dulcoside A, dulcoside A1, dulcoside B, stevioside, stevioside B, stevioside D, stevioside E, stevioside E2, stevioside F, rubusoside, rebaudioside C, rebaudioside C2, rebaudioside G, rebaudioside G1, rebaudioside F, rebaudioside F1, rebaudioside F2, rebaudioside F3, rebaudioside KA, rebaudioside Ll, rebaudioside R, rebaudioside R1, glycosylated forms thereof, MRP products thereof, and combinations thereof.

In some embodiments, the G-SMW-SG-MRP composition is prepared from a Maillard reaction mixture that includes G-SMW-SG formed from one, two, or three Stevia extracts (SEs), where each SE is enriched for an SMW-SG as listed in e.g., Table B.

In one embodiment, the G-SMW-SG-MRP composition is prepared from a Maillard reaction mixture that includes a single G-SMW-SG. In a particular embodiment, the single G-SMW-SG is glycosylated rebaudioside B, glycosylated steviolbioside, glycosylated steviol monoside or GRU.

In another embodiment, the G-SMW-SG-MRP composition is prepared from a Maillard reaction mixture that includes two GSGs from GRB, GSTB, GSTM and GRU.

In another embodiment, the G-SMW-SG-MRP composition is prepared from a Maillard reaction mixture that includes three GSGs from GRB, GSTB, GSTM and GRU.

In another embodiment, the G-SMW-SG-MRP composition is prepared from a Maillard reaction mixture that includes GRB, GSTB, GSTM and GRU.

In some embodiments, the G-SMW-SG-MRP composition includes an MRP prepared from a Maillard reaction mixture that includes one or more G-SMW-SG, such as GRB, GSTB, GSTM and GRU, or a combination thereof, where the one or more G-SMW-SG are present in the Maillard reaction mixture, individually or collectively, in an amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt %. In some embodiments, the Maillard reaction mixture further includes one or more unreacted SGs and/or dextrins.

In one embodiment, the G-SMW-SG-MRP composition is prepared from a Maillard reaction mixture including an exogenous amine donor comprising a free amino group, where the amine donor is an amino acid, a peptide (including dipeptides, tripeptides, and oligopeptides), a protein, a protein extract, a proteolytic or nonenzymatic digest thereof, or a combination thereof.

In another embodiment, the G-SMW-SG-MRP composition is prepared from a Maillard reaction mixture where the exogenous amine donor is an amino acid selected from the group consisting of alanine, glycine, isoleucine, leucine, methionine, tryptophan, phenylalanine, proline, valine, cysteine, serine, threonine, tyrosine, asparagine, and glutamine, histidine, lysine, aspartate, glutamate, or a combination thereof.

In another embodiment, the G-SMW-SG-MRP composition is prepared from a Maillard reaction mixture carried out a temperature of 50-250° C.

In some embodiments, the composition of the present application comprises one or more SMW-SGs selected from the list in Table B. In some embodiments, the one or more SMW-SGs are selected from the group consisting of steviol monoside A, dulcoside A, dulcoside A1, dulcoside B, stevioside, stevioside B, stevioside D, stevioside E, stevioside E2, stevioside F, rubusoside, rebaudioside C, rebaudioside C2, rebaudioside G, rebaudioside G1, rebaudioside F, rebaudioside F1, rebaudioside F2, rebaudioside F3, rebaudioside KA, rebaudioside Ll, rebaudioside R, and rebaudioside R1.

In some embodiments, the composition of the present application includes (a) one or more G-SMW-SG-MRPs in combination with one or more of (b), (c) and/or (d), wherein (b) comprises one or more SMW-SGs, one or more SEs enriched for one or more SMW-SGs, and/or one or more STEs entiched for RU; wherein (c) comprises one or more G-SMW-SGs, one or more GSEs prepared from SEs enriched for one or more G-SMW-SGs, and/or one or more STEs entiched for RU; and wherein (d) comprises conventional MRPs.

In some embodiments, the composition of the present application further comprises one or more HMW-SGs, G-HMW-SGs and/or G-HMW-SG-MRPs.

In some embodiments, the composition of the present application further comprises one or more stevia extracts (SEs), glycosylated SEs (GSEs), sweet tea extracts (StEs), glycosylated STEs (GSTEs). Extracts from Stevia leaves or sweet tea leave, for example, provide SGs with varying percentages corresponding to the SGs present in a particular extract. A Stevia/sweet tea extract may contain various combinations of individual SGs, wherein the extract may be defined by the proportion of a particular SG in the extract.

For example, as used herein, the phrase “total steviol glycosides” refers to the total amount (w/w %) of different SGs and/or GSGs in a composition, unless specific groups of SGs or GSGs are measured in the examples. Further, an acronym of the type “YYxx” is used herein with reference to an SG composition or a GSG composition formed therefrom, where YY refers to a given (such as RA) or collection of compounds (e.g., SGs), where “xx” is typically a percent by weight number between 1 and 100 denoting the level of purity of a given compound (such as RA) or collection of compounds, where the weight percentage of YY in the dried product is equal to or greater than xx. The acronym “YYxx+WWzz” refers to a composition, where each one of “YY” and “WW” refers to a given compound (such as RA) or a collection of compounds (e.g., SGs), and where each of “xx” and “zz” refers to a percent by weight number between 1 and 100 denoting the level of purity of a given compound (such as RA) or a collection of compounds, where the weight percentage of YY in the dried product is equal to or greater than xx, and where the weight percentage of WW in the dried product is equal to or greater than zz.

The acronym “RAx” refers to a Stevia composition containing RA in amount of ≥x % and <(x+10)% with the following exceptions: the acronym “RA100” specifically refers to pure RA; the acronym “RA99.5” specifically refers to a composition where the amount of RA is ≥99.5 wt %, but <100 wt %; the acronym “RA99” specifically refers to a composition where the amount of RA is ≥99 wt %, but <100 wt %; the acronym “RA98” specifically refers to a composition where the amount of RA is ≥98 wt %, but <99 wt %; the acronym “RA97” specifically refers to a composition where the amount of RA is ≥97 wt %, but <98 wt %; the acronym “RA95” specifically refers to a composition where the amount of RA is ≥95 wt %, but <97 wt %; the acronym “RA85” specifically refers to a composition where the amount of RA is ≥85 wt %, but <90 wt %; the acronym “RA75” specifically refers to a composition where the amount of RA is ≥75 wt %, but <80 wt %; the acronym “RA65” specifically refers to a composition where the amount of RA is ≥65 wt %, but <70 wt %; the acronym “RA20” specifically refers to a composition where the amount of RA is ≥15 wt %, but <30 wt %.

The acronym “GSG-RAxx” refers to a GSG composition prepared in an enzymatically catalyzed glycosylation process with RAxx as the starting SG material. More generally, acronyms of the type “GSG-YYxx” refer to a composition of the present application where YY refers to a compound (such as RA, RB, RC, RD, RE, RI and RM), or a composition (e.g., RA20), or a mixture of compositions (e.g., RA40+RB8). For example, GSG-RA20 refers to the glycosylation products formed from RA20.

In some embodiments, the composition of the present application may further include non-steviol glycoside components. Certain non-steviol glycoside components are volatile substances characterized by a characteristic aroma and/or flavor, such as a citrus flavor and other flavors described herein. In addition, the composition of the present application may include certain non-volatile types of non-steviol glycoside substances comprising one or more molecules characterized by terpene, di-terpene, or ent-kaurene structure. Accordingly, in some embodiments, the composition of the present application may include one or more volatile and/or one or more non-volatile types of non-steviol glycoside substances.

SEs and STEs for use in the present application can be fractionated to select for small molecular weight (SMW) molecules as described in Table B or high molecular weight (HMW) molecules having a size greater of equal to 965 daltons.

SEs and STEs or use in the present application can be combined with one or more G-SMW-SG-MRPs in the compositions described herein. Exemplary SEs/STEs that can be combined with the one or more G-SMW-SG-MRPs are described in the following paragraphs.

Much like the case with the G-SMWs described above, GSGs, GSEs and GSTEs can be similarly obtained by synthetic manipulation or by enzymatic processes to produce both naturally occurring and non-naturally occurring GSGs. Exemplary GSGs of the present application include Stevioside G1 (ST-G1), Stevioside G2 (ST-G2), Stevioside G3 (ST-G3), Stevioside G4 (ST-G4), Stevioside G5 (ST-G5), Stevioside G6 (ST-G6), Stevioside G7 (ST-G7), Stevioside G8 (ST-G8), Stevioside G9 (ST-G9), Rebaudioside A G1 (RA-G1), Rebaudioside A G2 (RA-G2), Rebaudioside A G3 (RA-G3), Rebaudioside A G4 (RA-G4), Rebaudioside A G5 (RA-G5), Rebaudioside A G6 (RA-G6), Rebaudioside A G7 (RA-G7), Rebaudioside A G8 (RA-G8), Rebaudioside A G9 (RA-G9), Rebaudioside B G1 (RB-G1), Rebaudioside B G2 (RB-G2), Rebaudioside B G3 (RB-G3), Rebaudioside B G4 (RB-G4), Rebaudioside B G5 (RB-G5), Rebaudioside B G6 (RB-G6), Rebaudioside B G7 (RB-G7), Rebaudioside B G8 (RB-G8), Rebaudioside B G9 (RB-G9), Rebaudioside C G1 (RC-G1), Rebaudioside C G2 (RC-G2), Rebaudioside C G3 (RC-G3), Rebaudioside C G4 (RC-G4), Rebaudioside C G5 (RC-G5), Rebaudioside C G6 (RC-G6), Rebaudioside C G7 (RC-G7), Rebaudioside C G8 (RC-G8), Rebaudioside C G9 (RC-G9), Rebaudioside D G1, Rebaudioside D G2, Rebaudioside D G3, Rebaudioside D G4, Rebaudioside D G5, Rebaudioside D G6, Rebaudioside D G7, Rebaudioside D G8, Rebaudioside D G9, Rebaudioside E G1, Rebaudioside E G2, Rebaudioside E G3, Rebaudioside E G4, Rebaudioside E G5, Rebaudioside E G6, Rebaudioside E G7, Rebaudioside E G8, Rebaudioside E G9, Rebaudioside F G1, Rebaudioside F G2, Rebaudioside F G3, Rebaudioside F G4, Rebaudioside F G5, Rebaudioside F G6, Rebaudioside F G7, Rebaudioside F G8, Rebaudioside F G9, Rebaudioside M G1, Rebaudioside M G2, Rebaudioside M G3, Rebaudioside E G4, Rebaudioside M G5, Rebaudioside M G6, Rebaudioside M G7, Rebaudioside M G8, Rebaudioside M G9, Rubusoside G1, Rubusoside G2, Rubusoside G3, Rubusoside G4, Rubusoside G5, Rubusoside G6, Rubusoside G7, Rubusoside G8, Rubusoside G9, Dulcoside A G1, Dulcoside A G2, Dulcoside A G3, Dulcoside A G4, Dulcoside A G5, Dulcoside A G6, Dulcoside A G7, Dulcoside A G8, Dulcoside A G9.

Exemplary GSEs/GSTEs include GRU30 and GRU40. GRU30 is prepared from RU30 as a key starting material. GRU40 is prepared from RU40 as a key starting material.

In some embodiments, the composition of the present application is a food or beverage product, comprising one or more G-SMW-SG-MRPs and one or more high intensity sweeteners, wherein the G-SMW-SG-MRPs are present in an amount that is less than 20,000 ppm, less than 1,000 ppm, less than 800 ppm, 600 ppm, less than 500 ppm, less than 400 ppm, less than 200 ppm, less than 100 ppm, less than 50 ppm, less than 20 ppm or less than 10 ppm. In some embodiments, the G-SMW-SG-MRPs are present, individually or collectively, in an amount that is less than 100 ppm. In some embodiments, the food or beverage product further comprises residual SMW-SGs.

In another embodiments, the composition of the present application is a food or beverage product, comprising (1) a G-SMW-SG-MRP and (2) one or more mono-glycosylated, di-glycosylated, tri-glycosylated, tetra-glycosylated and/or penta-glycosylated SMW-SG, wherein the glycosylated SMW-SG(s) are present, individually or collectively, at a concentration more than 1 ppm, 10 ppm, 50 ppm, 100 ppm, 150 ppm, 200 ppm, 250 ppm, 300 ppm, 500 ppm, 1,000 ppm or 10,000 ppm. In some embodiments, the food or beverage product further comprises residual SMW-SGs.

In another embodiments, the composition of the present application is a food or beverage product, comprising (1) a G-SMW-SG-MRP and (2) one or more mono-glycosylated, di-glycosylated, tri-glycosylated, tetra-glycosylated and/or penta-glycosylated SMW-SG, wherein the glycosylated SMW-SG(s) are present, individually or collectively, at a concentration less than 10,000 ppm, 5,000 ppm, 1,000 ppm, 500 ppm, 300 ppm, 250 ppm, 100 ppm, 50 ppm, 10 ppm, 5 ppm or 1 ppm. In some embodiments, the food or beverage product further comprises residual SMW-SGs.

The inventor also surprisingly found that G-SMW-SG-MRPs and/or G-SMW-SGs can enhance the astringency and accelerate a quick acidity sensation. In some embodiment, the composition of the present application includes one or more G-SMW-SG-MRPs and/or G-SMW-SGs present in amount(s) to enhance the astringency and quick acid on-site sensation. In some embodiments, the composition contains a tea extract, a tea concentrate, cranberry juice, cranberry flavor, cranberry concentrate, grapefruit juice, grapefruit concentrate, grapefruit flavor, or a lemon and/or lime flavored juice or concentrate. In some embodiments, the composition contains one or more G-SMW-SG-MRPs and/or G-SMW-SGs in combination with quinic acid, where the quinic acid is above 0.1 ppm, 1 ppm, 5 ppm, 10 ppm, 50 ppm, 100 ppm, 200 ppm, 500 ppm, 1,000 ppm, 2,000 ppm, 5,000 ppm, 10,000 ppm, 50,000 ppm or 100,000 ppm.

Surprisingly, the inventor has also found that G-SMW-SG-MRPs and/or G-SMW-SGs can improve the solubility and enhance the sweetness of stevia glycosides. In particular, synergistic effects have been observed when these components have been combined together. In some embodiments, a consumable product includes one or more G-SMW-SG-MRPs and/or G-SMW-SGs in combination with one or more stevia extracts comprising one or more stevia glycosides selected from Reb A, Reb B, Reb C, Reb D, Reb E, Reb I, Reb M, Reb 0, and Reb N, such that the solubility and/or sweetness of the stevia extract(s) is increased.

In some embodiments, the composition of the present application comprises (a) one or more G-SMW-SG-MRPs and/or one or more G-SMW-SGs; and (b) SMW-SGs and/or HMW-SGs, including one or more stevia glycosides selected from Reb A, Reb B, Reb C, Reb D, Reb E, Reb M, Reb N, and Reb 0, wherein component (a) is added in an amount sufficient to significantly improve solubility, increase sweetness, reduce bitterness, and/or reduce metallic or lingering aftertastes in the composition in part (b).

In some embodiment, the composition of the present application comprises: ((a) one or more G-SMW-SG-MRPs and/or one or more G-SMW-SGs; and (b) SMW-SGs and/or HMW-SGs, including one or more stevia glycosides selected from Reb A, Reb B, Reb C, Reb D, Reb E, Reb M, Reb N, and Reb 0, wherein the (a)-to-(b) ratio (w/w) is 1:99 to 99:1. In some embodiments, the (a)-to-(b) ratio (w/w) of the composition is 1:99 to 30:1, 1:99 to 10:1, 1:99 to 3:1, 1:99 to 1:1, 1:99 to 1:3, 1:99 to 1:10, 1:99 to 1:30, 3:99 to 99:1, 3:99 to 30:1, 3:99 to 10:1, 3:99 to 3:1, 3:99 to 1:1, 3:99 to 1:3, 3:99 to 1:10, 10:99 to 99:1, 10:99 to 30:1, 10:99 to 10:1, 10:99 to 3:1, 10:99 to 1:1, 10:99 to 1:3, 30:99 to 99:1, 30:99 to 30:1, 30:99 to 10:1, 30:99 to 3:1, 30:99 to 1:1, 1:1 to 99:1, 1:1 to 30:1, 1:1 to 10:1, 1:1 to 3:1, 3:1 to 99:1, 3:1 to 30:1, 3:1 to 10:1, 10:1 to 99:1, 10:1 to 30:1, or 30:1 to 99:1. In some embodiments, part (a) is about, or great than, 1%, 2%, 5%, 10%, 15%, 20%, 25%, 30%, 35%, 40%, 45%, 50%, 55%, 60%, 65%, 70%, 75%, 80%, 85%, 90% or 95% by weight of the composition. In some embodiments, part (b) is about, or less than, 50%, 40%, 30%, 20%, 10%, 5%, 2% or 1% by weight of the composition.

In another embodiment, the composition of the present application is a flavor or sweetener that comprises: (a) one or more G-SMW-SG-MRPs and/or one or more G-SMW-SGs; and (b) one or more substances selected from a monk fruit extract, a glycosylated monk fruit extract, or both, wherein component (a) comprise at least 1%, at least 2%, at least 3%, at least 4%, at least 5%, at least 10%, at least 20%, at least 30%, at least 50%, at least 60%, at least 80%, at least 90%, or at least 95% (w/w) of the flavor or sweetener.

In another embodiment, the composition of the present application is a flavor or sweetener comprises: (a) one or more G-SMW-SG-MRPs and/or G-SMW-SGs, and (b) one or more substances selected from sucralose, acesulfame K, saccharin, aspartame, Neotame, and alitame, where the one or more substances in part (a) are present in the flavor or sweetener in an amount of at least 1%, at least 2%, at least 3%, at least 4%, at least 5%, at least 10%, at least 20%, at least 30%, at least 50%, at least 60%, at least 80%, at least 90%, or at least 95% (w/w).

In another embodiment, the composition of the present application is a flavor or sweetener comprises: (a) one or more G-SMW-SG-MRPs and/or G-SMW-SGs; and (b) one or more substances selected from polydextrins, modified starch, inulin, erythritol, where the one or more substances in part (a) are present in the flavor or sweetener in an amount of at least 1%, at least 2%, at least 3%, at least 4%, at least 5%, at least 10%, at least 20%, at least 30%, at least 50%, at least 60%, at least 80%, at least 90%, or at least 95% (w/w).

Sugar reduced, fat reduced and salt reduced food and beverage lack of freshness, taste and flavor compared with their conventional full sugar, full fat and full salt versions. The inventor surprisingly found adding the plant extracts containing less-volatile or non-volatile substances from flavor sourced plants instead of essential oil or volatile flavors could significantly improve the freshness, characteristic flavor of food and beverage. An embodiment of a composition comprises: (a) one or more G-SMW-SG-MRPs; (b) a plant extract containing less-volatile or non-volatile substances. An further embodiments of composition, where the plant extract is selected from vanilla extract, mango extract, cinnamon extract, citrus extract, coconut extract, ginger extract, viridiflorol extract, almond extract, bay extract, thyme extract, cedar leaf extract, nutmeg extract, allspice extract, sage extract, mace extract, mint extract, clove extract, grape juice concentrate, apple juice concentrate, banana juice concentrate, watermelon juice concentrate, pear juice concentrate, peach juice concentrate, strawberry juice concentrate, raspberry juice concentrate, cherry concentrate, plum concentrate, pineapple concentrate, apricot concentrate, lemon juice concentrate, lime juice concentrate, orange juice concentrate, tangerine juice concentrate, grapefruit concentrate or any other fruit, berry, tea, vegetable, cocoa, chocolate, spices, herbs concentrate.

In some embodiments, the one or more G-SMW-SG-MRPs comprise an MRP prepared from a Maillard reaction mixture comprising a G-SMW-SG, where the total G-SMW-SG content in the reaction mixture is at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the composition of the present application includes MRPs formed from one or more flavonoid glycosides, isoflavone glycosides, saponin glycosides, phenol glycosides, cynophore glycosides, anthraquinone glycosides, cardiac glycosides, bitter glycosides, coumarin glycosides, and/or sulfur glycosides.

In some embodiments, the composition of the present application includes a G-SMW-SG-MRP composition formed from a reaction mixture additionally comprising one or more glycosylated flavonoid glycosides, glycosylated isoflavone glycosides, glycosylated saponin glycosides, glycosylated phenol glycosides, glycosylated cynophore glycosides, glycosylated anthraquinone glycosides, glycosylated cardiac glycosides, glycosylated bitter glycosides, glycosylated coumarin glycosides, and/or glycosylated sulfur glycosides.

In some embodiments, the composition of the present application includes a G-SMW-SG-MRP composition formed from a reaction mixture additionally comprising from one or more flavonoid glycosides, isoflavone glycosides, saponin glycosides, phenol glycosides, cynophore glycosides, anthraquinone glycosides, cardiac glycosides, bitter glycosides, coumarin glycosides, or sulfur glycosides.

In some embodiments, the composition of the present application additionally includes an MRP composition formed from one or more glycosylated flavonoid glycosides, glycosylated isoflavone glycosides, glycosylated saponin glycosides, glycosylated phenol glycosides, glycosylated cynophore glycosides, glycosylated anthraquinone glycosides, glycosylated cardiac glycosides, glycosylated bitter glycosides, glycosylated coumarin glycosides, and/or glycosylated sulfur glycosides.

In some embodiments, the composition of the present application includes an MRP composition formed from a reaction mixture additionally comprising from one or more flavonoid glycosides, isoflavone glycosides, saponin glycosides, phenol glycosides, cynophore glycosides, anthraquinone glycosides, cardiac glycosides, bitter glycosides, coumarin glycosides, or sulfur glycosides.

In some embodiments, the composition of the present application comprises one or more G-SMW-SG-MRPs and a sweetener enhancer, such as thaumatin.

In some embodiments, the composition of the present application includes one or more components in addition to the G-SMW-SG-MRP composition and the sweetener, where the component(s) are selected from the group consisting of SMW-SGs, SMW-SG-MRPs, G-SMW-SGs, SEs, SGs, GSEs, GSGs, Stevia-MRPs, STEs, STCs, GSTEs, GSTCs, GST-MRPs, and conventional MRPs.

In one aspect, the composition of the present application comprises two different components, the components can have ratios of from 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51 and 50:50, and all ranges therebetween wherein the ratios are from 1:99 and vice versa, e.g., ratios of from 99:1 to 51:49, from 70:30 to 58:42, etc.

In some embodiments, the two different components are selected from the group consisting of G-SMW-SG-MRPs, C-MRPs, SMW-SGs, G-SMW-SG-MRPs, G-SMW-SGs, SMW-SG-MRPs, STEs, STCs, RU, GSTEs, GSTCs, GSUs, STE-MRPs, STC-MRPs, RU-MRPs, GSTE-MRPs, GSTC-MRPs, GRU-MRPs, SGs, SEs, GSGs, GSEs, SG-MRPs, SE-MRPs, GSG-MRPs, GSE-MRPs, sugar donors, amine donors, sweeteners, non-nutritive sweeteners, high intensity natural sweeteners, high intensity synthetic or semi-synthetic sweeteners, sweetener enhancers, components of stevia extracts, such as SMW-SGs, HMW-SGs, stevioside, steviolbioside, steviol monoside, RA, RB, RC, RD, RE, RF, RH, RI, RJ, RK, RL, RM, RN, RO, rubusoside, and dulcoside A, components of sweet tea extracts, including STGs and suaviosides, and components of monk fruit extracts, including mogrosides.

In some embodiments, the composition of the present application comprises three different components. The components can have ratios of from 1:1:98, 1:2:97, 1:3:96, 1:4:95, 1:5:94, 1:6:93, 1:7:92, 1:8:91, 1:9:90, 1:10:89, 1:11:88, 1:12:87, 1:13:86, 1:14:85, 1:15:84, 1:16:83, 1:17:82, 1:18:81, 1:19:80, 1:20:79, 1:21:78, 1:22:77, 1:23:76, 1:24:75, 1:25:74, 1:26:73, 1:27:72, 1:28:71, 1:29:70, 1:30:69, 1:31:68, 1:32:67, 2:3:95, 2:4:94, 2:5:93, 2:6:92, 2:7:91, 2:8:90, 2:9:89, 2:10:88, 2:11:87, 2:12:86, 2:13:85, 2:14:84, 2:15:83, 2:16:82, 2:17:81, 2:18:80, 2:19:79, 2:20:78, 2:21:77, 2:22:76, 2:23:75, 2:24:74, 2:25:73, 2:26:72, 2:27:71, 2:28:70, 2:29:69, 2:30:68, 2:31:67, 2:32:66, 2:3:95, 3:3:94, 3:4:93, 3:5:92, 3:6:91, 3:7:90, 3:8:89, 3:9:88, 3:10:87, 3:11:86, 3:12:85, 3:13:84, 3:14:83, 3:15:82, 3:16:81, 2:17:80, 3:18:79, 3:19:78, 3:20:77, 3:21:76, 3:22:75, 3:23:74, 3:24:73, 3:25:72, 3:26:71, 3:27:70, 3:28:69, 3:29:68, 3:30:67, 3:31:66, 3:32:65, 4:4:92, 4:5:91, 4:6:90, 4:7:89, 4:8:88, 4:9:87, 4:10:86, 4:11:85, 4:12:84, 4:13:83, 4:14:82, 4:15:81, 4:16:80, 4:17:79, 4:18:78, 4:19:77, 4:20:76, 4:21:75, 4:22:74, 4:23:73, 4:24:72, 4:25:71, 4:26:70, 4:27:69, 4:28:68, 4:29:67, 4:30:66, 4:31:65, 4:32:64, 5:5:90, 5:6:89, 5:7:88, 5:8:87, 5:9:86, 5:10:85, 5:11:84, 5:12:83, 5:13:82, 5:14:81, 5:15:80, 5:16:79, 5:17:78, 5:18:77, 5:19:76, 5:20:75, 5:21:74, 5:22:73, 5:23:72, 5:24:71, 5:25:70, 5:26:69, 5:27:68, 5:28:67, 5:29:66, 5:30:65, 5:31:64, 5:32:63, 6:6:88, 6:7:87, 6:8:86, 6:9:85, 6:10:84, 6:11:83, 6:12:82, 6:13:81, 6:14:80, 6:15:79, 6:16:78, 6:17:77, 6:18:76, 6:19:75, 6:20:74, 6:21:73, 6:22:72, 6:23:71, 6:24:70, 6:25:69, 6:26:68, 6:27:67, 6:28:66, 6:29:65, 6:30:64, 6:31:63, 6:32:62, 7:7:86, 7:8:85, 7:9:84, 7:10:83, 7:11:82, 7:12:81, 7:13:80, 7:14:79, 7:15:78, 7:16:77, 7:17:76, 7:18:75, 7:19:74, 7:20:73, 7:21:72, 7:22:71, 7:23:70, 7:24:69, 7:25:68, 7:26:67, 7:27:66, 7:28:65, 7:29:64, 7:30:63, 7:31:62, 7:32:61, 8:8:84, 8:9:83, 8:10:82, 8:11:81, 8:12:80, 8:13:79, 8:14:78, 8:15:77, 8:16:76, 8:17:75, 8:18:74, 8:19:73, 8:20:72, 8:21:71, 8:22:70, 8:23:69, 8:24:68, 8:25:67, 8:26:66, 8:27:65, 8:28:64, 8:29:63, 8:30:62, 8:31:61, 8:32:60, 9:9:82, 9:10:81, 9:11:80, 9:12:79, 9:13:78, 9:14:77, 9:15:76, 9:16:75, 9:17:74, 9:18:73, 9:19:72, 9:20:71, 9:21:70, 9:22:69, 9:23:68, 9:24:67, 9:25:66, 9:26:65, 9:27:64, 9:28:63, 9:29:62, 9:30:61, 9:31:60, 9:32:59, 10:10:80, 10:11:79, 10:12:78, 10:13:77, 10:14:76, 10:15:75, 10:16:74, 10:17:73, 10:18:72, 10:19:71, 10:20:70, 10:21:69, 10:22:68, 10:23:67, 10:24:66, 10:25:65, 10:26:64, 10:27:63, 10:28:62, 10:29:61, 10:30:60, 10:31:59, 10:32:58, 11:11:78, 11:12:77, 11:13:76, 11:14:75, 11:15:74, 11:16:73, 11:17:72, 11:18:71, 11:19:70, 11:20:69, 11:21:68, 11:22:67, 11:23:66, 11:24:65, 11:25:64, 11:26:63, 11:27:62, 11:28:61, 11:29:60, 11:30:59, 11:31:58, 11:32:57, 12:12:76, 12:13:75, 12:14:74, 12:15:73, 12:16:72, 12:17:71, 12:18:70, 12:19:69, 12:20:68, 12:21:67, 12:22:66, 12:23:65, 12:24:64, 12:25:63, 12:26:62, 12:27:61, 12:28:60, 12:29:59, 12:30:58, 12:31:57, 12:32:56, 13:13:74, 13:14:73, 13:15:72, 13:16:71, 13:17:70, 13:18:69, 13:19:68, 13:20:67, 13:21:66, 13:22:65, 13:23:64, 13:24:63, 13:25:62, 13:26:61, 13:27:60, 13:28:59, 13:29:58, 13:30:57, 13:31:56, 13:32:55, 14:14:72, 14:15:71, 14:16:70, 14:17:69, 14:18:68, 14:19:67, 14:20:66, 14:21:65, 14:22:64, 14:23:63, 14:24:62, 14:25:61, 14:26:60, 14:27:59, 14:28:58, 14:29:57, 14:30:56, 14:31:55, 14:32:54, 15:15:70, 15:16:69, 15:17:68, 15:18:67, 15:19:66, 15:20:65, 15:21:64, 15:22:63, 15:23:62, 15:24:61, 15:25:60, 15:26:59, 15:27:58, 17:28:57, 15:29:56, 15:30:55, 15:31:54, 15:32:53, 16:16:68, 16:17:67, 16:18:66, 16:19:65, 16:20:64, 16:21:63, 16:22:62, 16:23:61, 16:24:60, 16:25:59, 16:26:58, 16:27:57, 16:28:56, 16:29:55, 16:30:54, 16:31:53, 16:32:52, 17:17:66, 17:18:65, 17:19:64, 17:20:63, 17:21:62, 17:22:61, 17:23:60, 17:24:59, 17:25:58, 17:26:57, 17:27:56, 17:28:55, 17:29:54, 17:30:53, 17:31:52, 17:32:51, 18:18:64, 18:19:63, 18:20:62, 18:21:61, 18:22:60, 18:23:59, 18:24:58, 18:25:57, 18:26:56, 18:27:55, 18:28:54, 18:29:53, 18:30:52, 18:31:51, 18:32:50, 19:19:62, 19:20:61, 19:21:60, 19:22:59, 19:23:58, 19:24:57, 19:25:56, 19:26:55, 19:27:54, 19:28:53, 19:29:52, 19:30:51, 19:31:50, 19:32:49, 20:20:60, 20:21:59, 20:22:58, 20:23:57, 20:24:56, 20:25:55, 20:26:54, 20:27:53, 20:28:52, 20:29:51, 20:30:50, 20:31:49, 20:32:48, 21:21:58, 21:22:57, 21:23:56, 21:24:55, 21:25:54, 21:26:53, 21:27:52, 21:28:51, 21:29:50, 21:30:49, 21:31:48, 21:32:47, 22:22:56, 22:23:55, 22:24:54, 22:25:53, 22:26:52, 22:27:51, 22:28:50, 22:29:49, 22:30:48, 22:31:47, 22:32:46, 23:23:54, 23:24:53, 23:25:52, 23:26:51, 23:27:50, 23:28:49, 23:29:48, 23:30:47, 23:31:46, 23:32:45, 24:24:52, 24:25:51, 24:26:50, 24:27:49, 24:28:48, 24:29:47, 24:30:46, 24:31:45, 24:32:44, 25:25:50, 25:26:49, 25:27:48, 25:28:47, 25:29:46, 25:30:45, 25:31:44, 25:32:43, 26:26:48, 26:27:47, 26:28:46, 26:29:45, 26:30:44, 26:31:43, 26:32:42, 27:27:46, 27:28:45, 27:29:44, 27:30:43, 27:31:42, 27:32:41, 28:28:44, 28:29:43, 28:30:42, 28:31:41, 28:32:40, 29:29:42, 29:30:41, 29:31:40, 29:32:39, 30:30:40, 30:31:39, 30:32:38, 31:31:38, 31:32:37, 32:32:36, 32:33:35, and 33.3:33.3:33.3, and all ranges therebetween wherein the ratios are from 1:1:98 and vice versa, e.g., a ratio of from 1:1:98 to 33.3:33.3:33.3, from 10:30:70 to 15:40:45, etc.

In some embodiments, the three different components are selected from the group consisting of G-SMW-SG-MRPs, C-MRPs, SMW-SGs, G-SMW-SG-MRPs, G-SMW-SGs, SMW-SG-MRPs, STEs, STCs, RU, GSTEs, GSTCs, GSUs, STE-MRPs, STC-MRPs, RU-MRPs, GSTE-MRPs, GSTC-MRPs, GRU-MRPs, SGs, SEs, GSGs, GSEs, SG-MRPs, SE-MRPs, GSG-MRPs, GSE-MRPs, sugar donors, amine donors, sweeteners, non-nutritive sweeteners, high intensity natural sweeteners, high intensity synthetic or semi-synthetic sweeteners, sweetener enhancers, components of stevia extracts, such as SMW-SGs, HMW-SGs, stevioside, steviolbioside, steviol monoside, RA, RB, RC, RD, RE, RF, RH, RI, RJ, RK, RL, RM, RN, RO, rubusoside, and dulcoside A, components of sweet tea extracts, including STGs and suaviosides, and components of monk fruit extracts, including mogrosides.

It is further noted that the present disclosure is not limited to compositions having only two or three different components, and that the exemplary ratios are non-limiting. Rather, the same formula can be followed for establishing ratios of as many different components as are contained within a given composition. As a further example, in a composition that comprises 20 different components described herein, the components can have ratios of from 1:1:1:1:1:1:1:1:1:1:1:1:1:1:1:1:1:1:1:81 to 5:5:5:5:5:5:5:5:5:5:5:5:5:5:5:5:5:5:5:5, and all possible combinations of ratios therebetween. In some embodiments, a composition of the present disclosure may have up to and including a combination of all compounds.

Another aspect of the present application relates to a method to improve the taste profile of a consumable product. The method comprises adding to the consumable product an effective amount of a composition of the present application. In some embodiments, the addition of the composition of the present application improves the sweetness of the consumable product. In some embodiments, the addition of the composition reduce bitterness, metallic aftertaste and/or lingering aftertaste of the consumable product.

In some embodiments, the consumable product is a high intensity sweetener. In some embodiments, the consumable product is a beverage. In some embodiments, the consumable product is a food product. In some embodiments, the consumable product is a bakery product. In some embodiments, the consumable product is a diary product.

### III. Rationale for the Subject Matter of the Present Application

Sugar(s) are primarily considered as sweet tastants present in perceivable concentrations in unprocessed foods. In this context, sugars are defined as mono- and disaccharides, which taste sweet in unprocessed foods at naturally occurring amounts. The main sweet tasting sugars in one's daily diet are sucrose, glucose and fructose.

At second glance, sugars are surprisingly multi-functional compounds. Sugars represent one of the basic tastes, highly important during evolution as basic tastes represent key decision makers for ingestion or refusal of food. Sugars deliver a virtually immediate source of workable energy to the body, including the brain. Accordingly, they provide an outstandingly important energy source. Sugar preferences in humans re thought to be initiated in the last trimester of pregnancy, when babies are “tasting” sweetness in the diet of their mother up to their delivery. This results in the acceptance and request of a mother's milk, which can be important for survival. Sugars are well-known for interactions within and across different modalities during flavor perception. The perception of sugar sweetness is associated with stimulation of dopaminergic midbrain areas related to the pleasant behavioral responses.

The inventor has found that retronasal olfactory sensations have evolved to be more sensitive to chemical substances important for nutrition, including sources of energy, such as sugar, amine donors, and the like. It is not proper to use conventional knowledge to measure quality or sensibility of the thresholds associated with retronasal olfactory sensation by volatile substances, which are sensed by orthonasal olfactory sensation to position the location of goods. Compositions of the present application can enhance the sensitivity of retronasal responses to improve the overall likeness of consumables.

Mouth-feeling is the combination of stimuli triggered by physical and chemical properties of food in the mouth. Smooth, creamy, milky, watery, viscous (light-, medium-, full-bodied), coating, contracting/mouth-watering, drying/astringent, cooling, refreshing and effervescent are typical descriptors for the mouth-feeling of liquids. For solid and semi-solid foods, more texture-related descriptors, including hard, soft, sandy, gritty, sticky and oily are used. Sometimes trigeminal sensations (e.g., spicy, hot, cold) are included to describe mouth-feeling.

Sugar is an important factor for the texture of food and has a substantial impact on the mouth-feeling. Especially in beverages, sugar is the dominant ingredient for perception of the mouth-feeling. Replacement of sugar with HIS causes a significant change in the mouth-feeling, which need to be recognized in product development. HIS sweetened beverages are regularly rated as void, watery or lacking bodiness as a consequence of impaired mouth-feeling. Even if mouth-feeling is fully or partially restored by bulking agents, a lack of sugar is perceived due to the missing masking effects of sugar on acidity, as well as bitterness and typical sugar-odorant interactions.

Mouth-feeling is often falsely restricted to non-volatile flavor compounds. The inventor has surprisingly found that mouth-feeling, especially mouth-coating is not dependent on the viscosity of consumables. The air stream containing aerosol comprising less or non-volatile substances formed during chewing and swallowing of consumables can elicit the soft rubbing effect of oral and or nasal cavity and enhance the mouth and/or nose coating, thus enhancing the overall mouth-coating feel. Embodiments of the present application can elicit the soft rubbing effect in oral and or nasal cavities.

The inventor of the present application has further found that fat perception is not only a conventional taste sensation. An aerosol containing an amine donor can enhance fat perception via taste buds in the oral and retronasal cavities and improve the overall likeness of consumables. Embodiments of the present application can enhance fat perception.

Depending on the desired results, the degree of glycosylation in stevia glycosides, such as small molecular weight stevia glycosides, can be controlled. The final glycosylation products may contain unreacted stevia glycosides and sugar donors. Such products can be used as is, or they can be further purified to remove the unreacted stevia glycosides and sugar donors. Further, the unreacted stevia glycosides can be used for further glycosylation reactions. In some embodiments, compositions of the present application contain glycosylated small molecular weight stevia glycosides, unreacted small molecular weight stevia glycosides, and sugar donors, where the unreacted small molecular weight stevia glycosides are present in amounts less than 90%, 60%, 50%, 20%, 10%, or 5% of the composition (w/w).

Sweet taste is a receptor-mediated sensation Type II taste buds, based on the activity of T1R2 and T1R3 receptor subunit proteins which form heterodimers. These transmembrane proteins allow humans to sense a variety of sweet substances, including sugars (mono- and disaccharides, sugar alcohols), certain amino acids, plant-based glycosides (steviolglycosides, mogrosides, glycyrrhizin), proteins (brazzein, thaumatin, monellin) and synthetic HIS. Also, naturally occurring taste-modifying proteins, such as neoculin and miraculin, bind to and activate the T1R2/T1R3 receptors.

Although both T1R2 and T1R3 subunits are needed to elicit sweet taste sensations, T1R2 is the specific subunit for sweet sensations, while T1R3 is involved in the sensation of umami taste. Binding of ligands to this dimerized sweet taste receptor leads to activation of the G-protein, α-gustducin. This leads to activation of the phospholipase C (PLC)/IP3 pathway, triggering the release of intracellular Ca′ which activates voltage dependent Nat channels resulting in the release of ATP to activate purinergic receptors on afferent fibers so as to transmit information concerning the taste sensation to the brain.

Interestingly, taste bud cells of the T-family type, which are responsible for sweet, umami and bitter sensations share the same signalling pathway for transmission of signals. T1R2/T1R3 receptors are also present in the gastro-intestinal tract and play a vital role in nutrient sensing and glucose homeostasis. The inventor has surprisingly found that compositions of the present application can activate sweet, bitter and umami taste buds so as to block bitterness and improve sweet and umami taste sensations. An embodiment of composition in this invention can elicit both sweet and umami taste buds.

Basic taste sensation mechanisms for sweetness generate a time-intensity profile of sweetness as obtained for sugar, which represents a gold standard or reference. When replacing sugar with high intensity sweeteners, differences in time to onset of sweetness, time to maximum sweetness, and time to disappearance of sweetness can prevent a sugar sweetness perception. Compositions of the present application can generate time intensity profiles of sweetness from high intensity sweeteners that largely mimic those from sugar.

Stimuli exceeding the detection threshold are processed in the brain, triggering in the first instance an expectation. Secondly, the brain recognizes the sum of stimuli or stays in an ambiguous mode. Lastly, the brain compares the perception of expectations and recognitions/ambiguities with information stored consciously or unconsciously.

This process leads to following possible scenarios:

| | | | | Perception |
|---|---|---|---|---|
| Expectation | → | | → | Satisfaction, Fondness |
| | | | | (Positive context) |
| | → | Recognition | → | Disappointment |
| | | | | (Negative context) |
| | [symbol] | | → | Disappointment |
| | → | | → | Surprise |
| | | | | (worth remembering) |
| | → | Ambiguity | → | Surprise |
| | | | | (not worth |
| | | | | remembering) |

→ . . . meets; [symbol]
. . . does not meet

From the above scenarios, it becomes obvious that the preferred scenario yielding satisfaction/fondness depends on expectations matching with recognition and perception in a positive context. This represents a hedonistically favorable setting for consumer acceptance and preference for products in a retail setting.

The only alternate scenario yielding consumer acceptance/preference (surprise, worth remembering) is based on ambiguity/non-recognition, but a decision to store the perception for later retrieval. That represents a favorable, hedonistic consumer decision to e.g., repeat the dinner at the 3-star Michelin restaurant.

Recognition of flavor initiates a cognitive bottom-up approach, while ambiguity initiates a cognitive top-down approach. A cognitive bottom-up approach is initiated when stimuli are strong and are presented long enough and clearly enough to attract an expected attention that can quickly be converted to a flavor recognition. A cognitive top-down approach is initiated when stimuli are presented weakly and vaguely in a short time frame to attract an expected attention. In such a case, a quick decision for flavor recognition is impossible and the brain takes over to generate a representation of what it is expecting.

Replacement of sugars by high intensity sweeteners is likely to cause a top-down approach leading to an expectation of sugar sweetness which then is compared to sensations from foods or beverages. The more ambiguous the sensations are recognized, the more the confirmation of the expectation fails, and the more a process of searching for defects is initiated. The strongest combination to predict satisfaction/fondness of flavors associated with a food or beverage is a cognitive bottom-up approach with a quick flavor recognition that facilitates perception in positive context.

A sweet taste is a strong and clear stimulus attracting our attention initiating a bottom-up approach with quick recognition and satisfying perception. Sugar sweetness differs from high intensity sweetness, since tasting sugar, but not a high intensity sweetener, leads to the activation of pleasure-generating brain circuitry. Compositions of the present application can active the pleasure generating brain circuitry and effect the signaling of calorific nutrition to brain.

The inventor has found that priming effects constitute another widely neglected consideration for triggering sugar sweetness perception. Priming is a phenomenon whereby exposure to one stimulus influences a response to a subsequent stimulus without conscious guidance or intention. Priming effects relate to subconscious modifications of later appearing sensory stimuli. Importantly, any sweetened food contains priming odor components—whether palatable or not—which our brain associates together with later appearing sensory signals as sugar sweetness or at least the sensation of fondness or deliciousness (kokumi). While the first describes the ideal situation, the latter facilitates a quick satisfying decision. High intensity sweeteners do not contain such components to create priming effects. However, compositions of the present application can initiate the priming effects of sugar-like sweetness perception.

Sugars and high intensity sweeteners activate primary taste pathways. Taste pleasantness is associated with activity in the insula and prefrontal cortex. Unrefined sugars elicit stronger brain responses in the anterior insula, frontal operculum, striatum and anterior cingulate compared to high intensity sweeteners. However, only unrefined sugar, but not high intensity sweeteners, activate dopaminergic midbrain areas in relation to the behavioral pleasantness response. The inventor of the present application has found that adding compositions of the present application alone or in combination with high intensity sweeteners to consumables elicits stronger brain responses in reward areas than the responses to sweetener alone and that these responses are not different from those produced by unrefined sugar. Thus, in certain embodiments, a method to elicit brain responses in reward areas can be achieved by adding compositions of the present application with or without high intensity sweeteners in consumable products.

Memories of taste and flavor are sequential and in order. They can be accessed in the order that they are remembered. Like Marcel Proust wrote in his book, human beings are unable to directly reverse the sequence of a memory. Each sensory characteristic of taste and flavor of consumables is remembered as an elaborate hierarchy of nested activities.

Consumers are constantly predicting the future and hypothesizing what we will experience in taste and smell. This expectation influences what we actually perceived from consumables. Consumers' conscious experience of perceptions is actually changed by their interpretations. Consumers can recognize a pattern of taste and flavor of consumables even if only part of it is perceived and even if it contains alterations. Consumers' recognition ability is apparently able to detect invariant features of a pattern-characteristics that survive real-world variations. Segmenting the temporal sequence and size of the tasting decision, this implicates familiar tastes and smells that spark the memory and allows a taster's attention to focus on expected familiar tastes and flavors of consumables, particular those where the perception is positive.

The present application provides compositions and methods for providing the major components of flavor playing crucial roles in recognition of flavor by simultaneous activation of millions of pattern recognitions for a given flavor. As each input from a low-level recognition of taste and flavor from a consumable flows up to a higher level, the perceptional connection can be weighted to provide an indication of how important that particular element in the pattern is. Thus, the more significant elements of pattern recognition for flavors are more heavily weighted in the context of triggering recognition by the taster. If a particular level is unable to fully process and recognize the taste and flavor, the task of recognition would be sent to the next higher level. If none of the levels succeeds in recognizing the pattern of taste and flavor of consumables, it is deemed to be a new pattern of taste and flavor.

Classifying a pattern of taste and flavor as new does not necessarily mean that every aspect of it is new. A person's brain has evolved to save energy when making recognition decisions of taste and flavor. The earlier the flavor is recognized at low-level pattern recognizer, the less energy would be spent for brain for recognition. The present application provides a method to accelerate the speed of recognition of a taste and flavor in consumable, thus increases the palatability. Thalamus is considered a gateway for collecting and preparing sensory information of consumable to enter the neocortex. The neocortex is responsible for sensory perception. Hundreds of millions of pattern recognizers of taste and flavor in the neocortex to be constantly checking in with the thalamus. Neocortex will determine whether a sensory experience of taste and flavor is novel or not in order to present it to the hippocampus. The present application provides a composition containing many familiar pattern of substances which are able to be recognized at low-level of recognizer. An embodiment of current composition is used for treatment of consumers who suffer from memories losses by ingesting the consumable containing composition in this invention to evoke their memories by the familiar taste and flavors.

The inventors have surprisingly found that compositions in this invention can be used to enhance the umami attributes of consumables. A particular aspect of what makes umami delicious is the aftertaste of consumables. Umami develops over a different time frame than saltiness and sourness, which disappear quite quickly. Umami persists for longer than all the other basic tastes. This lingering aftertaste is probably one of the reasons why consumers associate umami with deliciousness and something pleasant. It is a taste sensation with fullness and roundness that completely permeates the oral cavity and then dissipates very slowly.

The enhanced umami by this invention can successfully mask the unpleasant taste of low sugar, low fat and low salt consumables. The receptors for sweetness are closely related to the receptors for umami taste. Without bound by theory, the inventor found there is strong synergy between umami taste substances such as MSG, 5′ribonucleotides (such as IMP, GMP). An embodiment of composition containing umami substances which could increase palatability of high intensity sweeteners. Alanine also play a role for umami except MSG. Alapyridaine enhances not only the umami tastes, but also strengthens the sweet and salty tastes. An embodiment of composition of the present application comprises alapyridaine.

Oligosaccharides are carbohydrate chains containing 3-10 sugar units. Oligosaccharides can be made of any sugar monomers, such as ADMO s (algae derived marine oligosaccharide) AOS (Arabino-oligosaccharides), COS (Chitooligosaccharides), FOS (Fructooligosaccharides), GOS (Galactooligosaccharides), HMO (Human milk oligosaccharides), MAOS (Mannan oligosaccharides), MOS (Maltooligosaccharides), POS (Pectic oligosaccharides), SOS (Soya-oligosaccharides), TOS (Transgalactosylated oligosaccharides), XOS (Xylooligosaccharides). Oligosaccharides normally have mild sweet taste, lower viscosity, moisturizing, low water activity. Adding oligosaccharides in the composition of this invention could improve the sweet taste of composition, such as creating honey flavored sweet and flavor composition. When using the composition containing in this invention, it could block the crystallization of ice creams etc., thus provide improved taste and flavor of consumables. An embodiment of composition comprises oligosaccharides.

When ingesting consumables, trigeminal sensation instead of taste buds on the tongue and olfactory bulb cells gets the first impression of taste sensation such as sourness, salty, sweetness of consumables. There are many research about synergy between taste and flavor. The inventor surprisingly found that trigeminal sensation has strong interaction with taste and flavor. There are many compounds present in many foods or aromatic spices creates trigeminal stimuli, such as substances present in mustard oil, chili peppers, or horseradish, are responsible for pungency. Other trigeminal stimuli such as menthol or eucalyptol are also responsible for cooling sensations. Astringency is another trigeminal sensation, described as a dry mouthfeel that is generated by particular foods (unripe fruits) or drinks (tea or red wine), which are rich in polyphenolic compounds such as tannins. An embodiment of a method to use trigeminal stimuli to improve the taste and flavor of consumables, especially consumables with less sugar, less fat, and less salt. An embodiment of composition of a sweetener or a flavor includes (a) G-SMW-SG-MRPs and (b) trigeminal stimuli substances.

Trigeminal stimuli substances plays the big role for mouth-feel, especially mouth contracting and mouth drying. Mouthfeel could be classified into three categories: Mouth coating, mouth contracting, and mouth dry. Mouth coating is one type of mouthfeel. The word coating is chosen because these elements leave a thin layer behind in the mouth. Saliva becomes thicker, more viscous. Mouth coating is related strongly to texture of consumable. Compared with mouth coating, mouth contracting is another type of mouthfeel. Mouth contracting is the sematic trigeminal sensation, it has no or less relation with texture of consumables in mouth. Acidity, salty and all kinds of irritation (pepper, mustard, horse radish, ginger) cause contraction in the mouth, it is called mouth contracting. Just as carbonic acid (CO2) does in a variety of drinks, such as mineral water, sparkling wines, beer and soda. Light, fresh white and red wines with a nice acidity are examples of ‘contracting’ drinks. A low temperature also makes the mouth contract. This implies that serving temperature influences mouthfeel (and flavor intensity as we will see). Contraction gives the impression of refreshment, of cleansing the mouth. Contracting elements will often stimulate saliva flow. An embodiment of composition in this invention improves the mouth-contracting of consumables.

As one of main attribute of mouth contracting, freshness stands for the property of being pure and fresh (as if newly made) of consumable. From a sensory point of view perception of freshness is a multi-sensory decision process. Freshness cannot be perceived by single taste receptors nor is it represented by a single stimulus of somatosensory neurons. Freshness can be triggered on a perceptual level and is an important part of the sensory characteristics of a product (smell, taste, mouth-feeling, cognitive mechanisms and psychophysiological factors). Semantic and perceptual information is processed concomitantly, inter-connected and each other influencing. The processing involves a continuous context-based alignment with information stored in our memory. At the end of the processing stands a decision whether or not freshness is perceived.

Freshness perception is mandatory to generate a refreshing feeling that is associated positively in the memory with freshness. Fresh fruits are a good model to comprehend the perceived freshness and the refreshing feeling (i.e. apple, orange). Freshness is not necessarily associated with refreshing (i.e., fresh bread, fresh fish) but in case of beverages, especially fruit based ones, refreshing feeling is in most cases the ultimate target to achieve. A refreshing feeling is connected to the positive experiences of alleviating unpleasant symptoms in the mouth and throat (dry mouth, thirst) as consequence of feeling hot, of exercise or of mental fatigue. An embodiment of composition in this invention improves the freshness of consumables and make quicker recognition of flavor.

Quick sweet and or freshness perception are important contributors to a consumer's “hedonic preference”. A complicated and long lasting sensory decision making process to recognize a taste or a flavor triggers failure search and defect analysis (lower overall quality rating).

The quick sweet and or freshness decision depends on the combination of sensory signals and their fit with our acquired perception of freshness. The clearer and the easier recognizable a set of signals appears, the quicker and easier our brain can decide in favor of good sweet and or freshness perception, the less attention to be paid to other attributes of sensory perception. Ambiguity in a set of signals prevents a quick decision making process. A set of unclear and/or unrecognized sensory signals triggers uncertainty in our brain. This uncertainty is either interpreted as “not recognizable” or yields a decision telling us “similar to . . . with following defects” with psychological attention.

Quick and early recognition of a taste and or a flavor is not only of major importance for the sweet and or freshness decision. Our brain tends to stop further considerations once a decision is made (evolutionary useful feature as thinking costs a lot of energy). With other words, once a familiar sweet or freshness decision is made, sensory attributes will no more followed up making failure responses or defect analysis much less probable than in cases where it took long time to recognize a taste or a flavor.

Freshness is an ignored sensory attribution by the food and beverage industry. Slow sweet perception is an underestimated factor for palatability of consumables. An embodiment of composition in this invention could improve the freshness and or quick onset sweetness which could significantly improve the palatability of consumables.

An embodiment of a food and beverage comprises one or more G-SMW-SG-MRPs which contribute sucrose equivalences (SugarEs) above 1%, above 1.5%, above 2%, above 2.5%, above 3%, above 4, above 5%. In other embodiments, the present application provides methods for using one or more G-SMW-SG-MRPs as food ingredients or food additives. A further embodiment of a food ingredient or additive comprises one or more G-SMW-SG-MRPs. It should be noted that the rubusoside used in the compositions and methods of the present application can originate from any source, including but not limited to sweet tea, stevia leaves, enzymatic conversion from stevia extracts and stevia glycosides, fermentation, hydrolysis, and other biosynthetic or synthetic methods.

The inventor surprisingly found that G-SMW-SG-MRPs can significantly mask the bitterness, metallic taste of natural high intensity sweeteners such as stevia extract, stevia glycosides, monk fruit juice, monk fruit extract, licorice extract, and also high synthetic sweeteners, such as Acesulfame K, sucralose. Thus, in certain embodiments, a food flavor or sweetener can comprise: (a) one or more G-SMW-SG-MRPs; and (b) one or more components selected from natural or synthetic high sweeteners.

High intensity sweeteners, including natural sweeteners, such as stevia extract, monk fruit extract etc, and synthetic sweeteners, such as sucralose, acesulfame-K, aspartame, sodium saccharin etc. are characterized by their slow on-site, less high-peak sweetness, lower tongue heaviness, sweet aftertaste, less mouth coating, slipperiness, and high bitter aftertaste, metallic aftertaste. An extraordinary or good beverage must have synchronized or harmonized sweetness temporal profile, acidity temporal profile and aroma temporal profile. However, it is painful for food and beverage formulators when using these high intensity sweeteners to make these three dimensions synchronized, especially for sugar reduced, sugar free products. Normally, the sequence of formulation is to have balanced sweetness and sourness, then add flavor, but it is so difficult to have good balanced sweetness and sourness for sugar reduced, sugar free products. These defects of high intensity sweeteners make the current diet products less palatable to consumers. In current prevailing market, flavor, acidity and sweetness are dis-integrated in diet products, such non-synchronized products leave either initial bad taste/flavor which are difficult to be swallowed, or aftertaste or after flavor with bad impression, not hedonic at all. Most case, the flavor temporal profile is very short, or the flavor comes first before sweet or sour taste, or the bitterness, lingering, metallic taste. All so-called good taste of natural sweeteners, such as GSGs, higher molecule SGs such as RI, RD, RM, highly purified RA and RE, and synthetic sweeteners, such as Ace-K and sucralose, create metallic and lingering taste, which are difficult for consumers to swallow. Swallowing is a big decision for consumers. When feeding babies and children, if it is bitter, they will use their tongue to repel the food from the tongue. Swallowing is the first and most important frontier in securing our lives. The mouth is a scout for identifying the risk. A good food or beverage should create a synchronized aroma/taste that lets us relax and release the alertness and suspiciousness so as to signal to the recipient that the food or beverages is harmless to swallow.

Tasty food and beverage have their own footprints. The inventor has surprisingly found that G-SMW-SG-MRPs can provide great tools for designing such products. Tasting a beverage has a particular physical and psychological sequence; well designed products have a characteristic rhythm and temporal sequence in providing a satisfactory response to the product. For example, the physical sequence of drinking beverage consists of ordering a drink, looking at the drink, taking in the drink and swallowing the drink. The psychological sequence of drinking a beverage can be described by three stages: LIKING, WANTING and THINKING.

LIKING: When ordering a drink, consumers always have something in their memo, it means consumers have expectation. Therefore, color of product, words and photos in the package, sound of opening cans, sniff smell, all these are alluring factors for liking. The simple top note currently provided by flavor houses might not be enough for creating LIKING, especially for sugar reduced product. Liking is not only an issue to have volatile top note. The inventor has found that G-SMW-SG-MRPs and blends thereof can create retronasal aroma to enhance the orthonasal smell. An embodiment of composition comprises one or more G-SMW-SG-MRPs which create a retronasal aroma to enhance the orthonasal smell.

WANTING: When drinking the beverage in mouth, if the general impression including flavor/taste is good, it is easy to make a big “swallowing” decision. If the product does not taste good, the swallowing will be restricted. If the product is so, we swallow, then our natural reaction is to stretch our tongue out of mouth to show dislike, resulting in a feeling of regret. Wanting is not an issue only for taste, but strongly depends on the hidden retronasal aroma. Use of the G-SMW-SG-MRPs according to the present application can provide retronasal aromas which can accelerate the speed and frequency of swallowing. Therefore, in preferred embodiments, a composition of the present application includes one or more G-SMW-SG-MRPs can accelerate the speed and frequency of swallowing.

THINKING: After swallowing, the first reaction psychologically is to confirm the expectation. Great designed products create surprise and desire. The present application provides a product which can make foods and beverages tasty so as to exceed expectations leading to the consumer to desire more of the product. Therefore, in preferred embodiments, a composition of the present application includes one or more G-SMW-SG-MRPs which create retronasal aromas to improve a consumer's approval and desire for the food or beverage product.

The inventor has surprisingly found that G-SMW-SG-MRPs can better synchronize the overall taste dimensions of sweetness, flavor, sourness, and mouthfeel so as to provide quick sweetness onset, less sweet lingering, and a characteristic flavor. These features are useful for many food and beverage applications and can make the formulation job easier and faster. Thus, the present application has been developed to provide G-SMW-SG-MRPs which can synchronize the sweetness, sourness, mouthfeel and flavor in food and beverage products. An embodiment of composition includes G-SMW-SG-MRPs which provide a quick onset of sweetness/flavor and less lingering sweetness. In certain embodiments, G-SMW-SG-MRPs in combination with one or more other high intensity sweeteners can provide quick onset of sweetness/flavor and less lingering sweetness. In certain particular embodiments, a modified food or beverage comprises rubusoside in amount less than 100 ppm.

The nasal cavity encompasses a large surface area and is a good approach for brain nutrition and medicines. Sublingual administration has certain advantages over oral administration. Being more direct, it is often faster and effective. The intranasal and sublingual routes of drug administration have been used for a variety of medications. The present application provides a solution to make intranasal and sublingual nutrition and medicines more palatable. Therefore, in some embodiments, an intranasal or sublingual composition includes one or more G-SMW-SG-MRPs. In one embodiment, a CBD composition includes a cannabis extract or cannabis oil product containing one or more G-SMW-SG-MRPs for use in a food or beverage product, preferably in an intranasal or sublingual form.

Masking bitter taste remains a primary goal for food and beverage industry. Bitterness has been a challenge with a wide range of foodstuffs, such as fruits including grapefruit, passionfruit, oranges, vegetables including cucumbers, avocados, beverage including beer, coffee, chocolate, and protein products including dairy and soy products. The inventor of the present application has developed new compositions comprising one or more G-SMW-SG-MRPs which can mask the bitterness of food and beverage products.

The inventor has surprisingly found that MRPs formed from natural plant derived products such as stevia, sweet tea, monk fruit, licorice etc. can maintain the overall flavor intensity and sensory quality of beverage and foods during process and storage so as to reduce the amount of flavor added to a food and beverage. In one embodiment, a consumable product includes one or more MRP ingredients derived from stevia, sweet tea, monk fruit, licorice etc., which can maintain the overall flavor intensity and sensory quality of the consumable.

Poor aqueous solubility is not only an obstacle applications regarding stevia glycosides, but also for pharmaceutically active substances, herb extracts, carotenoids, such as lutein, zeaxanthin, lutein esters, epilutein; polyphenols, such apple polyphenols, kiwi polyphenols, and grape seed polyphenols; flavonoids, such as flavonoids extracted from Gingko biloba, and alkaloids, such as devil's claw extract etc. The inventor has found that high intensity sweetener extracts, such as stevia extracts, sweet tea extracts, and monk fruit extracts can improve the solubility of substances which have poor water solubility, including crude extracts containing non-stevia glycosides or non-sweetening substances. In one embodiment, a sweetening or flavor composition includes: (a) one or more ingredients selected from stevia extracts, sweet tea extracts, monk fruit extracts, licorice extracts, glycosylated products therefrom, and MRP products therefrom; and (b) one or more ingredients selected from herb extracts or pharmaceutically active ingredients, where the ingredients in (a) improve the solubility and/or bioavailability of the ingredients in (b).

Flavors from edible products such as fruits, berries, herbs and species are useful to enhance the palatability of foods and beverages. However, the prevailing mindset in the flavor industry is to use volatile substances providing an olfactory smell as a key factor for measuring the quality of flavor. The inventor has found that flavors containing flavor substances from plant juices, such as fruit juice, berries juice, fresh herb or other species juices can have a substantially positive impact on retronasal flavors when added to a food or beverage. Flavor compositions comprising less volatile and/or non-volatile substances are important in influencing the palatability of foods and beverages. In one embodiment, a flavoring composition includes: (a) one or more ingredients selected from stevia extracts, sweet tea extracts, monk fruit extracts and licorice extracts, including glycosylated products thereof and MRP products thereof, and (b) one or more flavors extracted or concentrated from one or more ingredients selected from plant juices such as fruits juices, berries juices, herb and species fresh juices, where (b) comprises less-volatile and/or non-volatile substances from juices, and where the flavoring composition improves the palatability of food and beverage. An additional embodiment of such composition comprises water soluble juicy substances, such as fruit or juice concentrates or extracts from watermelon, bilberry, citrus, orange, lime, lemon, kiwi, apple etc.

In some embodiments, a stevia extract, sweet tea extract, monk fruit extract or licorice extract can be enriched for the presence of aromatic terpene substances containing oxygen in the structure. In some embodiments, a citrus or tangerine taste is enhanced by heat-treating a terpene- and/or terpenoid-rich stevia extract, sweet tea extract, monk fruit extract or licorice extract under acidic conditions comprising e.g., citric acid, tartaric acid, fumaric acid, lactic acid, malic acid etc., more preferably citric acid. In addition, substances, such as linalool can react with citric acid with or without a Maillard reaction. Vacuum distillation of fractions or column chromatography employing macroporous resins and/or silica gels, including ion exchange resins produced by Dow and Sunresin can be used for further purification.

In one embodiment, the present application provides a composition comprising a tangerine (or citrus) flavored stevia extract and method for producing the same. In a particular embodiment, a method to produce a citrus flavored stevia extract involves a heat process with or without a Maillard reaction under acid conditions, more preferably in a Maillard reaction with citric acid.

In another embodiment, a sweetening or flavor composition includes flavor substances derived from stevia, sweet tea, monk fruit or licorice plants, including leaves, roots, seeds, etc. therefrom.

### IV. Consumable Products Comprising G-SMW-SG-MRPs and G-SMW-SGs

The compositions and methods described herein are useful in a wide range of consumable products. A non-limiting outline of products for application of the sweet tea-based sweetening or flavor compositions described herein includes the following:

1 Dairy Products

1.1 Milk and dairy—based drinks

Milk and buttermilk

Buttermilk (plain)

Dairy based drinks, flavored and/or fermented

1.2 Fermented, renneted milk products (excluding drinks)

1.3 Condensed milk and analogues

Condensed milk (plain)

Beverage whiteners

1.4 Cream (plain) and similar products

Pasteurized cream

Sterilized, UHT, whipping or whipped and reduced-fat creams

Clotted cream

Cream analogues

1.5 Milk or cream powders

Milk or cream powders

Milk or cream powders analogues

1.6 Cheese

Unripened cheese

Ripened cheese

Whey cheese

Processed cheese

Cheese analogues

1.7 Dairy-based desserts (e.g., ice cream, ice milk, pudding, fruit or flavored yogurt)

1.8 Whey and whey products, excluding whey cheese

2 Fats and oils and fat emulsions (type water-in-oil)

2.1 Fats and oils essentially free from water

2.2 Fat emulsions, water-in-oil

2.3 Fat emulsions other than 2.2, including mixed and/or flavored products based on fat emulsions.

2.4 Fat-based desserts (excluding dairy-based desserts)

3 Edible ices, including sherbet and sorbet

4 Fruits and vegetables (including mushrooms and fungi, roots and tubers, pulses and legumes) and nuts and seeds

4.1 Fruit

4.1.1 Fresh fruit

Untreated fruit

Surface—treated fruit

Peeled or cut fruit

4.1.2 Processed fruit

Frozen fruit

Dried fruit

Fruit in vinegar, oil or brine

Canned or bottled (pasteurized) fruit

Jams, jellies and marmalades

Fruit—based spread

Candied fruit

Fruit preparations, including pulp and fruit toppings

Fruit-based desserts, including fruit-flavored water-based desserts

Fermented fruit products

Fruit fillings for pastries

Cooked or fried fruits

4.2 Vegetables (including mushrooms and fungi, roots and tubers, pulses and legumes) and nuts and seeds

4.2.1 Fresh vegetables

Untreated vegetables

Surface treated vegetables

Peeled or cut vegetables

4.2.2 Processed vegetable and nuts and seeds

Frozen vegetable

Dried vegetables

Vegetables in vinegar, oil or brine

Canned or bottled (pasteurized) vegetables

Vegetable, nut and seed purees and spreads

Vegetable, nut and seed pulps and preparations

Fermented vegetable products

Cooked or fried vegetables

5 Confectionery

5.1 Cocoa products and chocolate products, including imitations and chocolate substitutes

Cocoa mixes (powder and syrups)

Cocoa based spreads, including fillings

Cocoa and chocolate products (e.g., milk chocolate bars, chocolate flakes, white chocolate)

Imitation chocolate and chocolate substitute products

5.2 Sugar-based confectionery other than 5.1, 5.3 and 5.4, including hard and soft candy and nougats

5.3 Chewing gum

5.4 Decorations (e.g., for fine bakery wares), toppings (non-fruit) and sweet sauces

6 Cereals and cereal products, including flours and starches from roots and tubers, and pulses and legumes, excluding bakery wares

Whole, broken or flaked grain, including rice

Flours and starches

Breakfast cereals, including rolled oats

Pastas and noodles

Cereals and starch-based desserts (e.g., rice pudding, tapioca pudding)

Batters (e.g., for fish or poultry)

7 Bakery wares

7.1 Bread and ordinary bakery wares

Breads and rolls

Crackers, excluding sweet crackers

Other ordinary bakery products (e.g., bagels, pitta, English muffins)

Bread-type products, including bread stuffing and breadcrumbs

7.2 Fine bakery wares

Cakes, cookies and pies (e.g., fruit-filled or custard types)

Other fine bakery products (e.g., doughnuts, sweet rolls, scones and muffins)

Mixes for fine bakery wares (e.g., cakes, pancakes)

8 Meat and meat products, including poultry and game

8.1 Fresh meat, poultry and game

Fresh meat, poultry and game, whole pieces or cuts

Fresh meat, poultry and game, comminuted

8.2 Processed meat, poultry and game products in whole pieces or cuts

8.3 Processed comminuted meat, poultry and game products

8.4 Edible casings (e.g., sausage casings)

9 Fish and fish products, including mollusks, crustaceans and echinoderms

9.1 Fish and fish products

9.2 Processed fish and fish products

9.3 Semi-preserved fish and fish products

9.4 Fully preserved fish and fish products

10 Eggs and egg products

10.1 Fresh eggs

10.2 Egg products

10.3 Preserved eggs

10.4 Egg-based desserts

11 Sweeteners, including honey

11.1 White and semi-white sugar (sucrose or sacharose), fructose, glucose (dextrose), xylose, sugar solutions and syrups, and (partially) inverted sugars, including molasses, treacle and sugar toppings.

11.2 Other sugar and syrups (e.g., brown sugar, maple syrup)

11.3 Honey

11.4 Table—top sweeteners, including those containing high-intensity sweeteners, other than 11.1-11.3

12 Salt, spices, soups, sauces, salads, protein products, etc

12.1 Salt

12.2 Herbs, spices, seasonings (including salt substitutes) and condiments

12.3 Vinegars

12.4 Mustards

12.5 Soups and broths

Ready-to-eat soups and broths, including canned, bottled and frozen

Mixes for soups and broths

12.6 Sauces and similar products

Emulsified sauces (e.g., mayonnaise, salad dressing)

Non-emulsified sauces (e.g., ketchup, cheese sauce, cream sauce, brown gravy)

Mixes for sauces and gravies

12.7 Salads (e.g., macaroni salad, potato salad) and sandwich spreads (excluding cocoa- and nut-based spreads)

12.8 Yeast

12.9 Protein products

13 Foodstuffs intended for particular nutritional uses

13.1 Infant formulae and follow-up formulae

13.2 Foods for young children (weaning food)

13.3 Diabetic foods intended for special medical purposes

13.4 Diabetic formulae for slimming purposes and weight reduction

13.5 Diabetic foods other than 13.1-13.4

13.6 Food supplements

14 Beverage excluding dairy products

14.1 Non-alcoholic (“soft”) beverages

14.1.1 Waters

Natural mineral waters and source waters

Table waters and soda waters

14.1.2 Fruit and vegetable juices

Canned or bottled (pasteurized) fruit juice

Canned or bottled (pasteurized) vegetable juice

Concentrates (liquid or solid) for fruit juice

Concentrates (liquid or solid) for vegetable juice

14.1.3 Fruit and vegetable nectars

Canned or bottled (pasteurized) fruit nectar

Canned or bottled (pasteurized) vegetable nectar

Concentrate (liquid or solid) for fruit nectar

Concentrate (liquid or solid) for vegetable nectar

14.1.4 Water-based flavored drinks, including ‘sport’ or ‘electrolyte” drinks

Carbonated drinks

Non-carbonated drinks, including punches

Concentrates (liquid or solid) for drinks

14.1.15 Coffee, coffee substitutes, tea, herbal infusions and other hot cereal beverages, excluding cocoa

14.2 Alcoholic beverages, including alcohol-free and low-alcoholic counterparts

14.2.1 Beer or malt beverage

14.2.2 Cider and perry

14.2.3 Wines

Still wine

Sparking and semi-sparkling wines

Fortified wine and liquor wine

Aromatized wine

14.2.4 Fruit wine

14.2.5 Mead

14.2.6 Spirituous beverages

Spirituous beverage containing at least 15% alcohol

Spirituous beverage containing less than 15% alcohol

15 Ready-to-eat savories

Snacks, potato-, cereal-, flour-, or starch-based (from roots and tubers, pulses and legumes)

Processed nuts, including coated nuts and nut mixtures (with e.g., dried fruit)

16 Composite foods (e.g., casseroles, meat pies, mincemeat)—foods that could not be placed in categories 1-15.

In one aspect, the present application provides an orally consumable product comprising the sweetening or flavor composition of the present application described herein. The term “consumables”, as used herein, refers to substances which are contacted with the mouths of people or animals, including substances, which are taken into and subsequently ejected from the mouth, substances which are drunk, eaten, swallowed or otherwise ingested, and are safe for human or animal consumption when used in a generally acceptable range.

The sweetening or flavor compositions of the present application can be added to an orally consumable product to provide a sweetened product or a flavored product. The sweetening or flavor compositions of the present application can be incorporated into any oral consumable product, including but not limited to, for example, beverages and beverage products, food products or foodstuffs (e.g., confections, condiments, baked goods, cereal compositions, dairy products, chewing compositions, and tabletop sweetener compositions), pharmaceutical compositions, smoking compositions, oral hygiene compositions, dental compositions, and the like. Consumables can be sweetened or unsweetened. Consumables employing the sweetening or flavor compositions of the present application are also suitable for use in processed agricultural products, livestock products or seafood; processed meat products such as sausage and the like; retort food products, pickles, preserves boiled in soy sauce, delicacies, side dishes; soups; snacks, such as potato chips, cookies, or the like; as shredded filler, leaf, stem, stalk, homogenized leaf cured and animal feed.

### A. Beverages and Beverage Products

In some embodiments, a beverage or beverage product comprises a composition of the present application, or a sweetener composition comprising the same. The beverage may be sweetened or unsweetened. The composition of the present application, or sweetener composition comprising the same, may be added to a beverage to sweeten the beverage or enhance its existing sweetness or flavor profile. In some embodiments, the composition of the present application comprises (1) one or more G-SMW-SG-MRPs and/or (2) one or more G-SMW-SGs.

A “beverage” or “beverage product,” is used herein with reference to a ready-to-drink beverage, beverage concentrate, beverage syrup, or powdered beverage. Suitable ready-to-drink beverages include carbonated and non-carbonated beverages. Carbonated beverages include, but are not limited to, frozen carbonated beverages, enhanced sparkling beverages, cola, fruit-flavored sparkling beverages (e.g., lemon-lime, orange, grape, strawberry and pineapple), ginger-ale, soft drinks and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g., black tea, green tea, red tea, oolong tea), coffee, cocoa drink, broths, beverages comprising milk components (e.g., milk beverages, coffee comprising milk components, cafe au lait, milk tea, fruit milk beverages), beverages comprising cereal extracts, and smoothies. Beverages may be frozen, semi-frozen (“slush”), non-frozen, ready-to-drink, concentrated (powdered, frozen, or syrup), dairy, non-dairy, probiotic, prebiotice, herbal, non-herbal, caffeinated, non-caffeinated, alcoholic, non-alcoholic, flavored, non-flavored, vegetable-based, fruit-based, root/tuber/corm-based, nut-based, other plant-based, cola-based, chocolate-based, meat-based, seafood-based, other animal-based, algae-based, calorie enhanced, calorie-reduced, and calorie-free.

The resulting beverages may be dispensed in open containers, cans, bottles or other packaging. Such beverages and beverage preparations can be in ready-to-drink, ready-to-cook, ready-to-mix, raw, or ingredient form and can use the composition as a sole sweetener or as a co-sweetener.

A significant challenge in the beverage industry is to preserve flavor in drinks. Normally, essential oils and their fractions are used as key flavors. They are prone to be oxidized to create unpleasant flavor(s) or the components easily evaporate to cause the food or beverage to lose their initial designed flavors as they sit on shelves. The embodiments herein provide new methods and compositions to overcome those disadvantages and provide new solutions to the food and flavor industry.

Compared with conventional flavors, which are mainly preserved in different oils or oil soluble solvents, the present embodiments provide new methods to provide water soluble solutions, syrups and powders for flavoring agents.

Compared to conventional isolated flavors, often as extracts from plant or animal sources, which are not always compatible for top note flavor and/or taste when sugar replacement sweeteners are added, the current embodiments provide new types of combined multi components which are compatible for a designed flavor.

The embodiments surprisingly create sugar reduced sweeteners which have better taste than sugar including, for example, sweetening agents from plants, such as Stevia, sweet tea, monk fruit, licorice etc, as well as synthetic sweeteners, such as sucralose.

Beverage concentrates and beverage syrups can be prepared with an initial volume of liquid matrix (e.g., water) and the desired beverage ingredients. Full strength beverages are then prepared by adding further volumes of water. Powdered beverages are prepared by dry-mixing all of the beverage ingredients in the absence of a liquid matrix. Full strength beverages are then prepared by adding the full volume of water.

Beverages comprise a matrix, i.e., the basic ingredient in which the ingredients—including the compositions of the present application—are dissolved. In one embodiment, a beverage comprises water of beverage quality as the matrix, such as, for example deionized water, distilled water, reverse osmosis water, carbon-treated water, purified water, demineralized water or combinations thereof, can be used. Additional suitable matrices include, but are not limited to phosphoric acid, phosphate buffer, citric acid, citrate buffer and carbon-treated water.

The size of bubbles in a carbonated beverage can significantly affect the mouth feel and flavor of the beverage. It is desirable to manipulate one or more properties of the bubbles produced in a beverage. Such properties can include the size of bubbles produced, the shape of bubbles, the amount of bubbles generated, and the rate at which bubbles are released or otherwise generated. Taste tests revealed a preference for carbonated beverages containing bubbles of smaller size.

The inventors of the present application have surprisingly found that the addition of G-SMW-SG-MRPs can minimize the size of bubbles, thus improving the mouth feel and flavor of beverages. Accordingly, in some embodiments, compositions containing G-SMW-SG-MRPs, with or without other additives such as sweetening agents and/or thaumatin, can be used as additives to manipulate the size of bubbles, preferably for reducing the size of bubbles.

Additionally, the inventors surprisingly found that inclusion of thaumatin in the Maillard reaction or inclusion of thaumatin in combination of MRPs can significantly improve the overall taste profile of food and beverages to have a better mouth feel, a creamy taste, a reduction of bitterness of other ingredients in food and beverage, such as astringency of tea, protein, or their extracts, acidic nature and bitterness of coffee, etc. It can also reduce lingering, bitterness and metallic aftertaste of natural, synthetic high intensity sweeteners, or their combinations, their combination with other sweeteners, with other flavors much more than thaumatin itself. Thus, it plays a unique function in sugar reduction or sugar free products, and can be used as an additive for improving the taste performance of food and beverage products comprising one or more sweetening agents or sweeteners such as sucralose, acesulfame-K, aspartame, steviol glycosides, stevia extracts, swingle extracts, sweet tea extracts, allulose, sodium saccharin, sodium cyclamate or siratose.

A probiotic beverage normally is made by fermenting milk, or skimmed milk powder, sucrose and/or glucose with selected bacteria strains, by manufacturers such as Yakult or Weichuan. Normally, a large amount of sugar is added to the probiotic beverage to provide nutrients to the probiotics in order to keep them alive during shelf life. Actually, the main function of such a large amount of sugar is also needed to counteract the sourness of probiotic beverage and enhance its taste. Sweetness and the thickness are the two key attributes that are most affected for the acceptability of the beverage. It is a challenge for the manufacturers to produce tasteful probiotic beverages of reduced sugar versions.

In any of the embodiments described in the present application, the final concentration of G-SMW-SG-MRPs and/or G-SMW-SGs may be present in any of the beverages described herein, individually or collectively, in an amount of 0.0001 ppm, 0.001 ppm, 0.01 ppm, 0.1 ppm, 1 ppm, 2 ppm, 5 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 100 ppm, 110 ppm, 120, ppm, 130 ppm, 140 ppm, 150 ppm, 160 ppm, 170 ppm, 180 ppm, 190 ppm, 200 ppm, 220 ppm, 240 ppm, 260 ppm, 280 ppm, 300 ppm, 320 ppm, 340 ppm, 360 ppm 380 ppm, 400 ppm, 420 ppm, 440 ppm, 460 ppm, 480 ppm, 500 ppm, 525 ppm, 550 ppm, 575 ppm, 600 ppm, 625 ppm, 650 ppm, 675 ppm, 700 ppm, 725 ppm, 750 ppm, 775 ppm, 800 ppm, 825 ppm, 850 ppm, 875 ppm, 900 ppm, 925 ppm, 950 ppm, 975 ppm, 1,000 ppm, 1,200 ppm, 1,400 ppm, 1,600 ppm, 1,800 ppm, 2,000 ppm, 2,200 ppm, 2,400 ppm, 2,600 ppm, 2,800 ppm, 3,000 ppm, 3,200 ppm, 3,400 ppm, 3,600 ppm, 3,800 ppm, 4,000 ppm, 4,200 ppm, 4,400 ppm, 4,600 ppm, 4,800 ppm, 5,000 ppm, 5,500 ppm, 6,000 ppm, 6,500 ppm, 7,000 ppm, 7,500 ppm, 8,000 ppm, 8,500 ppm, 9,000 ppm, 9,500 ppm, 10,000 ppm, 11,000 ppm, 12,000 ppm, 13000 ppm, 14,000 ppm, 15,000 ppm, or a range defined by any pair of the aforementioned concentration values in this paragraph.

In more particular embodiments, the G-SMW-SG-MRPs and/or G-SMW-SGs may be present in any of the beverages described herein, individually or collectively, at a final concentration ranging from 1 ppm to 15,000 ppm, from 1 ppm to 10,000 ppm, from 1 ppm to 5,000 ppm, from 10 ppm to 1,000 ppm, from 50 ppm to 900 ppm, from 50 ppm to 600 ppm, from 50 ppm to 500 ppm, from 50 ppm to 400 ppm, from 50 ppm to 300 ppm, from 50 ppm to 200 ppm, from 100 ppm to 600 ppm, from 100 ppm to 500 ppm, from 100 ppm to 400 ppm, from 100 ppm to 300 ppm, from 100 ppm to 200 ppm, from 125 ppm to 600 ppm, from 125 ppm to 500 ppm, from 125 ppm to 400 ppm, from 125 ppm to 300 ppm, from 125 ppm to 200 ppm, from 150 ppm to 600 ppm, from 150 ppm to 500 ppm, from 150 ppm to 500 ppm, from 150 ppm to 400 ppm, from 150 ppm to 300 ppm, from 150 ppm to 200 ppm, from 200 ppm to 600 ppm, from 200 ppm to 500 ppm, from 200 ppm to 400 ppm, from 200 ppm to 300 ppm, from 300 ppm to 600 ppm, from 300 ppm to 500 ppm, from 300 ppm to 400 ppm, from 400 ppm to 600 ppm, from 500 ppm to 600 ppm, from 20 ppm to 200 ppm, from 20 ppm to 180 ppm, from 20 ppm to 160 ppm, from 20 ppm to 140 ppm, from 20 ppm to 120 ppm, from 20 ppm to 100 ppm, from 20 ppm to 80 ppm, from 20 ppm to 60 ppm, from 20 ppm to 40 ppm, from 40 ppm to 150 ppm, from 40 ppm to 130 ppm, from 40 ppm to 100 ppm, from 40 ppm to 90 ppm, from 40 ppm to 70 ppm, from 40 ppm to 50 ppm, from 20 ppm to 100 ppm, from 40 ppm to 100 ppm, from 50 ppm to 100 ppm, from 60 ppm to 100 ppm, from 80 ppm to 100 ppm, from 5 ppm to 100 ppm, from 5 ppm to 95 ppm, from 5 ppm to 90 ppm, from 5 ppm to 85 ppm, from 5 ppm to 80 ppm, from 5 ppm to 75 ppm, from 5 ppm to 70 ppm, from 5 ppm to 65 ppm, from 5 ppm to 60 ppm, from 5 ppm to 55 ppm, from 5 ppm to 50 ppm, from 5 ppm to 45 ppm, from 5 ppm to 40 ppm, from 5 ppm to 35 ppm, from 5 ppm to 30 ppm, from 5 ppm to 25 ppm, from 5 ppm to 20 ppm, from 5 ppm to 15 ppm, from 5 ppm to 10 ppm, any aforementioned concentration value in this paragraph, or a range defined by any pair of the aforementioned concentration values in this paragraph. As used herein, “final concentration” refers to the concentration of, for example, any one of the aforementioned components present in any final composition or final orally consumable product (i.e., after all ingredients and/or compounds have been added to produce the composition or to produce the orally consumable product).

### B. Confections

In some embodiments, the consumable product comprising one or more G-SMW-SG-MRPs of the present application is a confection. In some embodiments, a “confection” refers to a sweet, a lollipop, a confectionery, or similar term. The confection generally contains a base composition component and a sweetener component. A “base composition” refers to any composition which can be a food item and provides a matrix for carrying the sweetener component. An MRP or other composition of the present application comprising the same can serve as the sweetener component. The confection may be in the form of any food that is typically perceived to be rich in sugar or is typically sweet.

In other embodiments of the present application, the confection may be a bakery product, such as a pastry, Bavarian cream, blancmange, cake, brownie, cookie, mousse and the like; a dessert, such as yogurt, a jelly, a drinkable jelly, a pudding; a sweetened food product eaten at tea time or following meals; a frozen food; a cold confection, such as ice, ice milk, lacto-ice and the like (food products in which sweeteners and various other types of raw materials are added to milk products, and the resulting mixture is agitated and frozen); ice confections, such as sherbets, dessert ices and the like (food products in which various other types of raw materials are added to a sugary liquid, and the resulting mixture is agitated and frozen); general confections, e.g., baked confections or steamed confections such as crackers, biscuits, buns with bean-jam filling, halvah, alfaj or, and the like; rice cakes and snacks; table top products; general sugar confections such as chewing gum (e.g., including compositions which comprise a substantially water-insoluble, chewable gum base, such as chicle or substitutes thereof, including jetulong, guttakay rubber or certain comestible natural synthetic resins or waxes), hard candy, soft candy, mints, nougat candy, jelly beans, fudge, toffee, taffy, Swiss milk tablet, licorice candy, chocolates, gelatin candies, marshmallow, marzipan, divinity, cotton candy, and the like; sauces including fruit flavored sauces, chocolate sauces and the like; edible gels; cremes including butter cremes, flour pastes, whipped cream and the like; jams including strawberry jam, marmalade and the like; and breads including sweet breads and the like or other starch products, or combinations thereof.

Suitable base compositions for embodiments of this application may include flour, yeast, water, salt, butter, eggs, milk, milk powder, liquor, gelatin, nuts, chocolate, citric acid, tartaric acid, fumaric acid, natural flavors, artificial flavors, colorings, polyols, sorbitol, isomalt, maltitol, lactitol, malic acid, magnesium stearate, lecithin, hydrogenated glucose syrup, glycerine, natural or synthetic gum, starch, and the like, or combinations thereof. Such components generally are recognized as safe (GRAS) and/or are U.S. Food and Drug Administration (FDA)-approved.

In any of the condiments described herein, the G-SMW-SG-MRPs and/or G-SMW-SGs may be present in any of the confections described herein, individually or collectively, at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %., 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, the G-SMW-SG-MRPs may be present in any of the confections described herein, individually or collectively, at a final weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %., 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, or 90 wt % to 99 wt %.

The base composition of the confection may optionally include other artificial or natural sweeteners, bulk sweeteners, or combinations thereof. Bulk sweeteners include both caloric and non-caloric compounds. Non-limiting examples of bulk sweeteners include sucrose, dextrose, maltose, dextrin, dried invert sugar, fructose or fruit sugar, levulose, honey, unrefined sweetener, galactose, syrups, such as agave syrup or agave nectar, maple syrup, corn syrup, including high fructose corn syrup (HFCS); solids, tagatose, polyols (e.g., sorbitol, mannitol, xylitol, lactitol, erythritol, and maltitol), hydrogenated starch hydrolysates, isomalt, trehalose, or mixtures thereof. Generally, the amount of bulk sweetener present in the confection ranges widely depending on the particular embodiment of the confection and the desired degree of sweetness. Those of ordinary skill in the art will readily ascertain the appropriate amount of bulk sweetener.

### C. Condiments

In some embodiments, the consumable product containing G-SMW-SG-MRPs and/or G-SMW-SGs of the present application is a condiment. Condiments, as used herein, are compositions used to enhance or improve the flavor of a food or beverage. Non-limiting examples of condiments include ketchup (catsup); mustard; barbecue sauce; butter; chili sauce; chutney; cocktail sauce; curry; dips; fish sauce; horseradish; hot sauce; jellies, jams, marmalades, or preserves; mayonnaise; peanut butter; relish; remoulade; salad dressings (e.g., oil and vinegar, Caesar, French, ranch, bleu cheese, Russian, Thousand Island, Italian, and balsamic vinaigrette), salsa; sauerkraut; soy sauce; steak sauce; syrups; tartar sauce; and Worcestershire sauce.

Condiment bases generally comprise a mixture of different ingredients, non-limiting examples of which include vehicles (e.g., water and vinegar); spices or seasonings (e.g., salt, pepper, garlic, mustard seed, onion, paprika, turmeric, or combinations thereof); fruits, vegetables, or their products (e.g., tomatoes or tomato-based products (paste, puree), fruit juices, fruit juice peels, or combinations thereof); oils or oil emulsions, particularly vegetable oils; thickeners (e.g., xanthan gum, food starch, other hydrocolloids, or combinations thereof); and emulsifying agents (e.g., egg yolk solids, protein, gum arabic, carob bean gum, guar gum, gum karaya, gum tragacanth, carageenan, pectin, propylene glycol esters of alginic acid, sodium carboxymethyl-cellulose, polysorbates, or combinations thereof). Recipes for condiment bases and methods of making condiment bases are well known to those of ordinary skill in the art.

Generally, condiments also comprise caloric sweeteners, such as sucrose, high fructose corn syrup, molasses, honey, or brown sugar. In exemplary embodiments of the condiments provided herein, a composition containing one or more G-SMW-SG-MRPs and/or G-SMW-SGs of the present application is used instead of traditional caloric sweeteners.

The condiment composition optionally may include other natural and/or synthetic high-potency sweeteners, bulk sweeteners, pH modifying agents (e.g., lactic acid, citric acid, phosphoric acid, hydrochloric acid, acetic acid, or combinations thereof), fillers, functional agents (e.g., pharmaceutical agents, nutrients, or components of a food or plant), flavoring agents, colorings, or combinations thereof.

In any of the confections described herein, the G-SMW-SG-MRPs and/or G-SMW-SGs may be present in any of the condiments described herein, individually or collectively, at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, the G-SMW-SG-MRPs and/or G-SMW-SGs may be present in any of the condiments described herein, individually or collectively, at a final weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %., 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, or 90 wt % to 99 wt %.

### D. Dairy Products

A wide variety of dairy products can be made using the G-SMW-SG-MRPs and/or G-SMW-SGs of the present invention. Such products include without limitation, milk, whole milk, buttermilk, skim milk, infant formula, condensed milk, dried milk, evaporated milk, fermented milk, butter, clarified butter, cottage cheese, cream cheese, and various types of cheese.

In any of the solid dairy compositions described herein, the G-SMW-SG-MRPs and/or G-SMW-SGs may be present in the solid dairy composition, individually or collectively, at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, the G-SMW-SG-MRPs and/or G-SMW-SGs may be present in any of the dairy products described herein, individually or collectively, at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %., 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, or 90 wt % to 99 wt %.

Alternatively, in any of the liquid dairy compositions described herein, the G-SMW-SG-MRPs and/or G-SMW-SGs may be present in the liquid dairy composition, individually or collectively at a final concentration of 0.0001 ppm, 0.001 ppm, 0.01 ppm, 0.1 ppm, 1 ppm, 2 ppm, 5 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 100 ppm, 110 ppm, 120, ppm, 130 ppm, 140 ppm, 150 ppm, 160 ppm, 170 ppm, 180 ppm, 190 ppm, 200 ppm, 220 ppm, 240 ppm, 260 ppm, 280 ppm, 300 ppm, 320 ppm, 340 ppm, 360 ppm 380 ppm, 400 ppm, 420 ppm, 440 ppm, 460 ppm, 480 ppm, 500 ppm, 525 ppm, 550 ppm, 575 ppm, 600 ppm, 625 ppm, 650 ppm, 675 ppm, 700 ppm, 725 ppm, 750 ppm, 775 ppm, 800 ppm, 825 ppm, 850 ppm, 875 ppm, 900 ppm, 925 ppm, 950 ppm, 975 ppm, 1,000 ppm, 1,200 ppm, 1,400 ppm, 1,600 ppm, 1,800 ppm, 2,000 ppm, 2,200 ppm, 2,400 ppm, 2,600 ppm, 2,800 ppm, 3,000 ppm, 3,200 ppm, 3,400 ppm, 3,600 ppm, 3,800 ppm, 4,000 ppm, 4,200 ppm, 4,400 ppm, 4,600 ppm, 4,800 ppm, 5,000 ppm, 5,500 ppm, 6,000 ppm, 6,500 ppm, 7,000 ppm, 7,500 ppm, 8,000 ppm, 8,500 ppm, 9,000 ppm, 9,500 ppm, 10,000 ppm, 11,000 ppm, 12,000 ppm, 13000 ppm, 14,000 ppm, 15,000 ppm, or a range defined by any pair of the aforementioned concentration values in this paragraph.

In more particular embodiments, the G-SMW-SG-MRPs and/or G-SMW-SGs may be present in the liquid dairy composition, individually or collectively at a final concentration ranging from 1 ppm to 15,000 ppm, from 1 ppm to 10,000 ppm, from 1 ppm to 5,000 ppm, from 10 ppm to 1,000 ppm, from 50 ppm to 900 ppm, from 50 ppm to 600 ppm, from 50 ppm to 500 ppm, from 50 ppm to 400 ppm, from 50 ppm to 300 ppm, from 50 ppm to 200 ppm, from 100 ppm to 600 ppm, from 100 ppm to 500 ppm, from 100 ppm to 400 ppm, from 100 ppm to 300 ppm, from 100 ppm to 200 ppm, from 125 ppm to 600 ppm, from 125 ppm to 500 ppm, from 125 ppm to 400 ppm, from 125 ppm to 300 ppm, from 125 ppm to 200 ppm, from 150 ppm to 600 ppm, from 150 ppm to 500 ppm, from 150 ppm to 500 ppm, from 150 ppm to 400 ppm, from 150 ppm to 300 ppm, from 150 ppm to 200 ppm, from 200 ppm to 600 ppm, from 200 ppm to 500 ppm, from 200 ppm to 400 ppm, from 200 ppm to 300 ppm, from 300 ppm to 600 ppm, from 300 ppm to 500 ppm, from 300 ppm to 400 ppm, from 400 ppm to 600 ppm, from 500 ppm to 600 ppm, from 20 ppm to 200 ppm, from 20 ppm to 180 ppm, from 20 ppm to 160 ppm, from 20 ppm to 140 ppm, from 20 ppm to 120 ppm, from 20 ppm to 100 ppm, from 20 ppm to 80 ppm, from 20 ppm to 60 ppm, from 20 ppm to 40 ppm, from 40 ppm to 150 ppm, from 40 ppm to 130 ppm, from 40 ppm to 100 ppm, from 40 ppm to 90 ppm, from 40 ppm to 70 ppm, from 40 ppm to 50 ppm, from 20 ppm to 100 ppm, from 40 ppm to 100 ppm, from 50 ppm to 100 ppm, from 60 ppm to 100 ppm, from 80 ppm to 100 ppm, from 5 ppm to 100 ppm, from 5 ppm to 95 ppm, from 5 ppm to 90 ppm, from 5 ppm to 85 ppm, from 5 ppm to 80 ppm, from 5 ppm to 75 ppm, from 5 ppm to 70 ppm, from 5 ppm to 65 ppm, from 5 ppm to 60 ppm, from 5 ppm to 55 ppm, from 5 ppm to 50 ppm, from 5 ppm to 45 ppm, from 5 ppm to 40 ppm, from 5 ppm to 35 ppm, from 5 ppm to 30 ppm, from 5 ppm to 25 ppm, from 5 ppm to 20 ppm, from 5 ppm to 15 ppm, or from 5 ppm to 10 ppm.

### E. Cereal Compositions

In some embodiments, the consumable product comprising one or more G-SMW-SG-MRPs and/or G-SMW-SGs of the present application is a cereal composition. Cereal compositions typically are eaten either as staple foods or as snacks. Non-limiting examples of cereal compositions for use in some embodiments include ready-to-eat cereals as well as hot cereals. Ready-to-eat cereals are cereals which may be eaten without further processing (i.e., cooking) by the consumer. Examples of ready-to-eat cereals include breakfast cereals and snack bars. Breakfast cereals typically are processed to produce a shredded, flaky, puffy, or extruded form. Breakfast cereals generally are eaten cold and are often mixed with milk and/or fruit. Snack bars include, for example, energy bars, rice cakes, granola bars, and nutritional bars. Hot cereals generally are cooked, usually in either milk or water, before being eaten. Non-limiting examples of hot cereals include grits, porridge, polenta, rice, oatmeal, and rolled oats.

Cereal compositions generally comprise at least one cereal ingredient. As used herein, the term “cereal ingredient” denotes materials such as whole or part grains, whole or part seeds, and whole or part grass. Non-limiting examples of cereal ingredients for use in some embodiments include maize, wheat, rice, barley, bran, bran endosperm, bulgur, sorghums, millets, oats, rye, triticale, buckwheat, fonio, quinoa, bean, soybean, amaranth, teff, spelt, and kaniwa.

The cereal composition comprises one or more G-SMW-SG-MRPs and/or G-SMW-SGs of the present application and at least one cereal ingredient. The G-SMW-SG-MRPs and/or G-SMW-SGs may be added to the cereal composition in a variety of ways, such as, for example, as a coating, as a frosting, as a glaze, or as a matrix blend (i.e., added as an ingredient to the cereal formulation prior to the preparation of the final cereal product).

Accordingly, in some embodiments, one or more G-SMW-SG-MRPs and/or G-SMW-SGs of the present application are added to the cereal composition as a matrix blend. In one embodiment, one or more G-SMW-SG-MRPs and/or G-SMW-SGs are blended with a hot cereal prior to cooking to provide a sweetened hot cereal product. In another embodiment, one or more G-SMW-SG-MRPs and/or G-SMW-SGs are blended with the cereal matrix before the cereal is extruded.

In some embodiments, one or more G-SMW-SG-MRPs and/or G-SMW-SGs may be present, individually or collectively are added to the cereal composition as a coating, such as, for example, in combination with food grade oil and applying the mixture onto the cereal. In a different embodiment, one or more G-SMW-SG-MRPs and/or G-SMW-SGs and the food grade oil are applied to the cereal separately, by applying either the oil or the sweetener first. Non-limiting examples of food grade oils for use some embodiments include vegetable oils such as corn oil, soybean oil, cottonseed oil, peanut oil, coconut oil, canola oil, olive oil, sesame seed oil, palm oil, palm kernel oil, or mixtures thereof. In yet another embodiment, food grade fats may be used in place of the oils, provided that the fat is melted prior to applying the fat onto the cereal.

In another embodiment, one or more G-SMW-SG-MRPs and/or G-SMW-SGs are added to the cereal composition as a glaze. Non-limiting examples of glazing agents for use in some embodiments include corn syrup, honey syrups and honey syrup solids, maple syrups and maple syrup solids, sucrose, isomalt, polydextrose, polyols, hydrogenated starch hydrolysate, aqueous solutions thereof, or mixtures thereof. In another such embodiment, one or more G-SMW-SG-MRPs and/or G-SMW-SGs are added as a glaze by combining with a glazing agent and a food grade oil or fat and applying the mixture to the cereal. In yet another embodiment, a gum system, such as, for example, gum acacia, carboxymethyl cellulose, or algin, may be added to the glaze to provide structural support. In addition, the glaze also may include a coloring agent, and also may include a flavor.

In another embodiment one or more G-SMW-SG-MRPs and/or G-SMW-SGs are added to the cereal composition as a frosting. In one such embodiment, the one or more G-SMW-SG-MRPs and/or G-SMW-SGs are combined with water and a frosting agent and then applied to the cereal. Non-limiting examples of frosting agents for use in some embodiments include maltodextrin, sucrose, starch, polyols, or mixtures thereof. The frosting also may include a food grade oil, a food grade fat, a coloring agent, and/or a flavor.

In any of the cereal compositions described herein, one or more G-SMW-SG-MRPs and/or G-SMW-SGs are present in any of the cereal composition described herein, individually or collectively, at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In some embodiments, one or more G-SMW-SG-MRPs and/or G-SMW-SGs are present in any of the cereal composition described herein, individually or collectively, at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %., 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, or 90 wt % to 99 wt %.

### F. Chewing Compositions

In some embodiments, the consumable product comprising one or more G-SMW-SG-MRPs and/or G-SMW-SGs of the present application is a chewing composition. The term “chewing compositions” include chewing gum compositions, chewing tobacco, smokeless tobacco, snuff, chewing gum and other compositions which are masticated and subsequently expectorated.

Chewing gum compositions generally comprise a water-soluble portion and a water-insoluble chewable gum base portion. The water soluble portion, which typically includes one or more G-SMW-SG-MRPs and/or G-SMW-SGs of the present application, dissipates with a portion of the flavoring agent over a period of time during chewing while the insoluble gum base portion is retained in the mouth. The insoluble gum base generally determines whether a gum is considered chewing gum, bubble gum, or a functional gum.

The insoluble gum base, which is generally present in the chewing gum composition in an amount in the range of about 15 to about 35 weight percent of the chewing gum composition, generally comprises combinations of elastomers, softeners (plasticizers), emulsifiers, resins, and fillers. Such components generally are considered food grade, recognized as safe (GRA), and/or are U.S. Food and Drug Administration (FDA)-approved.

Elastomers, the primary component of the gum base, provide the rubbery, cohesive nature to gums and can include one or more natural rubbers (e.g., smoked latex, liquid latex, or guayule); natural gums (e.g., jelutong, perillo, sorva, massaranduba balata, massaranduba chocolate, nispero, rosindinha, chicle, and gutta hang kang); or synthetic elastomers (e.g., butadiene-styrene copolymers, isobutylene-isoprene copolymers, polybutadiene, polyisobutylene, and vinyl polymeric elastomers). In a particular embodiment, the elastomer is present in the gum base in an amount in the range of about 3 to about 50 weight percent of the gum base.

Resins are used to vary the firmness of the gum base and aid in softening the elastomer component of the gum base. Non-limiting examples of suitable resins include a rosin ester, a terpene resin (e.g., a terpene resin from α-pinene, β-pinene and/or D-limonene), polyvinyl acetate, polyvinyl alcohol, ethylene vinyl acetate, and vinyl acetate-vinyl laurate copolymers. Non-limiting examples of rosin esters include a glycerol ester of a partially hydrogenated rosin, a glycerol ester of a polymerized rosin, a glycerol ester of a partially dimerized rosin, a glycerol ester of rosin, a pentaerythritol ester of a partially hydrogenated rosin, a methyl ester of rosin, or a methyl ester of a partially hydrogenated rosin. In some embodiment, the resin is present in the gum base in an amount in the range of about 5 to about 75 weight percent of the gum base.

Softeners, which also are known as plasticizers, are used to modify the ease of chewing and/or mouth feel of the chewing gum composition. Generally, softeners comprise oils, fats, waxes, and emulsifiers. Non-limiting examples of oils and fats include tallow, hydrogenated tallow, large, hydrogenated or partially hydrogenated vegetable oils (e.g., soybean, canola, cottonseed, sunflower, palm, coconut, corn, safflower, or palm kernel oils), cocoa butter, glycerol monostearate, glycerol triacetate, glycerol abietate, lecithin, monoglycerides, diglycerides, triglycerides acetylated monoglycerides, and free fatty acids. Non-limiting examples of waxes include polypropylene/polyethylene/Fisher-Tropsch waxes, paraffin, and microcrystalline and natural waxes (e.g., candelilla, beeswax and carnauba). Microcrystalline waxes, especially those with a high degree of crystallinity and a high melting point, also may be considered as bodying agents or textural modifiers. In some embodiments, the softeners are present in the gum base in an amount in the range of about 0.5 to about 25 weight percent of the gum base.

Emulsifiers are used to form a uniform dispersion of the insoluble and soluble phases of the chewing gum composition and also have plasticizing properties. Suitable emulsifiers include glycerol monostearate (GMS), lecithin (phosphatidyl choline), polyglycerol polyricinoleic acid (PPGR), mono and diglycerides of fatty acids, glycerol distearate, tracetin, acetylated monoglyceride, glycerol triacetate, and magnesium stearate. In some embodiments, the emulsifiers are present in the gum base in an amount in the range of about 2 to about 30 weight percent of the gum base.

The chewing gum composition also may comprise adjuvants or fillers in either the gum base and/or the soluble portion of the chewing gum composition. Suitable adjuvants and fillers include lecithin, inulin, polydextrin, calcium carbonate, magnesium carbonate, magnesium silicate, ground limestone, aluminum hydroxide, aluminum silicate, talc, clay, alumina, titanium dioxide, and calcium phosphate. In some embodiments, lecithin can be used as an inert filler to decrease the stickiness of the chewing gum composition. In other some embodiments, lactic acid copolymers, proteins (e.g., gluten and/or zein) and/or guar can be used to create a gum that is more readily biodegradable. The adjuvants or fillers are generally present in the gum base in an amount up to about 20 weight percent of the gum base. Other optional ingredients include coloring agents, whiteners, preservatives, and flavors.

In some embodiments of the chewing gum composition, the gum base comprises about 5 to about 95 weight percent of the chewing gum composition, more desirably about 15 to about 50 weight percent of the chewing gum composition, and even more desirably from about 20 to about 30 weight percent of the chewing gum composition.

The soluble portion of the chewing gum composition may optionally include other artificial or natural sweeteners, bulk sweeteners, softeners, emulsifiers, flavoring agents, coloring agents, adjuvants, fillers, functional agents (e.g., pharmaceutical agents or nutrients), or combinations thereof. Suitable examples of softeners and emulsifiers are described above.

Bulk sweeteners include both caloric and non-caloric compounds. Non-limiting examples of bulk sweeteners include sucrose, dextrose, maltose, dextrin, dried invert sugar, fructose, high fructose corn syrup, levulose, galactose, corn syrup solids, tagatose, polyols (e.g., sorbitol, mannitol, xylitol, lactitol, erythritol, and maltitol), hydrogenated starch hydrolysates, isomalt, trehalose, or mixtures thereof. In some embodiments, the bulk sweetener is present in the chewing gum composition in an amount in the range of about 1 to about 75 weight percent of the chewing gum composition.

Flavoring agents may be used in either the insoluble gum base or soluble portion of the chewing gum composition. Such flavoring agents may be natural or artificial flavors. In some embodiments, the flavoring agent comprises an essential oil, such as an oil produced from a plant or a fruit, peppermint oil, spearmint oil, other mint oils, clove oil, cinnamon oil, oil of wintergreen, bay, thyme, cedar leaf, nutmeg, allspice, sage, mace, and almonds. In another embodiment, the flavoring agent comprises a plant extract or a fruit essence such as apple, banana, watermelon, pear, peach, grape, strawberry, raspberry, cherry, plum, pineapple, apricot, or mixtures thereof. In still another embodiment, the flavoring agent comprises a citrus flavor, such as an extract, essence, or oil of lemon, lime, orange, tangerine, grapefruit, citron, or kumquat.

In some embodiments, the chewing gum composition comprises one or more G-SMW-SG-MRPs and/or G-SMW-SGs of the present application and a gum base.

In any of the chewing gum compositions described herein, the one or more G-SMW-SG-MRPs and/or G-SMW-SGs of the present application may be present in the chewing gum composition, individually or collectively, at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, the one or more G-SMW-SG-MRPs and/or G-SMW-SGs of the present application may be present in any of the chewing gum compositions described herein, individually or collectively, at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %., 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, or 90 wt % to 99 wt %.

### G. Tabletop Sweetener Compositions

In general, tabletop sugar replacements lack certain taste attributes associated with sugar, especially for solid tabletop sweeteners. In addressing this need, the inventor of the present application has developed more palatable tabletop sugar replacements than commonly known. Specifically, in some embodiments, the present application provides an orally consumable product comprising one or more G-SMW-SG-MRPs and/or G-SMW-SGs of the present application in the form of an orally consumable tabletop sweetener composition. In one embodiment, the orally consumable tabletop sweetener composition has a taste similar to molasses.

In some embodiments, the tabletop sweetener composition may further include at least one bulking agent, additive, anti-caking agent, functional ingredient or combination thereof.

Suitable “bulking agents” include, but are not limited to, maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and the like, or mixtures thereof. Additionally, in accordance with still other embodiments of the application, granulated sugar (sucrose) or other caloric sweeteners such as crystalline fructose, other carbohydrates, or sugar alcohol can be used as a bulking agent due to their provision of good content uniformity without the addition of significant calories.

As used herein, the phrase “anti-caking agent” and “flow agent” refers to any composition which assists in content uniformity and uniform dissolution. In some embodiments, non-limiting examples of anti-caking agents include cream of tartar, aluminium silicate (Kaolin), calcium aluminium silicate, calcium carbonate, calcium silicate, magnesium carbonate, magnesium silicate, mono-, di- and tri-calcium orthophosphate, potassium aluminium silicate, silicon dioxide, sodium aluminium silicate, salts of stearic acid, microcrystalline cellulose (Avicel, FMC BioPolymer, Philadelphia, Pa.), and tricalcium phosphate. In one embodiment, the anti-caking agents are present in the tabletop sweetener composition in an amount from about 0.001 to about 3% by weight of the tabletop sweetener composition.

The tabletop sweetener compositions can be packaged in any form known in the art. Non-limiting forms include, but are not limited to, powder form, granular form, packets, tablets, sachets, pellets, cubes, solids, and liquids.

In one embodiment, the tabletop sweetener composition is a single-serving (portion control) packet comprising a dry-blend. Dry-blend formulations generally may comprise powder or granules. Although the tabletop sweetener composition may be in a packet of any size, an illustrative non-limiting example of conventional portion control tabletop sweetener packets are approximately 2.5 by 1.5 inches and hold approximately 1 gram of a sweetener composition having a sweetness equivalent to 2 teaspoons of granulated sugar (— 8 g). The amount of an MRP composition of the present application in a dry-blend tabletop sweetener formulation can vary. In some embodiments, a dry-blend tabletop sweetener formulation may comprise a Composition of the present application in an amount from about 1% (w/w) to about 10% (w/w) of the tabletop sweetener composition.

Solid tabletop sweetener embodiments include cubes and tablets. A non-limiting example of conventional cubes is equivalent in size to a standard cube of granulated sugar, which is approximately 2.2×2.2×2.2 cm3 and weighs approximately 8 g. In one embodiment, a solid tabletop sweetener is in the form of a tablet or any other form known to those skilled in the art.

A tabletop sweetener composition also may be embodied in the form of a liquid, wherein one or more G-SMW-SG-MRPs and/or G-SMW-SGs of the present application are combined with a liquid carrier. Suitable non-limiting examples of carrier agents for liquid tabletop sweeteners include water, alcohol, polyol, glycerin base or citric acid base dissolved in water, or mixtures thereof. The sweetness equivalent of a tabletop sweetener composition for any of the forms described herein or known in the art may be varied to obtain a desired sweetness profile. For example, a tabletop sweetener composition may have a degree of sweetness comparable to that of an equivalent amount of standard sugar. In another embodiment, the tabletop sweetener composition may comprise a sweetness of up to 100 times that of an equivalent amount of sugar. In another embodiment, the tabletop sweetener composition may comprise a sweetness of up to 90 times, 80 times, 70 times, 60 times, 50 times, 40 times, 30 times, 20 times, 10 times, 9 times, 8 times, 7 times, 6 times, 5 times, 4 times, 3 times, and 2 times that of an equivalent amount of sugar.

In any of the tabletop sweetener compositions described herein, the one or more G-SMW-SG-MRPs and/or G-SMW-SGs of the present application may be present in the tabletop sweetener composition, individually or collectively, at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, or 100 wt %, or a weight concentration range defined by any two of the aforementioned weight percentages in this paragraph.

In more particular embodiments, the one or more G-SMW-SG-MRPs and/or G-SMW-SGs of the present application may be present in any of the tabletop sweetener compositions described herein, individually or collectively, at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %., 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, or 90 wt % to 99 wt %.

### H. Medicinal Compositions

In certain embodiments, one or more G-SMW-SG-MRPs and/or G-SMW-SGs of the present application may be used in medicinal compositions. As used herein, the term “medicinal composition” includes solids, gases and liquids which are ingestible materials having medicinal value, such as cough syrups, cough drops, medicinal sprays, vitamins, and chewable medicinal tablets that are administered orally or used in the oral cavity in the form of e.g., a pill, tablet, spray, capsule, syrup, drop, troche agent, powder, and the like.

### I. Oral Hygiene Compositions

In some embodiments, one or more G-SMW-SG-MRPs and/or G-SMW-SGs of the present application may be used in an oral hygiene composition. As used herein, the “oral hygiene composition” includes mouthwashes, mouth rinses, breath fresheners, toothpastes, tooth polishes, dentifrices, mouth sprays, teeth whitening agents, soaps, perfumes, and the like.

### J. Cosmetic Compositions

In some embodiments, one or more G-SMW-SG-MRPs and/or G-SMW-SGs of the present application are utilized in a cosmetic composition for enhancing the aroma of a cosmetic or skin-care product. As used herein, the term “cosmetic composition” means a composition that is formulated for topical application to skin, which has a pleasant color, odor and feel, and which does not cause unacceptable discomfort (stinging, tautness or redness) liable to discourage the consumer from using it.

Cosmetic composition may be preferably formulated in the form of an emulsion, e.g., W/O (water-in-oil), 0/W (oil-in-water), W/O/W (water-in-oil-in-water), 0/W/0 (oil-in-water-in-oil) emulsion, PIT emulsion, Pickering emulsion, emulsion with a low oil content, micro- or nanoemulsion, a solution, e.g., in oil (fatty oils or fatty acid esters, in particular C6-C32 fatty acid C2-C30 esters) or silicone oil, dispersion, suspension, creme, lotion or milk, depending on the production method and ingredients, a gel (including hydrogel, hydrodispersion gel, oleogel), spray (e.g., pump spray or spray with propellant) or a foam or an impregnating solution for cosmetic wipes, a detergent, e.g., soap, synthetic detergent, liquid washing, shower and bath preparation, bath product (capsule, oil, tablet, salt, bath salt, soap, etc.), effervescent preparation, a skin care product such as e.g., an emulsion (as described above), ointment, paste, gel (as described above), oil, balsam, serum, powder (e.g., face powder, body powder), a mask, a pencil, stick, roll-on, pump, aerosol (foaming, non-foaming or post-foaming), a deodorant and/or antiperspirant, mouthwash and mouth rinse, a foot care product (including keratolytic, deodorant), an insect repellent, a sunscreen, aftersun preparation, a shaving product, aftershave balm, pre- and aftershave lotion, a depilatory agent, a hair care product such as e.g., shampoo (including 2-in-1 shampoo, anti-dandruff shampoo, baby shampoo, shampoo for dry scalps, concentrated shampoo), conditioner, hair tonic, hair water, hair rinse, styling creme, pomade, perm and setting lotion, hair spray, styling aid (e.g., gel or wax), hair smoothing agent (detangling agent, relaxer), hair dye such as e.g., temporary direct-dyeing hair dye, semi-permanent hair dye, permanent hair dye, hair conditioner, hair mousse, eye care product, make-up, make-up remover or baby product.

### K. Smokable Compositions

In some embodiments, one or more G-SMW-SG-MRPs and/or G-SMW-SGs of the present application may be used in a smokable composition. The term “smokable composition,” as used herein, includes any material that can be smoked or inhaled, such as tobacco and cannabis, as well as any smokable material that is burned to provide desirable aromas (e.g., charcoal briquettes for grilling foods, incense etc). The smoking compositions may encompass cigarettes, electronic cigarettes (e-cigarettes), cigars, pipe and cigar tobacco, chew tobacco, vaporizable liquids, and all forms of tobacco such as shredded filler, leaf, stem, stalk, homogenized leaf cured, reconstituted binders, reconstituted tobacco from tobacco dust, fines, or other sources in sheet, pellet or other forms. “Smokable compositions” also include cannabis compositions (e.g., flower materials, leaf materials, extracts, oils, edible candies, vaporizable liquids, cannabis-infused beverages, etc.) and tobacco substitutes formulated from non-tobacco materials.

### V. Taste Profiles and Taste Testing of Compositions of the Present Application

The compositions of the present application and methods regarding the same as described herein are useful for improved taste and aroma profiles of many consumable products relative to control samples. The phrase “taste profile”, which is interchangeable with “sensory profile” and “sweetness profile”, may be defined as the temporal profile of all basic tastes of a sweetener. The “temporal profile” may be considered to represent the intensity of sweetness perceived over time in tasting of the composition by a human, especially a trained “taster”. Carbohydrate and polyol sweeteners typically exhibit a quick onset followed by a rapid decrease in sweetness, which disappears relatively quickly on swallowing a food or beverage containing the same. In contrast, high intensity natural sweeteners typically have a slower sweet taste onset reaching a maximal response more slowly, followed by a decline in intensity more slowly than with carbohydrate and polyol sweeteners. This decline in sweetness is often referred to as “sweetness linger” and is a major limitation associated with the use of high intensity natural sweeteners.

In the context of taste tasting, the terms “improve”, “improved” and “improvement” are used interchangeably with reference to a perceived advantageous change in a composition or consumable product upon introduction of the compositions of the present application relative to the original taste profile of the composition or consumable product without the added G-SMW-SG-MRP and/or G-GSMW-SGs in any aspect, such as less bitterness, better sweetness, better sour taste, better aroma, better mouth feel, better flavor, less aftertaste, etc. The terms “improve” or “improvement” can refer to a slight change, a change, or a significant change of the original taste profile, etc., which makes the composition more palatable to an individual.

In some embodiments, the compositions of the present application and methods described herein are useful for improving the taste and aroma profiles for other synthetic sweeteners, such as sucralose, ACE-K, aspartame, sodium saccharin, and mixtures thereof, and for natural high intensity sweeteners such as steviol glycosides, Stevia extracts, monk fruit extract, monk fruit components, licorice extract, licorice components.

In some embodiments, the compositions of the present application may be evaluated with reference to the degree of their sucrose equivalence. Accordingly, the compositions of the present application may be diluted or modified with respect to its ingredients to conform with this sucrose equivalence.

The onset and decay of sweetness when the compositions of the present application are consumed can be perceived by trained human tasters and measured in seconds from first contact with a taster's tongue (“onset”) to a cutoff point (typically 180 seconds after onset) to provide a “temporal profile of sweetness”. A plurality of such human tasters is called a “sensory panel.” In addition to sweetness, sensory panels can also judge the temporal profile of the other “basic tastes”: bitterness, saltiness, sourness, piquance (aka spiciness), and umami (aka savoriness or meatiness). The onset and decay of bitterness when a sweetener is consumed, as perceived by trained human tasters and measured in seconds from first perceived taste to the last perceived aftertaste at the cutoff point, is called the “temporal profile of bitterness.” Aromas from aroma producing substances are volatile compounds which are perceived by the aroma receptor sites of the smell organ, i.e., the olfactory tissue of the nasal cavity. They reach the receptors when drawn in through the nose (orthonasal detection) and via the throat after being released by chewing (retronasal detection). The concept of aroma substances, like the concept of taste substances, is to be used loosely, since a compound might contribute to the typical aroma or taste of one food, while in another food it may cause a faulty aroma or taste, or both, resulting in an off-flavor. Thus, sensory profile may include evaluation of aroma as well.

The term “mouth feel” involves the physical and chemical interaction of a consumable in the mouth. More specifically, as used herein, the term “mouth feel” refers to the fullness sensation experienced in the mouth, which relates to the body and texture of the consumable such as its viscosity. Mouth feel is one of the most important organoleptic properties and the major criteria that consumers use to judge the quality and freshness of foods. Subtle changes in a food and beverage product's formulation can change mouth feel significantly. Simply taking out sugar and adding a high intensity sweetener can cause noticeable alterations in mouth feel, making a formerly good product unacceptable to consumers. Sugar not only sweetens, it also builds body and viscosity in food and beverage products, and leaves a slight coating on the tongue. For example, reducing salt levels in soup changes not only taste, but can alter mouth feel as well. Primarily it is the mouth feel that is always the compliant with non-sugar sweeteners.

The phrase “sweetness detection threshold” refers to the minimum concentration at which panelists consisting of 1-10 persons are able to detect sweetness in a composition, liquid or solid. This is further defined as provided in the Examples herein and are conducted by the methods described in Sensory Testing for Flavorings with Modifying Properties by Christie L. Harman, John B. Hallagan, and the FEMA Science, Committee Sensory Data Task Force, November 2013, Volume 67, No. 11 and Appendix A attached thereto, the teachings of which are incorporated herein by reference.

“Threshold of sweetness” refers to a concentration of a material below which sweetness cannot be detected, but can still impart a flavor to a consumable (including water). When half of a trained panel of testers determines something is “sweet” at a given concentration, then the sample meets the threshold. When less than half of a panel of testers cannot discern sweetness at a given concentration, then concentrations of the substance below the sweetness level are considered a flavoring agent.

It should be understood that the flavoring agents described herein can be used in combination with other sweetening agents, including high-intensity natural and synthetic sweeteners, to encapsulate and reduce or eliminate the unwanted off taste present in the composition. There is a sequence of steps in Maillard reaction(s) that can be used to produce flavor(s). That is, there can be a first step where a first reaction takes place between a first sugar donor and a first amine donor under appropriate conditions followed by a second reaction with a second sugar donor and a second amine donor, and possible subsequent reactions to provide a complex flavorant composition that is a combination of various Maillard reaction products between, for example, the first sugar donor and first amine donor, along with the reaction between the first sugar donor and a second amine donor or a second sugar donor reacting with the first sugar donor, etc. under the Maillard reaction conditions described herein. The processes described herein can be used to preserve flavors.

For example, to dissolve any flavor or flavor combination in a dissolved steviol glycosides solution, afterwards, the solution could be ready to use, or it could be further concentrated to syrup or powder form. For evaluating the taste profile of a given composition, a sample may be tested by e.g., a panel of 1-10 people. In some cases, a trained taster may independently taste the sample(s) first. The taster may be asked to describe the taste profile and score 0-5 according to the increasing sugar like, bitterness, aftertaste and lingering taste profiles. The taster may be allowed to re-taste, and then make notes for the sensory attributes perceived. Afterwards, another group of 1-10 tasters may similarly taste the sample(s), record its taste attributes and discuss the samples openly to find a suitable description. Where more than 1 taster disagrees with the results, the tasting may be repeated. For example, a “5” for sugar like is the best score for having a taste that is sugar like and conversely a value of 0 or near zero is not sugar like. Similarly, a “5” for bitterness, aftertaste and lingering is not desired. A value of zero or near zero means that the bitterness, aftertaste and/or lingering is reduced or is removed. Other taste attributes may include astringency and overall likability.

In some embodiments, vanilla, maltol or other flavor modifier product(s) “FMPs” can be added to the compositions described herein to further improve the taste. FMPs, such as maltol, ethyl-maltol, vanillin, ethyl vanillin, m-methylphenol, and m-n-propylphenol can further enhance the mouth feel, sweetness and aroma of the compositions described herein. Thus, in some embodiments, one or more FMPs may be added before or after the Maillard reaction, such as maltol, ethyl-maltol, vanillin, ethyl vanillin, m-methylphenol, m-n-propylphenol, or combinations thereof. In certain embodiments, MRPs and/or sweeteners may be combined with one or more FMPs. Particular MRP/FMP combinations include MRPs and maltol; MRPs and vanillin; sweetener(s) and maltol; sweetener(s) and vanillin etc. Such compositions may be used in any of the food or beverage products described herein.

Production of G-SMW-SG-MRPs and/or G-SMW-SGs may involve the use of any of the following methodologies, including reflux at atmospheric pressure, reaction under pressure, oven drying, vacuum oven drying, roller/drum drying, surface scraped heat exchange, and/or extrusion.

The inventors of the present application have also developed a unique process which can preserve useful flavor substances originating from natural high intensity sweetener plants, including stevia, sweet tea, monk fruit, licorice etc and recovered in in the form of stevia extracts, sweet tea extracts, monk fruit extracts, licorice etc. Such flavor substances can be further amplified in glycosylation and/or Maillard reactions involving the foregoing extracts in combination with various amine donors as described herein.

Additionally, flavor substances in natural high intensity sweetener plants can also include new flavor substances from new natural high intensity sweetener plant varieties produced by hybridizing, grafting and other cultivating methods.

A flavoring agent, other than a flavor derived from a Maillard reaction product as described herein, can be added to the compositions described herein before or after a Maillard reaction has been effected. Suitable flavoring agents include, for example, natural flavors, vitamins, such as vitamin C, artificial flavors, spices, seasonings, and the like. Exemplary flavor agents include synthetic flavor oils and flavoring aromatics and/or oils, uronic acids (e.g., glucuronic acid and galacturonic acid) or oleoresins, essences, and distillates, and a combination comprising at least one of the foregoing.

During the Maillard reaction or following completion of the Maillard reaction, “top note” agents may be added, which are often quite volatile, vaporizing at or below room temperature. “Top notes” are often what give foods their fresh flavors. Suitable top note agents include but are not limited to, for example, furfuryl mercaptan, methional, nonanal, trans,trans-2,4-decadienal, 2,2′-(dithiodimethylene) difuran, 2-methyl-3-furanthiol, 4-methyl-5-thiazoleethanol, pyrazineethanethiol, bis(2-methyl-3-furyl) disulfide, methyl furfuryl disulfide, 2,5-dimethyl-2,5-dihydroxy-1,4-dithiane, 95%, trithioacetone, 2,3-butanedithiol, methyl 2-methyl-3-furyl disulfide, 4-methylnonanoic acid, 4-methyloctanoic acid, or 2-methyl-3-tetrahydrofuranthiol.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors, such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavoring agent include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, a wasabi (Japanese horseradish) flavor; a nut flavor, such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

Generally any flavoring agent or food additive, such as those described in “Chemicals Used in Food Processing”, Publication No 1274, pages 63-258, by the National Academy of Sciences, can be used. This publication is incorporated herein by reference.

As used herein, a “flavoring agent” or “flavorant” herein refers to a compound or an ingestibly acceptable salt or solvate thereof that induces a flavor or taste in an animal or a human. The flavoring agent can be natural, semi-synthetic, or synthetic. Suitable flavorants and flavoring agent additives for use in the compositions of the present application include, but are not limited to, vanillin, vanilla extract, mango extract, cinnamon, citrus, coconut, ginger, viridiflorol, almond, bay, thyme, cedar leaf, nutmeg, allspice, sage, mace, menthol (including menthol without mint), an essential oil, such as an oil produced from a plant or a fruit, such as peppermint oil, spearmint oil, other mint oils, clove oil, cinnamon oil, oil of wintergreen, or an oil of almonds; a plant extract, fruit extract or fruit essence from grape skin extract, grape seed extract, apple, banana, watermelon, pear, peach, grape, strawberry, raspberry, cherry, plum, pineapple, apricot, a flavoring agent comprising a citrus flavor, such as an extract, essence, or oil of lemon, lime, orange, tangerine, grapefruit, citron, kumquat, or combinations thereof. Flavorants for use in the present application include both natural and synthetic substances which are safe for humans or animals when used in a generally accepted range.

Non-limiting examples of proprietary flavorants include Dohler™ Natural Flavoring Sweetness Enhancer K14323 (Dohler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, N.J., U.S.A.), and Sucramask™ (Creative Research Management, Stockton, Calif., U.S.A.).

In the any of the embodiments described in the present application, the flavoring agent may be present in the composition of the present application in an amount effective to provide a final concentration of about 0.1 ppm, 0.5 ppm, 1 ppm, 2 ppm, 5 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 100 ppm, 110 ppm, 120 ppm, 130 ppm, 140 ppm, 150 ppm, 160 ppm, 170 ppm, 180 ppm, 190 ppm, 200 ppm, 220 ppm, 240 ppm, 260 ppm, 280 ppm, 300 ppm, 320 ppm, 340 ppm, 360 ppm, 380 ppm, 400 ppm, 425 ppm, 450 ppm, 475 ppm, 500 ppm, 550 ppm, 600 ppm, 650 ppm, 700 ppm, 750 ppm, 800 ppm, 850 ppm, 900 ppm, 950 ppm, 1000 ppm, 1500 ppm, 2000 ppm, 2500 ppm, 3000 ppm, 3500 ppm, 4000 ppm, 4500 ppm, 5000 ppm, 6000 ppm, 7000 ppm, 8000 ppm, 9000 ppm, 10,000 ppm, 11,000 ppm, 12,000 ppm, 13,000 ppm, 14,000 ppm, or 15,000 ppm; or to provide a final concentration corresponding to any one of the aforementioned values in this paragraph; or to provide a final concentration range corresponding to any pair of the aforementioned values in this paragraph.

In more particular embodiments, the flavoring agent may be present in the composition of the present application in an amount effective to provide a final concentration ranging from 10 ppm to 1000 ppm, from 50 ppm to 900 ppm, from 50 ppm to 600 ppm, from 50 ppm to 500 ppm, from 50 ppm to 400 ppm, from 50 ppm to 300 ppm, from 50 ppm to 200 ppm, from 75 ppm to 600 ppm, from 75 ppm to 500 ppm, from 75 ppm to 400 ppm, from 75 ppm to 300 ppm, from 75 ppm to 200 ppm, from 75 ppm to 100 ppm, from 100 ppm to 600 ppm, from 100 ppm to 500 ppm, from 100 ppm to 400 ppm, from 100 ppm to 300 ppm, from 100 ppm to 200 ppm, from 125 ppm to 600 ppm, from 125 ppm to 500 ppm, from 125 ppm to 400 ppm, from 125 ppm to 300 ppm, from 125 ppm to 200 ppm, from 150 ppm to 600 ppm, from 150 ppm to 500 ppm, from 150 ppm to 500 ppm, from 150 ppm to 400 ppm, from 150 ppm to 300 ppm, from 150 ppm to 200 ppm, from 200 ppm to 600 ppm, from 200 ppm to 500 ppm, from 200 ppm to 400 ppm, from 200 ppm to 300 ppm, from 300 ppm to 600 ppm, from 300 ppm to 500 ppm, from 300 ppm to 400 ppm, from 400 ppm to 600 ppm, from 500 ppm to 600 ppm; or to provide a final concentration corresponding to any one of the aforementioned values in this paragraph; or to provide a final concentration range corresponding to any pair of the aforementioned values in this paragraph.

### VI. G-SMW-SG-MRPs and/or G-SMW-SGs as Flavor Enhancers

The inventors have surprisingly found that G-SMW-SG-MRPs and/or G-SMW-SGs can bind the volatiles of various flavors used in food, beverages, cosmetics, feeds and pharmaceuticals. The G-SMW-SG-MRPs and/or G-SMW-SGs prepared by the methods disclosed herein could be widely soluble in water, water/alcohol, alcohol, and other organic solvents used for the flavor industry at different temperatures. The sweet tea composition could naturally encapsulate the flavor produced during the processes described herein. Therefore, it is also excellent carrier or encapsulating material for flavors, including but not limited to flavors and spices originated from plants such as bark, flowers, fruits, leaves, animals such as concentrated meat and sea food soups etc., and their extracts such as essential oils etc. In one aspect, a processed flavor is added to solution containing one or more G-SMW-SG-MRPs and/or G-SMW-SGs, then dried into a powder by any method, including but not limited spray-drying, crystallization, tray-drying, freeze drying etc. Thus, volatile flavors could be preserved. Normally, MRP flavors have to be maintained at low temperatures such as 10 degrees centigrade. The advantage of the present embodiments is that the flavors encapsulated by the G-SMW-SG-MRPs and/or G-SMW-SGs can kept at room temperature or even higher temperatures without much loss of flavor. The antioxidant properties of G-SMW-SG-MRPs and/or G-SMW-SGs can play an additional role in protection of the flavors. In addition, depending on desired product, specially designed compositions can enhance a foam for a specific application such as foamed/frothy coffee. In addition, an anti-foaming agent could be added together or separately during the reaction processes descried herein, such that the product could be used to prevent foaming for beverage bottling applications.

Compared to other HMW-SGs and/or G-HMW-SGs initiating sweet taste Receptor Cells (TRCs). LMW-SGs and/or G-LMW-SGs could not only initiate the sweet taste receptor celles, but also create broadly responsive signals using a PLCB3 signaling pathway. Since its structure of carboxyl group, it could regulate the ion channels in trigeminal fibers and play unique roles in thermosensation and pain communicate with taste neurons. Without bounding with theory, an embodiment of composition and method to improve the taste of high intensity sweeteners by regulating the taste profile via PLCB3 signaling pathway and or ion channels by LMW-SGs and or G-LMW-SGs.

In some embodiments, the composition of the present application comprises onne or more G-SMW-SG-MRPs and/or one or more G-SMW-SGs derived from carboxyl group-containing SMW-SGs. Examples of carboxyl group-containing SMW-SGs include, but are not limited to, RB, STB and STM.

Another advantage of the present embodiments is that flavors could be absorbed in or to the inner surface of pores of G-SMW-SG-MRPs and/or G-SMW-SGs-containing powders. Flavors are preserved and can be released when in solution. The present embodiments avoid the use of starch, or dextrin as a carrier which can bring wheat taste to the flavors.

Citrus flavors are among the most popular flavors in the food market. They are widely used in sauces and dressings as well as in sweet products, such as beverages, cookies, and desserts. Their consumption is growing steadily at more than 3% per year. Unfortunately, they are highly susceptible to the surroundings and deteriorate during processing and storage. Of all commercial citrus products, citrus flavor in beverages is the most delicate and difficult flavor to preserve. Lemon oil or lemon juice volatiles contain unstable flavor substances such as citral. The degradation of citrus flavors lowers intensity and balance, and develops unacceptable “off-flavors” from the degradation products. The generation of off-flavors is an especially troublesome problem negatively impacting the market potential of citrus flavors in the market place. Therefore, many investigators have attempted to better understand the mechanism of deterioration and inhibit deterioration of these flavors.

The compositions and method in the present application have succeeded in stabilizing flavors in solution or even powder form. It is assumed that flavor substances are dissolved by stevia glycosides. Fat soluble flavor substances are surrounded or protected by steviol in the structure of stevia glycosides to prevent attachment of free radicals in water solution. On the surface of surrounded stevia glycosides, MRPs form a membrane acting as an antioxidant to protect the flavor substances. Additionally, dextrin residues and other sugar donors can act as coating material for powdered formulations to prevent attachment of oxygen in air.

Compared with traditional essential oil flavors which have to be emulsified before being added to beverages, the compositions and methods of the present application do not require the use of emulsifiers. This maximizes the intensity of flavor, stabilizes the flavor from degradation by oxygen, light, heat etc., and makes the beverage transparent. In one embodiment, a stabilized flavor composition comprises: (a) one or more G-SMW-SG-MRPs and/or G-SMW-SGs, residues of dextrin and/or other types of sugar donors; and (b) a flavor substance. In a further aspect, a consumable food or beverage product contains the aforementioned substances in both (a) and (b).

Freshness is one of the most important factors representing consumers' satisfaction with the sensory qualities present in fruit or berry juices, juice flavored beverages, fruited foods etc. Freshly squeezed juices without any treatment provide a refreshing, pleasant flavor with the mouth-contracting characteristics of fruits. Mouth-contracting is one type of mouthfeeling where ingredients cause contraction like freshness, acidity, salt, and spiciness in the mouth. Contracting substances typically stimulate saliva flow. Commercial fruit juices have shown variations in quality and freshness resulted from deterioration of flavor substances during the product's shelf-life as well as seasonal variations in fruit quality. Juice flavor is composed of a broad mixture of different aroma fractions containing a variety of volatile compounds. The aroma compounds in these fractions may undergo several changes during processing and storage that gradually lead to a loss of freshness and the formation of unpleasant aromas (off-flavors). Most of these changes are acid-catalyzed reactions supported by the acidity of the juice and accelerated by high processing and storage temperatures.

Freshness is an important character of quality for food and beverage products and is characterized by various definitions or aspects. In one aspect, the freshness or lack of freshness is perceived as a sensation. For example, a basil leave on a plant has a fresh smell and fresh taste. The same leaf after 2 days on the shelf doesn't smell fresh or taste fresh. In another aspect, freshness is derived from a multisensory sensation and a learned expectation together which can provide a “refreshing” sensation. For example, a consumer can assess sparkling water as fresh or refreshing even before drinking it. When people are thirsty and an unknown drink is provided, the effect of the unknown drink may be subconsciously compared with sparkling water. The basic properties of cognitive freshness are clear. Coldness, colorless, carbonated are typical characters of refreshing; sourness enhances freshness; colors such as red or orange increase thirst-quenching perception; flavors, such as mint, orange, peppermint, lemon, citrus, and peach are among the most refreshing aromas.

Without being bound by theory, the inventor's surprising findings strongly show that retronasal aroma is an inseparable part of taste. Taste and retronasal aromas arise from integrated senses. A lot of what is perceived as taste by human beings is in fact the result of retronasal aromas passing through the nose. It is known that people with severe colds have a greatly reduced sense of taste, because retronasal aromas cannot reach the retronasal olfactory receptors in the nose. Retronasal aromas compete with taste when reaching a sensory impression of a food or beverage product by the brain. Sweetness and mouthfeel cannot be solely attribute sensory perceptions originating on the tongue or in the mouth. Retronasal aroma (or nose-feeling) significantly contributes to what is considered traditional mouthfeel (mouth-contracting, mouth-coating, mouth-dry) without necessarily increasing the viscosity of a food or beverage. Aromas contracting with the mouth give the impression of refreshment and cleansing of the mouth. The compositions of the present application can be classified as contracting aromas that can stimulate saliva flow.

Compared with prevailing industry approaches for improving the overall taste and flavor of food and beverage products, the present application provides a unique approach to taste and flavor that better integrates aroma and taste to provide more tasteful food and beverage products. For example, in contrast to many of the traditional approaches in the flavor industry that rely on the use of essential oils having strong orthonasal sensory characteristics, the inventor of the present application has surprisingly found that retronasal aroma plays a more important role than orthonasal smell in making a consumable product with improved hedonic characteristics. By providing good mouthfeel and intensity of aroma, the compositions of the present application provide improved overall flavor. In one embodiment, a composition of the present application includes one or more G-SMW-SG-MRPs, and optionally, one or more substances selected from G-SMW-SGs, SMW-SGs, SMW-SG-MRPs, SGs, SEs, STEs, GSGs, GSEs, GSTEs, Stevia-MRPs and C-MRPs, including MRPs thereof, where one or more sensory attributes selected from mouth-contracting, mouth-coating, mouthfeel, flavor intensity, and sweetness are increased relative to a composition without the one or more substances.

In some instances, people have acquired a reduction or loss in their sensory capabilities for taste and smell, especially upon aging or following infections by viruses, such as COVID-19. The compositions and methods of the present application provide effective tools for enhancing retronasal olfactory senses to make food and beverages more palatable for being swallowed. This can improve the speed of drinking beverages or eating foods by those with such reduced senses. Without being bound by theory, it is believed that the compositions of the present application are anti-inflammatory for the mucous membranes of the oral cavity, throat and retronasal cavity, and cause increased permeability of aroma substances through the epithelium. Thus, in some embodiments, the composition comprises one or more G-SMW-SG-MRPs and/or G-SMW-SGs, where at least one of the substances is an angiogenesis inhibitor. In some embodiments, the composition may further include one or more members selected from lutein, epilutein, and/or anthocyanins. Such composition may be used, for example, in patients suffering from COVID-19 or other sensory deficiencies.

The inventor has surprisingly found that compositions comprising low molecular weight stevia glycosides, such as rubusoside and glycosylated low molecular weight stevia glycosides, including glycosylated rubusoside, as well as MRPs formed therefrom can increase the freshness of food and beverage products, and provide an improved, quicker onset of sweetness. These substances are further believed to provide an earlier recognition of flavor by the brain. The resultant effect of quick-onset of sweetness and refreshing flavor enables consumers to categorize food or beverage products quicker than if those glycosides were not added. The effect of this addition can provide improved overall flavor and taste of food and beverage products.

For instance, when high intensity sweeteners, such as sucralose, Acesulfame K, monk fruit extract, stevia glycosides are used as sweeteners, lingering is always generated. The lingering becomes the lead sensation. It dominates other sensations and distracts tasters from other sensations. However, the compositions of the present application can block the lingering and bitterness of high intensity sweeteners and act synergistically to improve sweetness.

In one embodiment, a flavor composition or sweetener composition comprises one or more G-SMW-SG-MRPs and/or G-SMW-SGs, wherein the one or more substances generate a quick onset of sweetness, enhance the strength of orthonasal smell, improve the freshness, and/or increase the sweetness of a food or beverage product.

In another embodiment, a method to accelerate flavor identification by the brain comprises adding one or more G-SMW-SG-MRPs and/or G-SMW-SGs, wherein the identification is accelerated by less than 1 second, less than 0.5 second, less than 0.1 second, less than 0.01 second, or less than 0.001 second.

Oral mucosa can be classified into three different types: masticatory mucosa, lining mucosa and specialized mucosa. Masticatory mucosa covers the gingiva and hard palate, which accounts for about 25% of the oral mucosa. Specialized mucosa with characteristics of both masticatory and lining mucosa is found on the dorsum of the tongue. The dorsum of tongue accounts for about 15% of the oral mucosa. Lining mucosa covers the remaining regions, except for the dorsal surface of the tongue. Liming mucosa is related to the conventional third of the major chemosensory systems, the trigeminal chemosensory system. The neurons and their associated endings in this system are typically activated by chemicals classified as irritants, including air pollutants (e.g., sulfur dioxide), ammonia (smelling salts), ethanol (liquor), acetic acid (vinegar), carbon dioxide (in soft drinks), menthol (in various inhalants), and capsaicin (the compound in chili peppers that elicits the characteristic burning sensation). Contrary to conventional knowledge, the inventor of the present application believes that the lining mucosa contains taste and aroma receptors, and plays a principal role in overall taste and aroma together with retronasal nose-tasting, retronasal nose-coating, retronasal nose-aroma and taste by tongue. This means that the overall flavor, including taste and aroma, is an integrated and inseparable entity created by taste and flavor receptors spreading in lining mucosal sites, in addition to tongue, throat and retronasal areas.

Substances such as G-SMW-SG-MRPs and/or G-SMW-SGs can stimulate trigeminal nerve receptors in the mouth and retronasal cavity, and play an important role in flavor and taste identification of consumable products. Further, when combining G-SMW-SG-MRPs and/or G-SMW-SGs with pungent and irritant chemicals, synergistic effects are observed. Whereas pungent and irritant chemicals can activate trigeminal nerve receptors at lower thresholds or concentrations when combined with rubusoside-based glycosides or other small molecular stevia glycosides. Thus, in one embodiment, a composition or consumable product comprises: (a) one or more flavor and/or taste substances, and (b) one or more G-SMW-SG-MRPs, wherein the threshold for activating trigeminal receptors is reduced compared to a composition or product containing only the one or more flavor and/or taste substance in part (a).

The inventor has surprisingly found that G-SMW-SG-MRPs and/or G-SMW-SGs can be used as trigeminal nerve stimulants. When used together with other taste or flavor stimulants, these substances can induce nerve firing, elicit enhanced sensations such as irritation, burning, stinging, tingling, pain, as well as the general perception of temperature, viscosity, weight, and freshness. When used at higher concentrations, these trigeminal stimulants can suppress the perception of olfactory compounds. Thus, in one embodiment, a composition or consumable product comprises: (a) one or more flavor and taste substances, and (b) one or more G-SMW-SG-MRPs and/or G-SMW-SGs, where stimulation strength of (a) is enhanced when using (b) at lower concentrations; and stimulation strength of (a) is reduced when using (b) at higher concentrations.

Without being bound by theory, the inventor believes that masticatory mucosa and lining mucosa are essentially responsible for mouth-contracting, and specialized mucosa is mainly responsible for mouth-coating or tongue-coating. Both are responsible for mouthfeel. It is further believed that the lining mucosa is responsive to SMW-SGs and their corresponding GSGs so as to exhibit significant flexibility, biocompatibility and propensity for adhesively attaching to these mucosal surfaces. Accordingly, these substances are believed to improve permeability and adhesiveness of flavor substances to oral mucosa so as to bind sensory receptors responsive to bitterness, as well as metallic and synthetic tastes, thereby blocking other unpleasant substances to these receptors that would otherwise have a negative effect on taste and flavor. Nasal mucosa are particularly sensitive; rubusoside, glycosylated rubusoside and MRPs formed therefrom exhibit better accessibility and stronger impact on nasal mucosa.

In view of the foregoing, one embodiment of the present application includes a composition comprising one or more G-SMW-SG-MRPs and/or G-SMW-SGs. Adding these components to a consumable product can enhance the mouth-contracting and freshness of the consumable product. In a more particular embodiment, the composition further comprises one or more components selected from SGs, SEs, STEs, GSGs, GSEs, GSTEs, Stevia-MRPs, C-MRPs, where the amount of G-SMW-SG-MRPs and/or G-SMW-SGs is less than 95%, less than 80%, less than 50%, less than 30%, less than 10%, less than 1%, less than 0.5%, or less than 0.1%. Further, inclusion of the one or more components can reduce the amount of rubusosides and/or glycosylated rubusosides necessary to enhance the mouth-coating of consumable food and beverage products.

Improving the freshness of food and beverage products can modify their overall flavor, acidity and sweetness profiles, regardless of whether the product contains sugar(s) or a reduced sugar content. In particular, the freshness of food and beverage products, including both sugar containing and reducing sugar versions thereof, can be significantly improved by combining G-SMW-SG-MRPs and/or G-SMW-SGs with flavor substances, especially water phase essence flavors or water phase concentrated flavors, such as lemon juice concentrated aroma, orange juice concentrated aroma, cucumber concentrated aroma, and apple juice concentrated aroma etc. Adding these compositions to food and beverage can enhance the contracting mouthfeel, orthonasal smell, retronasal aroma, reduce lingering, reduce metallic and artificial aftertaste of both natural and synthetic high intensity sweeteners, make the food and beverage products more palatable, and provide new flavors with improved sensory characteristics.

Umami is a delicious aroma formed by convergence of taste and retronasal olfactory pathways in the human brain. Soy sauces are widely used in Asian area. There is strong demand to reduce salt and or added sugar in soy sauces. The inventor has surprisingly found that adding one or more G-SMW-SG-MRPs and/or one or more G-SMW-SGs can reduce the amount of salt, increase the mouthfeel or mouth-coating, minimize the off-taste of fermentation and soybean, and/or improve the umami taste when used in soy sauces. In one aspect, a method to improve the taste profile of a sugar or reduced sugar soy sauce includes the step of adding to the soy sauce one or more G-SMW-SG-MRPs and/or one or more G-SMW-SGs described in the present application, optionally with one or more substances selected from SGs, SEs, STEs, GSGs, GSEs, GSTEs, Stevia-MRPs and C-MRPs.

Jams contain high sugars such as sucrose, fructose etc. The inventor has surprisingly found that adding or combining one or more G-SMW-SG-MRPs and/or one or more G-SMW-SGs described in the present application, optionally with one or more substances selected from SGs, SEs, STEs, GSGs, GSEs, GSTEs, Stevia-MRPs and C-MRPs in a jam can increase the freshness of fruit flavors in the jam, increase the sweetness of the jam and/or increase the mouthfeel of the jam.

Fermented milks, such as yogurt, exhibit long lasting sourness, which is unpleasant to many consumers. There is huge challenge to reduce sugar and fat in yogurt and other milk products. Plant-based protein beverages, such as soybean milk and coconut milk have grassy, beany off-note aromas. The inventor has surprisingly found that adding compositions of the present application containing one or more G-SMW-SG-MRPs and/or one or more G-SMW-SGs, optionally with one or more SGs, SEs, STEs, GSGs, GSEs, GSTEs, Stevia-MRPs and C-MRPs can improve the mouthfeel or mouth-coating, quick onset sweetness, reduce unpleasant aftertastes, and/or reduce the sourness of fermented protein beverages, where the protein is from an animal and/or plant source. The compositions of the present application are particularly well suited for use with plant-based proteins so as to provide taste and retronasal olfactory inputs to the brain that can be observed by neuroimaging.

Glucose transporters GLUT1 (transports glucose) and GLUTS (transports fructose) have been implicated in several diseases including cancer and diabetes. In one embodiment, the present application provides a method for weight management, comprising oral administration of a consumable product containing one or more G-SMW-SG-MRPs and/or one or more G-SMW-SGs, wherein the one or more G-SMW-SG-MRPs and/or one or more G-SMW-SGs are present in the consumable product in an amount sufficient for reducing absorption of glucose and/or fructose or inhibiting their transport by GLUT1 and/or GLUTS.

The inventor has surprisingly found that compositions of the present application containing rubusoside, glycosylated rubusoside, and/or MRPs from therefrom can act synergistically with vanilla extract, vanillin, or ethyl vanillin to reduce the amount of vanilla or vanillin needed in a consumable. In one embodiment, a composition of the present application includes one or more G-SMW-SG-MRPs and/or one or more G-SMW-SGs in combination with one or more substances selected from vanilla extract, vanillin, and ethyl vanillin.

In addition, the inventor has surprisingly found that compositions of the present application composition containing one or more G-SMW-SG-MRPs and/or one or more G-SMW-SGs can create a fatty taste sensation, or enhance the fat taste-feeling of skim milk, vegetable burgers, and other low fat food and beverage products. In this case, it is believed that one or more G-SMW-SG-MRPs and/or one or more G-SMW-SGs act in combination with fat to produce a synergistic effect with respect to fat sensation in a consumable product containing these substances. Accordingly, in one embodiment, a composition of the present application includes one or more G-SMW-SG-MRPs and/or one or more G-SMW-SGs in combination with one or more fats.

When modified starches, such as hydroxypropyl distarch phosphate (cross-linked hydroxylpropyl ether starch) are used as a stabilizers or fat replacers in food and beverages, they create a chalky or starchy taste, which may be characterized by the sensation of granules or particles on the tongue or in the cavity of the mouth. The inventor has surprisingly found that compositions of the present application can significantly minimize the chalky or starchy taste when modified starch is used in a consumable. In one embodiment, a composition of the present application includes one or more G-SMW-SG-MRPs and/or one or more G-SMW-SGs in combination with one or more modified starches, where the one or more substances are added in an amount sufficient to reduce an otherwise chalky or starchy taste, characterized by the sensation of granules or particles on the tongue or mouth cavity.

When water insoluble or less water soluble substances, such as stevia extracts or stevia glycosides are combined with the compositions of the present application, the solubility of the substances can be improved. Moreover, when the poorly water soluble or insoluble substances are high intensity sweeteners combined with the compositions of the present application, the overall sweetness can be synergistically increased. In one embodiment, a composition of the present application includes one or more G-SMW-SG-MRPs and/or one or more G-SMW-SGs, and one or more poorly water soluble or insoluble stevia glycosides, including but not limited to Reb A, Reb B, Reb C, stevioside, Reb D, Reb I, Reb N, Reb M, Reb 0, where the solubility and sweetness of the one or more poorly water soluble or insoluble stevia glycosides is increased when combined with the one or more substances.

The fresh pressed sugar-cane or sugar beet juice, its concentrate with low temperature or short time concentration could be combined with the composition in this invention to boost the sweet taste profile of products. An embodiment of a composition comprises one or more G-SMW-SG-MRPs and/or one or more G-SMW-SGs, and one or more substances obtained from sugar-cane, preferably the fresh pressed sugar-cane or sugar beet juice, or its concentrate with low temperature or short time concentration where the maximum flavors are reserved. An embodiment of a composition comprises one or more G-SMW-SG-MRPs and one or more substances obtained from sugar-cane, where the sugar-cane product has less sweetness such as caramelized molasses, or less sweetener dark colored sugar-cane or sugar beet products.

In one aspect, the present application relates to a composition comprising (a) one or more G-SMW-SG-MRPs and/or one or more G-SMW-SGs; and (b) one or more substances selected from Reb A, Reb B, Reb D, Reb E, Reb I and/or Reb M, where the components in parts (a) and (b) are added in amounts sufficient so that the sweetness of the one or more substance in part (b) is synergistically increased by the addition of rubusoside and/or glycosylated rubusoside; or where the lingering aftertaste, metallic aftertaste and/or bitter aftertaste of the one or more substances in part (b) are reduced by the addition of rubusoside and/or glycosylated rubusoside. In this embodiment, the substances in part (a) can be obtained from stevia extracts, by fermentation, or by bioconversion; the rubusoside or glycosylated rubusoside can be obtained from sweet tea extracts, by chemical synthesis, by fermentation, by bio-conversion from stevioside, or by bio-conversion from other substances, such as terpenes. In some embodiments, part (b) comprises Reb A. In some embodiments, part (b) comprises Reb B. In some embodiments, part (b) comprises Reb D. In some embodiments, part (b) comprises Reb E. In some embodiments, part (b) comprises Reb I. In some embodiments, part (b) comprises Reb M. In some embodiments, part (b) comprises Reb A and Reb B. In some embodiments, part (b) comprises Reb A and Reb D. In some embodiments, part (b) comprises Reb A and Reb E. In some embodiments, part (b) comprises Reb A and Reb M. In some embodiments, part (b) comprises Reb B and Reb D. In some embodiments, part (b) comprises Reb B and Reb E. In some embodiments, part (b) comprises Reb B and Reb M. In some embodiments, part (b) comprises Reb D and Reb E. In some embodiments, part (b) comprises Reb D and Reb M. In some embodiments, part (b) comprises Reb E and Reb M. In some embodiments, part (b) comprises Reb A and Reb I. In some embodiments, part (b) comprises Reb B and Reb I. In some embodiments, part (b) comprises Reb D and Reb I. In some embodiments, part (b) comprises Reb E and Reb I. In some embodiments, part (b) comprises Reb M and Reb I. In some embodiments, part (b) comprises Reb A, Reb B and Reb D. In some embodiments, part (b) comprises Reb A, Reb B and Reb E. In some embodiments, part (b) comprises Reb A, Reb B and Reb M. In some embodiments, part (b) comprises Reb B, Reb D and Reb E In some embodiments, part (b) comprises Reb B, Reb D and Reb M. In some embodiments, part (b) comprises Reb D, Reb E and Reb M. In some embodiments, part (b) comprises Reb A, Reb B and Reb I. In some embodiments, part (b) comprises Reb A, Reb D and Reb I. In some embodiments, part (b) comprises Reb A, Reb E and Reb I. In some embodiments, part (b) comprises Reb A, Reb M and Reb I. In some embodiments, part (b) comprises Reb B, Reb D and Reb I. In some embodiments, part (b) comprises Reb B, Reb E and Reb I. In some embodiments, part (b) comprises Reb B, Reb M and Reb I. In some embodiments, part (b) comprises Reb D, Reb E and Reb I. In some embodiments, part (b) comprises Reb D, Reb M and Reb I. In some embodiments, part (b) comprises Reb E, Reb M and Reb I.

In some embodiments, the weight ratio of part (a) to part (b) is 1:99 to 99:1. In some embodiments, the ratio (w/w) of the composition in part (a) to the composition in part (b), is 1:99 to 30:1, 1:99 to 10:1, 1:99 to 3:1, 1:99 to 1:1, 1:99 to 1:3, 1:99 to 1:10, 1:99 to 1:30, 3:99 to 99:1, 3:99 to 30:1, 3:99 to 10:1, 3:99 to 3:1, 3:99 to 1:1, 3:99 to 1:3, 3:99 to 1:10, 10:99 to 99:1, 10:99 to 30:1, 10:99 to 10:1, 10:99 to 3:1, 10:99 to 1:1, 10:99 to 1:3, 30:99 to 99:1, 30:99 to 30:1, 30:99 to 10:1, 30:99 to 3:1, 30:99 to 1:1, 1:1 to 99:1, 1:1 to 30:1, 1:1 to 10:1, 1:1 to 3:1, 3:1 to 99:1, 3:1 to 30:1, 3:1 to 10:1, 10:1 to 99:1, 10:1 to 30:1, or 30:1 to 99:1. In some embodiments, part (a) is about, or great than, 1%, 2%, 5%, 10%, 15%, 20%, 25%, 30%, 35%, 40%, 45%, 50%, 55%, 60%, 65%, 70%, 75%, 80%, 85%, 90% or 95% by weight of the composition. In some embodiments, part (b) is about, or less than, 50%, 40%, 30%, 20%, 10%, 5%, 2% or 1% by weight of the composition.

The inventor has surprisingly found a sweetness synergy one or more G-SMW-SG-MRPs and/or one or more G-SMW-SGs, and other sweeteners. In one embodiment, a composition of the present application includes: (a) one or more G-SMW-SG-MRPs and/or one or more G-SMW-SGs; and (b) one or more ingredients selected from following components:

(1) A glycosylated mogroside (GMG) or mixtures of GMGs.

(2) A GMG in combination with a sugar donor.

(3) A GMG in combination with a GSG.

(4) A GMG in combination with an SG.

(5) A GMG in combination with a mogroside (MG).

(6) A GMG, a GSG and a sugar donor.

(7) A GMG, an SG and a sugar donor.

(8) A GMG, an MG and a sugar donor.

(9) A GMG, a GSG and an SG.

(10) A GMG, a GSG and an MG.

(11) A GMG, an SG and an MG.

(12) A GMG, a GSG, an SG and an MG.

(13) A GMG, a GSG an SG and a sugar donor.

(14) A GMG, a GSG, an MG and a sugar donor.

(15) A GMG, a GSG an SG, an MG and a sugar donor.

(16) An MG, an SG, a GSG and a sugar donor.

(17) An MG and a GSG.

(18) An MG, a GSG and an SG.

(19) An MG, a GSG and a sugar donor.

(20) An MG, a GSG, an SG and a sugar donor.

(21) A stevia extract.

(22) A stevia extract and a sugar donor.

(23) A steviol glycoside (SG).

(24) A steviol glycoside (SG) and a sugar donor.

(25) A glycosylated steviol glycoside (GSG).

(26) A glycosylated steviol glycoside (GSG) and a sugar donor.

(27) A swingle extract (mogroside extract).

(28) A swingle extract (mogroside extract) and a sugar donor.

(29) A glycosylated swingle extract.

(30) A glycosylated swingle extract and a sugar donor.

(31) A mogroside (MG) or a mixture of MGs.

(32) A mogroside (MG) and a sugar donor.

(33) A glycosylated mogroside (GMG).

(34) A glycosylated mogroside and a sugar donor

(35) A steviol glycoside (SG) and a glycosylated steviol glycoside (GSG).

(36) A steviol glycoside (SG), a glycosylated steviol glycoside (GSG) and a sugar donor.

(37) A sweet tea extract (STE), sweet tea component (STC), sweet tea glycoside (STG), a glycosylated STE (GSTE), a glycosylated STC (GSTC) and/or a glycosylated STG (GSTG).

(38) Any of the above 37 combinations further including one or more salts.

(39) Any of the above 38 further including a sweetener.

(40) Any of the above 39 combinations further including a sweetener enhancer.

(41) Any MRPs using any of the above 40 combinations used as raw materials to form an MRP composition.

It should be understood, that in the 40 combinations noted above, that where the singular is used, e.g., a glycosylated stevia glycoside, the plural of such is included, e.g., glycosylated stevia glycosides.

An embodiment of composition comprises (a) and (b), where the ratio of (a) to (b) is from 1:99 to 99:1. A further embodiment of food and beverage comprises (a) and (b). An additional embodiment of food and beverage comprises (a) and (b), where total amount of (a) and (b) is from 1 ppm to 10,000 ppm.

Caramelization can occur in the course of Maillard reaction. Exemplary reactions include:

1. equilibration of anomeric and ring forms

2. sucrose inversion to fructose and glucose

3. condensation

4. intramolecular bonding

5. isomerization of aldoses to ketoses

6. dehydration reactions

7. fragmentation reactions

8. unsaturated polymer formation

One embodiment comprises one or more of these non-volatile substances originating from G-SMW-SG-MRPs and/or G-SMW-SGs, including remaining sugar donors, remaining amine donors, and caramelized substances thereof. The caramelized substances can include e.g., caramelized disaccharides, trisaccharides, tetrasaccharides etc., which are formed by sugar donors; dimer-peptides, tri-peptides, tetra-peptides etc., which are formed by amine donors; glycosylamine and their derivatives, such as Amadori compounds, Heyns compounds, enolisated compounds, sugar fragments, amino acid fragments, and non-volatile flavor compounds formed by Maillard reactions of sugars and amino acid donors.

Thickeners such as hydrocolloids or polyols are used in liquid to improve the mouth feel by increasing the viscosity, they are also used in solid base product as filler for low cost sugar products. However, they could create a chalky or a floury taste, and higher viscosities would make a beverage less palatable. Therefore, there is a need to find a solution to reduce the amount of thickeners to be used for food and beverage especially for sugar, fat and salt reduction products. The inventors surprisingly found that adding one or more G-SMW-SG-MRPs and/or one or more G-SMW-SGs can enhance the mouth feel of thickeners and have a synergistic effect without necessarily increasing the viscosity, thus improving the palatability of the food or beverage. An embodiment comprises one or more G-SMW-SG-MRPs and/or one or more G-SMW-SGs, and sweetening agent(s), or a mixture one or more G-SMW-SG-MRPs and/or one or more G-SMW-SGs, sweetening agents, such as thaumatin, and a thickener, wherein the thickener is selected from one or more hydrocolloids and/or polyols. In one embodiment, a composition of the present invention can comprise one or more G-SMW-SG-MRPs and/or one or more G-SMW-SGs in combination with at least one sweetening agent, sweetener, or both. The one or more G-SMW-SG-MRPs are formed as a direct result of a Maillard reaction without separation or purification. The one or more G-SMW-SG-MRPs may comprise the Maillard reaction products of an SMW-SG, and amine donor, and a sugar donor, where the sugar donor comprises a reducing sugar, sweetener and/or sweetening agent.

Exemplary sweeteners may be selected from the group consisting of sorbitol, xylitol, mannitol, aspartame, acesulfame-K, neotame, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-phenylalanine 1-methyl ester, glycyrrhizin, sodium cyclamate, or mixtures thereof.

Exemplary sweetening agents may include one or more products selected from the group consisting of a stevia extract, a swingle extract, a glycosylated stevia extract, a sweet tea extract, a glycosylated sweet extract, a glycosylated swingle extract, a glycosylated steviol glycoside, a glycosylated suavioside, a glycosylated mogroside or a mixture thereof. Stevia extracts may include one or more steviol glycoside components (SGCs). From the perspective of volatile and non-volatile substances, the Maillard reaction results in the formation of volatile substances (comprising pure and impure substances) and non-volatile substances (comprising pure and impure substances).

G-SMW-SG-MRPs may include various isolated products, either partially volatile substances or partially non-volatile substances removed from the direct result of the Maillard reaction. With increasing demand of natural flavors such as vanilla, citrus, cocoa, coffee etc., the food and beverage industry face a big challenge to meet consumers' requirements. For example, the harvest of citrus in recent years has been heavily influenced by fruit disease which has created a shortage. Vanilla, coffee and Cocoa supply is always strongly influenced by climate. To increase their availability, farmers have to use more land to compete with other necessary cultivation of food and vegetable products, thus there is an additional danger of deforestation. Therefore, there is a need to find alternative sources to complement the market demand. The inventors surprisingly found that adding one or more G-SMW-SG-MRPs and/or one or more G-SMW-SGs can significantly improve the taste profile of flavors, lower the threshold of flavors and reduce the amount of flavors to be used.

Consumers are demanding ‘cleaner’ labels while retailers demand longer shelf life. The use of natural antioxidants such as tocopherols and rosemary extracts can solve these problems simultaneously. However, natural antioxidants always retain their own characteristic aroma, which makes it difficult to incorporate them in food and beverages. There is a need to look for alternative solutions. The inventors surprisingly found that adding one or more G-SMW-SG-MRPs and/or one or more G-SMW-SGs to food or beverages could significantly reduce the negative aroma of antioxidants and provide a synergy of antioxidant property. In one embodiment, a composition comprises one or more G-SMW-SG-MRPs and/or one or more G-SMW-SGs (or a mixture of one or more G-SMW-SG-MRPs and/or one or more G-SMW-SGs and sweetening agent(s), or a mixture of one or more G-SMW-SG-MRPs, sweetening agent(s), and thaumatin, and optionally a natural antioxidant.

Thaumatin is a good alternative solution for sugar reduction. However, its lingering taste makes it difficult to be used at higher dosages. The inventors surprisingly found adding one or more G-SMW-SG-MRPs and/or one or more G-SMW-SGs can substantially reduce the lingering and bitterness of thaumatin and widen its usage in foods and beverages. In one aspect, compositions comprising one or more G-SMW-SG-MRPs and/or one or more G-SMW-SGs, and thaumatin are disclosed, including food or beverages comprising one or more G-SMW-SG-MRPs and/or one or more G-SMW-SGs, and thaumatin. Addition of a sweetening agent, such as stevia, together with one or more one or more G-SMW-SG-MRPs and/or one or more G-SMW-SGs can significantly improve the taste profile of thaumatin, reducing its lingering taste. Thaumatin has synergy with one or more G-SMW-SG-MRPs and/or one or more G-SMW-SGs to reduce the bitterness and/or aftertaste of stevia.

Maillard reaction products also create problems for the food industry. A lot of resources have been expended to prevent Maillard reactions in food proceeding in order to keep the good quality of food. Therefore, there is a need to find methods to produce useful Maillard reaction products from which the food and beverage industry could benefit. In one aspect, 2-Amino-1-methyl-6-phenylimidazo (4, 5-b)pyridine (Ph1P) is formed in high amounts and is usually responsible for around 80% of the aromatic amines present in cooked meat products. It is listed on the IARC list of carcinogens. It is now understood that (HAAs) are over 100 fold more mutagenic than Aflatoxin B1. For example, heterocyclic aromatic amines (HAAs) can be formed under mild conditions—when glucose, glycine and creatine/creatinine are left at room temperature in a phosphate buffer for 84 days HAA's are formed. HAA's are reported in all kinds of cooked meat and fish products especially those that have been grilled, barbecued or roasted. Traditional restaurant food preparation tends to produce more HAA's than fast food outlets. With chicken, deep fat frying produces the highest levels of HAA's. Increasing mutagenic activity correlates with increased weight loss during cooking. In BBQ′d beef additional mutagenic components are present. Acrylamide for example, was first identified in 2002 by Margaret Tornquist of Stockholm University. She compared the blood samples of Swedish tunnel builders working with a sealant containing acrylamide with those of the general population. The results showed that the general population was regularly exposed to high levels of acrylamide. Rat feeding studies revealed that acrylamide increased the rates of several types of cancer. All these results showed that there is a need to find alternative solutions to provide the desired taste without these harmful substances, especially for bread, grilled meat, roasted coffee and chocolate. The inventor's solution was to select a suitable sugar and amine donor to create taste or flavor which could be added in food or beverages, especially for sweet foods and beverages. When adding one or more G-SMW-SG-MRPs, it would allow for conditions of baking, frying, grilling, roasting of food at lower temperatures, to have shorter heating times, and thus reduce the amount of harmful substances, or avoid creating harmful substances compared with traditional food process methods. Meanwhile, traditional methods heat the whole food which consumes a lot of energy and creates more pollution when compared to this invention. The invention makes it possible to create new methods of baking, frying, grilling and roasting without compromising taste.

In one aspect, a food or beverage can include healthy and harmless one or more G-SMW-SG-MRPs and/or one or more G-SMW-SGs. Proteins constitute an important healthy factor for foods and beverages. However, protein's raw egg taste and smell is an obstacle for wide use. Bean protein, whey protein and Coconut protein possess characteristic unpleasant tastes after drying. There is a need to find solutions to make them palatable. The inventors surprisingly found that adding compositions of this invention could significantly block the unpleasant taste of the protein and make it more palatable to consumers. One embodiment pertains to a composition comprising one or more one or more G-SMW-SG-MRPs and/or one or more G-SMW-SGs (or a mixture of one or more G-SMW-SG-MRPs and/or one or more G-SMW-SGs, and sweetening agent(s), or a mixture of one or more G-SMW-SG-MRPs and/or one or more G-SMW-SGs, sweetening agent(s) and thaumatin) and protein(s).

Another embodiment pertains to proteins (food) and beverages comprising one or more G-SMW-SG-MRPs and/or one or more G-SMW-SGs, or a mixture of one or more G-SMW-SG-MRPs and/or one or more G-SMW-SGs, and one or more sweetening agent, or a mixture of one or more G-SMW-SG-MRPs and/or one or more G-SMW-SGs, one or more sweetening agents and thaumatin. Reduced fat foods and beverages are prevalent in the market. However, lack of mouth feel and saturated fat taste on the tongue make them unpalatable for consumers. There exists a need to find a solution to solve it. The inventors surprisingly found adding compositions this invention could significantly improve the mouth feel and overall taste of reduced fat food and beverages. One embodiment pertains to compositions comprising fat and one or more G-SMW-SG-MRPs and/or one or more G-SMW-SGs (or a mixture of one or more G-SMW-SG-MRPs and/or one or more G-SMW-SGs, and sweetening agent(s), or a mixture of one or more G-SMW-SG-MRPs and/or one or more G-SMW-SGs, sweetening agent(s) and thaumatin). One embodiment pertains to partially or completed reduced fat foods and beverages one or more G-SMW-SG-MRPs and/or one or more G-SMW-SGs, or a mixture of one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Reduced salt foods and beverages are in high demand. However, the taste is not very satisfying to most consumers. There is need to find a solution to enhance the salty taste without increasing sodium intake. The inventors surprisingly found there is synergy of one or more G-SMW-SG-MRPs and/or one or more G-SMW-SGs, mixture(s) of one or more G-SMW-SG-MRPs and/or one or more G-SMW-SGs, and sweetening agent(s), mixture(s) of one or more G-SMW-SG-MRPs and/or one or more G-SMW-SGs, and sweetening agent(s) and thaumatin with salt. One embodiment pertains to reduced salt compositions with one or more G-SMW-SG-MRPs and/or one or more G-SMW-SGs, or mixture(s) of one or more G-SMW-SG-MRPs and/or one or more G-SMW-SGs, and sweetening agent(s), mixture(s) of one or more G-SMW-SG-MRPs and/or one or more G-SMW-SGs, and sweetening agent(s) and thaumatin. One embodiment provides salt foods or beverages comprising one or more G-SMW-SG-MRPs and/or one or more G-SMW-SGs, or a mixture of one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Foods and beverages containing vegetable or vegetable juices, especially garlic, ginger, beet root etc. have their strong characteristic flavors, which sometimes become taste barriers for certain consumers. There is need to find solution to neutralize or harmonize the taste of this type of food or beverage. The inventors surprisingly found that adding the compositions this invention could harmonize the taste of such foods and beverages and make them more consumer-likeable products. One embodiment provides vegetable containing foods and beverages comprising one or more G-SMW-SG-MRPs and/or one or more G-SMW-SGs, or a mixture of one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Vegetables with a bitter taste such as artichoke, broccoli, radicchio, arugula, brussel sprout, chicory, white asparagus, endive, kale and brassica, dandelion, eggplant and bitter melon are added into foods and beverages providing healthy choices to consumers. However, there is a need to find a solution to neutralize or mask the bitter taste associated with the vegetables. The inventors surprisingly found that adding the compositions of this invention could harmonize the taste of such foods and beverages and make them more consumer-likeable products. One embodiment pertain to bitter vegetable containing foods and beverages comprising one or more G-SMW-SG-MRPs and/or one or more G-SMW-SGs, or a mixture of one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Foods and beverages containing juices, juice concentrate, or fruit extract such as cranberry, pomegranate, bilberry, raspberry, lingonberry, grapefruit, lime and citrus have a sour and astringent taste. The inventors surprisingly found that adding compositions of this invention could harmonize the taste and make it acceptable to consumers. One embodiment contains fruit or fruit juice foods or beverages comprising one or more one or more G-SMW-SG-MRPs and/or one or more G-SMW-SGs, or a mixture of one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Foods and beverages containing minerals and trace elements can have a metallic taste. There is a need to find a solution to overcome this drawback. The inventors surprisingly found that adding compositions of this invention could block the metallic taste of minerals, thus improving the palatable taste of foods and beverages to consumers. One embodiment pertains to mineral enriched foods or beverages comprising one or more one or more G-SMW-SG-MRPs and/or one or more G-SMW-SGs, or a mixture of one or more G-SMW-SG-MRPs and/or one or more G-SMW-SGs and one or more sweetening agents, or a mixture of one or more G-SMW-SG-MRPs and/or one or more G-SMW-SGs, one or more sweetening agents and thaumatin.

Vitamin fortified foods and beverages provide challenges to acceptable taste due to bitterness or stale taste associated with Vitamin B series and sour and tingling tastes for Vitamin C. The inventors surprisingly found that adding composition of this invention could block the bitterness of Vitamin B series and improve the taste and mouth feel of Vitamin C as well as overall likeability. One embodiment is a vitamin fortified food or beverage containing one or more G-SMW-SG-MRPs and/or one or more G-SMW-SGs, or a mixture of one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Foods and beverages containing amino acids such as arginine, aspartic acid, cysteine HCl, glutamine, histidine HCl, isoleucine, lysine HCl, methionine, proline, tryptophan and valine have bitter, metallic or an alkaline taste. A solution is required to overcome these drawbacks. The inventors surprisingly found that adding compositions of this invention to amino acids could block the bitter, metallic or alkaline taste. One embodiment pertains to amino acid enriched foods and beverages comprising one or more G-SMW-SG-MRPs and/or one or more G-SMW-SGs, or a mixture of one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Foods and beverages containing fatty acids such as linoleic acid, linolenic acid and palmitoleic acid have a mineral or pungent taste. There is a need to find a solution to overcome these drawbacks. The inventors surprisingly found that adding composition of this invention could block the mineral or pungent taste of fatty acids. One embodiment pertains to fatty acid containing foods and beverages comprising one or more G-SMW-SG-MRPs and/or one or more G-SMW-SGs, or a mixture of one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Foods and beverages that contain natural herbs, natural herb extracts, concentrates, purified substances from herbs such as tonic water, etc. have earthy, grassy, herb tastes which are unpalatable to a lot of consumers. There is need to find a solution. The inventors surprisingly found that adding the compositions this invention could significantly mask or reduce the grassy, earthy or herb taste in such foods and beverages. One embodiment provides an herb or herb extract enriched food or beverage comprising one or more G-SMW-SG-MRPs and/or one or more G-SMW-SGs, or a mixture of one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Foods and beverages that contain caffeine, tea extract, ginseng juice or ginseng extract, taurine or guarana that function to boost energy, while having an earthy or bitter taste, which requires a solution. The inventors surprisingly found that adding the compositions of this invention could significantly mask or reduce the earthy or bitter taste of such foods and beverages. One embodiment provides an energy food or beverage comprising one or more G-SMW-SG-MRPs and/or one or more G-SMW-SGs, or a mixture one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Foods and beverages that contain cocoa powder or coffee powder, cocoa or coffee extract, have a bitter taste. The inventors surprisingly found that adding the compositions of this invention could significantly mask the bitter taste and/or enhance the flavor of such foods and beverages. One embodiment provides a cocoa or coffee containing foods or beverages comprising one or more G-SMW-SG-MRPs and/or one or more G-SMW-SGs, or a mixture of one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Foods and beverages that contain tea powder or tea extract, or flavored tea have a bitter taste or astringent mouth feel. The inventors surprisingly found that adding the compositions of this invention could significantly mask the bitter taste and/or improve the mouth feel.

An embodiment provides a tea containing food or beverage comprising one or more G-SMW-SG-MRPs and/or one or more G-SMW-SGs, or a mixture of one or more G-SMW-SG-MRPs and/or one or more G-SMW-SGs, and one or more sweetening agents, or mixture of one or more G-SMW-SG-MRPs and/or one or more G-SMW-SGs, one or more sweetening agents and thaumatin.

Alcoholic products such as wine, liquor, whisky etc. have huge variations in taste due to changes in quality of raw materials from year to year. Also there are customers that cannot accept the astringent taste etc. of the alcohol, thus, there is a need to find a solution to produce tasty alcohol products. The inventors surprisingly found that adding the compositions of this invention could block the astringent taste and make the product taste more full. One embodiment of alcohol in products comprising one or more G-SMW-SG-MRPs and/or one or more G-SMW-SGs, or a mixture of one or more G-SMW-SG-MRPs and/or one or more G-SMW-SGs, and one or more sweetening agents, or a mixture of one or more G-SMW-SG-MRPs and/or one or more G-SMW-SGs, one or more sweetening agents and thaumatin.

Sauces, such as soy bean sauces, Jams, chocolate, butter, cheese etc. cannot depend upon fermentation to create flavors to meet consumers' demands. There is a need to find a simple solution to enhance the taste and flavor of these products. The inventors found that adding the compositions of this invention could improve the overall taste of these fermented products. One embodiment provides sauces or fermented products comprising one or more G-SMW-SG-MRPs and/or one or more G-SMW-SGs, or a mixture of one or more G-SMW-SG-MRPs and/or one or more G-SMW-SGs, and one or more sweetening agents, or mixture of one or more G-SMW-SG-MRPs and/or one or more G-SMW-SGs, one or more sweetening agents and thaumatin.

With the increase of obesity and a diabetic population, limiting sugar has become a top concern for a healthy diet choices worldwide, with consumers preferring for low sugar foods and beverages but without a sacrifice in taste. High intensive natural sugar alternatives such as stevia extract, monk fruit extract and sweet tea extract, and artificial high intensive sweetener such as sucralose, ACE-K and aspartame, are applied in foods and beverages for reduced sugar product claims, each of these highly intensive sugar alternatives has a unique taste profile but none tastes exactly like sugar. Some bring bitter or metallic off notes which results in the low sugar food and beverage to have an unsatisfactory taste to consumers' palate. A solution to improve the taste of low sugar foods and beverages is imperative in the promotion of a healthy diet.

Current beverages with low sugar or sugar free, such as fruit juices and concentrates for fruit juice, vegetable juice and concentrate for vegetable juice, fruit nectars and concentrates from fruit nectar, vegetable nectar and concentrate from vegetable nectar, taste flat and watery with an unpleasant aftertaste. The inventors surprisingly found that adding the composition of this invention could improve the taste profile, remove bitter or metallic aftertaste, and make the beverage taste more like sugar. One embodiment of low sugar or sugar free beverages comprising one or more G-SMW-SG-MRPs and/or one or more G-SMW-SGs, or a mixture of one or more G-SMW-SG-MRPs and/or one or more G-SMW-SGs, and one or more sweetening agents, or mixture of one or more G-SMW-SG-MRPs and/or one or more G-SMW-SGs, one or more sweetening agents and thaumatin.

Water—based flavored beverages, including ‘sport’, ‘energy’ or ‘electrolyte’ beverages and in particular, beverages such as carbonated water-based flavored beverages, non-carbonated water based flavored beverages, concentrates (liquid or solid) for water-based flavored beverages, often taste flat and watery with an unpleasant aftertaste. The inventors surprisingly found that by adding the compositions of this invention to the beverages could improve the taste profile, remove bitter or metallic aftertaste, and/or the flavor is enhanced. One embodiment pertains to low sugar or sugar free water-based flavored beverages comprising one or more G-SMW-SG-MRPs and/or one or more G-SMW-SGs, or a mixture of one or more G-SMW-SG-MRPs and/or one or more G-SMW-SGs, and one or more sweetening agents, or mixture of one or more G-SMW-SG-MRPs and/or one or more G-SMW-SGs, one or more sweetening agents and thaumatin.

Low sugar or sugar free dairy foods and beverages such as milk and flavored milk, butter milk and flavored butter milk, fermented and renneted milk, flavored fermented and renneted milk, condensed milk and flavored condensed milk, and flavored ice-cream taste flat and watery with an unpleasant aftertaste. The inventors surprisingly found that adding the compositions of this invention could improve the taste profile, remove bitter or metallic aftertaste, enhance flavor, and improve the mouth feel and/or overall likeability. One embodiment pertains to low sugar or sugar free dairy products comprising one or more G-SMW-SG-MRPs and/or one or more G-SMW-SGs, or a mixture of one or more G-SMW-SG-MRPs and/or one or more G-SMW-SGs, and one or more sweetening agents, or mixture of one or more G-SMW-SG-MRPs and/or one or more G-SMW-SGs, one or more sweetening agents and thaumatin.

Cannabidiol (CBD) oil, for example, is extracted from the stalks, seeds and flower of plants like hemp and has a taste that is commonly described as nutty, earthy or grassy. There is a need to find a solution to make it palatable for eating and smoking. Adding the compositions of this invention to CBD oil could mask the unpleasant taste. One embodiment pertains to of CBD oil comprising one or more G-SMW-SG-MRPs and/or one or more G-SMW-SGs, or a mixture of one or more G-SMW-SG-MRPs and/or one or more G-SMW-SGs, and one or more sweetening agents, or mixture of one or more G-SMW-SG-MRPs and/or one or more G-SMW-SGs, one or more sweetening agents and thaumatin.

Nicotine has a bitter or astringent taste and aroma when inhaled. Popular electronic cigarettes require an improved taste and aroma. Adding the compositions of this invention to nicotine could mask nicotine's unpleasant taste. One embodiment pertains to nicotine contained in a cigarette product, either in solid or liquid form, comprising one or more G-SMW-SG-MRPs and/or one or more G-SMW-SGs, or a mixture of one or more G-SMW-SG-MRPs and/or one or more G-SMW-SGs, and one or more sweetening agents, or mixture of one or more G-SMW-SG-MRPs and/or one or more G-SMW-SGs, one or more sweetening agents and thaumatin.

The compositions of the present application could also be used for cosmetic, pharmaceutical, feed industry.

Maillard reaction products from Maillard reaction can taste bitter when applied to foods and beverages, especially when the reaction time is long at elevated temperatures or when the Maillard reaction products are used at higher dosages. For bitterness-sensitive people, Maillard reaction products are bitter at all concentrations in solution. The inventors found G-SMW-SG-MRPs could block the bitterness of Maillard reaction products, while one or more G-SMW-SG-MRPs could modify the lingering, bitterness, aftertaste etc. Surprisingly, the bitterness from G-SMW-SG-MRPs are not superimposed or multiplied.

In one aspect, a flavoring agent(s) in combination with one or more G-SMW-SG-MRPs and/or one or more G-SMW-SGs is provided. It has been found that substances including rubusoside surprisingly protects the flavoring agent. Not to be limited by any theory, there is a surprising protective effect exerted by the sweet tea or rubusoside-rich derived products on the flavoring agent(s).

For example, unlike typical powdered flavoring agents which have a strong aroma, the inventors have surprisingly found that the combination of (1) one or more G-SMW-SG-MRPs and/or one or more G-SMW-SGs and (2) one or more flavoring agents in a powder form results in a composition with minimal smell. However, when the same combination is dissolved in a solution (e.g., water, alcohol or mixtures thereof), the aroma of the flavoring agent is released resulting in a strong smell.

The above observations are not meant to be limited to powders. The one or more G-SMW-SG-MRPs and/or one or more G-SMW-SGs and the flavoring agent(s) can be part of a liquid composition, such as a syrup.

In one aspect, the reaction products of the embodiments described herein can be dissolved at neutral pH.

In one embodiment, the processes of the embodiments described herein are useful for improvement of taste and aroma profile for other natural sweeteners, including but not limited to licorice, thaumatin etc., their mixtures, their mixtures with sweet tea or rubusoside-rich derived products, etc.

In another embodiment, the processes of the embodiments described herein are used for improvement of taste and aroma profile for other synthetic sweeteners, including but not limited to AC-K, aspartame, sodium saccharin, sucralose or their mixtures.

The embodiments described above are applicable for any synthetic sweetener, blends thereof and other natural sweeteners, blends thereof, or mixtures of synthetic and natural sweetener(s), especially with sucralose.

For example, one or more G-SMW-SG-MRPs and/or one or more G-SMW-SGs could be added in ratio of from about 1 to about 99% on a weight/weight basis of total raw material into the following formulation to create a Baked ham flavor:

Water 10%

Pork lard 5% to 10%

Cysteine 1% to 5%

Xylose 1% to 5%

Char Oil hickory 1% to 5%

Hydrolyzed vegetable protein 5% to 10%

Sunflower oil 50% to 75%

Mix them well with heating to 110 degree C. for two hours.

Cool with mixing to 95 degree C. for one hour.

Allow to separate and filter top oil layer while warm.

Another example is to add one or more ingredients selected from the group consisting of G-SMW-SG-MRPs and/or one or more G-SMW-SGs in a ratio of from about 1 to about 99% on a weight to weight basis of total material in the following formulation to create tea flavored products:

Reducing sugar: high fructose corn syrup

Protein: theanine

Acids: citric acid or phosphoric acid

The ratio of reducing sugar and acid is 1 to 0.5. Theanine is from about 0.01 to about 0.5%.

1. The mixture was heated at 100 to 120 degree C. for 15 minutes.

2. Soluble tea solids was added to the solution and then heated at 182 degree C. for 30 minutes. The ratio of tea solids and reducing sugar is about 1:6 to about 2:8.

3. Distilled water was added to the mixture and kept at 100 degree C. for 45 minutes followed by filtration.

Another example is to add one or more G-SMW-SG-MRPs and/or one or more G-SMW-SGs by ratio of from about 1 to about 99% on a weight to weight basis of total raw material in the following formulation to create specific vegetable flavored products:

Reducing sugars: glucose, fructose, or sucrose.

Dehydrated vegetables: cabbage, onion, leek, tomato, eggplant, broccoli sprouts, kidney beans, corn, and bean sprouts.

| | | |
|---|---|---|
| Soybean oil | 500~700 | Kgs. |
| Selected vegetable | 30~70 | Kgs. |
| Sugar and water | 25~50 | Kgs. |
| Cysteine | 0.001~0.05 | Kgs. |

The mixture was mixed uniformly and maintained at the temperature of 135 degree C. for 3 hours.

The solution was cooled down.

Mushroom flavor products can be prepared by adding one or more compositions comprising a G-SMW-SE-MRP and/or a G-SMW-SG in ratio of from about 1 to about 99% on a weight to weight basis of total raw material by following procedures:

1. Mushroom Hydrolysate:

Milled dry mushroom 10 to about 30 grams were mixed with distilled water in a ratio of 1:10 to about 1:50.

The mixtures were preheated at 85 degree C. for 30 minutes in order to denature protein.

After cooling the mixture to 0 degree C., the enzymatic hydrolysis was conducted in two steps.

1st Step:

The pH of the mixture was adjusted to about 4 to about 6, then cellulase was added at a ratio of 2:100 or 5:100 while the temperature was between about 55 and about 70 degree. for 2˜3 hours.

2nd Step:

The pH was adjusted to 7, then neutral protease was added with at a ratio of 3:100.

The mixture was digested at 55 degree C. for another 2 hours.

The hydrolysate was heated at 100 degree C. or higher for 30 minutes to inactivate the enzymes and was then centrifuged.

The final supernatant was collected.

2. Maillard Reaction of Mushroom

D-xylose (0.05˜0.20 g) and L-cysteine (0.10˜0.20 g) were dissolved into 30 ml of mushroom hydrolysate.

The pH of the mixture was adjusted to 7.4˜8.

Then the mixture was heated at 140 degree C. for 135 minutes.

In another embodiment, one or more G-SMW-SG-MRPs and/or one or more G-SMW-SGs in a ratio of from about 1 to about 99% on a weight to weight basis of total raw material could be added in the following enzyme modified cheese flavor process:

Cheddar cheese base preparation: Cheddar cheese: 48% Water: 48%

Trisodium Citrate: 2%

Salt: 1.85%

Sorbic Acid: 0.15%

Method:

Cook the cheddar cheese base, then cool cheddar cheese base to about 40˜45 centigrade, add the enzyme (the enzyme could be one or more selected from Lipase AY30, R, Protease M, A2, P6, Glutaminase SD);

Mix thoroughly;

Pour the mixture into the jar provided, seal the lid;

Incubate for 7.5 hours at 45 centigrade;

Allow to cool.

In another embodiment, one or more G-SMW-SG-MRPs and/or one or more G-SMW-SGs could be added in ratio of from about 1 to about 99% on weight to weight basis of total raw material in the following White meat reaction flavor preparation formulation:

1.25 g Cysteine, 1.00 g leucine, 1.25 g xylose, 2.00 g dextrose, 2.00 g salt, 3 g torula yeast bionis goldcell (one or more other type of yeasts such as baker's yeast Biospringer BA10, Autolyzed Yeast D120/8-PW, Maxarome standard powder, Prime Extract Maxarome Selected, HVP (Protex 2538, Exter 301, Springer 2020, Gistex HUMLS could be used too), 1.5 g sunflower oil, and 13 g water.

Method: Make the mixture and heat it as per general process flavor's production method.

In another embodiment, one or more G-SMW-SG-MRPs and/or one or more G-SMW-SGs could be added in ratio of from about 1 to about 99% on a weight to weight basis of total raw material in the following Red meat reaction flavor preparation:

1.5 g cysteine hydrochloride, 1.0 g methionine, 1.0 g thiamine, 1.0 g xylose, 1.5 g MSG, 0.5 g riboside, 9.0 g maxarome plus, 5.0 g gistex, 1.5 g onion powder, 1.0 g groundnut oil, 0.1 g black pepper oleoresin, and 26.0 g water.

Method: Weigh ingredients into screw cap bottles provided;

Mix thoroughly then measure the PH;

React under pressure at 125 centigrade for 30 minutes at 20 psi.

Above prepared flavors could be used in beef burger as an example:

102 g Minced beef, 100 g Minced chicken, 36 g chopped onion, 5 g rusk (dry type), 3 g water, 2.5 g salt, 0.25 g ground black pepper and 1.25-3.00 g reaction flavors.

Method: weigh ingredients into a bowl; mix until ingredients combined; divide into 60 g portion; form into a burger shape, fry.

Again, it should be emphasized that one or more G-SMW-SG-MRPs and/or one or more G-SMW-SGs detailed herein can be added before, during or after the Maillard reaction, preferably before and during the reaction without limitation of examples. The amine donor could be amino acid, peptide, protein or their mixture from either vegetable or animal source or their mixture. The fat could be either vegetable or animal source or their mixture, too.

Consumers are now open and willing to experiment with spices to experience new flavors like tamarind, lemongrass, ginger, kaffir lime, cinnamon and clove. From candy to beer to tea, everything with ginger is now fashionable. Ginger works well in alcoholic beverages as a mixer, in ginger beer itself, in confections, muffins and cookies.

Sodium metabisulfite, olive oil and ascorbic acid were found to be effective to stabilize the antibacterial activity. 1.5% CMC shows a good performance too. Ginseng is one of the top 10 best-selling herbal dietary supplements in US, but ginseng-containing products have been mostly limited to beverages, despite a growing functional food market. The original ginseng flavors include bitterness and earthiness and must be minimized in order to establish potential success in the US market. The embodiments described herein can successfully solve this issue and make new ginseng food products such as cookies, snacks, cereals energy bars, chocolates and coffee with great taste.

In Asia, especially south-east Asia, Rose, Jasmine, Pandan, Lemon grass, yellow ginger, blue ginger, lime leaf, curry leave, Lilies, basil, coriander, coconut etc. are specific local flavors. In East Asia, many herbs are used in the cooking such as Artemisia argyi, dandelion, Codonopsis pilosula, Radix Salviae Miltiorrhizae, Membranous Milkvetch Root, rhizoma gastrodiae etc. The inventors have found that adding one or more G-SMW-SG-MRPs could significantly improve the taste profile of these flavors and their added products. For example, one or more G-SMW-SG-MRPs can be added in ratio of from about 1 to about 99% on a weight to weight basis of total raw material in the following processes to prepare such flavored products:

Lilies as a raw material were washed and milled to give a lily slurry.

Alpha-amylase (0.1-0.8%) was added and treated at 70 degree C. for one and half hours.

Protease (0.05-0.20% by mass of the lily) was then added and heated at 55 degree C. for 70 minutes.

One or more G-SMW-SG-MRPs and/or one or more G-SMW-SGs could be also added in following process:

Fenugreek extract:

The seeds were roasted and crushed uniformly.

The seeds was extracted with ethyl alcohol, filtered to obtain a yellowish brown solution followed by concentration.

An extract 10 parts, glucose 1 part and proline 0.6 parts were mixed together and heated at 110˜120 degree C. for 4˜6 hours.

Savory is full of flavor, delicious and tasty-usually something that someone has cooked.

Savory foods are appetizing, pleasant or agreeable to the taste or smell, but there is a need to find suitable compatible a sweet taste balanced solution. One or more G-SMW-SG-MRPs and/or one or more G-SMW-SGs can be added into following formulation in ratio of 1˜99% on a weight to weight basis of total raw material to produce well balanced sweet products: 1) Tomato sauce formula:

| | | |
|---|---|---|
| olive oil | 25~50 | grams |
| onion diced | 150~200 | grams |
| garlic minced | 10~20 | grams |
| tomato paste | 600~900 | grams |
| salt | 5~10 | grams |
| basil chopped | 10~20 | grams |
| black pepper | 0.5~2 | gram |
| ground | | |

Cooking and mixing for 25 minutes

2) Grilled Flavor Formula:

Beef tallow or soybean oil is passed through a grilling device being heated at 450 degree C. continuously. The grilled flavor is collected through a condenser.

3) Roasted Meat Flavor:

A mixture of 8.0˜10 grams of cysteine, 8.0˜10 grams of thiamine, and 300 grams of vegetable protein hydrolysate is brought to 1000 grams by the addition of water and adjusted to a pH of 5.

The mixture is then boiled under reflux condition (100˜110 degree C.) at atmospheric pressure for 3˜5 hours and allowed to cool. A roasted meat flavor was formed.

4) Chicken Base Flavored Products:

| | |
|---|---|
| water | 10% |
| hydrolyzed | 10~20% |
| vegetable | |
| protein | |
| xylose | 0.10~0.50% |
| cysteine | 0.20~0.50% |

Premixing to form slurry.

Adding premix to sunflower oil while mixing.

| | |
|---|---|
| sunflower oil | 50~80% |

Heating with constant mixing to about 100˜110 degree C. for two to three hours.

Cool the mixture down to about 80 degree C. with mixing for another one hour.

Flavonoids are an important and widespread group of plant natural products that possess many biological activities. These compounds are part of the wide range of substances called “polyphenols”, which are widely known mainly by their antioxidant properties, and are present in human dietary sources showing great health benefits.

Neohesperidine and naringin, which are flavanone glycosides present in citrus fruits and grapefruit, are responsible for the bitterness of citrus juices. These substances and their derivatives, such as neohesperidine chalcone, naringin chalcone, phloracetophenone, neohesperidine dihydrochalcone, naringin dihydrochalcone etc. can be good candidates for bitterness or sweetener enhancers. The inventors surprisingly found adding these components in the compositions described herein could help the masking the bitterness or aftertaste of other ingredients and made the taste cleaner. One embodiment includes the compositions described herein and further comprises flavonoids, more preferably flavonoids containing flavonone glycosides. The ratio of flavonoids in the composition could be in range of from about 0.1 ppm to 99.9%.

Metal salts of dihydrochalcone having the following formula:

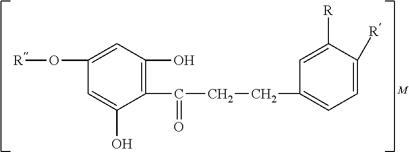

wherein R is selected from the group consisting of hydrogen and hydroxy, R′ is selected from the group consisting of hydroxy, methoxy, ethoxy and propoxy, and R″ is selected from the group consisting of neohesperidoxyl, B-rutinosyl and β-D-glucosyl, M is a mono- or divalent metal selected from the group consisting of an alkali metal and an alkaline earth metal, and n is an integer from 1 to 2 corresponding to the valence of the selected metal M.

Typical compounds of the above formula are the alkali or alkaline earth metal monosalts of the following:

Neohesperidin dihydrochalcone, having the formula:

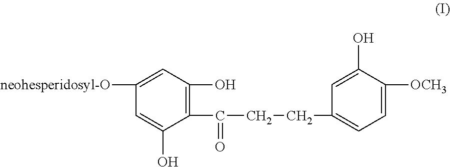

2′, 4′, 6′, 3-tetrahydroxy-4-n-propoxydihydrochalcone 4′-β neohesperidoside having the formula:

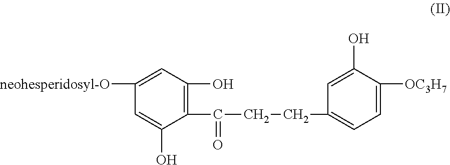

naringin dihydrochalcone of the formula:

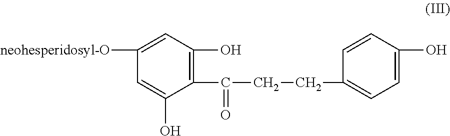

prunin dihydrochalcone of the formula:

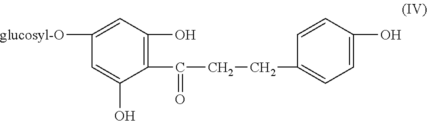

hesperidin dihydrochalcone having the formula:

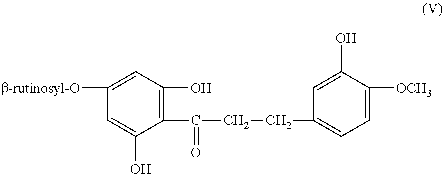

and hesperitin dihydrochalcone glucoside having the formula:

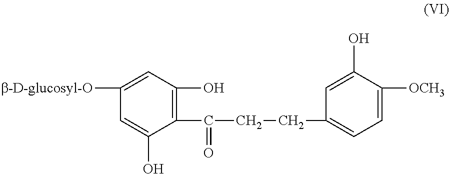

The alkali metal includes sodium, potassium, lithium, rubidium, cesium, and ammonium, while the term alkaline earth metal includes calcium, strontium and barium. Other alkali amino acids can serve as counterions. Thus embodiments of compositions described herein further comprises one or more salts of dihydrochalone.

The compositions described herein can further comprise one or more products selected from Trilobatin, phyllodulcin, Osladin, Polypodoside A, Eriodictyol, Homoeriodicyol sodium salt, hesperidin or hesperetin, Neohesperidin dihydrochalcone, naringin dihydrochalcone, or advantame to provide additional flavors and products. Another embodiment comprises of the compositions described herein and one or more of the aforementioned products, wherein the ratio of one or more products selected in the composition can be in the range of from about 0.1% to about 99.9%.

Advantame is high potency synthetic sweetener and can be used as a flavor enhancer. The inventors found that adding advantame into the compositions described herein can boost the flavor and taste profile of a food or beverage. In one aspect, Advantame can be added after conventional or non-conventional Maillard reaction. One embodiment provides compositions described herein which further comprise advantame, wherein the amount of advantame can be in the range of from about 0.01 ppm to about 100 ppm.

Creating a sweet enhanced meat process flavor can be obtained by adding one or more G-SMW-SE-MRPs to one or more of following ingredients: a source of sulphur: cysteine, (cystine), glutathione, methionine, thiamine, inorganic sulphides, meat extracts, and egg derivatives; an amino nitrogen source, such as amino acids, HVP's, yeast extracts, meat extracts; a sugar component, such as pentose and hexose sugars; vegetable powders (e.g., onion powder, tomato powder etc.); hydrolyzed gums, dextrins, pectins, alginates; fats and oils, such as animal fats, vegetable oils, coconut oils etc.; enzyme-hydrolyzed oils and fats; and/or other components, including herbs, spices, IMP, GMP, acids, etc.

Pigs, especially young pigs, appreciate good and pleasant tastes and aroma much the way young children do. Cats are notoriously fussy about the taste and smell of their feed. Feeds such as rapeseed meal, which has a bitter taste, are used as good protein sources for cattle, sheep, and horses. Even chickens are known for their taste discrimination, as chickens are selective to their feeds. Green, natural or organic farming of animals become more and more popular. Therefore, there is a need to find a solution to satisfy market requirements. An embodiment of feed or feed additives comprises the compositions described herein.

The intense sweetness and flavor/aroma enhancement properties of the compositions described herein provide useful applications in improving the palatability of medicines, traditional Chinese medicine, food supplements, beverage, food containing herbs, particularly those with unpleasant long-lasting active ingredients not easily masked by sugar or glucose syrups, let alone sweetening agents or synthetic high intensity sweeteners. The inventors surprisingly found the compositions described herein can mask the unpleasant taste and smell of the products containing these substances, for instance Goji berries juice, sea buckthorn juice, milk thistle extract, Ginkgo biloba extract etc. Thus traditional Chinese medicine, or food supplements can be combined with one or more of compositions described herein, especially when used as a masking agent.

Except for a reduced sugar donor and an amine donor, all other ingredients can be either added before, during and after the conventional Maillard reaction, more preferably before and during the Maillard reaction. An embodiment of composition in this invention preparable by adding all ingredients in the Maillard reaction to react together.

Products such as maltol, ethyl-maltol, vanillin, ethyl vanillin, m-methylphenol, and m-(n)-propylphenol can further enhance the mouthfeel, sweetness and aroma of the compositions described herein. In some embodiments, the sweetening or flavor composition of the present application further comprises one or more products selected from maltol, ethyl-maltol, vanillin, ethyl vanillin, m-methylpheonol, m-(n)propylphenol. In some embodiments, the sweetening or flavor compositions of the present application comprises a combination of one or more C-MRPs and maltol, C-MRPs and Vanillin, a combination of one or more G-SMW-SG-MRPs and maltol, a combination of one or more G-SMW-SG-MRPs and vanillin, etc. are provided. In some embodiments, a food or beverage comprises the above-described sweetening or flavor compositions.

Aquaplants and seafood cultivated from fresh water or sea water always have a fish smell or marine aroma. Examples of aromaiferous aquatic foodstuffs include spirulina powder or its enriched protein extract, protein extracted from duckweeds (lemnoideae family), fish protein, fish meal etc. There is a need to minimize or cover the unpleasant aroma to make the food product palatable. The inventors surprisingly found that compositions described herein could be added in these products to minimize the aromas to make them more acceptable to consumers including feeds for animals. Embodiments of consumables comprise components from aquaplants and/or seafood, and any of the compositions described herein.

Foods and beverages containing acids can irritate the tongue. For instance, products containing acetic acid can irritate the tongue and make that product unpalatable. The inventors surprisingly found that adding any of the compositions described herein could significantly balance the acid taste and make the products palatable.

Beverages containing vinegar, such as apple cider vinegar drink, shrub, switchel etc. have become popular in the market due to vinegar's health attributes. The acetic acid can be naturally occurring, for instance it is originated from fermentation of fruits such as apple, pear, persimmon etc., grains such as rice, wheat etc. It could be also synthetic. However, the taste of acetic acid is strong and sour and tends to burn the throat. Therefore, there is a need to find a solution to harmonize it. The inventors surprisingly found that adding any of the compositions described herein can strongly harmonize the taste of beverages containing acetic acid and make them palatable. One embodiment provides a composition comprising acetic acid and any of the compositions described herein. Another embodiment provides a method to harmonize the taste of acetic acid by using any of the compositions described herein. Another embodiment provides a consumable that comprises acetic acid and any of the compositions described herein. Another embodiment provides the use of any the compositions described herein in beverages containing acetic acid, where the dosage of the composition(s) described herein is above 10(′) ppb. Embodiments of the composition(s) described herein include, for example, one or more G-SMW-SG-MRPs, combinations of thaumatin and one or more G-SMW-SG-MRPs, combinations of one or more of G-SMW-SG-MRPs and one or more high intensity sweeteners, combinations of thaumatin, one or more G-SMW-SG-MRPs, and one or more high intensity sweeteners.

Thermotreating G-SMW-SG-MRPs, especially thermo-reaction treatment can result in improved taste of G-SMW-SG-MRPs. Thermo-treatment is like caramelization of G-SMW-SGs (without MRP(s)). The temperature range can be from 0-1000° C., in particular from about 20 to about 200° C., more particularly from about 60 to about 120° C. The period of treatment can be from be from a few seconds to a few days, more particularly about one day and even more particularly from about 1 hour to about 5 hours.

The inventors surprisingly found that adding one or more G-SMW-SG-MRPs, combinations of thaumatin and one or more G-SMW-SG-MRPs; combinations of thaumatin, one or more G-SMW-SG-MRPs, and one or more high intensity sweeteners; combinations of thaumatin, one or more G-SMW-SG-MRPs, and one or more high intensity sweetener in food and beverages containing alcohol to enhance the strength of alcohol.

Beer flavor and size and the amount of bubbles are important factors in measuring the quality of beer. Compositions described herein can be used for enhancing the flavor of beer taste and to adjust the size and amount of bubbles. In one embodiment, beer or beer containing products can include one or more G-SMW-SG-MRP compositions of the present application.

Foods having high sugar content such as area catechu, spicy bar (or called spicy strip, hot strip, spicy glutein), pickled vegetables, meat and fishes, or fermented foods always require large amounts of sugar in order to balance the total taste profile and make them more palatable. The inventors surprisingly found that combinations of one or more G-SMW-SG-MRPs and thaumatin; one or more G-SMW-SG-MRPs and one or more high intensity sweeteners; and one or more G-SMW-SG-MRPs, one or more high intensity sweeteners and thaumatin, can significantly improve the taste profile and/or palatability, especially when sugar reduction is required for such foods. For example, embodiments of such compositions include area catechu, spicy bar, pickled food, or fermented foods with one of composition(s) described herein.

Vegetable burgers have become popular in recent years, but the taste is still not palatable to most consumers. Compositions described herein can be used for enhancing the flavor and taste of the vegetable burger. In one embodiment, a vegetable burger comprises one or more G-SMW-SG-MRPs and thaumatin; one or more G-SMW-SG-MRPs and one or more high intensity sweeteners; or a combination of one or more G-SMW-SG-MRPs, one or more high intensity sweeteners and thaumatin.

Grilled foods often incorporate sugar to enhance the taste. However, sugar creates strong colors during grilling, and when the fried foods become cold, the sugar syrup becomes sticky. The inventors found that by adding the compositions described herein to the food to be grilled, these disadvantages can be overcome. For example, embodiments include grilled foods that include one or more G-SMW-SG-MRPs and/or one or more G-SMW-SGs, and thaumatin; one or more one or more G-SMW-SG-MRPs and/or one or more G-SMW-SGs, and one or more high intensity sweeteners; or a combination of one or more G-SMW-SG-MRPs and/or one or more G-SMW-SGs, one or more high intensity sweeteners, and thaumatin.

In another embodiment, a composition comprises (a) one or more G-SMW-SG-MRPs and/or one or more G-SMW-SGs; and (b) one or more substances selected from fibers, such as polydextrose; inulin, Promitor produced by Tate & Lyle; monosaccharide-derived polyols, such as erythritol, mannitol, xylitol, and sorbitol; disaccharide-derived alcohols such as isomalt, lactitol, and maltitol; hydrogenated starch hydrolysates; synthetic high intensity sweeteners, such as sodium saccharin, sucralose, aspartame, acesulfame-K, N—[N-[3-(3-hydroxy-4-methoxyphenyl)propyl]-alpha-aspartyl]-L-phenylalanine 1-methyl ester, sodium cyclamate, neotame; and/or natural low intensity sweeteners, such as trehalose, raffinose, cellobiose, tagatose, DOLCIA PRIMA™ allulose. Natural high intensity sweeteners include Licorice extract, glycyrrhizin-derived substances, stevia extracts, monk fruit extracts, glycosylated stevia extracts, glycosylated monk fruit extracts; modified starches, such as Rezista, Claria, Kolgauard etc. produced by Tate & Lyle; or mixtures thereof. A further embodiment of composition comprises (a) and (b), where ratio of (a) to (b) is from 1:99 to 99:1. An additional embodiment comprises (a) and (b), where the final product is in powder or liquid form. In another embodiment, a food or beverage syrup comprises (a) and (b).

In another embodiment, a composition comprises (a) one or more G-SMW-SG-MRPs and/or one or more G-SMW-SGs; and (b) a stevia glycoside composition containing one or more stevia glycosides selected from Reb A, Reb B, Reb C, Reb D, Reb E, Reb I, Reb M, Reb N, Reb O, Stevioside. An additional embodiment comprises the composition in (a) and (b), where ratio of (a) to (b) is from 1:99 to 99:1. In a further embodiment, a food or beverage comprises (a) and/or (b), where the total concentration of (a) is in range of 1 ppm to 10,000 ppm; and/or the total concentration of (b) is in range of 1 ppm to 2,000 ppm. In a further embodiment, a food or beverage syrup comprises (a) and (b) of the preceding embodiment.

The inventor surprisingly found that the present application can improve the solubility of stevia extract, stevia glycosides. An embodiment comprises (a) one or more G-SMW-SG-MRPs and/or one or more G-SMW-SGs; and (b) one or more stevia glycosides selected from Reb A, Reb B, Reb C, Reb D, Reb E, Reb I, Reb M, Reb N, Reb 0, and/or stevioside, where the one or more G-SMW-SG-MRPs and/or one or more G-SMW-SGs are present in an amount sufficient to improve the solubility of the stevia glycosides in (b).

G-SMW-SG-MRPs and G-SMW-SGs can inhibit absorption of glucose and fructose in intestine. Without being limited by theory, G-SMW-SG-MRPs, G-SMW-SGs, stevia extracts, stevia glycosides, sweet tea extracts, and sweet tea components may block the absorption of lactose and gluten by the intestines and nasal cavities in humans. In one embodiment, a consumable product comprises G-SMW-SG-MRPs and G-SMW-SGs in an amount sufficient to improve the tolerance to lactose and/or gluten. A further embodiment to use such consumable for weight management.

Volatile substances from G-SMW-SG-MRPs can form an aerosol when formulated in foods and beverages. These substances can inhibit the absorption of pollen or other substances which stimulate allergic reactions in humans. In one embodiment, a composition comprising one or more G-SMW-SG-MRPs can be used in an anti-allergy product. The composition can be included in a consumable product, a health supplement or a medical formulation comprising a sprayer.

Another aspect of the present application relates to compositions comprising one or more terpenoid glycosides (TGs), especially small molecular weight TGs (i.e., TGs with a molecular weight less than 965 Dalton, also referred to as SMW-TGs). TGs include steviol glycosides and other high intensity natural sweetening agents from plants, including glycosides, which may serve as sugar substitutes, and which are further described below. A glycoside is a molecule in which a sugar is bound to another functional group via a glycosidic bond. The sugar group is known as the glycone and the non-sugar group as the aglycone or genin part of the glycoside. Glycosides are prevalent in nature and represent a significant portion of all the pharmacologically active constituents of botanicals. As a class, aglycones are much less water-soluble than their glycoside counterparts.

Depending on whether the glycosidic bond lies “below” or “above” the plane of the cyclic sugar molecule, glycosides of the present application can be classified as α-glycosides or β-glycosides. Some enzymes such as α-amylase can only hydrolyze α-linkages; others, such as emulsin, can only affect β-linkages. Further, there are four types of linkages present between glycone and aglycone: a C-linked glycosidic bond, which cannot be hydrolyzed by acids or enzymes”; an O-linked glycosidic bond; an N-linked glycosidic bond; or an S-linked glycosidic bond.

The glycone can consist of a single sugar group (monosaccharide) or several sugar groups (oligosaccharide). Exemplary glycones include glucose, galactose, fructose, mannose, rhamnose, rutinose, xylose, lactose, arabinose, glucuronic acid etc. An aglycone is the compound remaining after the glycosyl group on a glycoside is replaced by a hydrogen atom. When combining a glycone with an aglycone, a number of different glycosides may be formed, including steviol glycosides, terpenoid glycosides, alcoholic glycosides, anthraquinone glycosides, coumarin glycosides, chromone glycosides, cucurbitane glycosides, cyanogenic glycosides, flavonoid glycosides, phenolic glycosides, steroidal glycosides, iridoid glycosides, and thioglycosides.

For example, the term “flavonoid aglycone” refers to an unglycosylated flavonoid. Flavonoid aglycones include flavone aglycones, flavanol aglycones, flavanone aglycones, isoflavone aglycones and mixtures thereof. Thus, the terms “flavone aglycone”, “flavanol aglycone”, “flavanone aglycone” and “isoflavone aglycones” refer to unglycosylated flavones, flavanols, flavanones and isoflavones, respectively. More particularly, the flavonoid aglycone may be selected from the group consisting of apigenin, luteolin, quercetin, kaempferol, myricetin, naringenin, pinocembrin, hesperetin, genistein, and mixtures thereof.

Terpenoid glycosides (TGs) for use in the present application, include e.g., steviol glycosides, Stevia extracts, mogrosides (MGs), Siraitia grosvenorii (luo han guo or monk fruit) plant extracts, rubusosides (RUs), Rubus suavissimus (Chinese sweet tea) plant extracts; flavanoid glycosides, such as neohesperidin dihydrochalcone (NHDC); osladin, a sapogenin steroid glycoside from the rhizome of Polypodium vulgare; trilobatin, a dihydrochalcone glucoside from apple leaves; eriodictyol, a bitter-masking flavonoid glycoside extracted from yerba santa (Eriodictyon californicum), one of the four flavanones extracted from this plant as having taste-modifying properties, along homoeriodictyol, its sodium salt, and sterubin; polypodoside A (from the rhizome of Polypodium glycyrrhiza); phyllodulcin, a coumarin glycoside found in Hydrangea macrophylla and Hydrangea serrata; swingle glycosides, such as mogroside V, mogroside IV, siamenoside I, and 11-oxomogroside V, which are cucurbitane glycosides; monatin, a naturally occurring, high intensity sweetener isolated from the plant Sclerochiton ilicifolius, and its salts (monatin SS, RR, RS, SR); hernandulcin, an intensely sweet chemical compound gained from the chiefly Mexican and South American plant Lippia dulcis; phlorizin, plant-derived dihydrochalcone that is a glucoside of phloretin, which is found primarily in unripe Malus (apple) and the root bark of apple; glycyphyllin, an alpha-L-rhamnoside derived from phloretin, the aglucone of phlorizin, a plant-derived dihydrochalcone; baiyunoside, a diterpene glycoside isolated from the Chinese drug Bai-Yun-Shen; pterocaryoside A and pterocaryoside B, secodammarane saponin glycosides isolated from Pterocarya pahurus Batal. (Juglandaceae), which are native to China; mukuroziosides Ia, Ib, IIa and Iib, acyclic sesquiterpene oligoglycosides isolated from the pericarp of Sapindus mukurossi and Sapindus rarak; phlomisoside I, a furanolabdane-type diterpene glycoside isolated from the roots of the Chinese plant, Phlomis betonicoides Diels (Lamiaceae); periandrin I and V, two sweet-tasting triterpene-glycosides from Periandra dulcis; abrusoside A-D, four sweet tasting triterpene glycosides from the leaves of Abrus precatorius; cyclocariosides I; II, and III, and synthetically glycosylated compositions thereof (e.g., GSGs, glycosylated Stevia extracts etc). Lithocarpus litseifolius folium (latin name) is a kind of species of sweet tea. Phlorizin and trilobatin are the main ingredients. Phlorizin is a glucoside of phloretin, a dihydrochalcone. Phlorhizin is abundant in the leaves of another kind of Sweet Tea (Lithocarpus polystachyus Rehd), too.

Plants contain aglycones, which normally are hydrophobic, water insoluble volatile substances. There are also glycosides in plants which are more water soluble. The inventor found that glycosylation process could make these hydrophobic compounds into water soluble and stable in water solution. The inventor surprisingly found that adding these substances in food and beverage could significantly improve the intensity of retronasal aroma, and MRPs have synergy effect with these glycoside substances to create a stronger palatable retronasal aroma when adding into food and beverage together. An embodiment of flavor composition comprises glycosylated treated ingredients to have content of glycosides higher than their natural plant sources before glycosylation treatment, where the ingredients are originated from plant sources such as leaves, flowers, fruits, berries, barks, seeds etc. An embodiment of such composition further comprises Maillard reaction products, or such composition could provide a sugar donor for Maillard reactions. An embodiment of these composition further include one or more components selected from stevia extract, stevia glycosides, glycosylated stevia extract, glycosylated stevia glycosides, sweet tea extract, sweet tea components, glycosylated sweet tea extract, glycosylated sweet tea components, monk fruit extract, monk fruit component, glycosylated monk fruit extract, glycosylated monk fruit component, licorice root extract, licorice root component, glycosylated licorice root extract, glycosylated licorice root component. An embodiment of all these types of glycosylated treated plant ingredients, their Maillard reaction blends or Maillard reacted products are used in food and beverage.

There is huge waste when producing food or beverage ingredients from natural sources, such as juice and flavor production, there is need to find solution to take use of these natural gifted waste to create new commercial value. Plant waste after extraction of flavor or other health active compounds could be useful in this invention. The present application could create commercial value to take use of every individual compounds from natural source. For example, the chocolate production process isn't typically very sustainable. The pulp, husk, and other components that surround the cacao bean are generally discarded as waste. Cacao juice is the juice from the mucilage, or the sticky pulp surrounding the cacao bean. This mucilage is a key element in the development of the flavor of chocolate. Cacao farmers use a wild fermentation process that starts with this sugary juice, which attracts certain bacteria. Cacao begins to ferment as soon as it is harvested, a process that is critical to its flavor. The cacao juice or other waste from chocolate production or glycosylated treated cacao juice could be excellent source of raw material to provide sugar donor for additional Maillard reaction to create a fresh retronasal chocolate aroma. The same is applied for coffee products, especially for green coffee bean extract, which is rich in chlorogenic acids. An embodiment of flavor composition comprises glycosylated cacao juice. A further embodiment of consumable comprises glycosylated cacao juice and Maillard reaction products higher than their original natural sources.

Green vanilla contains glycosides, namely gluco-vanillin (vanilloside) and glucovanillic alcohol. The water or water extraction of green vanilla can be used as retronasal aroma flavor. In an embodiment, a flavor composition additionally includes enriched vanilla glycosides higher than the natural occurred source. A further embodiment of flavor preparation to use green vanilla as raw material. An additional embodiment of a food or beverage includes vanilloside, where the vanilloside content is higher than 0.01 ppm, 0.1 ppm, 1 ppm, 5 ppm, 10 ppm, 50 ppm, 100 ppm, 1,000 ppm. Apple contains rich flavanols, phenolic acids, dihydrochalcones, flavonols, such as gallic acid, ferulic acid, caffeic acid, phloretin-2-O-beta-glucoside, quercetin-3-O-galactoside, qucercetin-3-O-glucoside, quecetin-3-O-rutinoside, quercetin-3-O-xyloside, qucertin-3-O-arabonoside, qucertin-3-O-rahmnoside etc. The polyphenols in apple extract could be further glycosylated. The apple polyphenols or their additional glycosylated compounds could act as sugar donor for Maillard reaction. The G-SMW-SG-MRPs can be used as flavors to enhance the intensity of retronasal flavor. An embodiment of a flavor composition may further include glycosides in apple polyphenols higher than its original natural sources. A further embodiment of a consumable may include apple polyphenols with enriched glycosides in amount of higher than 0.01 ppm, 0.1 ppm, 1 ppm, 5 ppm, 100 ppm, 1,000 ppm, 5,000 ppm.

Green coffee bean is rich in chlorogenic acids, but also contains other substances such as three trans-cinnamic acids (caffeic, ferulic and dimethoxycinnamic), six cinnamoyl-amino acid conjugates (caffeoyl-N-tyrosine, p-coumaroyl-N-tyrosine, caffeoyl-N-tryptophan, p-coumaroyl-N-tryptophan, feruloyl-N-tryptophan, caffeoyl-N-phenylalanine) and three cinnamoyl glycosides (caffeoylhexose, dicaffeoylhexose and dimethoxycinnamoylhexose). The green coffee bean extract could be glycosylated. Green coffee bean extract and/or glycosylated green coffee bean extract could act as sugar donor or amine donor for Maillard reactions. An embodiment of a flavor composition comprises glycosylated substances in green coffee bean extracts higher than its original natural sources. A further embodiment of a consumable comprises green coffee bean extracts with enriched glycosylated substances in amount of higher than 0.01 ppm, 0.1 ppm, 1 ppm, 5 ppm, 100 ppm, 1,000 ppm, 5,000 ppm, 1%, 5%, or 10%.

Flavonoids are widely contained in citrus such as lemon, conferring the typical taste and biological activities to lemon. There are five main flavonoid glycosides, of which the aglycone are eriocitrin, narirutin, hesperidin, rutin, and diosmin, respectively. Citrus extract could be glycosylated. Citrus extract or its glycosylated product could act as sugar donor for Maillard reaction. An embodiment of a flavor composition comprises glycosylated substances in citrus extracts higher than its original natural sources. A further embodiment of a consumable comprises lemon extract with enriched glycosylated substances in amount of higher than 0.01 ppm, 0.1 ppm, 1 ppm, 5 ppm, 100 ppm, 1,000 ppm, 5,000 ppm, 1%, 5% or 10% by weight.

Oleoresins are semi-solid extracts composed of a resin in solution in an essential and/or fatty oil, obtained by evaporation of the hydrocarbon solvent(s) used for their production. Compared to essential oils obtained by steam distillation, oleoresins ae rich in heavier, less volatile and lipophilic compounds, such as resins, waxes, fats and fatty oils. Gummo-oleoresins (oleo-gum resins, gum resins) occur mostly as crude balsams and contain also water-soluble gums. Oleoresins are prepared from spices, such as basil, capsicum (paprika), cardamom, celery seed, cinnamon bark, clove bud, fenugreek, fir balsam, ginger, jambu, labdanum, mace, marjoram, nutmeg, parsley, pepper (black/white), pimenta (allspice), rosemary, sage, savory (summer/winter), thyme, turmeric, vanilla, West Indian bay leaves. The solvents used are nonaqueous and may be polar (alcohols) or nonpolar (hydrocarbons, carbon dioxide). The waste after removing oleoresins, preferably, the water extraction of waste after removing oleoresins, more preferably, its glycosylated treated water extraction of waste after removing oleoresin, most preferably, the fresh juice, water or water/alcohol extracted from plant source, could be used as raw material as sugar donor, to have Maillard reaction with one or more of amine donors to create a pleasant retronasal aroma. Any natural sweetening agent in this invention could be added before or after the Maillard reaction. Surely water or water alcohol extraction of whole plant source material such as flower, seed, bark, leaves etc. could be used as raw material for glycosylation and/or Maillard reaction, too. For example, Zingiberaceae is the large diverse family comprised of rhizomatous plants with a higher concentration of phenolic compounds containing aglycones and glycosides. The normal ginger (Zingiber officinale Rosc.) and black ginger (Kaempferia parviflora Wall.) belongs to this family. The water extract of whole ginger root, the fresh ginger root juice, the water or water/alcohol extraction of ginger after removing oleoresins, preferably, the glycosylated products of these extracts could be flavor ingredients. Any of these ginger extract or their glycosylated products could be used as sugar donor to have Maillard reaction with any single or combined amine donors. One or more natural high intensity sweetener could be added before or after the Maillard reaction.

Natural sources used to produce food and beverage, such as apple to produce apple juice, citrus peels to produce citrus flavor. During the concentration of juice, water soluble volatile substances could be collected and could be used in the formulation of retronasal aroma. An embodiment of retronasal aroma composition comprises water soluble volatile substances. In some embodiments, the consumable product is a beverage or food, and the beverage or food includes (a) one or more G-SMW-SG-MRPs; and (b) one or more water soluble volatile substances from berries, fruit juices or vegetable juices, where the water soluble volatile substances in an amount of 0.01-5000 ppm.

Glycosides from original plants and their plant extracts before or after glycosylation, can act as a sugar donor in Maillard reactions so as to create a stable form of aroma substances, which can result in stronger and palatable retronasal flavors for consumables, including foods and beverages. An embodiment of composition comprises G-SMW-SG-MRPs prepared by reacting an amine donor with a glycoside sugar donor from a plant, plant extract, glycosylated plant extract, or a glycosylated glycoside from a plant, with or without an additional reducing sugar donor. Such an embodiment may be used in a method to provide a more palatable flavor to a consumable product.

Glycosides can also originate from animal sources. Amine donors can originate from animal sources, vegetable sources, fermentation, or chemical synthesis. The Maillard reaction can be controlled to undergo a complete reaction by consuming amine and/or sugar donors completely or it contains residue of amine donor and/or sugar donor. An embodiment of flavor comprises one or more ingredients selected from a sugar conjugated substance from plant, an amine conjugated substance and their reacted products. An embodiment of consumable comprises such ingredient.

The embodiments described above are applicable for any synthetic sweetener, blends thereof and other natural sweeteners, blends thereof, or mixtures of synthetic and natural sweetener(s), especially sucralose.

Diabetes is a chronic disease that occurs either when the pancreas does not produce enough insulin or when the body cannot effectively use the insulin it produces. To regulate the blood sugar, people with diabetes are instructed not to take or take less sugared consumables. The same is true for obese people. However, in such cases, there is an increased risk of developing depression. The consumables containing the compositions in present application could activate clusters of neurons either unconsciously or consciously, enhance consumers' attention of recognition of energy sources and flavors, initiate the reward system in the brain and create a hedonic feeling. Elderly people are prone to losing memory and developing Alzheimer's disease. Consumable products containing the compositions in the present application could produce familiar tastes and flavors, thus preventing or slowing the progress of memory loss and Alzheimer's disease development. An embodiment of a consumable product includes one or more compositions of G-SMW-SG-MRPs and/or G-SMW-SGs, which can improve the quality of lives for people with diabetes, depression and obesity in e.g., elderly people by activating the cluster of neurons in brain that generate hedonic feelings. An embodiment of such consumables could further activate the reward system in brain, and exhibit synergistic effects with caffeine or natural extracts containing caffeine.

High intensity sweeteners can have the disadvantage of slow onset, which can create a big challenge for the brain to recognize the safety of consumable products containing high intensity sweeteners. Slow-onset also distracts the attention for identifying unpleasant tastes, as well as unsynchronized tastes and flavors, which can generate a feeling of dislike. Quick onset of sweetness is an important feature for consumables containing sweeteners. The perceived quick onset feeling depends on the momentum of sweetness (momentum=velocity×strength), which is related to two factors: velocity and strength of sweet recognition. The inventor has surprisingly found that compositions containing different components and amounts according to the present application can improve the momentum of sweetness. Embodiments of comprising the substances of the present application can be used for improving the velocity and strength of sweetness.

Consumable products containing high intensity sweeteners generally lack long lasting flavor or contain flavors that are lost quickly during storage. Normally, the shelf lives of consumables are shorter. The inventor has surprisingly found that using compositions of the present application could significantly enhance and preserve the flavors in consumables, and extend their shelf life. Accordingly, the present application provides compositions for extending the shelf lives of consumables.

Honey is a sweet, viscous food substance made by honey bees and certain related insects. Bees produce honey from the sugary secretions of plants or honeydew. Honey consists mostly of glucose, fructose, maltose, and sucrose; water; other minor components include proteins, organic acids, amino acids, vitamins, flavonoids, and acetylcholine. The inventor has surprisingly found that the addition of honey or honey distillate as a sugar donor could significantly accelerate the recognition of sweetness and improve the taste and flavor profile of high intensity sweeteners.

Carrots are a traditional food containing sucrose, glucose, xylose, fructose and heptose. Carrot juice can be used as sugar donor in a Maillard reaction. Carrot juice distillates can be added before or after the Maillard reaction to enhance the sweet taste and flavor profile. Additional sweeteners, such as maple syrup, agave syrup and their hydrolyzed products, birch water, sweet fruit juices, including berry juices from e.g., strawberries and raspberries, and other fruit juices from cherries, pineapples, grapes, pears, apples, peaches, apricots, bananas, tomato etc. and vegetable juices from carrots, tomatoes etc. can be good sources for the sugar donor in the Maillard reactions of the present application.

In one embodiment, the composition of the present application includes (a) one or more G-SMW-SG-MRPs and/or one or more G-SMW-SGs; and (b) one or more components selected from honey, agave syrup, maple syrup, birch water and any fruit, berry or vegetable juice. A further embodiment includes a method for using one or more components selected from honey or honey distillate, sugar-cane juice, syrup or distillates, sugar beet juice, syrup or distillate, agave syrup or distillate, maple syrup or distillate, birch water or concentrate, and any fruit, berry, vegetable juice and distillates, any animal or plant source sweet products as a sugar donor in the Maillard reaction and their resulting reaction products for use in consumable products in an amount between about 1 to 5,000 ppm. In another embodiment, a sweetener or flavor includes one or more G-SMW-SG-MRPs and/or one or more G-SMW-SGs, which can activate the orbitofrontal cortex and adjoining agranular insula.

Fractions of fruit or vegetable juices, such as fruit juice distillates, fruit juice volatile concentrates or any type of fractions originated from fruits or vegetables etc. can be added to a composition of the present application during or after the Maillard reaction. In some embodiments, the G-SMW-SG-MRPs of the present application is produced from a reaction mixture comprising fractions of fruit or vegetable juices.

Oral viscosity can be perceived by the human primary taste cortex, mid insular area, and the orbitofrontal and perigenual cingulate cortices. It is known that the perigenual cingulate cortex can be activated by the texture of fat in the mouth and sucrose. Surprisingly, compositions of the present application can activate the perigenual cingulate cortex and medial orbitofrontal cortex so as to improve the mouthfeel of consumables containing high intensity sweeteners. In further embodiments, a sweetener or flavor comprises compositions of the present application that activate the insular taste cortex.

High intensity sweeteners do not activate neurons in the vagal ganglia and brainstem via the gut—brain axis to produce feelings of satiety. However, in certain embodiments, compositions of the embodiment of the present application containing high intensity sweeteners in combination with one or more G-SMW-SG-MRPs and/or one or more G-SMW-SGs, can stimulate such neurons to create a sugar-taking feeling without the accompaniment of ingested calories.

The inventor of the present application has surprisingly found that compositions containing one or more G-SMW-SG-MRPs and/or one or more G-SMW-SGs can improve the taste profile of certain steviol glycosides. One aspect of the present application provides a method to improve a taste of a composition containing such steviol glycosides by adding one or more G-SMW-SG-MRPs and/or one or more G-SMW-SGs to the composition.

### EXAMPLES

### Example 1. Sensory Evaluation Methods and their Use in Evaluating the Sweetness and Overall Likability of Samples

The products in examples below are evaluated by the following methods.

Sensory evaluation method: products were evaluated in terms of mouth feel, bitterness, bitterness lingering, sweet lingering, metallic aftertaste and overall likability.

A panel of 6 trained testers evaluated the samples and gave scores of 1-5 according to the followed standards. The average score of the panel members was taken as the score of each factor.

For mouth feel, one factor, kokumi, was evaluated.

(1) Kokumi Level

Evaluation standard: A 5% sucrose solution with neutral water was prepared. This solution was used as a standard solution to which the kokumi degree was set as 5.

A 250 ppm RA (available from Sweet Green Fields) solution was prepared with neutral water. This solution was used as a standard solution to which the kokumi degree was set as 1.

An appropriate amount of yeast extract (available from Leiber, 44400P-145) was dissolved in a 250 ppm aqueous solution of RA97 such that the degree of kokumi of the resulting solution was consistent with the standard solution of kokumi degree of 5 (5% sucrose). After evaluation by a panel of 6 testers, it was determined that a solution of 100 ppm the yeast extract dissolved in 250 ppm RA97 was substantially identical to the degree of kokumi of the 5% sucrose solution. Thus, the criteria for determining the degree of kokumi are as follows.

TABLE 1-1
Kokumi evaluation test standard
RA97 250 ppm

| | Range of yeast extract concentration | | | | |
|---|---|---|---|---|---|
| | <25 ppm | 25-50 ppm | 50-75 ppm | 75-100 ppm | >100 ppm |
| Score of | 1 | 2 | 3 | 4 | 5 |
| kokumi | | | | | |
| level | | | | | |

Evaluation Method:

The sample to be evaluated was dissolved in neutral deionized water. The tester placed 20-30 mL of the evaluation solution in their mouth. After 5 seconds the solution was spit out. After a mouthwash step with water, the standard solution was taken. If the degree of Kokumi was similar, the Kokumi degree of the sample solution could be determined as the Kokumi degree value of the standard solution. Otherwise it was necessary to take additional standard solutions and try again until the Kokumi degree value was determined.

(2) Bitterness

Quinine (99% purity) concentration of 10⁻⁸-10⁻⁴ mol/L was the bitterness standard, and the specific bitterness scoring standards are shown in the following table.

TABLE 1-2
Bitterness evaluation test standard

| | Range of quinine | | | | |
|---|---|---|---|---|---|
| | concentration mol/L | | | | |
| | <8 × | 8 × 10⁻⁷~ | 7 × 10⁻⁶~ | 2 × 10⁻⁵ ~ | >1 × |
| | 10⁻⁷ | 3 × 10⁻⁶ | 2 × 10⁻⁵ | 1 × 10⁻⁴ | 10⁻⁴ |
| Score of | 1 | 2 | 3 | 4 | 5 |
| bitterness | | | | | |

The sample to be evaluated was dissolved in neutral deionized water. The tester placed 20-30 mL of the evaluation solution in their mouth. After 5 seconds the sample was spit out. After a rinse step with water, the standard solution was tasted. If the bitter taste was similar, the bitterness of the sample could be determined as the bitterness value of the standard solution. Otherwise it was necessary to take additional standard solution(s) and try again until the bitterness value was determined.

(3) Bitterness Lingering

The sample to be evaluated was dissolved in neutral deionized water. The tester placed 20-30 mL of the evaluation solution in their mouth, and timing was started to record the bitterness start time and peak time. The test solution was then spit out. Recording of time continued for the time when the bitterness disappeared completely. The time at which the bitterness completely disappeared was compared to the time in the table below to determine the value of bitterness lingering.

TABLE 1-3
Bitterness lingering evaluation test standard

| | Time at which the bitterness | | | | |
|---|---|---|---|---|---|
| | completely disappears | | | | |
| | <20 s | 20-30 s | 30-40 s | 40-50 s | >50 s |
| Score of | 1 | 2 | 3 | 4 | 5 |
| bitterness | | | | | |
| lingering | | | | | |

(4) Sweet Lingering

The sample to be evaluated was dissolved in neutral deionized water. The tester placed 20-30 mL of the evaluation solution in their mouth, and timing was started to record the sweetness start time and peak time. The test solution was then spit out. Recording of time continued for the time when the sweetness disappeared completely. The time at which the sweetness completely disappeared was compared to the time in the table below to determine the value of sweet lingering.

TABLE 1-4
Sweet lingering evaluation test standard

| time at which the sweetness | | | | | |
|---|---|---|---|---|---|
| completely disappears | <20 s | 20-30 s | 30-40 s | 40-50 s | >50 s |
| Score of sweet lingering | 1 | 2 | 3 | 4 | 5 |

(5) Metallic Aftertaste

Sucralose (available from Anhui Jinhe Industrial Co., Ltd and Lot # is 201810013) was used as a standard reference. The specific metallic aftertaste scoring standards are shown in the table below.

TABLE 1-5
Metallic aftertaste evaluation test standard

| Range of | | | | | |
|---|---|---|---|---|---|
| sucralose | <50 | 50- | 100- | 150- | >200 |
| concentration | ppm | 100 ppm | 150 ppm | 200 ppm | ppm |
| Score of | 1 | 2 | 3 | 4 | 5 |
| metallic | | | | | |
| aftertaste | | | | | |

The sample to be evaluated was dissolved in neutral deionized water. The tester placed 20-30 mL of the evaluation solution in their mouth. After 5 seconds, the solution was spit out. After a rinse step with water the standard solution was tasted. If the metallic aftertaste was similar, the metallic aftertaste of the sample was determined as the metallic aftertaste score of the standard liquid, otherwise it was necessary to take additional standard liquid samples and taste it again until the metallic aftertaste score was determined.

(6) Overall Likability

Overall likability is the general impact of the sample. The sample to be evaluated was dissolved in neutral deionized water. The tester places 20-30 mL of the evaluation solution in their mouth and evaluate the general impact based on its kokumi, bitterness, bitterness lingering, sweet lingering, and metallic aftertaste. The test solution was then spit out. A score of 1-5 indicates a strong dislike, dislike, average, like, and strong like.

(7) Sucrose Equivalence

The terms “sucrose equivalence” and “SugarE” refer to the amount of non-sucrose sweetener required to provide the sweetness of a given percentage of sucrose in the same solution.

TABLE 1-6
SugarE evaluation standard:

| Sucrose | 1 g | 2 g | 3 g | 4 g | 5 g | 6 g | 7 g | 8 g | 9 g | 10 g |
|---|---|---|---|---|---|---|---|---|---|---|
| weight | | | | | | | | | | |
| Water volume | 100 mL | | | | | | | | | |
| SugarE | 1% | 2% | 3% | 4% | 5% | 6% | 7% | 8% | 9% | 10% |

Evaluation method: The sample to be evaluated was dissolved in neutral deionized water. The tester placed 20-30 mL of the evaluation solution in their mouth. After 5 seconds the solution was spit out. After a mouthwash step with water, the standard solution was taken. If the degree of SugarE was similar, the SugarE degree of the sample solution can be determined as the SugarE degree value of the standard solution. Otherwise it was necessary to take additional standard solutions and try again until the SugarE degree value was determined.

(8) Time-Intensity Curves

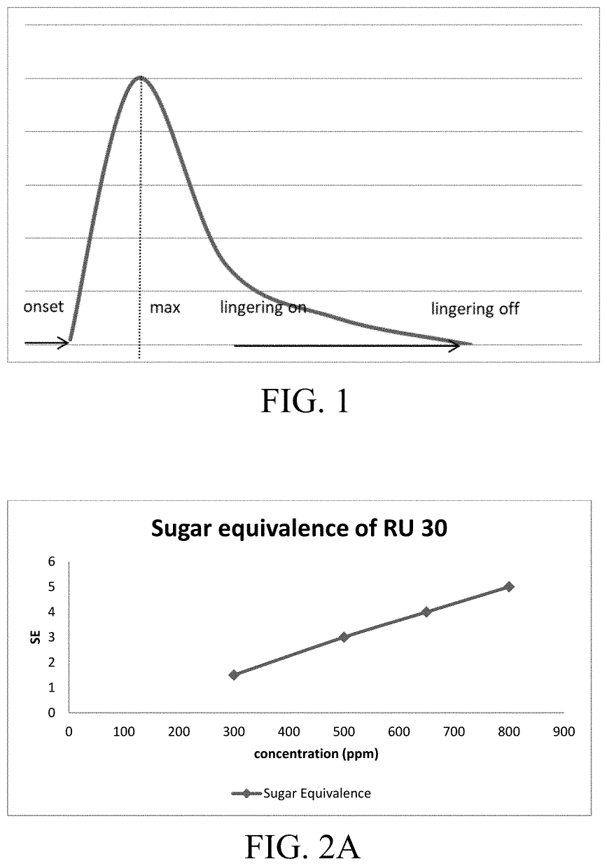

Evaluation method: Each person of the test panel had to drink sample solutions with defined concentrations. During the test, all persons had a time clock. They had to note the appearance-time for four specific points of a time-intensity curves (onset, maximum sweetness, lingering on and lingering off). The results were recorded and make a graph, mean values were calculated from at least 6 individual test persons. FIG. 1 shows a schematic diagram of an exemplary Time-intensity curve.

(9) Starch Taste

Maltodextrin (available from BAOLIBAO BIOLOGY Co., Ltd) was used as a standard reference. The specific starch taste scoring standards are shown in the table below.

TABLE 1-7
Starch taste evaluation test standard

| Maltodextrin | | | | | |
|---|---|---|---|---|---|
| concentration range | <0.5% | 0.5%-1% | 1%-2% | 2%-3% | >3% |
| Score of starch taste | 1 | 2 | 3 | 4 | 5 |

Each sample to be evaluated was dissolved in neutral deionized water. The tester placed 20-30 mL of the evaluation solution in their mouth. After 5 seconds, the solution was spit out. After a rinse step with water the standard solution was tasted. If the starch taste was similar, the starch taste of the sample was determined as the starch taste score of the standard liquid, otherwise it was necessary to take additional standard liquid samples and taste it again until the starch taste score was determined.

### Example 2. Preparation of Glycosylated Rebaudioside B, Glycosylated Steviolbioside and Glycosylated Steviol Monoside

A glycosylated steviol glycoside was prepared using steviol glycosides, such as rebaudioside B, steviolbioside and steviol monoside as materials (the contents and source are shown in Table 2-1) according to the following method:

TABLE 2-1
Contents and source of RB, STB and STM

| | Company | Lot#. | Content |
|---|---|---|---|
| RB | EPC Natural | EPC-316-61-02 | 93.61% |
| STB | Products Co., | EPC-316-58-01 | 92.12% |
| STM | Ltd. | EPC-316-58-01 | 91.61% |

i) 15 g maltodextrin (BAOLINGBAO BIOLOGY Co., Ltd) was dissolved in 45 mL deionized water

ii) 15 g steviol glycoside was added to the dissolved dextrin solution to form a mixture.

iii) 0.75 mL CGTase enzyme (Amano Enzyme, Inc) and 15 mL deionized water were added to the mixture and incubated at 69° C. for 20 hours to glycosylate the steviol glycoside with glucose molecules derived from maltodextrin.

iv) The reaction mixture of iii) was heated to 85° C. for 10 min to inactivate the CGTase, which was then removed by filtration.

v) The resulting solution of glycosylated steviol glycoside such as GRB, GSTB or GSTM, residual steviol glycoside such as RB, STB or STM and dextrin were decolored and spray dried, thereby yielding GRB, GSTB or GSTM as white powder.

### Example 3. Preparation of Flavored GRB-MRP-FTA, GSTB-MRP-FTA and GSTM-MRP-FTA from GRB, GSTB and GSTM, Glutamic Acid and Fructose

Materials: GRB, GSTB and GSTM: the product of Example 2.

Procedure: GRB, GSTB or GSTM, respectively, fructose, glutamic acid and water are weighted as mentioned in Table 3-1 and then mixed. The solution was then heated at about 100° C. for 1.5 hour. When the reaction was completed, the solution was filtered through filter paper and the filtrate was dried with a spray dryer, thereby obtained off white powder named as 3-01 to 3-03, respectively.

TABLE 3-1
Sample compositions.

| | Weight of | | Weight of | |
|---|---|---|---|---|
| Product | GRB, GSTB | Weight of | glutamic | Weight of |
| No. | or GSTM | fructose (g) | acid (g) | water (g) |
| 3-01 | GRB (9 g) | 0.5 | 0.5 | 5 |
| 3-02 | GSTB (9 g) | | | |
| 3-03 | GSTM (9 g) | | | |

### Example 4. GRB-MRP-FTA, GSTB-MRP-FTA and GSTM-MRP-FTA (3-01 to 3-03 in Ex. 3) Improve the Taste Profile of Carbonated Sugar-Free Peach Flavored Beverage (Artificial Sweetener Sucralose)

Process: GRB-MRP-FTA, GSTB-MRP-FTA and GSTM-MRP-FTA (3-01 to 3-03 in Ex. 3), sucralose (available from Anhui Jinhe Industrial Co., Ltd and Lot # is 201810013) and fruit flavoring (peach flavor, available from Givaudan China Ltd, Lot #: BJS003) were weighed and uniformly mixed as shown in Table 4-1.

TABLE 4-1
Sample compositions.

| | | | Fruit | | | | Fruit |
|---|---|---|---|---|---|---|---|
| | | Sucralose | flavoring | Water | MRP | Sucralose | flavoring |
| Sample | MRP (mg) | (mg) | (mg) | (mL) | (ppm) | (ppm) | (ppm) |
| Base | 0 | 10 | 30 | 100 | 0 | 100 | 300 |
| 4-01 | 10 | | | | 100 | | |
| | (Product 3-01) | | | | | | |
| 4-02 | 10 | | | | 100 | | |
| | (Product 3-02) | | | | | | |
| 4-03 | 10 | | | | 100 | | |
| | (Product 3-03) | | | | | | |

Experiment: Each sample in Table 4-1 was evaluated according to the aforementioned sensory evaluation method in Ex. 1, and the average score of the panel for each sensory attribute was taken as the evaluation test result. The taste profile for each sample is shown in Table 4-2.

TABLE 4-2
GRB-MRP-FTA, GSTB-MRP-FTA and GSTM-MRP-FTA (3-01 to
3-03 in Ex. 3) in carbonated sugar-free peach flavored
beverage (artificial sweetener sucralose).

| | Overall | Sweetness | | | Metallic |
|---|---|---|---|---|---|
| Sample | likability | onset | Flavor | Mouthfeel | aftertaste |
| Base | 2.5 | 2 | 3 | 2 | 4 |
| 4-01 | 3 | 2.5 | 3.2 | 3 | 1.5 |
| 4-02 | 3.5 | 2.8 | 3.5 | 3.2 | 2 |
| 4-03 | 3.5 | 3 | 3.5 | 2.8 | 2 |

Conclusion: GRB-MRP-FTA, GSTB-MRP-FTA and GSTM-MRP-FTA (3-01 to 3-03 in Ex. 3) significantly reduced the metallic aftertaste of sucralose. In addition, GRB-MRP-FTA, GSTB-MRP-FTA and GSTM-MRP-FTA (3-01 to 3-03 in Ex. 3) provided significantly improved the sweetness onset, mouthfeel and flavor of the carbonated sugar-free peach flavored beverage containing the artificial sweetener, sucralose. These sensory effects can be extended to beverages sweetened with any artificial sweeteners.

### Example 5. GRB-MRP-FTA, GSTB-MRP-FTA and GSTM-MRP-FTA (3-01 to 3-03 in Ex. 3) Improve the Taste Profile of Natural Sweetener RA

Process: GRB-MRP-FTA, GSTB-MRP-FTA and GSTM-MRP-FTA (3-01 to 3-03 in Example 3) and RA97 (available from Sweet Green Fields. The content of RA is 97.15%. Lot #3050123) were weighed and uniformly mixed according to the weight shown in Table 171-1, and dissolved in 100 mL pure water, and subjected to a sensory evaluation test.

TABLE 5-1
Sample compositions.

| | MRP | RA | Water | MRP | RA |
|---|---|---|---|---|---|
| Sample | (mg) | (mg) | (mL) | (mg) | (ppm) |
| Base | — | 10 | 100 | — | 200 |
| 5-01 | 5 | | | 50 | |
| | (Product 3-01) | | | | |
| 5-02 | 5 | | | 50 | |
| | (Product 3-02) | | | | |
| 5-03 | 5 | | | 50 | |
| | (Product 3-03) | | | | |

Experiment: Each sample was evaluated according to the sensory evaluation method in Ex. 1, and the average score of the panel for each sensory attribute in each sample was taken as the evaluation test result, the result of which are shown in Table 5-2.

TABLE 5-2
The sensory evaluation results of GRB-MRP-FTA, GSTB-MRP-FTA
and GSTM-MRP-FTA (3-01 to 3-03 in Ex. 3) in 200 ppm RA97.

| | Overall | Sweetness | Sweet | | Metallic |
|---|---|---|---|---|---|
| Sample | likability | onset | lingering | Mouthfeel | aftertaste |
| Base | 3 | 2 | 3 | 2 | 3 |
| 5-01 | 3.5 | 2.5 | 1.5 | 2.5 | 2 |
| 5-02 | 3.8 | 3 | 1.8 | 3 | 1.2 |
| 5-03 | 3.8 | 3 | 1.5 | 3 | 1.5 |

Conclusion: GRB-MRP-FTA, GSTB-MRP-FTA and GSTM-MRP-FTA (3-01 to 3-03 in Ex. 3) significantly reduced the metallic aftertaste and sweet lingering of RA97. In addition, GRB-MRP-FTA, GSTB-MRP-FTA and GSTM-MRP-FTA (3-01 to 3-03 in Ex. 3) provided significantly improved sweetness onset and mouthfeel of the RA97. These effects can be extended to all natural sweeteners.

### Example 6. Preparation of Purified Glycosylated Steviolbioside

Materials: Glycosylated steviolbioside (GSTB), the product produced in Ex. 2.

Procedure: 20 g GSTB and 60 ml solvent (methanol/water=1/1, v/v) were added in a 250 ml flask with a reflux condenser and thermometer. The solution was stirred and heated to a boiling reflux state, remaining in that state for 30 min. The reaction mixture was cooled to room temperature thus precipitating an off-white powder. 3.3 g powder was obtained by filtration and dried in vacuum oven. The resulting product was recorded as purified STB. The filtrate was evaporated to obtain 9.0 g of off-white powder. This product was recorded as purified GSTB. The contents of steviol glycosides in the resulting powders are shown in Table 6-1.

TABLE 6-1

| Sample | | | | | Residue |
|---|---|---|---|---|---|
| # | Product | STB(%) | TSG(%)* | TGSG(%)** | maltodextrin(%) |
| 6-1 | Purified | 60.41 | 60.98 | / | / |
| | STB | | | | |
| 6-2 | Purified | 4.21 | 4.39 | 61.03 | 32.77 |
| | GSTB | | | | |

Note:
*TSG refers to the content of total steviol glycosides (TSG(9)), which includes Rebaudioside A, Rebaudioside B, Rebaudioside C, Rebaudioside D, Rebaudioside F, stevioside, steviolbioside, rubusoside, and dulcoside A.
**TGSG refers to the sum of the TSG and the content of glycosylated steviol glycosides.

### Example 7. Purified Glycosylated Steviolbioside Improves the Taste Profile of the Artificial Sweetener, Sucralose

Process: Purified GSTB (6-02 in Ex. 6) and sucralose (available from Anhui Jinhe Industrial Co., Ltd and Lot # is 201810013) were weighed and uniformly mixed according to the weights shown in Table 7-1 and dissolved in 100 mL pure water.

TABLE 7-1
Sample compositions.

| | Weight of | Weight | Volume | Concentration | Concen- |
|---|---|---|---|---|---|
| | Purified | of | of | of Purified | tration |
| Compo- | GSTB | sucralose | water | GSTB | of sucralose |
| nents | (mg) | (mg) | (mL) | (ppm) | (ppm) |
| Base | | 8 | 100 | | 80 |
| 7-01 | 10 | 8 | 100 | 100 | 80 |
| 7-02 | 20 | 8 | 100 | 200 | 80 |

Experiment: Each sample was evaluated according to the aforementioned sensory evaluation method in Ex. 1, and average scores from the panel were taken as the evaluation test results. The resulting taste profiles are shown in Table 7-2.

TABLE 7-2
Sensory evaluation of purified GSTB in 80 ppm sucralose

| | Overall | Sweetness | Sweet | | Metallic |
|---|---|---|---|---|---|
| Sample | likability | onset | lingering | Mouthfeel | aftertaste |
| Base | 2.5 | 4 | 4 | 2 | 5 |
| 7-01 | 4 | 4 | 3 | 3 | 3.5 |
| 7-02 | 4.5 | 4 | 2 | 3 | 2 |

Conclusion: Purified GSTB significantly reduced the metallic aftertaste and sweet lingering of sucralose. In addition, purified GSTB provided an improved mouthfeel of the sucralose. These effects can be extended to all artificial sweeteners.

### Example κ. Purified GSTB Improves the Taste Profile of Natural Sweeteners Rebaudioside A (RA)

Process: Purified GSTB (6-02 in Ex. 6) and RA (available from Sweet Green Fields; RA content, 97.15%, Lot #3050123) were weighed and uniformly mixed according to the weights shown in Table 175-1 and dissolved in 100 mL pure water.

TABLE 8-1
Sample compositions.

| | | | | | Concen- |
|---|---|---|---|---|---|
| | Weight of | Weight | Volume | Concentration | tration |
| Compo- | Purified | of | of water | of purified | of RA |
| nents | GSTB (mg) | RA(mg) | (mL) | GSTB (ppm) | (ppm) |
| Base | | 20 | 100 | | 200 |
| 8-01 | 10 | 20 | 100 | 100 | 200 |
| 8-02 | 20 | 20 | 100 | 200 | 200 |

Experiment: Each sample was evaluated according to the aforementioned sensory evaluation method in Ex. 1, and average scores of the panel were taken as the evaluation test results. The resulting taste profiles are shown in Table 8-2.

TABLE 8-2
Purified GSTB in 200 ppm RA

| | Overall | Sweetness | Sweet | | Metallic |
|---|---|---|---|---|---|
| Sample | likability | onset | lingering | Mouthfeel | aftertaste |
| Base | 3 | 2.5 | 5 | 3 | 5 |
| 8-01 | 3.5 | 2.5 | 4 | 3.5 | 4 |
| 8-02 | 4 | 2.0 | 3.5 | 3.5 | 4 |

Conclusion: Purified GSTB significantly reduced the metallic aftertaste and sweet lingering of RA. In addition, purified GSTB provided improved sweetness onset and mouthfeel of the RA. These effects can be extended to all natural sweeteners.

### Example 9. Preparing of Rubusoside 30% (RU30) from Chinese Sweet Tea Leaves

Materials: Chinese sweet tea leaves, Ca(OH)₂ (Sinopharm Chemical Reagent Co., Ltd), FeSO₄ (Sinopharm Chemical Reagent Co., Ltd)

Process:

(i) 100 g crushed Chinese sweet tea leaves was dissolved in 1.5 L deionized water and stirred at 70-80° C. for 1 hours and then filtered out the waste.

(ii) 0.3-0.35% FeSO₄ was added to above (i) solution and adjusted the pH to 9-10 by using Ca(OH)₂.

(iii) the above (ii) solution was filtered and collected its solution.

(iv) the solution from (iii) was treated with cation exchange resin (Xi'an Lanxiao Technology New Material Co., Ltd) and then anion exchange resin (Xi'an Lanxiao Technology New Material Co., Ltd).

(v) the solution from (iv) was filtered by 300 Dalton membrane and collected its concentrated solution.

(vi) the solution from (v) was spray dried and yield RU30. The contents of are shown in table 9-1.

TABLE 9-1
Contents of RU30 (m/m %)
Steviol-Related Compounds % (m/m)

| | |
|---|---|
| Stev | 0.38 |
| Rub | 31.01 |
| Stev-Mon | 0.38 |
| Reb-A | 0.05 |
| Suavioside A | <0.01 |
| Suavioside B | 0.15 |
| Suavioside D1/D2 | 0.03 |
| Suavioside E | 0.03 |
| Suavioside F | <0.01 |
| Suavioside H | 0.07 |
| Suavioside K | 0.06 |
| Suavioside L | <0.01 |
| Suavioside O | <0.01 |
| Suavioside Q1/Q2 | 0.07 |
| Suavioside S1/S2 | 0.05 |
| 9-OH Suav J | 0.04 |
| Sum (% m/m) | 32.32 |

Non-Steviol compounds % (m/m)

| | |
|---|---|
| 3-Caffeoylquinic acid | 0.68 |
| 4-Caffeoylquinic acid | 0.91 |
| 5-Caffeoylquinic acid | 0.06 |
| 3,5-Dicaffeoylquinic acid | 0.29 |
| 3,4-Dicaffeoylquinic acid | 0.18 |
| 4,5-Dicaffeoylquinic acid | 0.37 |
| Kaempferol-hexoside | 0.64 |
| Quercetin-pentoside | 0.32 |
| Kaempferol-xyloside-hexoside | 0.60 |
| Quercetin-dihexoside-rhamnoside | 0.35 |
| Quercetin-dirhamnoside | 0.43 |
| Sum (% m/m) | 4.84 |

### Example 10. Preparation of Maltodextrin Glycosylated RU 30% (GRU30) and β-Cyclodextrin Glycosylated RU 30% (βGRU30)

A glycosylated reaction product composition was prepared using Rubusoside 30% (product of example 9) according to the following method:

(i) 15 g maltodextrin (BAOLIBAO BIOLOGY Co., Ltd) or β-cyclodextrin (Wacker Chemical Corp.) was dissolved in 45 ml deionized water

(ii) 15 g RU30 (product of 9-01 in example 9) was added to liquefied dextrin to form a mixture.

(iii) 0.75 ml CGTase enzyme (Amano Enzyme, Inc.) and 15 ml deionized water were added to the mixture and incubated at 69° C. for 20 hours to glycosylate the RU30 with glucose molecules derived from maltodextrin or β-cyclodextrin.

(iv) The reaction mixture of (iii) was heated to 85° C. for 10 min to inactivate the CGTase, which was then removed by filtration.

(v) The resulting solution of glycosylated rubusoside (GRU), residual RU and dextrin were decolored and spray dried, thereby yielding 25 g of GRU30 (product of 10-01 in example 10) or βGRU30 (product of 10-02 in example 10) as a white powder (the contents are shown in table 10-1

TABLE 10-1
Contents of GRU 30 and β-GRU 30.

| | | | | | | β-GRU 30 (15 mg/ml) | | | | | |
|---|---|---|---|---|---|---|---|---|---|---|---|
| GRU 30 (15 mg/ml) | | | | | | Ret. | | | | | |
| Time | | | | | % | Time | | | | | % |
| (min) | Area | +glc | m/z | mg/ml | (m/m) | (min) | Area | +glc | m/z | mg/ml | (m/m) |
| 40.9 | — | — | — | — | | 40.9 | 290.6 | 7 | 1937 | 0.08 | 0.51 |
| 42.7 | — | — | — | — | | 42.7 | 427.7 | 7 | 1937 | 0.12 | 0.79 |
| 43.4 | — | — | — | — | | 43.4 | 483.0 | 6 | 1775 | 0.12 | 0.83 |
| 43.8 | — | — | — | — | | 43.8 | 135.9 | 6 | 1775 | 0.03 | 0.17 |
| 44.0 | — | — | — | — | | 44.0 | 216.3 | 6 | 1775 | 0.05 | 0.32 |
| 44.5 | — | — | — | — | | 44.5 | 499.0 | 6 | 1775 | 0.13 | 0.86 |
| 45.1 | 428.6 | 5 | 1613 | 0.10 | 0.66 | 45.1 | 897.6 | 5 | 1613 | 0.22 | 1.48 |
| 45.7 | 299.3 | 5 | 1613 | 0.07 | 0.44 | 45.7 | 731.1 | 5 | 1613 | 0.18 | 1.19 |
| 46.2 | 246.3 | 5 | 1613 | 0.05 | 0.34 | 46.2 | 490.9 | 5 | 1613 | 0.12 | 0.77 |
| 46.8 | 503.6 | 5 | 1451 | 0.11 | 0.71 | 46.8 | 900.7 | 5 | 1451 | 0.20 | 1.34 |
| 47.4 | — | — | — | — | | 47.4 | 214.5 | 4 | 1451 | 0.04 | 0.26 |
| 48.1 | 1000.1 | 4 | 1451 | 0.22 | 1.49 | 48.1 | 1582.6 | 4 | 1451 | 0.36 | 2.41 |
| 48.6 | 190.0 | 4 | 1451 | 0.03 | 0.22 | 48.6 | 371.1 | 4 | 1451 | 0.08 | 0.51 |
| 49.0 | 538.4 | 4 | 1451 | 0.12 | 0.77 | 49.0 | 753.6 | 4 | 1451 | 0.17 | 1.11 |
| 49.5 | 460.7 | 4 | 1289 | 0.09 | 0.57 | 49.5 | 748.8 | 4 | 1289 | 0.15 | 0.98 |
| 50.2 | 393.1 | 4 | 1289 | 0.07 | 0.48 | 50.2 | 430.4 | 4 | 1289 | 0.08 | 0.53 |
| 50.7 | 1939.3 | 4 | 1289 | 0.40 | 2.64 | 50.7 | 2513.8 | 4 | 1289 | 0.52 | 3.44 |
| 51.4 | 826.4 | 3 | 1127 | 0.14 | 0.95 | 51.4 | 988.5 | 3 | 1127 | 0.17 | 1.15 |
| 52.0 | 1180.0 | 3 | 1127 | 0.21 | 1.38 | 52.0 | 1408.6 | 3 | 1127 | 0.25 | 1.66 |
| 52.6 | 874.2 | 3 | 1127 | 0.15 | 1.01 | 52.6 | 1067.5 | 3 | 1127 | 0.19 | 1.24 |
| 53.1 | 1859.1 | 2 | 965 | 0.92 | 6.10 | 53.1 | 1810.9 | 2 | 965 | 0.89 | 5.95 |
| 53.5 | 1555.8 | 2 | 965 | 0.77 | 5.11 | 53.5 | 1464.5 | 2 | 965 | 0.72 | 4.81 |
| 53.9 | 2209.0 | 2 | 965 | 1.09 | 7.26 | 53.9 | 2165.5 | 2 | 965 | 1.07 | 7.11 |
| 54.4 | 340.2 | 1 | 803 | 0.03 | 0.22 | 54.4 | 275.5 | 1 | 803 | 0.03 | 0.17 |
| 55.0 | 6548.3 | 1 | 803 | 0.75 | 5.02 | 55.0 | 5287.9 | 1 | 803 | 0.61 | 4.04 |
| 56.8 | 6488.3 | RU (0) | 641 | 0.67 | 4.46 | 56.8 | 4166.2 | RU (0) | 641 | 0.43 | 2.85 |

| | | | | | |
|---|---|---|---|---|---|
| Sum of RU/GRU (mg/ml) and % | 10.15 | 39.8 | Sum of RU/GRU (mg/ml) and % | 14.62 | 46.5 |
| (m/m): | | | (m/m): | | |

### Example 11. Sensory Evaluation Comparison of GRU30 with βGRU30

Materials:

GRU30, product of 10-01 in example 10

βGRU30, product of 10-02 in example 10

All the samples were weighed, uniformly mixed and dissolved in 100 ml pure water as shown in Table 11-1 prior to being subjected to the sensory evaluation tests described below.

TABLE 11-1
Test sample composition preparation.

| | concentration of | concentration of β | Volume of |
|---|---|---|---|
| | GRU30 | GRU30 | pure water |
| No. | (ppm) | (ppm) | (mL) |
| 11-1 | 300 | | 100 |
| 11-2 | | 300 | 100 |

Experiment: Each sample was evaluated according to the sensory evaluation method. Average scores from the test panel for each sensory criterium were recorded as the evaluation test results. The resulting taste profiles of the mixtures are shown in Table 11-2.

TABLE 11-2
Sensory evaluation of sweetener compositions.

| | Overall | Mouth | | Metallic |
|---|---|---|---|---|
| No. | likability | feel | Bitterness | aftertaste |
| GRU30 | 4 | 3 | 1 | 1 |
| βGRU30 | 3 | 2 | 2 | 2 |

Conclusion: Both products have improved mouthfeel and taste profile, and could act as excellent raw material for further fermentation process.

### Example 12. Preparing of Rubusoside 40% (RU40) from Chinese Sweet Tea Leaves

Materials: Chinese sweet tea leaves, Ca(OH)₂ (Sinopharm Chemical Reagent Co., Ltd), FeSO₄(Sinopharm Chemical Reagent Co., Ltd)

Process:

(i) 100 g crushed Chinese sweet tea leaves was dissolved in 1.5 L deionized water and stirred at 70-80° C. for 1 hours and then filter out the waste.

(ii) 0.3-0.35% FeSO₄ was added to above (i) solution and adjust the pH to 9-10 by using Ca(OH)₂.

(iii) the above (ii) solution was filtered and collected its solution.

(iv) the solution from (iii) was treated with cation exchange resin (Xi'an Lanxiao Technology New Material Co., Ltd) and then anion exchange resin (Xi'an Lanxiao Technology New Material Co., Ltd).

(v) the solution from (iv) was filtered by 800 Dalton membrane and collect its concentrated solution.

(vi) the solution from (v) was spray dried and yield RU40. The contents of are shown in table 12-1.

TABLE 12-1
Contents of RU40 (m/m %)

| Name | RD | RA | STV | RF | RC | DA | RU | RB | STB | TSG(9) |
|---|---|---|---|---|---|---|---|---|---|---|
| RU40 | 0.04 | 0.51 | 0.49 | 0.36 | / | / | 40.97 | / | / | 42.36 |

### Example 13. Preparation of Glycosylated RU 40% (GRU40)

A glycosylated reaction product composition was prepared using Rubusoside 40% (product of Example 12, RU40) according to the following method:

(i) 15 g maltodextrin (BAOLIBAO BIOLOGY Co., Ltd) was dissolved in 45 ml deionized water

(ii) 15 g RU40 was added to liquefied dextrin to form a mixture.

(iii) 0.75 ml CGTase enzyme (Amano Enzyme, Inc.) and 15 ml deionized water were added to the mixture and incubated at 69° C. for 20 hours to glycosylate the RU40 with glucose molecules derived from maltodextrin.

(iv) The reaction mixture of (iii) was heated to 85° C. for 10 min to inactivate the CGTase, which was then removed by filtration.

(v) The resulting solution of glycosylated rubusoside (GRU), residual RU and dextrin were decolored and spray dried, thereby yielding 23 g of GRU40 as a white powder.

### Example 14. Sweetness and Overall Likability of RU30 (Product of Example 9) and GRU30 (Product of 10-01 in Example 10)

RU30 and GRU30 are from Examples 9-10 were weighed and uniformly mixed according to the weights shown in Table 14-1 and 14-2; dissolved in 100 ml pure water; and subjected to a sweetness and overall likability evaluation test.

TABLE 14-1
RU30 (product of example 9) sample composition

| | Concentration of | Weight of | Volume of Pure |
|---|---|---|---|
| No. | RU30 (ppm) | RU30 (g) | Water (mL) |
| 6-1-01 | 300 | 0.03 | 100 |
| 6-1-02 | 500 | 0.05 | 100 |
| 6-1-03 | 650 | 0.065 | 100 |
| 6-1-04 | 800 | 0.08 | 100 |

TABLE 14-2
GRU30 (product of 10-01 in example 10) sample composition

| | Concentration of | Weight of | Volume of Pure |
|---|---|---|---|
| No. | GRU30 (ppm) | GRU30 (g) | Water (mL) |
| 6-2-01 | 350 | 0.035 | 100 |
| 6-2-02 | 750 | 0.075 | 100 |
| 6-2-03 | 1000 | 0.1 | 100 |
| 6-2-04 | 1200 | 0.12 | 100 |

The sugar equivalence and overall likability of above solutions were evaluated by the sensory evaluation methods. An overall likability score of 3 or above means palatable taste. The results are shown in Tables 14-3 and 14-4.

TABLE 14-3
Sugar equivalence and overall likability evaluation of RU30

| | Concentration of | Sugar | Overall |
|---|---|---|---|
| No. | RU30 (ppm) | Equivalence | likability |
| 6-1-01 | 300 | 1.5 | 3.5 |
| 6-1-02 | 500 | 3 | 2.8 |
| 6-1-03 | 650 | 4 | 2 |
| 6-1-04 | 800 | 5 | 1 |

TABLE 14-4
Sugar equivalence and overall likability evaluation of GRU30

| | Concentration of | Sugar | Overall |
|---|---|---|---|
| No. | GRU30 (ppm) | Equivalence | likability |
| 6-2-01 | 350 | 1.5 | 4 |
| 6-2-02 | 750 | 3 | 3 |
| 6-2-03 | 1000 | 4 | 2.5 |
| 6-2-04 | 1200 | 5 | 2 |

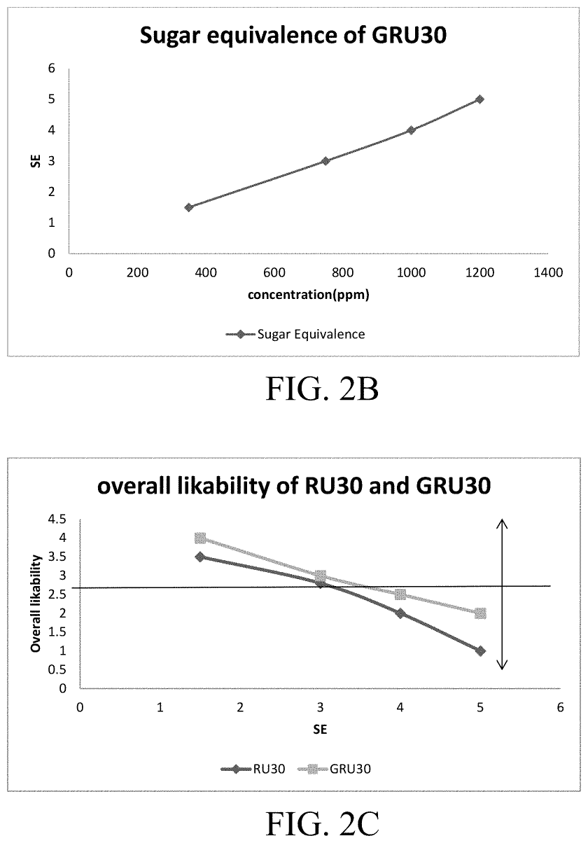

Data analysis: The Sugar equivalence evaluation of different concentrations of RU30 and GRU30 in this Example are shown in FIGS. 2A-B respectively.

The overall likability evaluation of different concentrations of RU30, GRU30 in this example are shown in FIG. 2C.

Conclusion: As shown in FIG. 2C, for RU30, the acceptable taste is 2SE. However, for GRU30, the acceptable taste improves to 3SE. This example demonstrates that the overall likability of RU30 can be modified by further modification, such as glycosylation. Again, RU30, any type of glycosylated RU30 could be used as raw material for further fermentation.

### Example 15. Evaluation of the Taste Profiles of RU30, GRU30 in a 30% Sugar Reduction System with Peach Flavor

Materials: RU30, product of example 9; GRU30, product of 10-01 in example 10.

Peach flavor essence: available from Givaudan Corp. Lot #: BJS004.

Preparation of sample solutions: RU30, GRU30, peach flavor essence and 7% sugar solution were mixed according to the weights shown in Table 15-1 below, a 10% sugar solution is selected as a reference.

TABLE 15-1
Test sample compositions.

| | | | | | Concentration | Concentration |
|---|---|---|---|---|---|---|
| | Weight of | Volume | Concentration of | Sugar | of peach | of citric |
| | RU30/GRU30 | of | RU30/ | concentration | flavor essence | acid(ppm) |
| Components | (g) | water | GRU30(ppm) | (%) | (ppm) | |
| Reference | 0 | 100 ml | 0 | 10 | 300 | 750 |
| RU30 | 0.05 | | 500 | 7 | | |
| GRU30 | 0.075 | | 750 | 7 | | |

TABLE 15-2
RU30, GRU30 in a 7% sugar solution

| | | Overall | Mouth | |
|---|---|---|---|---|
| sample | Flavor | likability | feel | Bitterness |
| Reference | 3 | 3 | 2 | 2 |
| RU30 | 2.8 | 2.5 | 3 | 2.5 |
| GRU30 | 4 | 4 | 4 | 1 |

Conclusion: in a 30% sugar reduction system, GRU30 were found to supply a significantly pleasant flavor and mouthfeel compared to RU30 and 10% sugar solution. In addition, GRU30 can also reduce the bitterness of peach flavor. This result shows that the mouth feel and flavor of RU30 can be significantly improved by glycosylation. It could be expected that fermentation of RU30 or GRU30 could provide unique flavor for food and beverage.

### Example 16. Evaluation of the Taste Profiles of RU30, GRU30 in a 40% Sugar Reduction Milk System

Materials: RU30, product of example 9; GRU30, product of 10-01 in example 10.

Whole fat pure milk, available from Inner Mongolia Yili Industrial Group Co., Ltd. Lot #20210916. Ingredients: raw milk.

Preparation of sample solutions: RU30, GRU30 and 6% sugar solution were mixed according to the weights shown in Table 16-1 below, a 10% sugar solution is selected as a reference.

TABLE 16-1
Test sample compositions.

| | Weight | | Concentration | Sugar |
|---|---|---|---|---|
| | of RU30/ | Volume of | of RU30/ | concentration |
| Components | GRU30 (g) | milk | GRU30(ppm) | (%) |
| Reference | 0 | 100 ml | 0 | 10 |
| RU30 | 0.065 | | 650 | 6 |
| GRU30 | 0.1 | | 1000 | 6 |

TABLE 16-2
RU30, GRU30 in a 6% sugar solution

| | | Overall | Mouth | |
|---|---|---|---|---|
| sample | Flavor | likability | feel | Bitterness |
| Reference | 3 | 3.5 | 2 | 1 |
| RU30 | 2.5 | 2 | 3 | 2 |
| GRU30 | 4.5 | 4.5 | 4 | 1 |

Conclusion: in a 40% sugar reduction milk system, GRU30 were found to significantly increase milk flavor and mouthfeel compared to RU30 and 10% sugar solution. This result shows that the mouth feel and flavor of RU30 can be significantly improved by glycosylation.

### Example 17. Preparation of GRU30-MRP-FTA/GRU40-MRP-FTA from GRU30/GRU40 Using Concentrated Apple Syrup as a Sugar Donor

Raw materials: GRU30: the product of 10-01 in Ex. 10; GRU40: the product of Ex. 12; concentrated apple syrup: Decolorized and deacidified concentrated apple juice (fructose content: 36.77%), available from China Haisheng Fresh Fruit Juice Co. Ltd, Weinan Branch, Lot #:25191005B01-05.

Process: GRU30/GRU40, concentrated apple syrup, glutamic acid, and water were weighed, mixed and dissolved. The resulting solution was then heated at about 100° C. for 1.5 hours. When the reaction was completed, the solution was filtered through filter paper and the filtrate was dried with a spray dryer, resulting in product 17-01 and 17-02 as off-white powder.

TABLE 17-1

| | | Weight/ | | Weight/ | Fructose | Weight |
|---|---|---|---|---|---|---|
| | Type of | GRU30/ | Weight/ | concentrated | solid | of |
| Product | GRU30/ | GRU40 | glutamic | apple syrup | equiv. | water |
| No. | GRU40 | (g) | acid (g) | (g) | (g) | (g) |
| 9-01 | GRU30 | 18 | 1 | 15.82 | 5.82 | 4 |
| 9-02 | GRU40 | 18 | 1 | 15.82 | 5.82 | 4 |

### Example 18. GRU30-MRP-FTA(Product of 17-01 in Example 17)/GRU40-MRP-FTA (Product of 17-02 in Example 17) Improve the Taste Profile of Sparkling Water Consist of Natural Sweeteners

Materials: GRU30-MRP-FTA(product of 17-01 in example 17)/GRU40-MRP-FTA (product of 17-02 in example 17); RA100 (RA content, 100.03%; available from Sweet Green Fields Co. Ltd., Lot # CT001-140604); Erythritol (available from Zhucheng Dongxiao Biotechnology Co., Ltd.); RA75/RB15 (available from Sweet Green Fields Co. Ltd., Lot #3080380); RA80/RB10/RD6 (available from Sweet Green Fields Co. Ltd., Lot #3080452).

Process: a natural sweeteners sparkling water were prepared by using above materials, which is selected as a base. And then a certain amount of GRU30-MRP-FTA(product of 17-01 in example 17)/GRU40-MRP-FTA (product of 17-02 in example 17) powder was added to the base to evaluate its effects. The details are in Table 18-1.

TABLE 18-1
Test sample preparation for sensory evaluations.

| | Weight | | | | | | |
|---|---|---|---|---|---|---|---|
| | of | | | | | | |
| | GRU30- | | | | | | |
| | MRP- | | | | | | |
| | FTA/ | Weight | | | | | Volume |
| | GRU40- | of | Weight | Weight | | | of |
| | MRP- | Citric | of | of | Weight of | Weight of | deionized |
| | FTA | Acid | Erythritol | RA100 | RA75/ | RA80/RB10/ | water |
| Product | (g) | (g) | (g) | (g) | RB15 (g) | RD6 (g) | (mL) |
| Base | — | 0.15 | 6 | 0.06 | 0.03 | 0.03 | 300 |
| GRU30- | 0.015 | 0.15 | 6 | 0.06 | 0.03 | 0.03 | 300 |
| MRP-FTA | | | | | | | |
| GRU40- | 0.015 | 0.15 | 6 | 0.06 | 0.03 | 0.03 | 300 |
| MRP-FTA | | | | | | | |

Each sample was evaluated and average scores from the test panel for each sensory criterium were recorded as the evaluation test results in Table 18-2.

TABLE 18-2
Sensory evaluation results.

| | Overall | Sweet | Sweet | Bitterness |
|---|---|---|---|---|
| No. | likability | onset | peak | lingering |
| base | 2 | 2 | 1.5 | 4 |
| GRU30-MRP- | 4 | 3 | 3 | 2 |
| FTA | | | | |
| GRU40-MRP- | 4.5 | 3.5 | 3 | 1 |
| FTA | | | | |

Conclusion: GRU30-MRP-FTA (product of 17-01 in example 17)/GRU40-MRP-FTA (product of 17-02 in example 17) can improve sweet onset and sweet peak, reduce bitterness lingering, and enhance overall likability of sparkling water. Such effect can be extended to all natural sweeteners. Sweet tea extract and glucosylated sweet tea extract could be used as raw material for maillard reaction, all type of sweet tea extract, glycosylated sweet tea extract and their MRPs could be further used for fermentation.

### Example 19. GRU30-MRP-FTA Improves the Taste Profile of Commercial Dairy Products

Reference: Whole fat pure milk, available from Inner Mongolia Yili Industrial Group Co., Ltd. Lot #20210316. Ingredients: raw milk.

Test sample: Dissolve certain amount of GRU30-MRP-FTA (product of 17-01 in example 17) powder into commercial dairy products. The details are as follows.

TABLE 19-1
Test sample composition

| Test | Weight of GRU30- | Volume of dairy | Concentration |
|---|---|---|---|
| Sample | MRP-FTA (mg) | product (mL) | (ppm) |
| Reference | / | 100 | / |
| 11-01 | 5 | 100 | 50 |

Experiment: Each sample was evaluated according to the sensory evaluation method. Average scores from the test panel for each sensory criterion were recorded as the evaluation test results. The resulting taste profiles of the mixtures are shown in Table 19-2.

TABLE 19-2
Sensory evaluation results of GRU30-MRP-FTA (product
of 17-01 in example 17) in a dairy product.

| | Overall | | Mouth |
|---|---|---|---|
| Sample | likability | Flavor | feel |
| Reference | 3.5 | 3 | 3 |
| 11-01 | 4.5 | 4 | 5 |

Conclusion: GRU30-MRP-FTA (product of 17-01 in example 17) provides a pleasant milk and creamy flavor and enhanced mouth feel of milk. The results showed that GRU30-MRP-FTA (product of 17-01 in example 17) improves the taste profile of dairy products. This effect can be extended to dairy products of all flavors.

### Example 20. GRU30-MRP-FTA (Product of 17-01 in Example 17) Improves the Taste of Black Tea Drink

Black tea drink: The black tea drink (Reference) was made according to the followed formulation.

Ingredients: Water 100 mL, sugar 8 g, citric acid 0.088g, malic Acid 0.022 g, black tea powder 0.2 g.

The test black tea drink (Test) was made according to the followed process.

GRU30-MRP-FTA (product of 17-01 in example 17) was dissolved into Reference. The details are as follows.

TABLE 20-1
Test sample components

| | Weight of GRU30-MRP- | |
|---|---|---|
| | FTA (product of 17-01 in | Volume of |
| Components | example 17) | reference (mL) |
| Reference | | 100 ml |
| GRU30-MRP- | 5 mg | 100 ml |
| FTA (product of | | |
| 17-01 in | | |
| example 17) | | |

Experiment: Reference and test samples were evaluated according to the sensory evaluation method. Average scores from the test panel for each sensory criterion were recorded as the evaluation test results. The resulting taste profiles of the mixtures are shown in Table 20-2.

TABLE 20-2
Sensory evaluation results of GRU30-MRP-FTA (product
of 17-01 in example 17) in a black tea drink.

| | Overall | | Mouth | | Bitterness |
|---|---|---|---|---|---|
| Sample | likability | Flavor | feel | Bitterness | lingering |
| Reference | 3 | 3 | 3 | 3 | 3.5 |
| GRU30-MRP- | 4.5 | 4 | 4 | 2 | 2 |
| FTA (product of | | | | | |
| 17-01 in | | | | | |
| example 17) | | | | | |

Conclusion: GRU30-MRP-FTA (product of 17-01 in example 17) significantly reduced the bitterness and bitterness lingering of black tea drink. In addition, GRU30-MRP-FTA (product of 17-01 in example 17) provided significantly improved flavor and mouth feel of the black tea drink. These effects can be extended to all tea drinks.

### Example 21. RU90 Improves the Bitterness of Quinine Sulfate Dihydrate

Quinine sulfate dihydrate: available from Maya reagent. Lot # MAYA-CR-5784. Purity: 99.0%.

RU90: available from Guilin Layin Natural Ingredients Corp. The concentration of RU is 86.39% Lot #20062501).

All the samples are made according to the followed process. Quinine sulfate dihydrate was selected as a reference. The details are as follows.

TABLE 21-1
Test sample components

| | | Concentration of | Volume of |
|---|---|---|---|
| | Concentration of | quinine sulfate | reference |
| Components | RU90 (ppm) | dehydrate (ppm) | (mL) |
| Reference | | 15 | 100 ml |
| RU90 | 100 | 15 | 100 ml |

Experiment: Reference and test samples were evaluated according to the sensory evaluation method. Average scores from the test panel for each sensory criterion were recorded as the evaluation test results. The resulting taste profiles of the mixtures are shown in Table 21-2.

TABLE 21-2
Sensory evaluation results of RU90 in quinine sulfate dihydrate.

| | Overall | Mouth | | Bitterness |
|---|---|---|---|---|
| Sample | likability | feel | Bitterness | lingering |
| Reference | 3 | 3 | 3 | 3 |
| RU90 | 4.5 | 4 | 4 | 4 |

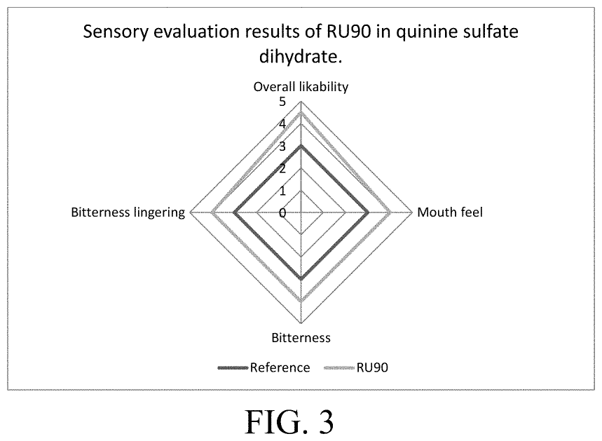

FIG. 3 shows sensory evaluation results of RU90 in quinine sulfate dihydrate. Conclusion: RU90 significantly enhance the bitterness and bitterness lingering of quinine sulfate dihydrate. In addition, RU90 provided significantly improved mouth feel of the quinine sulfate dihydrate. Stevia extract or sweet tea extract comprises enriched Ruboside could be used as bitterness enhancers. It could act as bitter substances, or used for reducing the sweetness of sweeteners. The inventor surprisingly found, taste profile of bitter substances such as quinine could be improved when using rubusoside enriched extract either from stevia or sweet tea extract or derivatives of stevia extract. Once higher amount of the composition containing rubusoside or glycosylated rubusoside is added in consumable containing bitter products such as quinine, it could enhance the bitterness of bitter substances and provide an improved mouthfeel. An embodiment of composition comprises SMW-SGs, G-SMW-SGs, G-SMW-SGs and bitter substances, where taste profile of bitter substances are improved, where the amount of bitterness substances in total composition is less than 99%, 90%, 50%, 40%, 20%, 10%, 1%.

The above description is for the purpose of teaching a person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the claimed components and steps in any sequence which is effective to meet the objectives there intended, unless the context specifically indicates the contrary.

What is claimed is:

1. A sweetening or flavor composition, comprising:
a Maillard reaction product (MRP) formed from a reaction mixture comprising
(a) a glycosylated small molecule weight steviol glycoside; and
(b) an amine donor,
wherein (a) and (b) undergo Maillard reaction; and
(2) a sweetener.

2. The sweetening or flavor composition of claim 1, wherein the Maillard reaction is carried out at a temperature of 50-250° C.

3. The sweetening or flavor composition of claim 1, wherein the glycosylated small molecule weight steviol glycoside is selected from the group consisting of glycosylated rebaudioside B, glycosylated steviolbioside, glycosylated steviol monoside, and glycosylated rubusoside.

4. The sweetening or flavor composition of claim 1, wherein the sweetener is a high intensity sweetener selected from the group consisting of stevia extracts, steviol glycosides, monk fruit extracts, mogrosides, sweet tea extracts, rubusoside, suaviosides, sucralose, acesulfame K, saccharine, aspartame and licorice extract.

5. The sweetening or flavor composition of claim 1, wherein the reaction mixture further comprises a sugar donor.

6. A consumable product comprising the sweetening or flavor composition of claim 1.

7. A method of improving the taste profile of a consumable product, comprising adding to the consumable product, a sufficient amount of the sweetening or flavor composition of claim 1.

8. A consumable product, comprising a Maillard reaction product (MRP) formed from a reaction mixture comprising:
(a) a small molecule weight steviol glycoside (SMW-SG) and/or a glycosylated small molecule weight steviol glycoside (G-SMW-SG); and
(b) an amine donor,
wherein (a) and (b) undergo Maillard reaction.

9. The consumable product of claim 8, wherein the Maillard reaction is carried out at a temperature of 50-250° C.

10. The consumable product of claim 8, wherein the SMW-SG is selected from the group consisting of rebaudioside B, steviolbioside, steviol monoside, and rubusoside, and wherein the G-SMW-SG is selected from the group consisting of glycosylated rebaudioside B, glycosylated steviolbioside, glycosylated steviol monoside and glycosylated rubusoside.

11. The consumable product of claim 8, further comprising a sweetener selected from the group consisting of stevia extracts, steviol glycosides, monk fruit extracts, mogrosides, sweet tea extracts, rubusoside, suaviosides, sucralose, acesulfame K, saccharine, aspartame and licorice extract.

12. The consumable product composition of claim 8, wherein the reaction mixture further comprises a sugar donor.

13. The consumable product of claim 8, wherein the consumable product is a beverage, a bakery product or a dairy product.

16. A method of improving a taste profile of a consumable product that contains a steviol glycoside composition as a sweetener, comprising:
adding to the consumable product, a sufficient amount of one or more small molecule weight steviol glycosides (SMW-SG)-related products, wherein the one or more SMW-SG related products are selected from the group consisting of glycosylated small molecule weight steviol glycosides (G-SMW-SGs), Maillard reaction products of small molecule weight steviol glycosides (SMW-SG-MRPs) and Maillard reaction products of glycosylated small molecule weight steviol glycosides (G-SMW-SG-MRPs),
wherein the addition of the one or more SMW-SG-related products improves a taste associated with the steviol glycoside composition.

17. The method of claim 16, wherein the one or more SMW-SG related products are selected from the group consisting of glycosylated rebaudioside B, glycosylated steviolbioside, glycosylated steviol monoside and glycosylated rubusoside.

18. The method of claim 16, wherein the one or more SMW-SG related products are selected from the group consisting of Maillard reaction products of glycosylated rebaudioside B, Maillard reaction products of glycosylated steviolbioside, Maillard reaction products of glycosylated steviol monoside and Maillard reaction products of glycosylated rubusoside.

19. The method of claim 16, wherein the taste associated with the steviol glycoside composition is sweetness onset.

20. The method of claim 16, wherein the taste associated with the steviol glycoside composition is metallic aftertaste.
